(19) United States
(12) Patent Application Publication
(10) Pub. No.: US 2010/0150120 A1
(43) Pub. Date: Jun. 17, 2010

(54) MOBILE APPLICATIONS FOR A MOBILE, BROADBAND, ROUTABLE INTERNET

(76) Inventors: Ludger Schlicht, Boca Raton, FL (US); Peter Atwal, Longwood, FL (US); Scott Y. Seidel, Fairfax, VA (US); Gregory C. Copeland, Plano, TX (US)

Correspondence Address: STRATEGIC PATENTS P.C.., C/O PORTFOLIOIP, P.O. BOX 52050, MINNEAPOLIS, MN, 55402, US

(21) Appl. No.: 12/554,807

(22) Filed: Sep. 4, 2009

Related U.S. Application Data
(60) Provisional application No. 61/094,394, filed on Sep. 4, 2008.
(60) Provisional application No. 61/094,546, filed on Sep. 5, 2008.
(60) Provisional application No. 61/118,232, filed on Nov. 26, 2008.
(60) Provisional application No. 61/094,584, filed on Sep. 5, 2008.
(60) Provisional application No. 61/094,591, filed on Sep. 5, 2008.
(60) Provisional application No. 61/094,594, filed on Sep. 5, 2008.
(60) Provisional application No. 61/094,611, filed on Sep. 5, 2008.
(60) Provisional application No. 61/095,298, filed on Sep. 8, 2008.
(60) Provisional application No. 61/095,310, filed on Sep. 9, 2008.
(60) Provisional application No. 61/094,183, filed on Sep. 4, 2008.
(60) Provisional application No. 61/094,203, filed on Sep. 4, 2008.
(60) Provisional application No. 61/094,279, filed on Sep. 4, 2008.
(60) Provisional application No. 61/094,294, filed on Sep. 4, 2008.
(60) Provisional application No. 61/094,231, filed on Sep. 4, 2008.
(60) Provisional application No. 61/094,247, filed on Sep. 4, 2008.
(60) Provisional application No. 61/094,310, filed on Sep. 4, 2008.
(60) Provisional application No. 61/103,106, filed on Oct. 6, 2008.
(60) Provisional application No. 61/111,384, filed on Nov. 5, 2008.
(60) Provisional application No. 61/112,131, filed on Nov. 6, 2008.
(60) Provisional application No. 61/121,169, filed on Dec. 9, 2008.
(60) Provisional application No. 61/187,656, filed on Jun. 16, 2009.

(51) Int. Cl. H04W 4/00

(52) U.S. Cl. 370/338

(57) ABSTRACT

In embodiments of the present invention improved capabilities are described for a mobile, broadband, routable internet that may facilitate use of mobile applications in which a plurality of mobile devices interact as nodes in a mobile ad hoc network and in which packets are IP routable to the individual device independent of fixed infrastructure elements. Certain mobile applications may be enabled on the mobile broadband routable internet by one or more enablers associated with the mobile broadband routable internet.

### CROSS-REFERENCE TO RELATED APPLICATIONS

This application claims the benefit of the following patent applications, each of which is hereby incorporated by reference in its entirety:

U.S. App. No. 61/094,394 filed Sep. 4, 2008; U.S. App. No. 61/094,546 filed Sep. 5, 2008; U.S. App. No. 61/118,232 filed Sep. 5, 2008; U.S. App. No. 61/094,584 filed Sep. 5, 2008; U.S. App. No. 61/094,591 filed Sep. 5, 2008; U.S. App. No. 61/094,594 filed Sep. 5, 2008; U.S. App. No. 61/094,611 filed Sep. 5, 2008; U.S. App. No. 61/095,298 filed Sep. 8, 2008; U.S. App. No. 61/095,310 filed Sep. 9, 2008; U.S. App. No. 61/094,183 filed Sep. 4, 2008; U.S. App. No. 61/094,203 filed Sep. 4, 2008; U.S. App. No. 61/094,279 filed Sep. 4, 2008; U.S. App. No. 61/094,294 filed Sep. 4, 2008; U.S. App. No. 61/094,231 filed Sep. 4, 2008; U.S. App. No. 61/094,247 filed Sep. 4, 2008; U.S. App. No. 61/094,310 filed Sep. 4, 2008; U.S. App. No. 61/103,106 filed Oct. 6, 2008; U.S. App. No. 61/111,384 filed Nov. 5, 2008; U.S. App. No. 61/112,131 filed Nov. 6, 2008; U.S. App. No. 61/121,169 filed Dec. 9, 2008; and U.S. App. No. 61/187,656 filed Jun. 16, 2009.

### FIELD OF THE INVENTION

The invention herein disclosed generally refers to networking, and more particularly to mobile networking.

### BACKGROUND

Existing wireless communications used in carrier-grade networks typically consist of a cell-based infrastructure where all mobile subscriber nodes must communicate directly with a network base station. As an alternative, wireless communications may utilize a mobile ad-hoc network, where any mobile node can communicate with any other node, either directly or through multiple hops across the network topology. However, existing mobile ad-hoc networks sometimes operate without any network infrastructure on a single fixed spectrum channel. Currently used techniques do not provide sufficient Quality of Service (QoS) needed to offer carrier-grade service in a heterogeneous broadband media environment containing both delay-sensitive (e.g., voice over Internet Protocol, VoIP) and delay-tolerant (e.g., internet browsing) traffic. Therefore, there exists a need to provide carrier-grade QoS in mobile networks.

### SUMMARY

In embodiments of the present invention improved capabilities are described for a mobile broadband routable internet (MBRI) providing for carrier-grade, networked, broadband, IP-routable communication among a plurality of mobile devices, where the mobile devices may represent a plurality of nodes that are linked together through a mobile ad-hoc network (MANET). Mobile devices may operate as peers in a peer-to-peer network, with full IP routing capabilities enabled within each mobile device, thereby allowing routing of IP-based traffic, including deployment of applications, to the mobile device without need for infrastructure conventionally required for mobile ad hoc networks, such as cellular telephony infrastructure. Full IP-routing to mobile devices may allow seamless integration to the fixed Internet, such as through fixed or mobile access points, such as for backhaul purposes. Thus, the MBRI may function as a standalone mobile Internet, without connection to the fixed Internet, or as an IP-routable extension of another network, whether it be the Internet, a local area network, a wide area network, a cellular network, a personal area network, or some other type of network that is capable of integration with an IP-based network.

In an aspect of the invention, methods and systems include providing a mobile, broadband, routable internet, in which a plurality of mobile devices interact as sending and receiving nodes in a mobile ad hoc network and in which packets are IP routable to the individual devices independent of fixed infrastructure elements; providing routing priority within the network, wherein the routing priority is provided by granting channel access to a node for which prioritized routing is identified and sending delay-sensitive data from the node before sending delay-tolerant data from the node; and providing a distributed computing mobile application that uses the routing priority to manage routing of data within the mobile, broadband, routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing support for peer-to-peer traffic within the network; and providing a distributed computing mobile application that provides fixed-network-independent capacity and service delivery by utilizing the peer-to-peer traffic network support.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer to peer connectivity within the mobile broadband routable internet; and providing a distributed computing mobile application that uses the peer to peer connectivity to facilitate mobile, fixed-infrastructure-independent, peer-to-peer application connection among at least a subset of the plurality of mobile devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing file sharing over the mobile broadband routable internet; and providing a distributed computing mobile application that uses file sharing without degrading system performance.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing user-generated applications over the mobile broadband routable internet; and providing a distributed computing mobile application associated with the mobile broadband routable internet, wherein the yyyy mobile application includes a user-generated application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer-to-peer applications over the mobile broadband routable internet; and providing a distributed computing mobile application that uses peer-to-peer applications without degrading performance of the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing direct device-to-device peering with symmetrical throughput between at least two nodes of the mobile broadband routable internet; and providing a distributed computing mobile application co-operating on the at least two nodes, wherein the yyyy mobile application utilizes the symmetrical throughput between the at least two nodes.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; facilitating direct-to-device application deployment over the mobile broadband routable internet; and providing a distributed computing mobile application that is deployed directly to a device in the mobile broadband routable internet using direct-to-device application deployment.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing data among a plurality of mobile broadband routable internet devices; and providing a distributed computing mobile application, wherein the mobile application uses the facility to access distributed data that is associated with the yyyy mobile application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing application components among a plurality of mobile broadband routable internet devices; and providing a distributed computing mobile application, components of which are distributed by the facility.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multicast routing within the network by allowing a data object to be transmitted by a device to a plurality of destinations over a plurality of routes; and providing a distributed computing mobile application that uses the multicast routing to at least distribute application-related updates.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote monitoring through the network; and providing a distributed computing mobile application that facilitates remote monitoring over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote control over the network; and providing a distributed computing mobile application that facilitates remote control over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote upgrade of at least one of software and services associated with the network; and providing a distributed computing mobile application that uses the remote upgrade to maintain a portion of the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an adaptive transmit power control facility for a device within the network, the adaptive transmit power control facility adapted to adjust transmission power of the device based on at least one of the density of proximate devices in the network, the condition of a neighboring device on the network, a channel condition of the network, a service level condition, a network performance condition, an environmental condition of the device and an application requirement of the device; and providing a distributed computing mobile application that uses adaptive transmit power control to adapt the transmit power associated with the application based on at least a density of devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing forwarding error correction on at least long IP packets; and providing a distributed computing mobile application that is enabled at least in part by utilizing forwarding error correction on the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for enabling adaptation of the data rate provided for links among devices within the network, the adaptation based on at least one of the density of devices in the network, the condition neighboring devices in the network, a channel condition of the network, a service level condition, a network performance condition, an environmental condition and an application requirement; and providing a distributed computing mobile application that adapts application related data transmission and receiving parameters based on the adaptive link data rates within the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing dynamic spectrum access capabilities within the network by determining communication spectrum quality and adjusting use of time frequency rectangles within the communication spectrum based on the determination; and providing a distributed computing mobile application that uses the dynamic spectrum access capabilities to provide enhanced use of spectral bandwidth.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; communicating among the plurality of devices over a radio communication spectrum and reusing portions of the spectrum for communication based on availability of time frequency rectangles within portions of the spectrum; and providing a distributed computing mobile application that reuses spectrum allocated for at least one other application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; and communicating wirelessly among at least a portion of the plurality of mobile devices, wherein the at least a portion of the plurality of mobile devices communicate independent of which radio frequency is used for the wireless communication; and wherein a distributed computing mobile application operating on at least two of the mobile devices exchanges information over the mobile broadband routable internet independent of the radio frequency.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing geo-location coding of device nodes in the network, wherein geo-location is based at least in part on a network location of a device node relative to other devices in the network; and providing a distributed computing mobile application that uses geo-location of device nodes in the network to facilitate at least one location-based service.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multimedia support within the network through a hybrid frame structure that includes variable slot duration and sub-channelization of bandwidth; and providing a distributed computing mobile application that uses multimedia support to provide yyyy related multimedia services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing time synchronization among nodes of the network, wherein the time synchronization is provided by communicating a representation of network timing at all the nodes with sufficient accuracy to enable reliable communications; and providing a distributed computing mobile application that uses network node time synchronization in delivery of the application services to device nodes in the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing seamless outdoor and indoor operation over the network; and providing a distributed computing mobile application takes advantage of the seamless outdoor and indoor operation to deliver services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing fixed radio installations that facilitate connection of the plurality of mobile devices, wherein the fixed radio installations are based at least in part on meeting a criteria associated with network radio propagation and performance; and providing a distributed computing mobile application that uses the fixed radio installation for backhaul communication associated with the application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an IP-compatible plug connection to at least one wired infrastructure type; and providing a distributed computing mobile application that uses the connection.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multiple fixed-network gateway interfaces connecting the mobile ad hoc network to a fixed network; and providing a distributed computing mobile application that communicates between a mobile device and a device on the fixed network.

In an aspect of the invention, methods and systems may include providing a mobile, broadband, routable internet, in which a plurality of mobile devices interact as nodes in a mobile ad hoc network and in which packets are IP routable to each of the devices independent of fixed infrastructure elements; providing an automated network design tool to facilitate low cost and fast network design engineering and deployment planning of the fixed infrastructure elements of the network; and deploying a distributed computing mobile application configured to use the networked designed by the design tool.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; deploying a plurality of low cost mesh access points to provide network coverage in a geography; and providing a distributed computing mobile application that communicates at least in part via the mesh access points.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing small form factor nodes that allow for low cost and fast capacity expansion and network upgrade; and providing a distributed computing mobile application that communicates at least in part via the small form factor nodes.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing communications between a mobile device and a device on a remote network so as to substantially favor routes through the mobile, broadband, routable Internet that have fewer hops between the mobile device and a backhaul access point; and providing a distributed computing mobile application that uses said communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing a user deployable access point that connects to the network; and providing a distributed computing mobile application that uses said access point.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing at least one base station controller function in at least one subscriber device, the base station controller function including at least one of an air interface management function, a signaling function, a concentration logic function, and a signal propagation function; and providing a distributed computing mobile application employing the at least one base state controller functions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing service provider tools to manage resource consumption of at least one device on the ad hoc network, wherein the tools are deployed on at least one of the plurality of mobile devices and use at least one management path for reporting usage of the at least one device; and providing a distributed computing mobile application for which the management path is used to report usage of the application.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing full radio resource management functions in at least one device, the radio resource management functions including at least one of radio management, handover, handoff, and foreign device cooperation functions, wherein the at least one device is a subscriber device; and providing a distributed computing mobile application operating responsively to a state of a managed radio resource.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multi-session functions in at least one of the plurality of devices, wherein the at least one device is a subscriber device; and providing a distributed computing mobile application communicating via multiple sessions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing cost-based routing functions in the network through dynamic forming and reforming of links and routes, wherein the cost-based routing functions are provided in a plurality of subscriber devices; and providing a distributed computing mobile application that uses the cost-based routing functions to deliver a desired balance of cost and quality of service.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP router functions at individual mobile devices of the network, wherein the individual mobile devices are subscriber devices; and providing a distributed computing mobile application that uses the IP router functions to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing, in at least one of the plurality of mobile devices, media access control layer capabilities including sub-network layer convergence functions selected from a list consisting of segmentation and reassembly, quality of service, throughput fairness, adaptive data rate control, and transmit power control, wherein the at least one mobile device is a subscriber device; and providing a distributed computing mobile application that uses the MAC layer to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing route diversity within the network to facilitate assurance of packet communication, wherein route diversity is based at least on a number of network devices in a geographic area; and providing a distributed computing mobile application that uses the route diversity to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; allowing layer 2 forwarding among at least some of the plurality of mobile devices; and providing a distributed computing mobile application that communicates via the layer 2 forwarding.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing the routable internet to a node in the network, wherein the node also communicates with a cellular network through at least one of the fixed infrastructure elements and the routable internet is provided outside the cellular network; and providing a distributed computing mobile application that communicates both through the cellular network and the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP application deployment to a device in the network, wherein the device also communicates with a cellular network through at least one of the fixed infrastructure elements and the IP application is deployed outside the cellular network; and providing a distributed computing mobile application that is deployed over IP and that communicates via the cellular network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network; and providing a distributed computing mobile application that communicates via the data packets.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network absent communications with the fixed infrastructure elements; and providing a distributed computing mobile application that communicates solely within the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/sec during normal operation; and providing a distributed computing mobile application that uses the communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/set when the nodes are in motion at vehicular speeds; and providing a distributed computing mobile application that uses the communications.

In an aspect of the invention, methods and systems include providing a mobile, broadband, routable internet, in which a plurality of mobile devices interact as nodes in a mobile ad hoc network and in which packets are IP routable to each of mobile devices of fixed infrastructure elements; and providing a distributed computing mobile application that communicates via the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; applying swarm intelligence to determine at least some parts of at least some routes through the mobile, broadband, routable internet; and providing a distributed computing mobile application that communicates via the mobile ad hoc network.

In an aspect of the invention, methods and systems include providing a mobile, broadband, routable internet, in which a plurality of mobile devices interact as sending and receiving nodes in a mobile ad hoc network and in which packets are IP routable to the individual devices independent of fixed infrastructure elements; providing routing priority within the network, wherein the routing priority is provided by granting channel access to a node for which prioritized routing is identified and sending delay-sensitive data from the node before sending delay-tolerant data from the node; and providing a web service deployed with MANET mobile application that uses the routing priority to manage routing of data within the mobile, broadband, routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing support for peer-to-peer traffic within the network; and providing a web service deployed with MANET mobile application that provides fixed-network-independent capacity and service delivery by utilizing the peer-to-peer traffic network support.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer to peer connectivity within the mobile broadband routable internet; and providing a web service deployed with MANET mobile application that uses the peer to peer connectivity to facilitate mobile, fixed-infrastructure-independent, peer-to-peer application connection among at least a subset of the plurality of mobile devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing file sharing over the mobile broadband routable internet; and providing a web service deployed with MANET mobile application that uses file sharing without degrading system performance.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing user-generated applications over the mobile broadband routable internet; and providing a web service deployed with MANET mobile application associated with the mobile broadband routable internet, wherein the yyyy mobile application includes a user-generated application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer-to-peer applications over the mobile broadband routable internet; and providing a web service deployed with MANET mobile application that uses peer-to-peer applications without degrading performance of the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing direct device-to-device peering with symmetrical throughput between at least two nodes of the mobile broadband routable internet; and providing a web service deployed with MANET mobile application co-operating on the at least two nodes, wherein the yyyy mobile application utilizes the symmetrical throughput between the at least two nodes.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; facilitating direct-to-device application deployment over the mobile broadband routable internet; and providing a web service deployed with MANET mobile application that is deployed directly to a device in the mobile broadband routable internet using direct-to-device application deployment.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing data among a plurality of mobile broadband routable internet devices; and providing a web service deployed with MANET mobile application, wherein the mobile application uses the facility to access distributed data that is associated with the yyyy mobile application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing application components among a plurality of mobile broadband routable internet devices; and providing a web service deployed with MANET mobile application, components of which are distributed by the facility.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multicast routing within the network by allowing a data object to be transmitted by a device to a plurality of destinations over a plurality of routes; and providing a web service deployed with MANET mobile application that uses the multicast routing to at least distribute application-related updates.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote monitoring through the network; and providing a web service deployed with MANET mobile application that facilitates remote monitoring over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote control over the network; and providing a web service deployed with MANET mobile application that facilitates remote control over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote upgrade of at least one of software and services associated with the network; and providing a web service deployed with MANET mobile application that uses the remote upgrade to maintain a portion of the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an adaptive transmit power control facility for a device within the network, the adaptive transmit power control facility adapted to adjust transmission power of the device based on at least one of the density of proximate devices in the network, the condition of a neighboring device on the network, a channel condition of the network, a service level condition, a network performance condition, an environmental condition of the device and an application requirement of the device; and providing a web service deployed with MANET mobile application that uses adaptive transmit power control to adapt the transmit power associated with the application based on at least a density of devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing forwarding error correction on at least long IP packets; and providing a web service deployed with MANET mobile application that is enabled at least in part by utilizing forwarding error correction on the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for enabling adaptation of the data rate provided for links among devices within the network, the adaptation based on at least one of the density of devices in the network, the condition neighboring devices in the network, a channel condition of the network, a service level condition, a network performance condition, an environmental condition and an application requirement; and providing a web service deployed with MANET mobile application that adapts application related data transmission and receiving parameters based on the adaptive link data rates within the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing dynamic spectrum access capabilities within the network by determining communication spectrum quality and adjusting use of time frequency rectangles within the communication spectrum based on the determination; and providing a web service deployed with MANET mobile application that uses the dynamic spectrum access capabilities to provide enhanced use of spectral bandwidth.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; communicating among the plurality of devices over a radio communication spectrum and reusing portions of the spectrum for communication based on availability of time frequency rectangles within portions of the spectrum; and providing a web service deployed with MANET mobile application that reuses spectrum allocated for at least one other application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; and communicating wirelessly among at least a portion of the plurality of mobile devices, wherein the at least a portion of the plurality of mobile devices communicate independent of which radio frequency is used for the wireless communication; and wherein a web service deployed with MANET mobile application operating on at least two of the mobile devices exchanges information over the mobile broadband routable internet independent of the radio frequency.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing geo-location coding of device nodes in the network, wherein geo-location is based at least in part on a network location of a device node relative to other devices in the network; and providing a web service deployed with MANET mobile application that uses geo-location of device nodes in the network to facilitate at least one location-based service.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multimedia support within the network through a hybrid frame structure that includes variable slot duration and sub-channelization of bandwidth; and providing a web service deployed with MANET mobile application that uses multimedia support to provide yyyy related multimedia services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing time synchronization among nodes of the network, wherein the time synchronization is provided by communicating a representation of network timing at all the nodes with sufficient accuracy to enable reliable communications; and providing a web service deployed with MANET mobile application that uses network node time synchronization in delivery of the application services to device nodes in the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing seamless outdoor and indoor operation over the network; and providing a web service deployed with MANET mobile application takes advantage of the seamless outdoor and indoor operation to deliver services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing fixed radio installations that facilitate connection of the plurality of mobile devices, wherein the fixed radio installations are based at least in part on meeting a criteria associated with network radio propagation and performance; and providing a web service deployed with MANET mobile application that uses the fixed radio installation for backhaul communication associated with the application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an IP-compatible plug connection to at least one wired infrastructure type; and providing a web service deployed with MANET mobile application that uses the connection.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multiple fixed-network gateway interfaces connecting the mobile ad hoc network to a fixed network; and providing a web service deployed with MANET mobile application that communicates between a mobile device and a device on the fixed network.

In an aspect of the invention, methods and systems may include providing a mobile, broadband, routable internet, in which a plurality of mobile devices interact as nodes in a mobile ad hoc network and in which packets are IP routable to each of the devices independent of fixed infrastructure elements; providing an automated network design tool to facilitate low cost and fast network design engineering and deployment planning of the fixed infrastructure elements of the network; and deploying a web service deployed with MANET mobile application configured to use the networked designed by the design tool.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; deploying a plurality of low cost mesh access points to provide network coverage in a geography; and providing a web service deployed with MANET mobile application that communicates at least in part via the mesh access points.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing small form factor nodes that allow for low cost and fast capacity expansion and network upgrade; and providing a web service deployed with MANET mobile application that communicates at least in part via the small form factor nodes.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing communications between a mobile device and a device on a remote network so as to substantially favor routes through the mobile, broadband, routable Internet that have fewer hops between the mobile device and a backhaul access point; and providing a web service deployed with MANET mobile application that uses said communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing a user deployable access point that connects to the network; and providing a web service deployed with MANET mobile application that uses said access point.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing at least one base station controller function in at least one subscriber device, the base station controller function including at least one of an air interface management function, a signaling function, a concentration logic function, and a signal propagation function; and providing a web service deployed with MANET mobile application employing the at least one base state controller functions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing service provider tools to manage resource consumption of at least one device on the ad hoc network, wherein the tools are deployed on at least one of the plurality of mobile devices and use at least one management path for reporting usage of the at least one device; and providing a web service deployed with MANET mobile application for which the management path is used to report usage of the application.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing full radio resource management functions in at least one device, the radio resource management functions including at least one of radio management, handover, handoff, and foreign device cooperation functions, wherein the at least one device is a subscriber device; and providing a web service deployed with MANET mobile application operating responsively to a state of a managed radio resource.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multi-session functions in at least one of the plurality of devices, wherein the at least one device is a subscriber device; and providing a web service deployed with MANET mobile application communicating via multiple sessions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing cost-based routing functions in the network through dynamic forming and reforming of links and routes, wherein the cost-based routing functions are provided in a plurality of subscriber devices; and providing a web service deployed with MANET mobile application that uses the cost-based routing functions to deliver a desired balance of cost and quality of service.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP router functions at individual mobile devices of the network, wherein the individual mobile devices are subscriber devices; and providing a web service deployed with MANET mobile application that uses the IP router functions to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing, in at least one of the plurality of mobile devices, media access control layer capabilities including sub-network layer convergence functions selected from a list consisting of segmentation and reassembly, quality of service, throughput fairness, adaptive data rate control, and transmit power control, wherein the at least one mobile device is a subscriber device; and providing a web service deployed with MANET mobile application that uses the MAC layer to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing route diversity within the network to facilitate assurance of packet communication, wherein route diversity is based at least on a number of network devices in a geographic area; and providing a web service deployed with MANET mobile application that uses the route diversity to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; allowing layer 2 forwarding among at least some of the plurality of mobile devices; and providing a web service deployed with MANET mobile application that communicates via the layer 2 forwarding.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing the routable internet to a node in the network, wherein the node also communicates with a cellular network through at least one of the fixed infrastructure elements and the routable internet is provided outside the cellular network; and providing a web service deployed with MANET mobile application that communicates both through the cellular network and the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP application deployment to a device in the network, wherein the device also communicates with a cellular network through at least one of the fixed infrastructure elements and the IP application is deployed outside the cellular network; and providing a web service deployed with MANET mobile application that is deployed over IP and that communicates via the cellular network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network; and providing a web service deployed with MANET mobile application that communicates via the data packets.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network absent communications with the fixed infrastructure elements; and providing a web service deployed with MANET mobile application that communicates solely within the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/sec during normal operation; and providing a web service deployed with MANET mobile application that uses the communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/set when the nodes are in motion at vehicular speeds; and providing a web service deployed with MANET mobile application that uses the communications.

In an aspect of the invention, methods and systems include providing a mobile, broadband, routable internet, in which a plurality of mobile devices interact as nodes in a mobile ad hoc network and in which packets are IP routable to each of mobile devices of fixed infrastructure elements; and providing a web service deployed with MANET mobile application that communicates via the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; applying swarm intelligence to determine at least some parts of at least some routes through the mobile, broadband, routable internet; and providing a web service deployed with MANET mobile application that communicates via the mobile ad hoc network.

In an aspect of the invention, methods and systems include providing a mobile, broadband, routable internet, in which a plurality of mobile devices interact as sending and receiving nodes in a mobile ad hoc network and in which packets are IP routable to the individual devices independent of fixed infrastructure elements; providing routing priority within the network, wherein the routing priority is provided by granting channel access to a node for which prioritized routing is identified and sending delay-sensitive data from the node before sending delay-tolerant data from the node; and providing a local ip-based swarming mobile application that uses the routing priority to manage routing of data within the mobile, broadband, routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing support for peer-to-peer traffic within the network; and providing a local ip-based swarming mobile application that provides fixed-network-independent capacity and service delivery by utilizing the peer-to-peer traffic network support.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer to peer connectivity within the mobile broadband routable internet; and providing a local ip-based swarming mobile application that uses the peer to peer connectivity to facilitate mobile, fixed-infrastructure-independent, peer-to-peer application connection among at least a subset of the plurality of mobile devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing file sharing over the mobile broadband routable internet; and providing a local ip-based swarming mobile application that uses file sharing without degrading system performance.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing user-generated applications over the mobile broadband routable internet; and providing a local ip-based swarming mobile application associated with the mobile broadband routable internet, wherein the yyyy mobile application includes a user-generated application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer-to-peer applications over the mobile broadband routable internet; and providing a local ip-based swarming mobile application that uses peer-to-peer applications without degrading performance of the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing direct device-to-device peering with symmetrical throughput between at least two nodes of the mobile broadband routable internet; and providing a local ip-based swarming mobile application co-operating on the at least two nodes, wherein the yyyy mobile application utilizes the symmetrical throughput between the at least two nodes.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; facilitating direct-to-device application deployment over the mobile broadband routable internet; and providing a local ip-based swarming mobile application that is deployed directly to a device in the mobile broadband routable internet using direct-to-device application deployment.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing data among a plurality of mobile broadband routable internet devices; and providing a local ip-based swarming mobile application, wherein the mobile application uses the facility to access distributed data that is associated with the yyyy mobile application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing application components among a plurality of mobile broadband routable internet devices; and providing a local ip-based swarming mobile application, components of which are distributed by the facility.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multicast routing within the network by allowing a data object to be transmitted by a device to a plurality of destinations over a plurality of routes; and providing a local ip-based swarming mobile application that uses the multicast routing to at least distribute application-related updates.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote monitoring through the network; and providing a local ip-based swarming mobile application that facilitates remote monitoring over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote control over the network; and providing a local ip-based swarming mobile application that facilitates remote control over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote upgrade of at least one of software and services associated with the network; and providing a local ip-based swarming mobile application that uses the remote upgrade to maintain a portion of the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an adaptive transmit power control facility for a device within the network, the adaptive transmit power control facility adapted to adjust transmission power of the device based on at least one of the density of proximate devices in the network, the condition of a neighboring device on the network, a channel condition of the network, a service level condition, a network performance condition, an environmental condition of the device and an application requirement of the device; and providing a local ip-based swarming mobile application that uses adaptive transmit power control to adapt the transmit power associated with the application based on at least a density of devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing forwarding error correction on at least long IP packets; and providing a local ip-based swarming mobile application that is enabled at least in part by utilizing forwarding error correction on the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for enabling adaptation of the data rate provided for links among devices within the network, the adaptation based on at least one of the density of devices in the network, the condition neighboring devices in the network, a channel condition of the network, a service level condition, a network performance condition, an environmental condition and an application requirement; and providing a local ip-based swarming mobile application that adapts application related data transmission and receiving parameters based on the adaptive link data rates within the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing dynamic spectrum access capabilities within the network by determining communication spectrum quality and adjusting use of time frequency rectangles within the communication spectrum based on the determination; and providing a local ip-based swarming mobile application that uses the dynamic spectrum access capabilities to provide enhanced use of spectral bandwidth.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; communicating among the plurality of devices over a radio communication spectrum and reusing portions of the spectrum for communication based on availability of time frequency rectangles within portions of the spectrum; and providing a local ip-based swarming mobile application that reuses spectrum allocated for at least one other application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; and communicating wirelessly among at least a portion of the plurality of mobile devices, wherein the at least a portion of the plurality of mobile devices communicate independent of which radio frequency is used for the wireless communication; and wherein a local ip-based swarming mobile application operating on at least two of the mobile devices exchanges information over the mobile broadband routable internet independent of the radio frequency.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing geo-location coding of device nodes in the network, wherein geo-location is based at least in part on a network location of a device node relative to other devices in the network; and providing a local ip-based swarming mobile application that uses geo-location of device nodes in the network to facilitate at least one location-based service.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multimedia support within the network through a hybrid frame structure that includes variable slot duration and sub-channelization of bandwidth; and providing a local ip-based swarming mobile application that uses multimedia support to provide yyyy related multimedia services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing time synchronization among nodes of the network, wherein the time synchronization is provided by communicating a representation of network timing at all the nodes with sufficient accuracy to enable reliable communications; and providing a local ip-based swarming mobile application that uses network node time synchronization in delivery of the application services to device nodes in the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing seamless outdoor and indoor operation over the network; and providing a local ip-based swarming mobile application takes advantage of the seamless outdoor and indoor operation to deliver services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing fixed radio installations that facilitate connection of the plurality of mobile devices, wherein the fixed radio installations are based at least in part on meeting a criteria associated with network radio propagation and performance; and providing a local ip-based swarming mobile application that uses the fixed radio installation for backhaul communication associated with the application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an IP-compatible plug connection to at least one wired infrastructure type; and providing a local ip-based swarming mobile application that uses the connection.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multiple fixed-network gateway interfaces connecting the mobile ad hoc network to a fixed network; and providing a local ip-based swarming mobile application that communicates between a mobile device and a device on the fixed network.

In an aspect of the invention, methods and systems may include providing a mobile, broadband, routable internet, in which a plurality of mobile devices interact as nodes in a mobile ad hoc network and in which packets are IP routable to each of the devices independent of fixed infrastructure elements; providing an automated network design tool to facilitate low cost and fast network design engineering and deployment planning of the fixed infrastructure elements of the network; and deploying a local ip-based swarming mobile application configured to use the networked designed by the design tool.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; deploying a plurality of low cost mesh access points to provide network coverage in a geography; and providing a local ip-based swarming mobile application that communicates at least in part via the mesh access points.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing small form factor nodes that allow for low cost and fast capacity expansion and network upgrade; and providing a local ip-based swarming mobile application that communicates at least in part via the small form factor nodes.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing communications between a mobile device and a device on a remote network so as to substantially favor routes through the mobile, broadband, routable Internet that have fewer hops between the mobile device and a backhaul access point; and providing a local ip-based swarming mobile application that uses said communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing a user deployable access point that connects to the network; and providing a local ip-based swarming mobile application that uses said access point.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing at least one base station controller function in at least one subscriber device, the base station controller function including at least one of an air interface management function, a signaling function, a concentration logic function, and a signal propagation function; and providing a local ip-based swarming mobile application employing the at least one base state controller functions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing service provider tools to manage resource consumption of at least one device on the ad hoc network, wherein the tools are deployed on at least one of the plurality of mobile devices and use at least one management path for reporting usage of the at least one device; and providing a local ip-based swarming mobile application for which the management path is used to report usage of the application.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing full radio resource management functions in at least one device, the radio resource management functions including at least one of radio management, handover, handoff, and foreign device cooperation functions, wherein the at least one device is a subscriber device; and providing a local ip-based swarming mobile application operating responsively to a state of a managed radio resource.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multi-session functions in at least one of the plurality of devices, wherein the at least one device is a subscriber device; and providing a local ip-based swarming mobile application communicating via multiple sessions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing cost-based routing functions in the network through dynamic forming and reforming of links and routes, wherein the cost-based routing functions are provided in a plurality of subscriber devices; and providing a local ip-based swarming mobile application that uses the cost-based routing functions to deliver a desired balance of cost and quality of service.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP router functions at individual mobile devices of the network, wherein the individual mobile devices are subscriber devices; and providing a local ip-based swarming mobile application that uses the IP router functions to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing, in at least one of the plurality of mobile devices, media access control layer capabilities including sub-network layer convergence functions selected from a list consisting of segmentation and reassembly, quality of service, throughput fairness, adaptive data rate control, and transmit power control, wherein the at least one mobile device is a subscriber device; and providing a local ip-based swarming mobile application that uses the MAC layer to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing route diversity within the network to facilitate assurance of packet communication, wherein route diversity is based at least on a number of network devices in a geographic area; and providing a local ip-based swarming mobile application that uses the route diversity to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; allowing layer 2 forwarding among at least some of the plurality of mobile devices; and providing a local ip-based swarming mobile application that communicates via the layer 2 forwarding.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing the routable internet to a node in the network, wherein the node also communicates with a cellular network through at least one of the fixed infrastructure elements and the routable internet is provided outside the cellular network; and providing a local ip-based swarming mobile application that communicates both through the cellular network and the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP application deployment to a device in the network, wherein the device also communicates with a cellular network through at least one of the fixed infrastructure elements and the IP application is deployed outside the cellular network; and providing a local ip-based swarming mobile application that is deployed over IP and that communicates via the cellular network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network; and providing a local ip-based swarming mobile application that communicates via the data packets.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network absent communications with the fixed infrastructure elements; and providing a local ip-based swarming mobile application that communicates solely within the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/sec during normal operation; and providing a local ip-based swarming mobile application that uses the communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/set when the nodes are in motion at vehicular speeds; and providing a local ip-based swarming mobile application that uses the communications.

In an aspect of the invention, methods and systems include providing a mobile, broadband, routable internet, in which a plurality of mobile devices interact as nodes in a mobile ad hoc network and in which packets are IP routable to each of mobile devices of fixed infrastructure elements; and providing a local ip-based swarming mobile application that communicates via the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; applying swarm intelligence to determine at least some parts of at least some routes through the mobile, broadband, routable internet; and providing a local ip-based swarming mobile application that communicates via the mobile ad hoc network.

In an aspect of the invention, methods and systems include providing a mobile, broadband, routable internet, in which a plurality of mobile devices interact as sending and receiving nodes in a mobile ad hoc network and in which packets are IP routable to the individual devices independent of fixed infrastructure elements; providing routing priority within the network, wherein the routing priority is provided by granting channel access to a node for which prioritized routing is identified and sending delay-sensitive data from the node before sending delay-tolerant data from the node; and providing a point to point communication mobile application that uses the routing priority to manage routing of data within the mobile, broadband, routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing support for peer-to-peer traffic within the network; and providing a point to point communication mobile application that provides fixed-network-independent capacity and service delivery by utilizing the peer-to-peer traffic network support.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer to peer connectivity within the mobile broadband routable internet; and providing a point to point communication mobile application that uses the peer to peer connectivity to facilitate mobile, fixed-infrastructure-independent, peer-to-peer application connection among at least a subset of the plurality of mobile devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing file sharing over the mobile broadband routable internet; and providing a point to point communication mobile application that uses file sharing without degrading system performance.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing user-generated applications over the mobile broadband routable internet; and providing a point to point communication mobile application associated with the mobile broadband routable internet, wherein the yyyy mobile application includes a user-generated application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer-to-peer applications over the mobile broadband routable internet; and providing a point to point communication mobile application that uses peer-to-peer applications without degrading performance of the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing direct device-to-device peering with symmetrical throughput between at least two nodes of the mobile broadband routable internet; and providing a point to point communication mobile application co-operating on the at least two nodes, wherein the yyyy mobile application utilizes the symmetrical throughput between the at least two nodes.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; facilitating direct-to-device application deployment over the mobile broadband routable internet; and providing a point to point communication mobile application that is deployed directly to a device in the mobile broadband routable internet using direct-to-device application deployment.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing data among a plurality of mobile broadband routable internet devices; and providing a point to point communication mobile application, wherein the mobile application uses the facility to access distributed data that is associated with the yyyy mobile application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing application components among a plurality of mobile broadband routable internet devices; and providing a point to point communication mobile application, components of which are distributed by the facility.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multicast routing within the network by allowing a data object to be transmitted by a device to a plurality of destinations over a plurality of routes; and providing a point to point communication mobile application that uses the multicast routing to at least distribute application-related updates.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote monitoring through the network; and providing a point to point communication mobile application that facilitates remote monitoring over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote control over the network; and providing a point to point communication mobile application that facilitates remote control over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote upgrade of at least one of software and services associated with the network; and providing a point to point communication mobile application that uses the remote upgrade to maintain a portion of the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an adaptive transmit power control facility for a device within the network, the adaptive transmit power control facility adapted to adjust transmission power of the device based on at least one of the density of proximate devices in the network, the condition of a neighboring device on the network, a channel condition of the network, a service level condition, a network performance condition, an environmental condition of the device and an application requirement of the device; and providing a point to point communication mobile application that uses adaptive transmit power control to adapt the transmit power associated with the application based on at least a density of devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing forwarding error correction on at least long IP packets; and providing a point to point communication mobile application that is enabled at least in part by utilizing forwarding error correction on the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for enabling adaptation of the data rate provided for links among devices within the network, the adaptation based on at least one of the density of devices in the network, the condition neighboring devices in the network, a channel condition of the network, a service level condition, a network performance condition, an environmental condition and an application requirement; and providing a point to point communication mobile application that adapts application related data transmission and receiving parameters based on the adaptive link data rates within the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing dynamic spectrum access capabilities within the network by determining communication spectrum quality and adjusting use of time frequency rectangles within the communication spectrum based on the determination; and providing a point to point communication mobile application that uses the dynamic spectrum access capabilities to provide enhanced use of spectral bandwidth.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; communicating among the plurality of devices over a radio communication spectrum and reusing portions of the spectrum for communication based on availability of time frequency rectangles within portions of the spectrum; and providing a point to point communication mobile application that reuses spectrum allocated for at least one other application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; and communicating wirelessly among at least a portion of the plurality of mobile devices, wherein the at least a portion of the plurality of mobile devices communicate independent of which radio frequency is used for the wireless communication; and wherein a point to point communication mobile application operating on at least two of the mobile devices exchanges information over the mobile broadband routable internet independent of the radio frequency.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing geo-location coding of device nodes in the network, wherein geo-location is based at least in part on a network location of a device node relative to other devices in the network; and providing a point to point communication mobile application that uses geo-location of device nodes in the network to facilitate at least one location-based service.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multimedia support within the network through a hybrid frame structure that includes variable slot duration and sub-channelization of bandwidth; and providing a point to point communication mobile application that uses multimedia support to provide yyyy related multimedia services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing time synchronization among nodes of the network, wherein the time synchronization is provided by communicating a representation of network timing at all the nodes with sufficient accuracy to enable reliable communications; and providing a point to point communication mobile application that uses network node time synchronization in delivery of the application services to device nodes in the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing seamless outdoor and indoor operation over the network; and providing a point to point communication mobile application takes advantage of the seamless outdoor and indoor operation to deliver services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing fixed radio installations that facilitate connection of the plurality of mobile devices, wherein the fixed radio installations are based at least in part on meeting a criteria associated with network radio propagation and performance; and providing a point to point communication mobile application that uses the fixed radio installation for backhaul communication associated with the application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an IP-compatible plug connection to at least one wired infrastructure type; and providing a point to point communication mobile application that uses the connection.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multiple fixed-network gateway interfaces connecting the mobile ad hoc network to a fixed network; and providing a point to point communication mobile application that communicates between a mobile device and a device on the fixed network.

In an aspect of the invention, methods and systems may include providing a mobile, broadband, routable internet, in which a plurality of mobile devices interact as nodes in a mobile ad hoc network and in which packets are IP routable to each of the devices independent of fixed infrastructure elements; providing an automated network design tool to facilitate low cost and fast network design engineering and deployment planning of the fixed infrastructure elements of the network; and deploying a point to point communication mobile application configured to use the networked designed by the design tool.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; deploying a plurality of low cost mesh access points to provide network coverage in a geography; and providing a point to point communication mobile application that communicates at least in part via the mesh access points.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing small form factor nodes that allow for low cost and fast capacity expansion and network upgrade; and providing a point to point communication mobile application that communicates at least in part via the small form factor nodes.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing communications between a mobile device and a device on a remote network so as to substantially favor routes through the mobile, broadband, routable Internet that have fewer hops between the mobile device and a backhaul access point; and providing a point to point communication mobile application that uses said communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing a user deployable access point that connects to the network; and providing a point to point communication mobile application that uses said access point.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing at least one base station controller function in at least one subscriber device, the base station controller function including at least one of an air interface management function, a signaling function, a concentration logic function, and a signal propagation function; and providing a point to point communication mobile application employing the at least one base state controller functions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing service provider tools to manage resource consumption of at least one device on the ad hoc network, wherein the tools are deployed on at least one of the plurality of mobile devices and use at least one management path for reporting usage of the at least one device; and providing a point to point communication mobile application for which the management path is used to report usage of the application.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing full radio resource management functions in at least one device, the radio resource management functions including at least one of radio management, handover, handoff, and foreign device cooperation functions, wherein the at least one device is a subscriber device; and providing a point to point communication mobile application operating responsively to a state of a managed radio resource.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multi-session functions in at least one of the plurality of devices, wherein the at least one device is a subscriber device; and providing a point to point communication mobile application communicating via multiple sessions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing cost-based routing functions in the network through dynamic forming and reforming of links and routes, wherein the cost-based routing functions are provided in a plurality of subscriber devices; and providing a point to point communication mobile application that uses the cost-based routing functions to deliver a desired balance of cost and quality of service.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP router functions at individual mobile devices of the network, wherein the individual mobile devices are subscriber devices; and providing a point to point communication mobile application that uses the IP router functions to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing, in at least one of the plurality of mobile devices, media access control layer capabilities including sub-network layer convergence functions selected from a list consisting of segmentation and reassembly, quality of service, throughput fairness, adaptive data rate control, and transmit power control, wherein the at least one mobile device is a subscriber device; and providing a point to point communication mobile application that uses the MAC layer to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing route diversity within the network to facilitate assurance of packet communication, wherein route diversity is based at least on a number of network devices in a geographic area; and providing a point to point communication mobile application that uses the route diversity to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; allowing layer 2 forwarding among at least some of the plurality of mobile devices; and providing a point to point communication mobile application that communicates via the layer 2 forwarding.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing the routable internet to a node in the network, wherein the node also communicates with a cellular network through at least one of the fixed infrastructure elements and the routable internet is provided outside the cellular network; and providing a point to point communication mobile application that communicates both through the cellular network and the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP application deployment to a device in the network, wherein the device also communicates with a cellular network through at least one of the fixed infrastructure elements and the IP application is deployed outside the cellular network; and providing a point to point communication mobile application that is deployed over IP and that communicates via the cellular network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network; and providing a point to point communication mobile application that communicates via the data packets.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network absent communications with the fixed infrastructure elements; and providing a point to point communication mobile application that communicates solely within the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/sec during normal operation; and providing a point to point communication mobile application that uses the communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/set when the nodes are in motion at vehicular speeds; and providing a point to point communication mobile application that uses the communications.

In an aspect of the invention, methods and systems include providing a mobile, broadband, routable internet, in which a plurality of mobile devices interact as nodes in a mobile ad hoc network and in which packets are IP routable to each of mobile devices of fixed infrastructure elements; and providing a point to point communication mobile application that communicates via the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; applying swarm intelligence to determine at least some parts of at least some routes through the mobile, broadband, routable internet; and providing a point to point communication mobile application that communicates via the mobile ad hoc network.

In an aspect of the invention, methods and systems include providing a mobile, broadband, routable internet, in which a plurality of mobile devices interact as sending and receiving nodes in a mobile ad hoc network and in which packets are IP routable to the individual devices independent of fixed infrastructure elements; providing routing priority within the network, wherein the routing priority is provided by granting channel access to a node for which prioritized routing is identified and sending delay-sensitive data from the node before sending delay-tolerant data from the node; and providing a location based service mobile application that uses the routing priority to manage routing of data within the mobile, broadband, routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing support for peer-to-peer traffic within the network; and providing a location based service mobile application that provides fixed-network-independent capacity and service delivery by utilizing the peer-to-peer traffic network support.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer to peer connectivity within the mobile broadband routable internet; and providing a location based service mobile application that uses the peer to peer connectivity to facilitate mobile, fixed-infrastructure-independent, peer-to-peer application connection among at least a subset of the plurality of mobile devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing file sharing over the mobile broadband routable internet; and providing a location based service mobile application that uses file sharing without degrading system performance.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing user-generated applications over the mobile broadband routable internet; and providing a location based service mobile application associated with the mobile broadband routable internet, wherein the yyyy mobile application includes a user-generated application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer-to-peer applications over the mobile broadband routable internet; and providing a location based service mobile application that uses peer-to-peer applications without degrading performance of the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing direct device-to-device peering with symmetrical throughput between at least two nodes of the mobile broadband routable internet; and providing a location based service mobile application co-operating on the at least two nodes, wherein the yyyy mobile application utilizes the symmetrical throughput between the at least two nodes.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; facilitating direct-to-device application deployment over the mobile broadband routable internet; and providing a location based service mobile application that is deployed directly to a device in the mobile broadband routable internet using direct-to-device application deployment.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing data among a plurality of mobile broadband routable internet devices; and providing a location based service mobile application, wherein the mobile application uses the facility to access distributed data that is associated with the yyyy mobile application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing application components among a plurality of mobile broadband routable internet devices; and providing a location based service mobile application, components of which are distributed by the facility.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multicast routing within the network by allowing a data object to be transmitted by a device to a plurality of destinations over a plurality of routes; and providing a location based service mobile application that uses the multicast routing to at least distribute application-related updates.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote monitoring through the network; and providing a location based service mobile application that facilitates remote monitoring over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote control over the network; and providing a location based service mobile application that facilitates remote control over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote upgrade of at least one of software and services associated with the network; and providing a location based service mobile application that uses the remote upgrade to maintain a portion of the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an adaptive transmit power control facility for a device within the network, the adaptive transmit power control facility adapted to adjust transmission power of the device based on at least one of the density of proximate devices in the network, the condition of a neighboring device on the network, a channel condition of the network, a service level condition, a network performance condition, an environmental condition of the device and an application requirement of the device; and providing a location based service mobile application that uses adaptive transmit power control to adapt the transmit power associated with the application based on at least a density of devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing forwarding error correction on at least long IP packets; and providing a location based service mobile application that is enabled at least in part by utilizing forwarding error correction on the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for enabling adaptation of the data rate provided for links among devices within the network, the adaptation based on at least one of the density of devices in the network, the condition neighboring devices in the network, a channel condition of the network, a service level condition, a network performance condition, an environmental condition and an application requirement; and providing a location based service mobile application that adapts application related data transmission and receiving parameters based on the adaptive link data rates within the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing dynamic spectrum access capabilities within the network by determining communication spectrum quality and adjusting use of time frequency rectangles within the communication spectrum based on the determination; and providing a location based service mobile application that uses the dynamic spectrum access capabilities to provide enhanced use of spectral bandwidth.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; communicating among the plurality of devices over a radio communication spectrum and reusing portions of the spectrum for communication based on availability of time frequency rectangles within portions of the spectrum; and providing a location based service mobile application that reuses spectrum allocated for at least one other application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; and communicating wirelessly among at least a portion of the plurality of mobile devices, wherein the at least a portion of the plurality of mobile devices communicate independent of which radio frequency is used for the wireless communication; and wherein a location based service mobile application operating on at least two of the mobile devices exchanges information over the mobile broadband routable internet independent of the radio frequency.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing geo-location coding of device nodes in the network, wherein geo-location is based at least in part on a network location of a device node relative to other devices in the network; and providing a location based service mobile application that uses geo-location of device nodes in the network to facilitate at least one location-based service.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multimedia support within the network through a hybrid frame structure that includes variable slot duration and sub-channelization of bandwidth; and providing a location based service mobile application that uses multimedia support to provide yyyy related multimedia services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing time synchronization among nodes of the network, wherein the time synchronization is provided by communicating a representation of network timing at all the nodes with sufficient accuracy to enable reliable communications; and providing a location based service mobile application that uses network node time synchronization in delivery of the application services to device nodes in the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing seamless outdoor and indoor operation over the network; and providing a location based service mobile application takes advantage of the seamless outdoor and indoor operation to deliver services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing fixed radio installations that facilitate connection of the plurality of mobile devices, wherein the fixed radio installations are based at least in part on meeting a criteria associated with network radio propagation and performance; and providing a location based service mobile application that uses the fixed radio installation for backhaul communication associated with the application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an IP-compatible plug connection to at least one wired infrastructure type; and providing a location based service mobile application that uses the connection.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multiple fixed-network gateway interfaces connecting the mobile ad hoc network to a fixed network; and providing a location based service mobile application that communicates between a mobile device and a device on the fixed network.

In an aspect of the invention, methods and systems may include providing a mobile, broadband, routable internet, in which a plurality of mobile devices interact as nodes in a mobile ad hoc network and in which packets are IP routable to each of the devices independent of fixed infrastructure elements; providing an automated network design tool to facilitate low cost and fast network design engineering and deployment planning of the fixed infrastructure elements of the network; and deploying a location based service mobile application configured to use the networked designed by the design tool.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; deploying a plurality of low cost mesh access points to provide network coverage in a geography; and providing a location based service mobile application that communicates at least in part via the mesh access points.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing small form factor nodes that allow for low cost and fast capacity expansion and network upgrade; and providing a location based service mobile application that communicates at least in part via the small form factor nodes.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing communications between a mobile device and a device on a remote network so as to substantially favor routes through the mobile, broadband, routable Internet that have fewer hops between the mobile device and a backhaul access point; and providing a location based service mobile application that uses said communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing a user deployable access point that connects to the network; and providing a location based service mobile application that uses said access point.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing at least one base station controller function in at least one subscriber device, the base station controller function including at least one of an air interface management function, a signaling function, a concentration logic function, and a signal propagation function; and providing a location based service mobile application employing the at least one base state controller functions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing service provider tools to manage resource consumption of at least one device on the ad hoc network, wherein the tools are deployed on at least one of the plurality of mobile devices and use at least one management path for reporting usage of the at least one device; and providing a location based service mobile application for which the management path is used to report usage of the application.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing full radio resource management functions in at least one device, the radio resource management functions including at least one of radio management, handover, handoff, and foreign device cooperation functions, wherein the at least one device is a subscriber device; and providing a location based service mobile application operating responsively to a state of a managed radio resource.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multi-session functions in at least one of the plurality of devices, wherein the at least one device is a subscriber device; and providing a location based service mobile application communicating via multiple sessions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing cost-based routing functions in the network through dynamic forming and reforming of links and routes, wherein the cost-based routing functions are provided in a plurality of subscriber devices; and providing a location based service mobile application that uses the cost-based routing functions to deliver a desired balance of cost and quality of service.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP router functions at individual mobile devices of the network, wherein the individual mobile devices are subscriber devices; and providing a location based service mobile application that uses the IP router functions to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing, in at least one of the plurality of mobile devices, media access control layer capabilities including sub-network layer convergence functions selected from a list consisting of segmentation and reassembly, quality of service, throughput fairness, adaptive data rate control, and transmit power control, wherein the at least one mobile device is a subscriber device; and providing a location based service mobile application that uses the MAC layer to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing route diversity within the network to facilitate assurance of packet communication, wherein route diversity is based at least on a number of network devices in a geographic area; and providing a location based service mobile application that uses the route diversity to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; allowing layer 2 forwarding among at least some of the plurality of mobile devices; and providing a location based service mobile application that communicates via the layer 2 forwarding.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing the routable internet to a node in the network, wherein the node also communicates with a cellular network through at least one of the fixed infrastructure elements and the routable internet is provided outside the cellular network; and providing a location based service mobile application that communicates both through the cellular network and the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP application deployment to a device in the network, wherein the device also communicates with a cellular network through at least one of the fixed infrastructure elements and the IP application is deployed outside the cellular network; and providing a location based service mobile application that is deployed over IP and that communicates via the cellular network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network; and providing a location based service mobile application that communicates via the data packets.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network absent communications with the fixed infrastructure elements; and providing a location based service mobile application that communicates solely within the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/sec during normal operation; and providing a location based service mobile application that uses the communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/set when the nodes are in motion at vehicular speeds; and providing a location based service mobile application that uses the communications.

In an aspect of the invention, methods and systems include providing a mobile, broadband, routable internet, in which a plurality of mobile devices interact as nodes in a mobile ad hoc network and in which packets are IP routable to each of mobile devices of fixed infrastructure elements; and providing a location based service mobile application that communicates via the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; applying swarm intelligence to determine at least some parts of at least some routes through the mobile, broadband, routable internet; and providing a location based service mobile application that communicates via the mobile ad hoc network.

In an aspect of the invention, methods and systems include providing a mobile, broadband, routable internet, in which a plurality of mobile devices interact as sending and receiving nodes in a mobile ad hoc network and in which packets are IP routable to the individual devices independent of fixed infrastructure elements; providing routing priority within the network, wherein the routing priority is provided by granting channel access to a node for which prioritized routing is identified and sending delay-sensitive data from the node before sending delay-tolerant data from the node; and providing a soft/smart phone mobile application that uses the routing priority to manage routing of data within the mobile, broadband, routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing support for peer-to-peer traffic within the network; and providing a soft/smart phone mobile application that provides fixed-network-independent capacity and service delivery by utilizing the peer-to-peer traffic network support.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer to peer connectivity within the mobile broadband routable internet; and providing a soft/smart phone mobile application that uses the peer to peer connectivity to facilitate mobile, fixed-infrastructure-independent, peer-to-peer application connection among at least a subset of the plurality of mobile devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing file sharing over the mobile broadband routable internet; and providing a soft/smart phone mobile application that uses file sharing without degrading system performance.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing user-generated applications over the mobile broadband routable internet; and providing a soft/smart phone mobile application associated with the mobile broadband routable internet, wherein the yyyy mobile application includes a user-generated application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer-to-peer applications over the mobile broadband routable internet; and providing a soft/smart phone mobile application that uses peer-to-peer applications without degrading performance of the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing direct device-to-device peering with symmetrical throughput between at least two nodes of the mobile broadband routable internet; and providing a soft/smart phone mobile application co-operating on the at least two nodes, wherein the yyyy mobile application utilizes the symmetrical throughput between the at least two nodes.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; facilitating direct-to-device application deployment over the mobile broadband routable internet; and providing a soft/smart phone mobile application that is deployed directly to a device in the mobile broadband routable internet using direct-to-device application deployment.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing data among a plurality of mobile broadband routable internet devices; and providing a soft/smart phone mobile application, wherein the mobile application uses the facility to access distributed data that is associated with the yyyy mobile application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing application components among a plurality of mobile broadband routable internet devices; and providing a soft/smart phone mobile application, components of which are distributed by the facility.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multicast routing within the network by allowing a data object to be transmitted by a device to a plurality of destinations over a plurality of routes; and providing a soft/smart phone mobile application that uses the multicast routing to at least distribute application-related updates.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote monitoring through the network; and providing a soft/smart phone mobile application that facilitates remote monitoring over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote control over the network; and providing a soft/smart phone mobile application that facilitates remote control over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote upgrade of at least one of software and services associated with the network; and providing a soft/smart phone mobile application that uses the remote upgrade to maintain a portion of the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an adaptive transmit power control facility for a device within the network, the adaptive transmit power control facility adapted to adjust transmission power of the device based on at least one of the density of proximate devices in the network, the condition of a neighboring device on the network, a channel condition of the network, a service level condition, a network performance condition, an environmental condition of the device and an application requirement of the device; and providing a soft/smart phone mobile application that uses adaptive transmit power control to adapt the transmit power associated with the application based on at least a density of devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing forwarding error correction on at least long IP packets; and providing a soft/smart phone mobile application that is enabled at least in part by utilizing forwarding error correction on the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for enabling adaptation of the data rate provided for links among devices within the network, the adaptation based on at least one of the density of devices in the network, the condition neighboring devices in the network, a channel condition of the network, a service level condition, a network performance condition, an environmental condition and an application requirement; and providing a soft/smart phone mobile application that adapts application related data transmission and receiving parameters based on the adaptive link data rates within the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing dynamic spectrum access capabilities within the network by determining communication spectrum quality and adjusting use of time frequency rectangles within the communication spectrum based on the determination; and providing a soft/smart phone mobile application that uses the dynamic spectrum access capabilities to provide enhanced use of spectral bandwidth.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; communicating among the plurality of devices over a radio communication spectrum and reusing portions of the spectrum for communication based on availability of time frequency rectangles within portions of the spectrum; and providing a soft/smart phone mobile application that reuses spectrum allocated for at least one other application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; and communicating wirelessly among at least a portion of the plurality of mobile devices, wherein the at least a portion of the plurality of mobile devices communicate independent of which radio frequency is used for the wireless communication; and wherein a soft/smart phone mobile application operating on at least two of the mobile devices exchanges information over the mobile broadband routable internet independent of the radio frequency.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing geo-location coding of device nodes in the network, wherein geo-location is based at least in part on a network location of a device node relative to other devices in the network; and providing a soft/smart phone mobile application that uses geo-location of device nodes in the network to facilitate at least one location-based service.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multimedia support within the network through a hybrid frame structure that includes variable slot duration and sub-channelization of bandwidth; and providing a soft/smart phone mobile application that uses multimedia support to provide yyyy related multimedia services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing time synchronization among nodes of the network, wherein the time synchronization is provided by communicating a representation of network timing at all the nodes with sufficient accuracy to enable reliable communications; and providing a soft/smart phone mobile application that uses network node time synchronization in delivery of the application services to device nodes in the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing seamless outdoor and indoor operation over the network; and providing a soft/smart phone mobile application takes advantage of the seamless outdoor and indoor operation to deliver services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing fixed radio installations that facilitate connection of the plurality of mobile devices, wherein the fixed radio installations are based at least in part on meeting a criteria associated with network radio propagation and performance; and providing a soft/smart phone mobile application that uses the fixed radio installation for backhaul communication associated with the application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an IP-compatible plug connection to at least one wired infrastructure type; and providing a soft/smart phone mobile application that uses the connection.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multiple fixed-network gateway interfaces connecting the mobile ad hoc network to a fixed network; and providing a soft/smart phone mobile application that communicates between a mobile device and a device on the fixed network.

In an aspect of the invention, methods and systems may include providing a mobile, broadband, routable internet, in which a plurality of mobile devices interact as nodes in a mobile ad hoc network and in which packets are IP routable to each of the devices independent of fixed infrastructure elements; providing an automated network design tool to facilitate low cost and fast network design engineering and deployment planning of the fixed infrastructure elements of the network; and deploying a soft/smart phone mobile application configured to use the networked designed by the design tool.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; deploying a plurality of low cost mesh access points to provide network coverage in a geography; and providing a soft/smart phone mobile application that communicates at least in part via the mesh access points.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing small form factor nodes that allow for low cost and fast capacity expansion and network upgrade; and providing a soft/smart phone mobile application that communicates at least in part via the small form factor nodes.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing communications between a mobile device and a device on a remote network so as to substantially favor routes through the mobile, broadband, routable Internet that have fewer hops between the mobile device and a backhaul access point; and providing a soft/smart phone mobile application that uses said communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing a user deployable access point that connects to the network; and providing a soft/smart phone mobile application that uses said access point.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing at least one base station controller function in at least one subscriber device, the base station controller function including at least one of an air interface management function, a signaling function, a concentration logic function, and a signal propagation function; and providing a soft/smart phone mobile application employing the at least one base state controller functions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing service provider tools to manage resource consumption of at least one device on the ad hoc network, wherein the tools are deployed on at least one of the plurality of mobile devices and use at least one management path for reporting usage of the at least one device; and providing a soft/smart phone mobile application for which the management path is used to report usage of the application.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing full radio resource management functions in at least one device, the radio resource management functions including at least one of radio management, handover, handoff, and foreign device cooperation functions, wherein the at least one device is a subscriber device; and providing a soft/smart phone mobile application operating responsively to a state of a managed radio resource.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multi-session functions in at least one of the plurality of devices, wherein the at least one device is a subscriber device; and providing a soft/smart phone mobile application communicating via multiple sessions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing cost-based routing functions in the network through dynamic forming and reforming of links and routes, wherein the cost-based routing functions are provided in a plurality of subscriber devices; and providing a soft/smart phone mobile application that uses the cost-based routing functions to deliver a desired balance of cost and quality of service.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP router functions at individual mobile devices of the network, wherein the individual mobile devices are subscriber devices; and providing a soft/smart phone mobile application that uses the IP router functions to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing, in at least one of the plurality of mobile devices, media access control layer capabilities including sub-network layer convergence functions selected from a list consisting of segmentation and reassembly, quality of service, throughput fairness, adaptive data rate control, and transmit power control, wherein the at least one mobile device is a subscriber device; and providing a soft/smart phone mobile application that uses the MAC layer to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing route diversity within the network to facilitate assurance of packet communication, wherein route diversity is based at least on a number of network devices in a geographic area; and providing a soft/smart phone mobile application that uses the route diversity to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; allowing layer 2 forwarding among at least some of the plurality of mobile devices; and providing a soft/smart phone mobile application that communicates via the layer 2 forwarding.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing the routable internet to a node in the network, wherein the node also communicates with a cellular network through at least one of the fixed infrastructure elements and the routable internet is provided outside the cellular network; and providing a soft/smart phone mobile application that communicates both through the cellular network and the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP application deployment to a device in the network, wherein the device also communicates with a cellular network through at least one of the fixed infrastructure elements and the IP application is deployed outside the cellular network; and providing a soft/smart phone mobile application that is deployed over IP and that communicates via the cellular network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network; and providing a soft/smart phone mobile application that communicates via the data packets.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network absent communications with the fixed infrastructure elements; and providing a soft/smart phone mobile application that communicates solely within the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/sec during normal operation; and providing a soft/smart phone mobile application that uses the communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/set when the nodes are in motion at vehicular speeds; and providing a soft/smart phone mobile application that uses the communications.

In an aspect of the invention, methods and systems include providing a mobile, broadband, routable internet, in which a plurality of mobile devices interact as nodes in a mobile ad hoc network and in which packets are IP routable to each of mobile devices of fixed infrastructure elements; and providing a soft/smart phone mobile application that communicates via the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; applying swarm intelligence to determine at least some parts of at least some routes through the mobile, broadband, routable internet; and providing a soft/smart phone mobile application that communicates via the mobile ad hoc network.

In an aspect of the invention, methods and systems include providing a mobile, broadband, routable internet, in which a plurality of mobile devices interact as sending and receiving nodes in a mobile ad hoc network and in which packets are IP routable to the individual devices independent of fixed infrastructure elements; providing routing priority within the network, wherein the routing priority is provided by granting channel access to a node for which prioritized routing is identified and sending delay-sensitive data from the node before sending delay-tolerant data from the node; and providing a video mobile application that uses the routing priority to manage routing of data within the mobile, broadband, routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing support for peer-to-peer traffic within the network; and providing a video mobile application that provides fixed-network-independent capacity and service delivery by utilizing the peer-to-peer traffic network support.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer to peer connectivity within the mobile broadband routable internet; and providing a video mobile application that uses the peer to peer connectivity to facilitate mobile, fixed-infrastructure-independent, peer-to-peer application connection among at least a subset of the plurality of mobile devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing file sharing over the mobile broadband routable internet; and providing a video mobile application that uses file sharing without degrading system performance.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing user-generated applications over the mobile broadband routable internet; and providing a video mobile application associated with the mobile broadband routable internet, wherein the yyyy mobile application includes a user-generated application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer-to-peer applications over the mobile broadband routable internet; and providing a video mobile application that uses peer-to-peer applications without degrading performance of the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing direct device-to-device peering with symmetrical throughput between at least two nodes of the mobile broadband routable internet; and providing a video mobile application co-operating on the at least two nodes, wherein the yyyy mobile application utilizes the symmetrical throughput between the at least two nodes.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; facilitating direct-to-device application deployment over the mobile broadband routable internet; and providing a video mobile application that is deployed directly to a device in the mobile broadband routable internet using direct-to-device application deployment.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing data among a plurality of mobile broadband routable internet devices; and providing a video mobile application, wherein the mobile application uses the facility to access distributed data that is associated with the yyyy mobile application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing application components among a plurality of mobile broadband routable internet devices; and providing a video mobile application, components of which are distributed by the facility.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multicast routing within the network by allowing a data object to be transmitted by a device to a plurality of destinations over a plurality of routes; and providing a video mobile application that uses the multicast routing to at least distribute application-related updates.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote monitoring through the network; and providing a video mobile application that facilitates remote monitoring over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote control over the network; and providing a video mobile application that facilitates remote control over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote upgrade of at least one of software and services associated with the network; and providing a video mobile application that uses the remote upgrade to maintain a portion of the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an adaptive transmit power control facility for a device within the network, the adaptive transmit power control facility adapted to adjust transmission power of the device based on at least one of the density of proximate devices in the network, the condition of a neighboring device on the network, a channel condition of the network, a service level condition, a network performance condition, an environmental condition of the device and an application requirement of the device; and providing a video mobile application that uses adaptive transmit power control to adapt the transmit power associated with the application based on at least a density of devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing forwarding error correction on at least long IP packets; and providing a video mobile application that is enabled at least in part by utilizing forwarding error correction on the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for enabling adaptation of the data rate provided for links among devices within the network, the adaptation based on at least one of the density of devices in the network, the condition neighboring devices in the network, a channel condition of the network, a service level condition, a network performance condition, an environmental condition and an application requirement; and providing a video mobile application that adapts application related data transmission and receiving parameters based on the adaptive link data rates within the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing dynamic spectrum access capabilities within the network by determining communication spectrum quality and adjusting use of time frequency rectangles within the communication spectrum based on the determination; and providing a video mobile application that uses the dynamic spectrum access capabilities to provide enhanced use of spectral bandwidth.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; communicating among the plurality of devices over a radio communication spectrum and reusing portions of the spectrum for communication based on availability of time frequency rectangles within portions of the spectrum; and providing a video mobile application that reuses spectrum allocated for at least one other application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; and communicating wirelessly among at least a portion of the plurality of mobile devices, wherein the at least a portion of the plurality of mobile devices communicate independent of which radio frequency is used for the wireless communication; and wherein a video mobile application operating on at least two of the mobile devices exchanges information over the mobile broadband routable internet independent of the radio frequency.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing geo-location coding of device nodes in the network, wherein geo-location is based at least in part on a network location of a device node relative to other devices in the network; and providing a video mobile application that uses geo-location of device nodes in the network to facilitate at least one location-based service.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multimedia support within the network through a hybrid frame structure that includes variable slot duration and sub-channelization of bandwidth; and providing a video mobile application that uses multimedia support to provide yyyy related multimedia services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing time synchronization among nodes of the network, wherein the time synchronization is provided by communicating a representation of network timing at all the nodes with sufficient accuracy to enable reliable communications; and providing a video mobile application that uses network node time synchronization in delivery of the application services to device nodes in the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing seamless outdoor and indoor operation over the network; and providing a video mobile application takes advantage of the seamless outdoor and indoor operation to deliver services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing fixed radio installations that facilitate connection of the plurality of mobile devices, wherein the fixed radio installations are based at least in part on meeting a criteria associated with network radio propagation and performance; and providing a video mobile application that uses the fixed radio installation for backhaul communication associated with the application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an IP-compatible plug connection to at least one wired infrastructure type; and providing a video mobile application that uses the connection.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multiple fixed-network gateway interfaces connecting the mobile ad hoc network to a fixed network; and providing a video mobile application that communicates between a mobile device and a device on the fixed network.

In an aspect of the invention, methods and systems may include providing a mobile, broadband, routable internet, in which a plurality of mobile devices interact as nodes in a mobile ad hoc network and in which packets are IP routable to each of the devices independent of fixed infrastructure elements; providing an automated network design tool to facilitate low cost and fast network design engineering and deployment planning of the fixed infrastructure elements of the network; and deploying a video mobile application configured to use the networked designed by the design tool.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; deploying a plurality of low cost mesh access points to provide network coverage in a geography; and providing a video mobile application that communicates at least in part via the mesh access points.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing small form factor nodes that allow for low cost and fast capacity expansion and network upgrade; and providing a video mobile application that communicates at least in part via the small form factor nodes.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing communications between a mobile device and a device on a remote network so as to substantially favor routes through the mobile, broadband, routable Internet that have fewer hops between the mobile device and a backhaul access point; and providing a video mobile application that uses said communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing a user deployable access point that connects to the network; and providing a video mobile application that uses said access point.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing at least one base station controller function in at least one subscriber device, the base station controller function including at least one of an air interface management function, a signaling function, a concentration logic function, and a signal propagation function; and providing a video mobile application employing the at least one base state controller functions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing service provider tools to manage resource consumption of at least one device on the ad hoc network, wherein the tools are deployed on at least one of the plurality of mobile devices and use at least one management path for reporting usage of the at least one device; and providing a video mobile application for which the management path is used to report usage of the application.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing full radio resource management functions in at least one device, the radio resource management functions including at least one of radio management, handover, handoff, and foreign device cooperation functions, wherein the at least one device is a subscriber device; and providing a video mobile application operating responsively to a state of a managed radio resource.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multi-session functions in at least one of the plurality of devices, wherein the at least one device is a subscriber device; and providing a video mobile application communicating via multiple sessions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing cost-based routing functions in the network through dynamic forming and reforming of links and routes, wherein the cost-based routing functions are provided in a plurality of subscriber devices; and providing a video mobile application that uses the cost-based routing functions to deliver a desired balance of cost and quality of service.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP router functions at individual mobile devices of the network, wherein the individual mobile devices are subscriber devices; and providing a video mobile application that uses the IP router functions to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing, in at least one of the plurality of mobile devices, media access control layer capabilities including sub-network layer convergence functions selected from a list consisting of segmentation and reassembly, quality of service, throughput fairness, adaptive data rate control, and transmit power control, wherein the at least one mobile device is a subscriber device; and providing a video mobile application that uses the MAC layer to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing route diversity within the network to facilitate assurance of packet communication, wherein route diversity is based at least on a number of network devices in a geographic area; and providing a video mobile application that uses the route diversity to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; allowing layer 2 forwarding among at least some of the plurality of mobile devices; and providing a video mobile application that communicates via the layer 2 forwarding.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing the routable internet to a node in the network, wherein the node also communicates with a cellular network through at least one of the fixed infrastructure elements and the routable internet is provided outside the cellular network; and providing a video mobile application that communicates both through the cellular network and the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP application deployment to a device in the network, wherein the device also communicates with a cellular network through at least one of the fixed infrastructure elements and the IP application is deployed outside the cellular network; and providing a video mobile application that is deployed over IP and that communicates via the cellular network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network; and providing a video mobile application that communicates via the data packets.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network absent communications with the fixed infrastructure elements; and providing a video mobile application that communicates solely within the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/sec during normal operation; and providing a video mobile application that uses the communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/set when the nodes are in motion at vehicular speeds; and providing a video mobile application that uses the communications.

In an aspect of the invention, methods and systems include providing a mobile, broadband, routable internet, in which a plurality of mobile devices interact as nodes in a mobile ad hoc network and in which packets are IP routable to each of mobile devices of fixed infrastructure elements; and providing a video mobile application that communicates via the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; applying swarm intelligence to determine at least some parts of at least some routes through the mobile, broadband, routable internet; and providing a video mobile application that communicates via the mobile ad hoc network.

In an aspect of the invention, methods and systems include providing a mobile, broadband, routable internet, in which a plurality of mobile devices interact as sending and receiving nodes in a mobile ad hoc network and in which packets are IP routable to the individual devices independent of fixed infrastructure elements; providing routing priority within the network, wherein the routing priority is provided by granting channel access to a node for which prioritized routing is identified and sending delay-sensitive data from the node before sending delay-tolerant data from the node; and providing a music mobile application that uses the routing priority to manage routing of data within the mobile, broadband, routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing support for peer-to-peer traffic within the network; and providing a music mobile application that provides fixed-network-independent capacity and service delivery by utilizing the peer-to-peer traffic network support.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer to peer connectivity within the mobile broadband routable internet; and providing a music mobile application that uses the peer to peer connectivity to facilitate mobile, fixed-infrastructure-independent, peer-to-peer application connection among at least a subset of the plurality of mobile devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing file sharing over the mobile broadband routable internet; and providing a music mobile application that uses file sharing without degrading system performance.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing user-generated applications over the mobile broadband routable internet; and providing a music mobile application associated with the mobile broadband routable internet, wherein the yyyy mobile application includes a user-generated application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer-to-peer applications over the mobile broadband routable internet; and providing a music mobile application that uses peer-to-peer applications without degrading performance of the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing direct device-to-device peering with symmetrical throughput between at least two nodes of the mobile broadband routable internet; and providing a music mobile application co-operating on the at least two nodes, wherein the yyyy mobile application utilizes the symmetrical throughput between the at least two nodes.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; facilitating direct-to-device application deployment over the mobile broadband routable internet; and providing a music mobile application that is deployed directly to a device in the mobile broadband routable internet using direct-to-device application deployment.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing data among a plurality of mobile broadband routable internet devices; and providing a music mobile application, wherein the mobile application uses the facility to access distributed data that is associated with the yyyy mobile application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing application components among a plurality of mobile broadband routable internet devices; and providing a music mobile application, components of which are distributed by the facility.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multicast routing within the network by allowing a data object to be transmitted by a device to a plurality of destinations over a plurality of routes; and providing a music mobile application that uses the multicast routing to at least distribute application-related updates.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote monitoring through the network; and providing a music mobile application that facilitates remote monitoring over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote control over the network; and providing a music mobile application that facilitates remote control over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote upgrade of at least one of software and services associated with the network; and providing a music mobile application that uses the remote upgrade to maintain a portion of the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an adaptive transmit power control facility for a device within the network, the adaptive transmit power control facility adapted to adjust transmission power of the device based on at least one of the density of proximate devices in the network, the condition of a neighboring device on the network, a channel condition of the network, a service level condition, a network performance condition, an environmental condition of the device and an application requirement of the device; and providing a music mobile application that uses adaptive transmit power control to adapt the transmit power associated with the application based on at least a density of devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing forwarding error correction on at least long IP packets; and providing a music mobile application that is enabled at least in part by utilizing forwarding error correction on the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for enabling adaptation of the data rate provided for links among devices within the network, the adaptation based on at least one of the density of devices in the network, the condition neighboring devices in the network, a channel condition of the network, a service level condition, a network performance condition, an environmental condition and an application requirement; and providing a music mobile application that adapts application related data transmission and receiving parameters based on the adaptive link data rates within the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing dynamic spectrum access capabilities within the network by determining communication spectrum quality and adjusting use of time frequency rectangles within the communication spectrum based on the determination; and providing a music mobile application that uses the dynamic spectrum access capabilities to provide enhanced use of spectral bandwidth.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; communicating among the plurality of devices over a radio communication spectrum and reusing portions of the spectrum for communication based on availability of time frequency rectangles within portions of the spectrum; and providing a music mobile application that reuses spectrum allocated for at least one other application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; and communicating wirelessly among at least a portion of the plurality of mobile devices, wherein the at least a portion of the plurality of mobile devices communicate independent of which radio frequency is used for the wireless communication; and wherein a music mobile application operating on at least two of the mobile devices exchanges information over the mobile broadband routable internet independent of the radio frequency.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing geo-location coding of device nodes in the network, wherein geo-location is based at least in part on a network location of a device node relative to other devices in the network; and providing a music mobile application that uses geo-location of device nodes in the network to facilitate at least one location-based service.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multimedia support within the network through a hybrid frame structure that includes variable slot duration and sub-channelization of bandwidth; and providing a music mobile application that uses multimedia support to provide yyyy related multimedia services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing time synchronization among nodes of the network, wherein the time synchronization is provided by communicating a representation of network timing at all the nodes with sufficient accuracy to enable reliable communications; and providing a music mobile application that uses network node time synchronization in delivery of the application services to device nodes in the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing seamless outdoor and indoor operation over the network; and providing a music mobile application takes advantage of the seamless outdoor and indoor operation to deliver services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing fixed radio installations that facilitate connection of the plurality of mobile devices, wherein the fixed radio installations are based at least in part on meeting a criteria associated with network radio propagation and performance; and providing a music mobile application that uses the fixed radio installation for backhaul communication associated with the application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an IP-compatible plug connection to at least one wired infrastructure type; and providing a music mobile application that uses the connection.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multiple fixed-network gateway interfaces connecting the mobile ad hoc network to a fixed network; and providing a music mobile application that communicates between a mobile device and a device on the fixed network.

In an aspect of the invention, methods and systems may include providing a mobile, broadband, routable internet, in which a plurality of mobile devices interact as nodes in a mobile ad hoc network and in which packets are IP routable to each of the devices independent of fixed infrastructure elements; providing an automated network design tool to facilitate low cost and fast network design engineering and deployment planning of the fixed infrastructure elements of the network; and deploying a music mobile application configured to use the networked designed by the design tool.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; deploying a plurality of low cost mesh access points to provide network coverage in a geography; and providing a music mobile application that communicates at least in part via the mesh access points.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing small form factor nodes that allow for low cost and fast capacity expansion and network upgrade; and providing a music mobile application that communicates at least in part via the small form factor nodes.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing communications between a mobile device and a device on a remote network so as to substantially favor routes through the mobile, broadband, routable Internet that have fewer hops between the mobile device and a backhaul access point; and providing a music mobile application that uses said communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing a user deployable access point that connects to the network; and providing a music mobile application that uses said access point.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing at least one base station controller function in at least one subscriber device, the base station controller function including at least one of an air interface management function, a signaling function, a concentration logic function, and a signal propagation function; and providing a music mobile application employing the at least one base state controller functions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing service provider tools to manage resource consumption of at least one device on the ad hoc network, wherein the tools are deployed on at least one of the plurality of mobile devices and use at least one management path for reporting usage of the at least one device; and providing a music mobile application for which the management path is used to report usage of the application.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing full radio resource management functions in at least one device, the radio resource management functions including at least one of radio management, handover, handoff, and foreign device cooperation functions, wherein the at least one device is a subscriber device; and providing a music mobile application operating responsively to a state of a managed radio resource.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multi-session functions in at least one of the plurality of devices, wherein the at least one device is a subscriber device; and providing a music mobile application communicating via multiple sessions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing cost-based routing functions in the network through dynamic forming and reforming of links and routes, wherein the cost-based routing functions are provided in a plurality of subscriber devices; and providing a music mobile application that uses the cost-based routing functions to deliver a desired balance of cost and quality of service.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP router functions at individual mobile devices of the network, wherein the individual mobile devices are subscriber devices; and providing a music mobile application that uses the IP router functions to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing, in at least one of the plurality of mobile devices, media access control layer capabilities including sub-network layer convergence functions selected from a list consisting of segmentation and reassembly, quality of service, throughput fairness, adaptive data rate control, and transmit power control, wherein the at least one mobile device is a subscriber device; and providing a music mobile application that uses the MAC layer to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing route diversity within the network to facilitate assurance of packet communication, wherein route diversity is based at least on a number of network devices in a geographic area; and providing a music mobile application that uses the route diversity to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; allowing layer 2 forwarding among at least some of the plurality of mobile devices; and providing a music mobile application that communicates via the layer 2 forwarding.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing the routable internet to a node in the network, wherein the node also communicates with a cellular network through at least one of the fixed infrastructure elements and the routable internet is provided outside the cellular network; and providing a music mobile application that communicates both through the cellular network and the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP application deployment to a device in the network, wherein the device also communicates with a cellular network through at least one of the fixed infrastructure elements and the IP application is deployed outside the cellular network; and providing a music mobile application that is deployed over IP and that communicates via the cellular network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network; and providing a music mobile application that communicates via the data packets.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network absent communications with the fixed infrastructure elements; and providing a music mobile application that communicates solely within the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/sec during normal operation; and providing a music mobile application that uses the communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/set when the nodes are in motion at vehicular speeds; and providing a music mobile application that uses the communications.

In an aspect of the invention, methods and systems include providing a mobile, broadband, routable internet, in which a plurality of mobile devices interact as nodes in a mobile ad hoc network and in which packets are IP routable to each of mobile devices of fixed infrastructure elements; and providing a music mobile application that communicates via the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; applying swarm intelligence to determine at least some parts of at least some routes through the mobile, broadband, routable internet; and providing a music mobile application that communicates via the mobile ad hoc network.

In an aspect of the invention, methods and systems include providing a mobile, broadband, routable internet, in which a plurality of mobile devices interact as sending and receiving nodes in a mobile ad hoc network and in which packets are IP routable to the individual devices independent of fixed infrastructure elements; providing routing priority within the network, wherein the routing priority is provided by granting channel access to a node for which prioritized routing is identified and sending delay-sensitive data from the node before sending delay-tolerant data from the node; and providing a gaming mobile application that uses the routing priority to manage routing of data within the mobile, broadband, routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing support for peer-to-peer traffic within the network; and providing a gaming mobile application that provides fixed-network-independent capacity and service delivery by utilizing the peer-to-peer traffic network support.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer to peer connectivity within the mobile broadband routable internet; and providing a gaming mobile application that uses the peer to peer connectivity to facilitate mobile, fixed-infrastructure-independent, peer-to-peer application connection among at least a subset of the plurality of mobile devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing file sharing over the mobile broadband routable internet; and providing a gaming mobile application that uses file sharing without degrading system performance.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing user-generated applications over the mobile broadband routable internet; and providing a gaming mobile application associated with the mobile broadband routable internet, wherein the yyyy mobile application includes a user-generated application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer-to-peer applications over the mobile broadband routable internet; and providing a gaming mobile application that uses peer-to-peer applications without degrading performance of the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing direct device-to-device peering with symmetrical throughput between at least two nodes of the mobile broadband routable internet; and providing a gaming mobile application co-operating on the at least two nodes, wherein the yyyy mobile application utilizes the symmetrical throughput between the at least two nodes.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; facilitating direct-to-device application deployment over the mobile broadband routable internet; and providing a gaming mobile application that is deployed directly to a device in the mobile broadband routable internet using direct-to-device application deployment.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing data among a plurality of mobile broadband routable internet devices; and providing a gaming mobile application, wherein the mobile application uses the facility to access distributed data that is associated with the yyyy mobile application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing application components among a plurality of mobile broadband routable internet devices; and providing a gaming mobile application, components of which are distributed by the facility.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multicast routing within the network by allowing a data object to be transmitted by a device to a plurality of destinations over a plurality of routes; and providing a gaming mobile application that uses the multicast routing to at least distribute application-related updates.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote monitoring through the network; and providing a gaming mobile application that facilitates remote monitoring over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote control over the network; and providing a gaming mobile application that facilitates remote control over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote upgrade of at least one of software and services associated with the network; and providing a gaming mobile application that uses the remote upgrade to maintain a portion of the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an adaptive transmit power control facility for a device within the network, the adaptive transmit power control facility adapted to adjust transmission power of the device based on at least one of the density of proximate devices in the network, the condition of a neighboring device on the network, a channel condition of the network, a service level condition, a network performance condition, an environmental condition of the device and an application requirement of the device; and providing a gaming mobile application that uses adaptive transmit power control to adapt the transmit power associated with the application based on at least a density of devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing forwarding error correction on at least long IP packets; and providing a gaming mobile application that is enabled at least in part by utilizing forwarding error correction on the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for enabling adaptation of the data rate provided for links among devices within the network, the adaptation based on at least one of the density of devices in the network, the condition neighboring devices in the network, a channel condition of the network, a service level condition, a network performance condition, an environmental condition and an application requirement; and providing a gaming mobile application that adapts application related data transmission and receiving parameters based on the adaptive link data rates within the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing dynamic spectrum access capabilities within the network by determining communication spectrum quality and adjusting use of time frequency rectangles within the communication spectrum based on the determination; and providing a gaming mobile application that uses the dynamic spectrum access capabilities to provide enhanced use of spectral bandwidth.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; communicating among the plurality of devices over a radio communication spectrum and reusing portions of the spectrum for communication based on availability of time frequency rectangles within portions of the spectrum; and providing a gaming mobile application that reuses spectrum allocated for at least one other application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; and communicating wirelessly among at least a portion of the plurality of mobile devices, wherein the at least a portion of the plurality of mobile devices communicate independent of which radio frequency is used for the wireless communication; and wherein a gaming mobile application operating on at least two of the mobile devices exchanges information over the mobile broadband routable internet independent of the radio frequency.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing geo-location coding of device nodes in the network, wherein geo-location is based at least in part on a network location of a device node relative to other devices in the network; and providing a gaming mobile application that uses geo-location of device nodes in the network to facilitate at least one location-based service.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multimedia support within the network through a hybrid frame structure that includes variable slot duration and sub-channelization of bandwidth; and providing a gaming mobile application that uses multimedia support to provide yyyy related multimedia services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing time synchronization among nodes of the network, wherein the time synchronization is provided by communicating a representation of network timing at all the nodes with sufficient accuracy to enable reliable communications; and providing a gaming mobile application that uses network node time synchronization in delivery of the application services to device nodes in the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing seamless outdoor and indoor operation over the network; and providing a gaming mobile application takes advantage of the seamless outdoor and indoor operation to deliver services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing fixed radio installations that facilitate connection of the plurality of mobile devices, wherein the fixed radio installations are based at least in part on meeting a criteria associated with network radio propagation and performance; and providing a gaming mobile application that uses the fixed radio installation for backhaul communication associated with the application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an IP-compatible plug connection to at least one wired infrastructure type; and providing a gaming mobile application that uses the connection.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multiple fixed-network gateway interfaces connecting the mobile ad hoc network to a fixed network; and providing a gaming mobile application that communicates between a mobile device and a device on the fixed network.

In an aspect of the invention, methods and systems may include providing a mobile, broadband, routable internet, in which a plurality of mobile devices interact as nodes in a mobile ad hoc network and in which packets are IP routable to each of the devices independent of fixed infrastructure elements; providing an automated network design tool to facilitate low cost and fast network design engineering and deployment planning of the fixed infrastructure elements of the network; and deploying a gaming mobile application configured to use the networked designed by the design tool.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; deploying a plurality of low cost mesh access points to provide network coverage in a geography; and providing a gaming mobile application that communicates at least in part via the mesh access points.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing small form factor nodes that allow for low cost and fast capacity expansion and network upgrade; and providing a gaming mobile application that communicates at least in part via the small form factor nodes.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing communications between a mobile device and a device on a remote network so as to substantially favor routes through the mobile, broadband, routable Internet that have fewer hops between the mobile device and a backhaul access point; and providing a gaming mobile application that uses said communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing a user deployable access point that connects to the network; and providing a gaming mobile application that uses said access point.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing at least one base station controller function in at least one subscriber device, the base station controller function including at least one of an air interface management function, a signaling function, a concentration logic function, and a signal propagation function; and providing a gaming mobile application employing the at least one base state controller functions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing service provider tools to manage resource consumption of at least one device on the ad hoc network, wherein the tools are deployed on at least one of the plurality of mobile devices and use at least one management path for reporting usage of the at least one device; and providing a gaming mobile application for which the management path is used to report usage of the application.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing full radio resource management functions in at least one device, the radio resource management functions including at least one of radio management, handover, handoff, and foreign device cooperation functions, wherein the at least one device is a subscriber device; and providing a gaming mobile application operating responsively to a state of a managed radio resource.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multi-session functions in at least one of the plurality of devices, wherein the at least one device is a subscriber device; and providing a gaming mobile application communicating via multiple sessions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing cost-based routing functions in the network through dynamic forming and reforming of links and routes, wherein the cost-based routing functions are provided in a plurality of subscriber devices; and providing a gaming mobile application that uses the cost-based routing functions to deliver a desired balance of cost and quality of service.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP router functions at individual mobile devices of the network, wherein the individual mobile devices are subscriber devices; and providing a gaming mobile application that uses the IP router functions to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing, in at least one of the plurality of mobile devices, media access control layer capabilities including sub-network layer convergence functions selected from a list consisting of segmentation and reassembly, quality of service, throughput fairness, adaptive data rate control, and transmit power control, wherein the at least one mobile device is a subscriber device; and providing a gaming mobile application that uses the MAC layer to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing route diversity within the network to facilitate assurance of packet communication, wherein route diversity is based at least on a number of network devices in a geographic area; and providing a gaming mobile application that uses the route diversity to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; allowing layer 2 forwarding among at least some of the plurality of mobile devices; and providing a gaming mobile application that communicates via the layer 2 forwarding.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing the routable internet to a node in the network, wherein the node also communicates with a cellular network through at least one of the fixed infrastructure elements and the routable internet is provided outside the cellular network; and providing a gaming mobile application that communicates both through the cellular network and the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP application deployment to a device in the network, wherein the device also communicates with a cellular network through at least one of the fixed infrastructure elements and the IP application is deployed outside the cellular network; and providing a gaming mobile application that is deployed over IP and that communicates via the cellular network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network; and providing a gaming mobile application that communicates via the data packets.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network absent communications with the fixed infrastructure elements; and providing a gaming mobile application that communicates solely within the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/sec during normal operation; and providing a gaming mobile application that uses the communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/set when the nodes are in motion at vehicular speeds; and providing a gaming mobile application that uses the communications.

In an aspect of the invention, methods and systems include providing a mobile, broadband, routable internet, in which a plurality of mobile devices interact as nodes in a mobile ad hoc network and in which packets are IP routable to each of mobile devices of fixed infrastructure elements; and providing a gaming mobile application that communicates via the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; applying swarm intelligence to determine at least some parts of at least some routes through the mobile, broadband, routable internet; and providing a gaming mobile application that communicates via the mobile ad hoc network.

In an aspect of the invention, methods and systems include providing a mobile, broadband, routable internet, in which a plurality of mobile devices interact as sending and receiving nodes in a mobile ad hoc network and in which packets are IP routable to the individual devices independent of fixed infrastructure elements; providing routing priority within the network, wherein the routing priority is provided by granting channel access to a node for which prioritized routing is identified and sending delay-sensitive data from the node before sending delay-tolerant data from the node; and providing a voice over ip mobile application that uses the routing priority to manage routing of data within the mobile, broadband, routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing support for peer-to-peer traffic within the network; and providing a voice over ip mobile application that provides fixed-network-independent capacity and service delivery by utilizing the peer-to-peer traffic network support.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer to peer connectivity within the mobile broadband routable internet; and providing a voice over ip mobile application that uses the peer to peer connectivity to facilitate mobile, fixed-infrastructure-independent, peer-to-peer application connection among at least a subset of the plurality of mobile devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing file sharing over the mobile broadband routable internet; and providing a voice over ip mobile application that uses file sharing without degrading system performance.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing user-generated applications over the mobile broadband routable internet; and providing a voice over ip mobile application associated with the mobile broadband routable internet, wherein the yyyy mobile application includes a user-generated application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer-to-peer applications over the mobile broadband routable internet; and providing a voice over ip mobile application that uses peer-to-peer applications without degrading performance of the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing direct device-to-device peering with symmetrical throughput between at least two nodes of the mobile broadband routable internet; and providing a voice over ip mobile application co-operating on the at least two nodes, wherein the yyyy mobile application utilizes the symmetrical throughput between the at least two nodes.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; facilitating direct-to-device application deployment over the mobile broadband routable internet; and providing a voice over ip mobile application that is deployed directly to a device in the mobile broadband routable internet using direct-to-device application deployment.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing data among a plurality of mobile broadband routable internet devices; and providing a voice over ip mobile application, wherein the mobile application uses the facility to access distributed data that is associated with the yyyy mobile application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing application components among a plurality of mobile broadband routable internet devices; and providing a voice over ip mobile application, components of which are distributed by the facility.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multicast routing within the network by allowing a data object to be transmitted by a device to a plurality of destinations over a plurality of routes; and providing a voice over ip mobile application that uses the multicast routing to at least distribute application-related updates.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote monitoring through the network; and providing a voice over ip mobile application that facilitates remote monitoring over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote control over the network; and providing a voice over ip mobile application that facilitates remote control over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote upgrade of at least one of software and services associated with the network; and providing a voice over ip mobile application that uses the remote upgrade to maintain a portion of the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an adaptive transmit power control facility for a device within the network, the adaptive transmit power control facility adapted to adjust transmission power of the device based on at least one of the density of proximate devices in the network, the condition of a neighboring device on the network, a channel condition of the network, a service level condition, a network performance condition, an environmental condition of the device and an application requirement of the device; and providing a voice over ip mobile application that uses adaptive transmit power control to adapt the transmit power associated with the application based on at least a density of devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing forwarding error correction on at least long IP packets; and providing a voice over ip mobile application that is enabled at least in part by utilizing forwarding error correction on the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for enabling adaptation of the data rate provided for links among devices within the network, the adaptation based on at least one of the density of devices in the network, the condition neighboring devices in the network, a channel condition of the network, a service level condition, a network performance condition, an environmental condition and an application requirement; and providing a voice over ip mobile application that adapts application related data transmission and receiving parameters based on the adaptive link data rates within the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing dynamic spectrum access capabilities within the network by determining communication spectrum quality and adjusting use of time frequency rectangles within the communication spectrum based on the determination; and providing a voice over ip mobile application that uses the dynamic spectrum access capabilities to provide enhanced use of spectral bandwidth.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; communicating among the plurality of devices over a radio communication spectrum and reusing portions of the spectrum for communication based on availability of time frequency rectangles within portions of the spectrum; and providing a voice over ip mobile application that reuses spectrum allocated for at least one other application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; and communicating wirelessly among at least a portion of the plurality of mobile devices, wherein the at least a portion of the plurality of mobile devices communicate independent of which radio frequency is used for the wireless communication; and wherein a voice over ip mobile application operating on at least two of the mobile devices exchanges information over the mobile broadband routable internet independent of the radio frequency.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing geo-location coding of device nodes in the network, wherein geo-location is based at least in part on a network location of a device node relative to other devices in the network; and providing a voice over ip mobile application that uses geo-location of device nodes in the network to facilitate at least one location-based service.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multimedia support within the network through a hybrid frame structure that includes variable slot duration and sub-channelization of bandwidth; and providing a voice over ip mobile application that uses multimedia support to provide yyyy related multimedia services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing time synchronization among nodes of the network, wherein the time synchronization is provided by communicating a representation of network timing at all the nodes with sufficient accuracy to enable reliable communications; and providing a voice over ip mobile application that uses network node time synchronization in delivery of the application services to device nodes in the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing seamless outdoor and indoor operation over the network; and providing a voice over ip mobile application takes advantage of the seamless outdoor and indoor operation to deliver services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing fixed radio installations that facilitate connection of the plurality of mobile devices, wherein the fixed radio installations are based at least in part on meeting a criteria associated with network radio propagation and performance; and providing a voice over ip mobile application that uses the fixed radio installation for backhaul communication associated with the application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an IP-compatible plug connection to at least one wired infrastructure type; and providing a voice over ip mobile application that uses the connection.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multiple fixed-network gateway interfaces connecting the mobile ad hoc network to a fixed network; and providing a voice over ip mobile application that communicates between a mobile device and a device on the fixed network.

In an aspect of the invention, methods and systems may include providing a mobile, broadband, routable internet, in which a plurality of mobile devices interact as nodes in a mobile ad hoc network and in which packets are IP routable to each of the devices independent of fixed infrastructure elements; providing an automated network design tool to facilitate low cost and fast network design engineering and deployment planning of the fixed infrastructure elements of the network; and deploying a voice over ip mobile application configured to use the networked designed by the design tool.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; deploying a plurality of low cost mesh access points to provide network coverage in a geography; and providing a voice over ip mobile application that communicates at least in part via the mesh access points.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing small form factor nodes that allow for low cost and fast capacity expansion and network upgrade; and providing a voice over ip mobile application that communicates at least in part via the small form factor nodes.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing communications between a mobile device and a device on a remote network so as to substantially favor routes through the mobile, broadband, routable Internet that have fewer hops between the mobile device and a backhaul access point; and providing a voice over ip mobile application that uses said communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing a user deployable access point that connects to the network; and providing a voice over ip mobile application that uses said access point.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing at least one base station controller function in at least one subscriber device, the base station controller function including at least one of an air interface management function, a signaling function, a concentration logic function, and a signal propagation function; and providing a voice over ip mobile application employing the at least one base state controller functions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing service provider tools to manage resource consumption of at least one device on the ad hoc network, wherein the tools are deployed on at least one of the plurality of mobile devices and use at least one management path for reporting usage of the at least one device; and providing a voice over ip mobile application for which the management path is used to report usage of the application.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing full radio resource management functions in at least one device, the radio resource management functions including at least one of radio management, handover, handoff, and foreign device cooperation functions, wherein the at least one device is a subscriber device; and providing a voice over ip mobile application operating responsively to a state of a managed radio resource.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multi-session functions in at least one of the plurality of devices, wherein the at least one device is a subscriber device; and providing a voice over ip mobile application communicating via multiple sessions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing cost-based routing functions in the network through dynamic forming and reforming of links and routes, wherein the cost-based routing functions are provided in a plurality of subscriber devices; and providing a voice over ip mobile application that uses the cost-based routing functions to deliver a desired balance of cost and quality of service.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP router functions at individual mobile devices of the network, wherein the individual mobile devices are subscriber devices; and providing a voice over ip mobile application that uses the IP router functions to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing, in at least one of the plurality of mobile devices, media access control layer capabilities including sub-network layer convergence functions selected from a list consisting of segmentation and reassembly, quality of service, throughput fairness, adaptive data rate control, and transmit power control, wherein the at least one mobile device is a subscriber device; and providing a voice over ip mobile application that uses the MAC layer to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing route diversity within the network to facilitate assurance of packet communication, wherein route diversity is based at least on a number of network devices in a geographic area; and providing a voice over ip mobile application that uses the route diversity to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; allowing layer 2 forwarding among at least some of the plurality of mobile devices; and providing a voice over ip mobile application that communicates via the layer 2 forwarding.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing the routable internet to a node in the network, wherein the node also communicates with a cellular network through at least one of the fixed infrastructure elements and the routable internet is provided outside the cellular network; and providing a voice over ip mobile application that communicates both through the cellular network and the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP application deployment to a device in the network, wherein the device also communicates with a cellular network through at least one of the fixed infrastructure elements and the IP application is deployed outside the cellular network; and providing a voice over ip mobile application that is deployed over IP and that communicates via the cellular network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network; and providing a voice over ip mobile application that communicates via the data packets.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network absent communications with the fixed infrastructure elements; and providing a voice over ip mobile application that communicates solely within the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/sec during normal operation; and providing a voice over ip mobile application that uses the communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/set when the nodes are in motion at vehicular speeds; and providing a voice over ip mobile application that uses the communications.

In an aspect of the invention, methods and systems include providing a mobile, broadband, routable internet, in which a plurality of mobile devices interact as nodes in a mobile ad hoc network and in which packets are IP routable to each of mobile devices of fixed infrastructure elements; and providing a voice over ip mobile application that communicates via the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; applying swarm intelligence to determine at least some parts of at least some routes through the mobile, broadband, routable internet; and providing a voice over ip mobile application that communicates via the mobile ad hoc network.

In an aspect of the invention, methods and systems include providing a mobile, broadband, routable internet, in which a plurality of mobile devices interact as sending and receiving nodes in a mobile ad hoc network and in which packets are IP routable to the individual devices independent of fixed infrastructure elements; providing routing priority within the network, wherein the routing priority is provided by granting channel access to a node for which prioritized routing is identified and sending delay-sensitive data from the node before sending delay-tolerant data from the node; and providing a locally deployed mobile application that uses the routing priority to manage routing of data within the mobile, broadband, routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing support for peer-to-peer traffic within the network; and providing a locally deployed mobile application that provides fixed-network-independent capacity and service delivery by utilizing the peer-to-peer traffic network support.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer to peer connectivity within the mobile broadband routable internet; and providing a locally deployed mobile application that uses the peer to peer connectivity to facilitate mobile, fixed-infrastructure-independent, peer-to-peer application connection among at least a subset of the plurality of mobile devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing file sharing over the mobile broadband routable internet; and providing a locally deployed mobile application that uses file sharing without degrading system performance.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing user-generated applications over the mobile broadband routable internet; and providing a locally deployed mobile application associated with the mobile broadband routable internet, wherein the yyyy mobile application includes a user-generated application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer-to-peer applications over the mobile broadband routable internet; and providing a locally deployed mobile application that uses peer-to-peer applications without degrading performance of the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing direct device-to-device peering with symmetrical throughput between at least two nodes of the mobile broadband routable internet; and providing a locally deployed mobile application co-operating on the at least two nodes, wherein the yyyy mobile application utilizes the symmetrical throughput between the at least two nodes.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; facilitating direct-to-device application deployment over the mobile broadband routable internet; and providing a locally deployed mobile application that is deployed directly to a device in the mobile broadband routable internet using direct-to-device application deployment.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing data among a plurality of mobile broadband routable internet devices; and providing a locally deployed mobile application, wherein the mobile application uses the facility to access distributed data that is associated with the yyyy mobile application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing application components among a plurality of mobile broadband routable internet devices; and providing a locally deployed mobile application, components of which are distributed by the facility.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multicast routing within the network by allowing a data object to be transmitted by a device to a plurality of destinations over a plurality of routes; and providing a locally deployed mobile application that uses the multicast routing to at least distribute application-related updates.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote monitoring through the network; and providing a locally deployed mobile application that facilitates remote monitoring over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote control over the network; and providing a locally deployed mobile application that facilitates remote control over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote upgrade of at least one of software and services associated with the network; and providing a locally deployed mobile application that uses the remote upgrade to maintain a portion of the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an adaptive transmit power control facility for a device within the network, the adaptive transmit power control facility adapted to adjust transmission power of the device based on at least one of the density of proximate devices in the network, the condition of a neighboring device on the network, a channel condition of the network, a service level condition, a network performance condition, an environmental condition of the device and an application requirement of the device; and providing a locally deployed mobile application that uses adaptive transmit power control to adapt the transmit power associated with the application based on at least a density of devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing forwarding error correction on at least long IP packets; and providing a locally deployed mobile application that is enabled at least in part by utilizing forwarding error correction on the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for enabling adaptation of the data rate provided for links among devices within the network, the adaptation based on at least one of the density of devices in the network, the condition neighboring devices in the network, a channel condition of the network, a service level condition, a network performance condition, an environmental condition and an application requirement; and providing a locally deployed mobile application that adapts application related data transmission and receiving parameters based on the adaptive link data rates within the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing dynamic spectrum access capabilities within the network by determining communication spectrum quality and adjusting use of time frequency rectangles within the communication spectrum based on the determination; and providing a locally deployed mobile application that uses the dynamic spectrum access capabilities to provide enhanced use of spectral bandwidth.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; communicating among the plurality of devices over a radio communication spectrum and reusing portions of the spectrum for communication based on availability of time frequency rectangles within portions of the spectrum; and providing a locally deployed mobile application that reuses spectrum allocated for at least one other application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; and communicating wirelessly among at least a portion of the plurality of mobile devices, wherein the at least a portion of the plurality of mobile devices communicate independent of which radio frequency is used for the wireless communication; and wherein a locally deployed mobile application operating on at least two of the mobile devices exchanges information over the mobile broadband routable internet independent of the radio frequency.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing geo-location coding of device nodes in the network, wherein geo-location is based at least in part on a network location of a device node relative to other devices in the network; and providing a locally deployed mobile application that uses geo-location of device nodes in the network to facilitate at least one location-based service.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multimedia support within the network through a hybrid frame structure that includes variable slot duration and sub-channelization of bandwidth; and providing a locally deployed mobile application that uses multimedia support to provide yyyy related multimedia services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing time synchronization among nodes of the network, wherein the time synchronization is provided by communicating a representation of network timing at all the nodes with sufficient accuracy to enable reliable communications; and providing a locally deployed mobile application that uses network node time synchronization in delivery of the application services to device nodes in the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing seamless outdoor and indoor operation over the network; and providing a locally deployed mobile application takes advantage of the seamless outdoor and indoor operation to deliver services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing fixed radio installations that facilitate connection of the plurality of mobile devices, wherein the fixed radio installations are based at least in part on meeting a criteria associated with network radio propagation and performance; and providing a locally deployed mobile application that uses the fixed radio installation for backhaul communication associated with the application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an IP-compatible plug connection to at least one wired infrastructure type; and providing a locally deployed mobile application that uses the connection.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multiple fixed-network gateway interfaces connecting the mobile ad hoc network to a fixed network; and providing a locally deployed mobile application that communicates between a mobile device and a device on the fixed network.

In an aspect of the invention, methods and systems may include providing a mobile, broadband, routable internet, in which a plurality of mobile devices interact as nodes in a mobile ad hoc network and in which packets are IP routable to each of the devices independent of fixed infrastructure elements; providing an automated network design tool to facilitate low cost and fast network design engineering and deployment planning of the fixed infrastructure elements of the network; and deploying a locally deployed mobile application configured to use the networked designed by the design tool.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; deploying a plurality of low cost mesh access points to provide network coverage in a geography; and providing a locally deployed mobile application that communicates at least in part via the mesh access points.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing small form factor nodes that allow for low cost and fast capacity expansion and network upgrade; and providing a locally deployed mobile application that communicates at least in part via the small form factor nodes.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing communications between a mobile device and a device on a remote network so as to substantially favor routes through the mobile, broadband, routable Internet that have fewer hops between the mobile device and a backhaul access point; and providing a locally deployed mobile application that uses said communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing a user deployable access point that connects to the network; and providing a locally deployed mobile application that uses said access point.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing at least one base station controller function in at least one subscriber device, the base station controller function including at least one of an air interface management function, a signaling function, a concentration logic function, and a signal propagation function; and providing a locally deployed mobile application employing the at least one base state controller functions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing service provider tools to manage resource consumption of at least one device on the ad hoc network, wherein the tools are deployed on at least one of the plurality of mobile devices and use at least one management path for reporting usage of the at least one device; and providing a locally deployed mobile application for which the management path is used to report usage of the application.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing full radio resource management functions in at least one device, the radio resource management functions including at least one of radio management, handover, handoff, and foreign device cooperation functions, wherein the at least one device is a subscriber device; and providing a locally deployed mobile application operating responsively to a state of a managed radio resource.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multi-session functions in at least one of the plurality of devices, wherein the at least one device is a subscriber device; and providing a locally deployed mobile application communicating via multiple sessions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing cost-based routing functions in the network through dynamic forming and reforming of links and routes, wherein the cost-based routing functions are provided in a plurality of subscriber devices; and providing a locally deployed mobile application that uses the cost-based routing functions to deliver a desired balance of cost and quality of service.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP router functions at individual mobile devices of the network, wherein the individual mobile devices are subscriber devices; and providing a locally deployed mobile application that uses the IP router functions to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing, in at least one of the plurality of mobile devices, media access control layer capabilities including sub-network layer convergence functions selected from a list consisting of segmentation and reassembly, quality of service, throughput fairness, adaptive data rate control, and transmit power control, wherein the at least one mobile device is a subscriber device; and providing a locally deployed mobile application that uses the MAC layer to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing route diversity within the network to facilitate assurance of packet communication, wherein route diversity is based at least on a number of network devices in a geographic area; and providing a locally deployed mobile application that uses the route diversity to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; allowing layer 2 forwarding among at least some of the plurality of mobile devices; and providing a locally deployed mobile application that communicates via the layer 2 forwarding.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing the routable internet to a node in the network, wherein the node also communicates with a cellular network through at least one of the fixed infrastructure elements and the routable internet is provided outside the cellular network; and providing a locally deployed mobile application that communicates both through the cellular network and the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP application deployment to a device in the network, wherein the device also communicates with a cellular network through at least one of the fixed infrastructure elements and the IP application is deployed outside the cellular network; and providing a locally deployed mobile application that is deployed over IP and that communicates via the cellular network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network; and providing a locally deployed mobile application that communicates via the data packets.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network absent communications with the fixed infrastructure elements; and providing a locally deployed mobile application that communicates solely within the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/sec during normal operation; and providing a locally deployed mobile application that uses the communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/set when the nodes are in motion at vehicular speeds; and providing a locally deployed mobile application that uses the communications.

In an aspect of the invention, methods and systems include providing a mobile, broadband, routable internet, in which a plurality of mobile devices interact as nodes in a mobile ad hoc network and in which packets are IP routable to each of mobile devices of fixed infrastructure elements; and providing a locally deployed mobile application that communicates via the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; applying swarm intelligence to determine at least some parts of at least some routes through the mobile, broadband, routable internet; and providing a locally deployed mobile application that communicates via the mobile ad hoc network.

In an aspect of the invention, methods and systems include providing a mobile, broadband, routable internet, in which a plurality of mobile devices interact as sending and receiving nodes in a mobile ad hoc network and in which packets are IP routable to the individual devices independent of fixed infrastructure elements; providing routing priority within the network, wherein the routing priority is provided by granting channel access to a node for which prioritized routing is identified and sending delay-sensitive data from the node before sending delay-tolerant data from the node; and providing an entertainment mobile application that uses the routing priority to manage routing of data within the mobile, broadband, routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing support for peer-to-peer traffic within the network; and providing an entertainment mobile application that provides fixed-network-independent capacity and service delivery by utilizing the peer-to-peer traffic network support.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer to peer connectivity within the mobile broadband routable internet; and providing an entertainment mobile application that uses the peer to peer connectivity to facilitate mobile, fixed-infrastructure-independent, peer-to-peer application connection among at least a subset of the plurality of mobile devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing file sharing over the mobile broadband routable internet; and providing an entertainment mobile application that uses file sharing without degrading system performance.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing user-generated applications over the mobile broadband routable internet; and providing an entertainment mobile application associated with the mobile broadband routable internet, wherein the yyyy mobile application includes a user-generated application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer-to-peer applications over the mobile broadband routable internet; and providing an entertainment mobile application that uses peer-to-peer applications without degrading performance of the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing direct device-to-device peering with symmetrical throughput between at least two nodes of the mobile broadband routable internet; and providing an entertainment mobile application co-operating on the at least two nodes, wherein the yyyy mobile application utilizes the symmetrical throughput between the at least two nodes.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; facilitating direct-to-device application deployment over the mobile broadband routable internet; and providing an entertainment mobile application that is deployed directly to a device in the mobile broadband routable internet using direct-to-device application deployment.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing data among a plurality of mobile broadband routable internet devices; and providing an entertainment mobile application, wherein the mobile application uses the facility to access distributed data that is associated with the yyyy mobile application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing application components among a plurality of mobile broadband routable internet devices; and providing an entertainment mobile application, components of which are distributed by the facility.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multicast routing within the network by allowing a data object to be transmitted by a device to a plurality of destinations over a plurality of routes; and providing an entertainment mobile application that uses the multicast routing to at least distribute application-related updates.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote monitoring through the network; and providing an entertainment mobile application that facilitates remote monitoring over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote control over the network; and providing an entertainment mobile application that facilitates remote control over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote upgrade of at least one of software and services associated with the network; and providing an entertainment mobile application that uses the remote upgrade to maintain a portion of the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an adaptive transmit power control facility for a device within the network, the adaptive transmit power control facility adapted to adjust transmission power of the device based on at least one of the density of proximate devices in the network, the condition of a neighboring device on the network, a channel condition of the network, a service level condition, a network performance condition, an environmental condition of the device and an application requirement of the device; and providing an entertainment mobile application that uses adaptive transmit power control to adapt the transmit power associated with the application based on at least a density of devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing forwarding error correction on at least long IP packets; and providing an entertainment mobile application that is enabled at least in part by utilizing forwarding error correction on the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for enabling adaptation of the data rate provided for links among devices within the network, the adaptation based on at least one of the density of devices in the network, the condition neighboring devices in the network, a channel condition of the network, a service level condition, a network performance condition, an environmental condition and an application requirement; and providing an entertainment mobile application that adapts application related data transmission and receiving parameters based on the adaptive link data rates within the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing dynamic spectrum access capabilities within the network by determining communication spectrum quality and adjusting use of time frequency rectangles within the communication spectrum based on the determination; and providing an entertainment mobile application that uses the dynamic spectrum access capabilities to provide enhanced use of spectral bandwidth.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; communicating among the plurality of devices over a radio communication spectrum and reusing portions of the spectrum for communication based on availability of time frequency rectangles within portions of the spectrum; and providing an entertainment mobile application that reuses spectrum allocated for at least one other application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; and communicating wirelessly among at least a portion of the plurality of mobile devices, wherein the at least a portion of the plurality of mobile devices communicate independent of which radio frequency is used for the wireless communication; and wherein an entertainment mobile application operating on at least two of the mobile devices exchanges information over the mobile broadband routable internet independent of the radio frequency.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing geo-location coding of device nodes in the network, wherein geo-location is based at least in part on a network location of a device node relative to other devices in the network; and providing an entertainment mobile application that uses geo-location of device nodes in the network to facilitate at least one location-based service.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multimedia support within the network through a hybrid frame structure that includes variable slot duration and sub-channelization of bandwidth; and providing an entertainment mobile application that uses multimedia support to provide yyyy related multimedia services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing time synchronization among nodes of the network, wherein the time synchronization is provided by communicating a representation of network timing at all the nodes with sufficient accuracy to enable reliable communications; and providing an entertainment mobile application that uses network node time synchronization in delivery of the application services to device nodes in the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing seamless outdoor and indoor operation over the network; and providing an entertainment mobile application takes advantage of the seamless outdoor and indoor operation to deliver services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing fixed radio installations that facilitate connection of the plurality of mobile devices, wherein the fixed radio installations are based at least in part on meeting a criteria associated with network radio propagation and performance; and providing an entertainment mobile application that uses the fixed radio installation for backhaul communication associated with the application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an IP-compatible plug connection to at least one wired infrastructure type; and providing an entertainment mobile application that uses the connection.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multiple fixed-network gateway interfaces connecting the mobile ad hoc network to a fixed network; and providing an entertainment mobile application that communicates between a mobile device and a device on the fixed network.

In an aspect of the invention, methods and systems may include providing a mobile, broadband, routable internet, in which a plurality of mobile devices interact as nodes in a mobile ad hoc network and in which packets are IP routable to each of the devices independent of fixed infrastructure elements; providing an automated network design tool to facilitate low cost and fast network design engineering and deployment planning of the fixed infrastructure elements of the network; and deploying an entertainment mobile application configured to use the networked designed by the design tool.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; deploying a plurality of low cost mesh access points to provide network coverage in a geography; and providing an entertainment mobile application that communicates at least in part via the mesh access points.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing small form factor nodes that allow for low cost and fast capacity expansion and network upgrade; and providing an entertainment mobile application that communicates at least in part via the small form factor nodes.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing communications between a mobile device and a device on a remote network so as to substantially favor routes through the mobile, broadband, routable Internet that have fewer hops between the mobile device and a backhaul access point; and providing an entertainment mobile application that uses said communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing a user deployable access point that connects to the network; and providing an entertainment mobile application that uses said access point.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing at least one base station controller function in at least one subscriber device, the base station controller function including at least one of an air interface management function, a signaling function, a concentration logic function, and a signal propagation function; and providing an entertainment mobile application employing the at least one base state controller functions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing service provider tools to manage resource consumption of at least one device on the ad hoc network, wherein the tools are deployed on at least one of the plurality of mobile devices and use at least one management path for reporting usage of the at least one device; and providing an entertainment mobile application for which the management path is used to report usage of the application.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing full radio resource management functions in at least one device, the radio resource management functions including at least one of radio management, handover, handoff, and foreign device cooperation functions, wherein the at least one device is a subscriber device; and providing an entertainment mobile application operating responsively to a state of a managed radio resource.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multi-session functions in at least one of the plurality of devices, wherein the at least one device is a subscriber device; and providing an entertainment mobile application communicating via multiple sessions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing cost-based routing functions in the network through dynamic forming and reforming of links and routes, wherein the cost-based routing functions are provided in a plurality of subscriber devices; and providing an entertainment mobile application that uses the cost-based routing functions to deliver a desired balance of cost and quality of service.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP router functions at individual mobile devices of the network, wherein the individual mobile devices are subscriber devices; and providing an entertainment mobile application that uses the IP router functions to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing, in at least one of the plurality of mobile devices, media access control layer capabilities including sub-network layer convergence functions selected from a list consisting of segmentation and reassembly, quality of service, throughput fairness, adaptive data rate control, and transmit power control, wherein the at least one mobile device is a subscriber device; and providing an entertainment mobile application that uses the MAC layer to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing route diversity within the network to facilitate assurance of packet communication, wherein route diversity is based at least on a number of network devices in a geographic area; and providing an entertainment mobile application that uses the route diversity to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; allowing layer 2 forwarding among at least some of the plurality of mobile devices; and providing an entertainment mobile application that communicates via the layer 2 forwarding.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing the routable internet to a node in the network, wherein the node also communicates with a cellular network through at least one of the fixed infrastructure elements and the routable internet is provided outside the cellular network; and providing an entertainment mobile application that communicates both through the cellular network and the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP application deployment to a device in the network, wherein the device also communicates with a cellular network through at least one of the fixed infrastructure elements and the IP application is deployed outside the cellular network; and providing an entertainment mobile application that is deployed over IP and that communicates via the cellular network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network; and providing an entertainment mobile application that communicates via the data packets.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network absent communications with the fixed infrastructure elements; and providing an entertainment mobile application that communicates solely within the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/sec during normal operation; and providing an entertainment mobile application that uses the communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/set when the nodes are in motion at vehicular speeds; and providing an entertainment mobile application that uses the communications.

In an aspect of the invention, methods and systems include providing a mobile, broadband, routable internet, in which a plurality of mobile devices interact as nodes in a mobile ad hoc network and in which packets are IP routable to each of mobile devices of fixed infrastructure elements; and providing an entertainment mobile application that communicates via the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; applying swarm intelligence to determine at least some parts of at least some routes through the mobile, broadband, routable internet; and providing an entertainment mobile application that communicates via the mobile ad hoc network.

In an aspect of the invention, methods and systems include providing a mobile, broadband, routable internet, in which a plurality of mobile devices interact as sending and receiving nodes in a mobile ad hoc network and in which packets are IP routable to the individual devices independent of fixed infrastructure elements; providing routing priority within the network, wherein the routing priority is provided by granting channel access to a node for which prioritized routing is identified and sending delay-sensitive data from the node before sending delay-tolerant data from the node; and providing a television mobile application that uses the routing priority to manage routing of data within the mobile, broadband, routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing support for peer-to-peer traffic within the network; and providing a television mobile application that provides fixed-network-independent capacity and service delivery by utilizing the peer-to-peer traffic network support.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer to peer connectivity within the mobile broadband routable internet; and providing a television mobile application that uses the peer to peer connectivity to facilitate mobile, fixed-infrastructure-independent, peer-to-peer application connection among at least a subset of the plurality of mobile devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing file sharing over the mobile broadband routable internet; and providing a television mobile application that uses file sharing without degrading system performance.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing user-generated applications over the mobile broadband routable internet; and providing a television mobile application associated with the mobile broadband routable internet, wherein the yyyy mobile application includes a user-generated application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer-to-peer applications over the mobile broadband routable internet; and providing a television mobile application that uses peer-to-peer applications without degrading performance of the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing direct device-to-device peering with symmetrical throughput between at least two nodes of the mobile broadband routable internet; and providing a television mobile application co-operating on the at least two nodes, wherein the yyyy mobile application utilizes the symmetrical throughput between the at least two nodes.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; facilitating direct-to-device application deployment over the mobile broadband routable internet; and providing a television mobile application that is deployed directly to a device in the mobile broadband routable internet using direct-to-device application deployment.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing data among a plurality of mobile broadband routable internet devices; and providing a television mobile application, wherein the mobile application uses the facility to access distributed data that is associated with the yyyy mobile application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing application components among a plurality of mobile broadband routable internet devices; and providing a television mobile application, components of which are distributed by the facility.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multicast routing within the network by allowing a data object to be transmitted by a device to a plurality of destinations over a plurality of routes; and providing a television mobile application that uses the multicast routing to at least distribute application-related updates.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote monitoring through the network; and providing a television mobile application that facilitates remote monitoring over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote control over the network; and providing a television mobile application that facilitates remote control over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote upgrade of at least one of software and services associated with the network; and providing a television mobile application that uses the remote upgrade to maintain a portion of the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an adaptive transmit power control facility for a device within the network, the adaptive transmit power control facility adapted to adjust transmission power of the device based on at least one of the density of proximate devices in the network, the condition of a neighboring device on the network, a channel condition of the network, a service level condition, a network performance condition, an environmental condition of the device and an application requirement of the device; and providing a television mobile application that uses adaptive transmit power control to adapt the transmit power associated with the application based on at least a density of devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing forwarding error correction on at least long IP packets; and providing a television mobile application that is enabled at least in part by utilizing forwarding error correction on the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for enabling adaptation of the data rate provided for links among devices within the network, the adaptation based on at least one of the density of devices in the network, the condition neighboring devices in the network, a channel condition of the network, a service level condition, a network performance condition, an environmental condition and an application requirement; and providing a television mobile application that adapts application related data transmission and receiving parameters based on the adaptive link data rates within the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing dynamic spectrum access capabilities within the network by determining communication spectrum quality and adjusting use of time frequency rectangles within the communication spectrum based on the determination; and providing a television mobile application that uses the dynamic spectrum access capabilities to provide enhanced use of spectral bandwidth.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; communicating among the plurality of devices over a radio communication spectrum and reusing portions of the spectrum for communication based on availability of time frequency rectangles within portions of the spectrum; and providing a television mobile application that reuses spectrum allocated for at least one other application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; and communicating wirelessly among at least a portion of the plurality of mobile devices, wherein the at least a portion of the plurality of mobile devices communicate independent of which radio frequency is used for the wireless communication; and wherein a television mobile application operating on at least two of the mobile devices exchanges information over the mobile broadband routable internet independent of the radio frequency.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing geo-location coding of device nodes in the network, wherein geo-location is based at least in part on a network location of a device node relative to other devices in the network; and providing a television mobile application that uses geo-location of device nodes in the network to facilitate at least one location-based service.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multimedia support within the network through a hybrid frame structure that includes variable slot duration and sub-channelization of bandwidth; and providing a television mobile application that uses multimedia support to provide yyyy related multimedia services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing time synchronization among nodes of the network, wherein the time synchronization is provided by communicating a representation of network timing at all the nodes with sufficient accuracy to enable reliable communications; and providing a television mobile application that uses network node time synchronization in delivery of the application services to device nodes in the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing seamless outdoor and indoor operation over the network; and providing a television mobile application takes advantage of the seamless outdoor and indoor operation to deliver services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing fixed radio installations that facilitate connection of the plurality of mobile devices, wherein the fixed radio installations are based at least in part on meeting a criteria associated with network radio propagation and performance; and providing a television mobile application that uses the fixed radio installation for backhaul communication associated with the application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an IP-compatible plug connection to at least one wired infrastructure type; and providing a television mobile application that uses the connection.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multiple fixed-network gateway interfaces connecting the mobile ad hoc network to a fixed network; and providing a television mobile application that communicates between a mobile device and a device on the fixed network.

In an aspect of the invention, methods and systems may include providing a mobile, broadband, routable internet, in which a plurality of mobile devices interact as nodes in a mobile ad hoc network and in which packets are IP routable to each of the devices independent of fixed infrastructure elements; providing an automated network design tool to facilitate low cost and fast network design engineering and deployment planning of the fixed infrastructure elements of the network; and deploying a television mobile application configured to use the networked designed by the design tool.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; deploying a plurality of low cost mesh access points to provide network coverage in a geography; and providing a television mobile application that communicates at least in part via the mesh access points.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing small form factor nodes that allow for low cost and fast capacity expansion and network upgrade; and providing a television mobile application that communicates at least in part via the small form factor nodes.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing communications between a mobile device and a device on a remote network so as to substantially favor routes through the mobile, broadband, routable Internet that have fewer hops between the mobile device and a backhaul access point; and providing a television mobile application that uses said communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing a user deployable access point that connects to the network; and providing a television mobile application that uses said access point.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing at least one base station controller function in at least one subscriber device, the base station controller function including at least one of an air interface management function, a signaling function, a concentration logic function, and a signal propagation function; and providing a television mobile application employing the at least one base state controller functions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing service provider tools to manage resource consumption of at least one device on the ad hoc network, wherein the tools are deployed on at least one of the plurality of mobile devices and use at least one management path for reporting usage of the at least one device; and providing a television mobile application for which the management path is used to report usage of the application.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing full radio resource management functions in at least one device, the radio resource management functions including at least one of radio management, handover, handoff, and foreign device cooperation functions, wherein the at least one device is a subscriber device; and providing a television mobile application operating responsively to a state of a managed radio resource.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multi-session functions in at least one of the plurality of devices, wherein the at least one device is a subscriber device; and providing a television mobile application communicating via multiple sessions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing cost-based routing functions in the network through dynamic forming and reforming of links and routes, wherein the cost-based routing functions are provided in a plurality of subscriber devices; and providing a television mobile application that uses the cost-based routing functions to deliver a desired balance of cost and quality of service.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP router functions at individual mobile devices of the network, wherein the individual mobile devices are subscriber devices; and providing a television mobile application that uses the IP router functions to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing, in at least one of the plurality of mobile devices, media access control layer capabilities including sub-network layer convergence functions selected from a list consisting of segmentation and reassembly, quality of service, throughput fairness, adaptive data rate control, and transmit power control, wherein the at least one mobile device is a subscriber device; and providing a television mobile application that uses the MAC layer to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing route diversity within the network to facilitate assurance of packet communication, wherein route diversity is based at least on a number of network devices in a geographic area; and providing a television mobile application that uses the route diversity to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; allowing layer 2 forwarding among at least some of the plurality of mobile devices; and providing a television mobile application that communicates via the layer 2 forwarding.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing the routable internet to a node in the network, wherein the node also communicates with a cellular network through at least one of the fixed infrastructure elements and the routable internet is provided outside the cellular network; and providing a television mobile application that communicates both through the cellular network and the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP application deployment to a device in the network, wherein the device also communicates with a cellular network through at least one of the fixed infrastructure elements and the IP application is deployed outside the cellular network; and providing a television mobile application that is deployed over IP and that communicates via the cellular network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network; and providing a television mobile application that communicates via the data packets.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network absent communications with the fixed infrastructure elements; and providing a television mobile application that communicates solely within the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/sec during normal operation; and providing a television mobile application that uses the communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/set when the nodes are in motion at vehicular speeds; and providing a television mobile application that uses the communications.

In an aspect of the invention, methods and systems include providing a mobile, broadband, routable internet, in which a plurality of mobile devices interact as nodes in a mobile ad hoc network and in which packets are IP routable to each of mobile devices of fixed infrastructure elements; and providing a television mobile application that communicates via the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; applying swarm intelligence to determine at least some parts of at least some routes through the mobile, broadband, routable internet; and providing a television mobile application that communicates via the mobile ad hoc network.

In an aspect of the invention, methods and systems include providing a mobile, broadband, routable internet, in which a plurality of mobile devices interact as sending and receiving nodes in a mobile ad hoc network and in which packets are IP routable to the individual devices independent of fixed infrastructure elements; providing routing priority within the network, wherein the routing priority is provided by granting channel access to a node for which prioritized routing is identified and sending delay-sensitive data from the node before sending delay-tolerant data from the node; and providing a personal area network mobile application that uses the routing priority to manage routing of data within the mobile, broadband, routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing support for peer-to-peer traffic within the network; and providing a personal area network mobile application that provides fixed-network-independent capacity and service delivery by utilizing the peer-to-peer traffic network support.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer to peer connectivity within the mobile broadband routable internet; and providing a personal area network mobile application that uses the peer to peer connectivity to facilitate mobile, fixed-infrastructure-independent, peer-to-peer application connection among at least a subset of the plurality of mobile devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing file sharing over the mobile broadband routable internet; and providing a personal area network mobile application that uses file sharing without degrading system performance.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing user-generated applications over the mobile broadband routable internet; and providing a personal area network mobile application associated with the mobile broadband routable internet, wherein the yyyy mobile application includes a user-generated application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer-to-peer applications over the mobile broadband routable internet; and providing a personal area network mobile application that uses peer-to-peer applications without degrading performance of the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing direct device-to-device peering with symmetrical throughput between at least two nodes of the mobile broadband routable internet; and providing a personal area network mobile application co-operating on the at least two nodes, wherein the yyyy mobile application utilizes the symmetrical throughput between the at least two nodes.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; facilitating direct-to-device application deployment over the mobile broadband routable internet; and providing a personal area network mobile application that is deployed directly to a device in the mobile broadband routable internet using direct-to-device application deployment.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing data among a plurality of mobile broadband routable internet devices; and providing a personal area network mobile application, wherein the mobile application uses the facility to access distributed data that is associated with the yyyy mobile application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing application components among a plurality of mobile broadband routable internet devices; and providing a personal area network mobile application, components of which are distributed by the facility.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multicast routing within the network by allowing a data object to be transmitted by a device to a plurality of destinations over a plurality of routes; and providing a personal area network mobile application that uses the multicast routing to at least distribute application-related updates.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote monitoring through the network; and providing a personal area network mobile application that facilitates remote monitoring over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote control over the network; and providing a personal area network mobile application that facilitates remote control over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote upgrade of at least one of software and services associated with the network; and providing a personal area network mobile application that uses the remote upgrade to maintain a portion of the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an adaptive transmit power control facility for a device within the network, the adaptive transmit power control facility adapted to adjust transmission power of the device based on at least one of the density of proximate devices in the network, the condition of a neighboring device on the network, a channel condition of the network, a service level condition, a network performance condition, an environmental condition of the device and an application requirement of the device; and providing a personal area network mobile application that uses adaptive transmit power control to adapt the transmit power associated with the application based on at least a density of devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing forwarding error correction on at least long IP packets; and providing a personal area network mobile application that is enabled at least in part by utilizing forwarding error correction on the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for enabling adaptation of the data rate provided for links among devices within the network, the adaptation based on at least one of the density of devices in the network, the condition neighboring devices in the network, a channel condition of the network, a service level condition, a network performance condition, an environmental condition and an application requirement; and providing a personal area network mobile application that adapts application related data transmission and receiving parameters based on the adaptive link data rates within the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing dynamic spectrum access capabilities within the network by determining communication spectrum quality and adjusting use of time frequency rectangles within the communication spectrum based on the determination; and providing a personal area network mobile application that uses the dynamic spectrum access capabilities to provide enhanced use of spectral bandwidth.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; communicating among the plurality of devices over a radio communication spectrum and reusing portions of the spectrum for communication based on availability of time frequency rectangles within portions of the spectrum; and providing a personal area network mobile application that reuses spectrum allocated for at least one other application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; and communicating wirelessly among at least a portion of the plurality of mobile devices, wherein the at least a portion of the plurality of mobile devices communicate independent of which radio frequency is used for the wireless communication; and wherein a personal area network mobile application operating on at least two of the mobile devices exchanges information over the mobile broadband routable internet independent of the radio frequency.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing geo-location coding of device nodes in the network, wherein geo-location is based at least in part on a network location of a device node relative to other devices in the network; and providing a personal area network mobile application that uses geo-location of device nodes in the network to facilitate at least one location-based service.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multimedia support within the network through a hybrid frame structure that includes variable slot duration and sub-channelization of bandwidth; and providing a personal area network mobile application that uses multimedia support to provide yyyy related multimedia services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing time synchronization among nodes of the network, wherein the time synchronization is provided by communicating a representation of network timing at all the nodes with sufficient accuracy to enable reliable communications; and providing a personal area network mobile application that uses network node time synchronization in delivery of the application services to device nodes in the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing seamless outdoor and indoor operation over the network; and providing a personal area network mobile application takes advantage of the seamless outdoor and indoor operation to deliver services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing fixed radio installations that facilitate connection of the plurality of mobile devices, wherein the fixed radio installations are based at least in part on meeting a criteria associated with network radio propagation and performance; and providing a personal area network mobile application that uses the fixed radio installation for backhaul communication associated with the application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an IP-compatible plug connection to at least one wired infrastructure type; and providing a personal area network mobile application that uses the connection.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multiple fixed-network gateway interfaces connecting the mobile ad hoc network to a fixed network; and providing a personal area network mobile application that communicates between a mobile device and a device on the fixed network.

In an aspect of the invention, methods and systems may include providing a mobile, broadband, routable internet, in which a plurality of mobile devices interact as nodes in a mobile ad hoc network and in which packets are IP routable to each of the devices independent of fixed infrastructure elements; providing an automated network design tool to facilitate low cost and fast network design engineering and deployment planning of the fixed infrastructure elements of the network; and deploying a personal area network mobile application configured to use the networked designed by the design tool.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; deploying a plurality of low cost mesh access points to provide network coverage in a geography; and providing a personal area network mobile application that communicates at least in part via the mesh access points.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing small form factor nodes that allow for low cost and fast capacity expansion and network upgrade; and providing a personal area network mobile application that communicates at least in part via the small form factor nodes.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing communications between a mobile device and a device on a remote network so as to substantially favor routes through the mobile, broadband, routable Internet that have fewer hops between the mobile device and a backhaul access point; and providing a personal area network mobile application that uses said communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing a user deployable access point that connects to the network; and providing a personal area network mobile application that uses said access point.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing at least one base station controller function in at least one subscriber device, the base station controller function including at least one of an air interface management function, a signaling function, a concentration logic function, and a signal propagation function; and providing a personal area network mobile application employing the at least one base state controller functions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing service provider tools to manage resource consumption of at least one device on the ad hoc network, wherein the tools are deployed on at least one of the plurality of mobile devices and use at least one management path for reporting usage of the at least one device; and providing a personal area network mobile application for which the management path is used to report usage of the application.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing full radio resource management functions in at least one device, the radio resource management functions including at least one of radio management, handover, handoff, and foreign device cooperation functions, wherein the at least one device is a subscriber device; and providing a personal area network mobile application operating responsively to a state of a managed radio resource.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multi-session functions in at least one of the plurality of devices, wherein the at least one device is a subscriber device; and providing a personal area network mobile application communicating via multiple sessions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing cost-based routing functions in the network through dynamic forming and reforming of links and routes, wherein the cost-based routing functions are provided in a plurality of subscriber devices; and providing a personal area network mobile application that uses the cost-based routing functions to deliver a desired balance of cost and quality of service.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP router functions at individual mobile devices of the network, wherein the individual mobile devices are subscriber devices; and providing a personal area network mobile application that uses the IP router functions to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing, in at least one of the plurality of mobile devices, media access control layer capabilities including sub-network layer convergence functions selected from a list consisting of segmentation and reassembly, quality of service, throughput fairness, adaptive data rate control, and transmit power control, wherein the at least one mobile device is a subscriber device; and providing a personal area network mobile application that uses the MAC layer to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing route diversity within the network to facilitate assurance of packet communication, wherein route diversity is based at least on a number of network devices in a geographic area; and providing a personal area network mobile application that uses the route diversity to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; allowing layer 2 forwarding among at least some of the plurality of mobile devices; and providing a personal area network mobile application that communicates via the layer 2 forwarding.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing the routable internet to a node in the network, wherein the node also communicates with a cellular network through at least one of the fixed infrastructure elements and the routable internet is provided outside the cellular network; and providing a personal area network mobile application that communicates both through the cellular network and the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP application deployment to a device in the network, wherein the device also communicates with a cellular network through at least one of the fixed infrastructure elements and the IP application is deployed outside the cellular network; and providing a personal area network mobile application that is deployed over IP and that communicates via the cellular network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network; and providing a personal area network mobile application that communicates via the data packets.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network absent communications with the fixed infrastructure elements; and providing a personal area network mobile application that communicates solely within the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/sec during normal operation; and providing a personal area network mobile application that uses the communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/set when the nodes are in motion at vehicular speeds; and providing a personal area network mobile application that uses the communications.

In an aspect of the invention, methods and systems include providing a mobile, broadband, routable internet, in which a plurality of mobile devices interact as nodes in a mobile ad hoc network and in which packets are IP routable to each of mobile devices of fixed infrastructure elements; and providing a personal area network mobile application that communicates via the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; applying swarm intelligence to determine at least some parts of at least some routes through the mobile, broadband, routable internet; and providing a personal area network mobile application that communicates via the mobile ad hoc network.

In an aspect of the invention, methods and systems include providing a mobile, broadband, routable internet, in which a plurality of mobile devices interact as sending and receiving nodes in a mobile ad hoc network and in which packets are IP routable to the individual devices independent of fixed infrastructure elements; providing routing priority within the network, wherein the routing priority is provided by granting channel access to a node for which prioritized routing is identified and sending delay-sensitive data from the node before sending delay-tolerant data from the node; and providing a desktop collaboration mobile application that uses the routing priority to manage routing of data within the mobile, broadband, routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing support for peer-to-peer traffic within the network; and providing a desktop collaboration mobile application that provides fixed-network-independent capacity and service delivery by utilizing the peer-to-peer traffic network support.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer to peer connectivity within the mobile broadband routable internet; and providing a desktop collaboration mobile application that uses the peer to peer connectivity to facilitate mobile, fixed-infrastructure-independent, peer-to-peer application connection among at least a subset of the plurality of mobile devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing file sharing over the mobile broadband routable internet; and providing a desktop collaboration mobile application that uses file sharing without degrading system performance.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing user-generated applications over the mobile broadband routable internet; and providing a desktop collaboration mobile application associated with the mobile broadband routable internet, wherein the yyyy mobile application includes a user-generated application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer-to-peer applications over the mobile broadband routable internet; and providing a desktop collaboration mobile application that uses peer-to-peer applications without degrading performance of the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing direct device-to-device peering with symmetrical throughput between at least two nodes of the mobile broadband routable internet; and providing a desktop collaboration mobile application co-operating on the at least two nodes, wherein the yyyy mobile application utilizes the symmetrical throughput between the at least two nodes.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; facilitating direct-to-device application deployment over the mobile broadband routable internet; and providing a desktop collaboration mobile application that is deployed directly to a device in the mobile broadband routable internet using direct-to-device application deployment.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing data among a plurality of mobile broadband routable internet devices; and providing a desktop collaboration mobile application, wherein the mobile application uses the facility to access distributed data that is associated with the yyyy mobile application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing application components among a plurality of mobile broadband routable internet devices; and providing a desktop collaboration mobile application, components of which are distributed by the facility.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multicast routing within the network by allowing a data object to be transmitted by a device to a plurality of destinations over a plurality of routes; and providing a desktop collaboration mobile application that uses the multicast routing to at least distribute application-related updates.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote monitoring through the network; and providing a desktop collaboration mobile application that facilitates remote monitoring over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote control over the network; and providing a desktop collaboration mobile application that facilitates remote control over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote upgrade of at least one of software and services associated with the network; and providing a desktop collaboration mobile application that uses the remote upgrade to maintain a portion of the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an adaptive transmit power control facility for a device within the network, the adaptive transmit power control facility adapted to adjust transmission power of the device based on at least one of the density of proximate devices in the network, the condition of a neighboring device on the network, a channel condition of the network, a service level condition, a network performance condition, an environmental condition of the device and an application requirement of the device; and providing a desktop collaboration mobile application that uses adaptive transmit power control to adapt the transmit power associated with the application based on at least a density of devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing forwarding error correction on at least long IP packets; and providing a desktop collaboration mobile application that is enabled at least in part by utilizing forwarding error correction on the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for enabling adaptation of the data rate provided for links among devices within the network, the adaptation based on at least one of the density of devices in the network, the condition neighboring devices in the network, a channel condition of the network, a service level condition, a network performance condition, an environmental condition and an application requirement; and providing a desktop collaboration mobile application that adapts application related data transmission and receiving parameters based on the adaptive link data rates within the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing dynamic spectrum access capabilities within the network by determining communication spectrum quality and adjusting use of time frequency rectangles within the communication spectrum based on the determination; and providing a desktop collaboration mobile application that uses the dynamic spectrum access capabilities to provide enhanced use of spectral bandwidth.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; communicating among the plurality of devices over a radio communication spectrum and reusing portions of the spectrum for communication based on availability of time frequency rectangles within portions of the spectrum; and providing a desktop collaboration mobile application that reuses spectrum allocated for at least one other application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; and communicating wirelessly among at least a portion of the plurality of mobile devices, wherein the at least a portion of the plurality of mobile devices communicate independent of which radio frequency is used for the wireless communication; and wherein a desktop collaboration mobile application operating on at least two of the mobile devices exchanges information over the mobile broadband routable internet independent of the radio frequency.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing geo-location coding of device nodes in the network, wherein geo-location is based at least in part on a network location of a device node relative to other devices in the network; and providing a desktop collaboration mobile application that uses geo-location of device nodes in the network to facilitate at least one location-based service.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multimedia support within the network through a hybrid frame structure that includes variable slot duration and sub-channelization of bandwidth; and providing a desktop collaboration mobile application that uses multimedia support to provide yyyy related multimedia services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing time synchronization among nodes of the network, wherein the time synchronization is provided by communicating a representation of network timing at all the nodes with sufficient accuracy to enable reliable communications; and providing a desktop collaboration mobile application that uses network node time synchronization in delivery of the application services to device nodes in the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing seamless outdoor and indoor operation over the network; and providing a desktop collaboration mobile application takes advantage of the seamless outdoor and indoor operation to deliver services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing fixed radio installations that facilitate connection of the plurality of mobile devices, wherein the fixed radio installations are based at least in part on meeting a criteria associated with network radio propagation and performance; and providing a desktop collaboration mobile application that uses the fixed radio installation for backhaul communication associated with the application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an IP-compatible plug connection to at least one wired infrastructure type; and providing a desktop collaboration mobile application that uses the connection.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multiple fixed-network gateway interfaces connecting the mobile ad hoc network to a fixed network; and providing a desktop collaboration mobile application that communicates between a mobile device and a device on the fixed network.

In an aspect of the invention, methods and systems may include providing a mobile, broadband, routable internet, in which a plurality of mobile devices interact as nodes in a mobile ad hoc network and in which packets are IP routable to each of the devices independent of fixed infrastructure elements; providing an automated network design tool to facilitate low cost and fast network design engineering and deployment planning of the fixed infrastructure elements of the network; and deploying a desktop collaboration mobile application configured to use the networked designed by the design tool.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; deploying a plurality of low cost mesh access points to provide network coverage in a geography; and providing a desktop collaboration mobile application that communicates at least in part via the mesh access points.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing small form factor nodes that allow for low cost and fast capacity expansion and network upgrade; and providing a desktop collaboration mobile application that communicates at least in part via the small form factor nodes.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing communications between a mobile device and a device on a remote network so as to substantially favor routes through the mobile, broadband, routable Internet that have fewer hops between the mobile device and a backhaul access point; and providing a desktop collaboration mobile application that uses said communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing a user deployable access point that connects to the network; and providing a desktop collaboration mobile application that uses said access point.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing at least one base station controller function in at least one subscriber device, the base station controller function including at least one of an air interface management function, a signaling function, a concentration logic function, and a signal propagation function; and providing a desktop collaboration mobile application employing the at least one base state controller functions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing service provider tools to manage resource consumption of at least one device on the ad hoc network, wherein the tools are deployed on at least one of the plurality of mobile devices and use at least one management path for reporting usage of the at least one device; and providing a desktop collaboration mobile application for which the management path is used to report usage of the application.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing full radio resource management functions in at least one device, the radio resource management functions including at least one of radio management, handover, handoff, and foreign device cooperation functions, wherein the at least one device is a subscriber device; and providing a desktop collaboration mobile application operating responsively to a state of a managed radio resource.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multi-session functions in at least one of the plurality of devices, wherein the at least one device is a subscriber device; and providing a desktop collaboration mobile application communicating via multiple sessions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing cost-based routing functions in the network through dynamic forming and reforming of links and routes, wherein the cost-based routing functions are provided in a plurality of subscriber devices; and providing a desktop collaboration mobile application that uses the cost-based routing functions to deliver a desired balance of cost and quality of service.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP router functions at individual mobile devices of the network, wherein the individual mobile devices are subscriber devices; and providing a desktop collaboration mobile application that uses the IP router functions to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing, in at least one of the plurality of mobile devices, media access control layer capabilities including sub-network layer convergence functions selected from a list consisting of segmentation and reassembly, quality of service, throughput fairness, adaptive data rate control, and transmit power control, wherein the at least one mobile device is a subscriber device; and providing a desktop collaboration mobile application that uses the MAC layer to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing route diversity within the network to facilitate assurance of packet communication, wherein route diversity is based at least on a number of network devices in a geographic area; and providing a desktop collaboration mobile application that uses the route diversity to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; allowing layer 2 forwarding among at least some of the plurality of mobile devices; and providing a desktop collaboration mobile application that communicates via the layer 2 forwarding.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing the routable internet to a node in the network, wherein the node also communicates with a cellular network through at least one of the fixed infrastructure elements and the routable internet is provided outside the cellular network; and providing a desktop collaboration mobile application that communicates both through the cellular network and the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP application deployment to a device in the network, wherein the device also communicates with a cellular network through at least one of the fixed infrastructure elements and the IP application is deployed outside the cellular network; and providing a desktop collaboration mobile application that is deployed over IP and that communicates via the cellular network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network; and providing a desktop collaboration mobile application that communicates via the data packets.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network absent communications with the fixed infrastructure elements; and providing a desktop collaboration mobile application that communicates solely within the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/sec during normal operation; and providing a desktop collaboration mobile application that uses the communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/set when the nodes are in motion at vehicular speeds; and providing a desktop collaboration mobile application that uses the communications.

In an aspect of the invention, methods and systems include providing a mobile, broadband, routable internet, in which a plurality of mobile devices interact as nodes in a mobile ad hoc network and in which packets are IP routable to each of mobile devices of fixed infrastructure elements; and providing a desktop collaboration mobile application that communicates via the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; applying swarm intelligence to determine at least some parts of at least some routes through the mobile, broadband, routable internet; and providing a desktop collaboration mobile application that communicates via the mobile ad hoc network.

In an aspect of the invention, methods and systems include providing a mobile, broadband, routable internet, in which a plurality of mobile devices interact as sending and receiving nodes in a mobile ad hoc network and in which packets are IP routable to the individual devices independent of fixed infrastructure elements; providing routing priority within the network, wherein the routing priority is provided by granting channel access to a node for which prioritized routing is identified and sending delay-sensitive data from the node before sending delay-tolerant data from the node; and providing a video calling mobile application that uses the routing priority to manage routing of data within the mobile, broadband, routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing support for peer-to-peer traffic within the network; and providing a video calling mobile application that provides fixed-network-independent capacity and service delivery by utilizing the peer-to-peer traffic network support.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer to peer connectivity within the mobile broadband routable internet; and providing a video calling mobile application that uses the peer to peer connectivity to facilitate mobile, fixed-infrastructure-independent, peer-to-peer application connection among at least a subset of the plurality of mobile devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing file sharing over the mobile broadband routable internet; and providing a video calling mobile application that uses file sharing without degrading system performance.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing user-generated applications over the mobile broadband routable internet; and providing a video calling mobile application associated with the mobile broadband routable internet, wherein the yyyy mobile application includes a user-generated application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer-to-peer applications over the mobile broadband routable internet; and providing a video calling mobile application that uses peer-to-peer applications without degrading performance of the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing direct device-to-device peering with symmetrical throughput between at least two nodes of the mobile broadband routable internet; and providing a video calling mobile application co-operating on the at least two nodes, wherein the yyyy mobile application utilizes the symmetrical throughput between the at least two nodes.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; facilitating direct-to-device application deployment over the mobile broadband routable internet; and providing a video calling mobile application that is deployed directly to a device in the mobile broadband routable internet using direct-to-device application deployment.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing data among a plurality of mobile broadband routable internet devices; and providing a video calling mobile application, wherein the mobile application uses the facility to access distributed data that is associated with the yyyy mobile application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing application components among a plurality of mobile broadband routable internet devices; and providing a video calling mobile application, components of which are distributed by the facility.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multicast routing within the network by allowing a data object to be transmitted by a device to a plurality of destinations over a plurality of routes; and providing a video calling mobile application that uses the multicast routing to at least distribute application-related updates.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote monitoring through the network; and providing a video calling mobile application that facilitates remote monitoring over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote control over the network; and providing a video calling mobile application that facilitates remote control over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote upgrade of at least one of software and services associated with the network; and providing a video calling mobile application that uses the remote upgrade to maintain a portion of the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an adaptive transmit power control facility for a device within the network, the adaptive transmit power control facility adapted to adjust transmission power of the device based on at least one of the density of proximate devices in the network, the condition of a neighboring device on the network, a channel condition of the network, a service level condition, a network performance condition, an environmental condition of the device and an application requirement of the device; and providing a video calling mobile application that uses adaptive transmit power control to adapt the transmit power associated with the application based on at least a density of devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing forwarding error correction on at least long IP packets; and providing a video calling mobile application that is enabled at least in part by utilizing forwarding error correction on the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for enabling adaptation of the data rate provided for links among devices within the network, the adaptation based on at least one of the density of devices in the network, the condition neighboring devices in the network, a channel condition of the network, a service level condition, a network performance condition, an environmental condition and an application requirement; and providing a video calling mobile application that adapts application related data transmission and receiving parameters based on the adaptive link data rates within the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing dynamic spectrum access capabilities within the network by determining communication spectrum quality and adjusting use of time frequency rectangles within the communication spectrum based on the determination; and providing a video calling mobile application that uses the dynamic spectrum access capabilities to provide enhanced use of spectral bandwidth.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; communicating among the plurality of devices over a radio communication spectrum and reusing portions of the spectrum for communication based on availability of time frequency rectangles within portions of the spectrum; and providing a video calling mobile application that reuses spectrum allocated for at least one other application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; and communicating wirelessly among at least a portion of the plurality of mobile devices, wherein the at least a portion of the plurality of mobile devices communicate independent of which radio frequency is used for the wireless communication; and wherein a video calling mobile application operating on at least two of the mobile devices exchanges information over the mobile broadband routable internet independent of the radio frequency.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing geo-location coding of device nodes in the network, wherein geo-location is based at least in part on a network location of a device node relative to other devices in the network; and providing a video calling mobile application that uses geo-location of device nodes in the network to facilitate at least one location-based service.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multimedia support within the network through a hybrid frame structure that includes variable slot duration and sub-channelization of bandwidth; and providing a video calling mobile application that uses multimedia support to provide yyyy related multimedia services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing time synchronization among nodes of the network, wherein the time synchronization is provided by communicating a representation of network timing at all the nodes with sufficient accuracy to enable reliable communications; and providing a video calling mobile application that uses network node time synchronization in delivery of the application services to device nodes in the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing seamless outdoor and indoor operation over the network; and providing a video calling mobile application takes advantage of the seamless outdoor and indoor operation to deliver services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing fixed radio installations that facilitate connection of the plurality of mobile devices, wherein the fixed radio installations are based at least in part on meeting a criteria associated with network radio propagation and performance; and providing a video calling mobile application that uses the fixed radio installation for backhaul communication associated with the application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an IP-compatible plug connection to at least one wired infrastructure type; and providing a video calling mobile application that uses the connection.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multiple fixed-network gateway interfaces connecting the mobile ad hoc network to a fixed network; and providing a video calling mobile application that communicates between a mobile device and a device on the fixed network.

In an aspect of the invention, methods and systems may include providing a mobile, broadband, routable internet, in which a plurality of mobile devices interact as nodes in a mobile ad hoc network and in which packets are IP routable to each of the devices independent of fixed infrastructure elements; providing an automated network design tool to facilitate low cost and fast network design engineering and deployment planning of the fixed infrastructure elements of the network; and deploying a video calling mobile application configured to use the networked designed by the design tool.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; deploying a plurality of low cost mesh access points to provide network coverage in a geography; and providing a video calling mobile application that communicates at least in part via the mesh access points.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing small form factor nodes that allow for low cost and fast capacity expansion and network upgrade; and providing a video calling mobile application that communicates at least in part via the small form factor nodes.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing communications between a mobile device and a device on a remote network so as to substantially favor routes through the mobile, broadband, routable Internet that have fewer hops between the mobile device and a backhaul access point; and providing a video calling mobile application that uses said communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing a user deployable access point that connects to the network; and providing a video calling mobile application that uses said access point.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing at least one base station controller function in at least one subscriber device, the base station controller function including at least one of an air interface management function, a signaling function, a concentration logic function, and a signal propagation function; and providing a video calling mobile application employing the at least one base state controller functions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing service provider tools to manage resource consumption of at least one device on the ad hoc network, wherein the tools are deployed on at least one of the plurality of mobile devices and use at least one management path for reporting usage of the at least one device; and providing a video calling mobile application for which the management path is used to report usage of the application.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing full radio resource management functions in at least one device, the radio resource management functions including at least one of radio management, handover, handoff, and foreign device cooperation functions, wherein the at least one device is a subscriber device; and providing a video calling mobile application operating responsively to a state of a managed radio resource.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multi-session functions in at least one of the plurality of devices, wherein the at least one device is a subscriber device; and providing a video calling mobile application communicating via multiple sessions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing cost-based routing functions in the network through dynamic forming and reforming of links and routes, wherein the cost-based routing functions are provided in a plurality of subscriber devices; and providing a video calling mobile application that uses the cost-based routing functions to deliver a desired balance of cost and quality of service.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP router functions at individual mobile devices of the network, wherein the individual mobile devices are subscriber devices; and providing a video calling mobile application that uses the IP router functions to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing, in at least one of the plurality of mobile devices, media access control layer capabilities including sub-network layer convergence functions selected from a list consisting of segmentation and reassembly, quality of service, throughput fairness, adaptive data rate control, and transmit power control, wherein the at least one mobile device is a subscriber device; and providing a video calling mobile application that uses the MAC layer to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing route diversity within the network to facilitate assurance of packet communication, wherein route diversity is based at least on a number of network devices in a geographic area; and providing a video calling mobile application that uses the route diversity to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; allowing layer 2 forwarding among at least some of the plurality of mobile devices; and providing a video calling mobile application that communicates via the layer 2 forwarding.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing the routable internet to a node in the network, wherein the node also communicates with a cellular network through at least one of the fixed infrastructure elements and the routable internet is provided outside the cellular network; and providing a video calling mobile application that communicates both through the cellular network and the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP application deployment to a device in the network, wherein the device also communicates with a cellular network through at least one of the fixed infrastructure elements and the IP application is deployed outside the cellular network; and providing a video calling mobile application that is deployed over IP and that communicates via the cellular network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network; and providing a video calling mobile application that communicates via the data packets.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network absent communications with the fixed infrastructure elements; and providing a video calling mobile application that communicates solely within the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/sec during normal operation; and providing a video calling mobile application that uses the communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/set when the nodes are in motion at vehicular speeds; and providing a video calling mobile application that uses the communications.

In an aspect of the invention, methods and systems include providing a mobile, broadband, routable internet, in which a plurality of mobile devices interact as nodes in a mobile ad hoc network and in which packets are IP routable to each of mobile devices of fixed infrastructure elements; and providing a video calling mobile application that communicates via the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; applying swarm intelligence to determine at least some parts of at least some routes through the mobile, broadband, routable internet; and providing a video calling mobile application that communicates via the mobile ad hoc network.

In an aspect of the invention, methods and systems include providing a mobile, broadband, routable internet, in which a plurality of mobile devices interact as sending and receiving nodes in a mobile ad hoc network and in which packets are IP routable to the individual devices independent of fixed infrastructure elements; providing routing priority within the network, wherein the routing priority is provided by granting channel access to a node for which prioritized routing is identified and sending delay-sensitive data from the node before sending delay-tolerant data from the node; and providing a video conferencing mobile application that uses the routing priority to manage routing of data within the mobile, broadband, routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing support for peer-to-peer traffic within the network; and providing a video conferencing mobile application that provides fixed-network-independent capacity and service delivery by utilizing the peer-to-peer traffic network support.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer to peer connectivity within the mobile broadband routable internet; and providing a video conferencing mobile application that uses the peer to peer connectivity to facilitate mobile, fixed-infrastructure-independent, peer-to-peer application connection among at least a subset of the plurality of mobile devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing file sharing over the mobile broadband routable internet; and providing a video conferencing mobile application that uses file sharing without degrading system performance.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing user-generated applications over the mobile broadband routable internet; and providing a video conferencing mobile application associated with the mobile broadband routable internet, wherein the yyyy mobile application includes a user-generated application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer-to-peer applications over the mobile broadband routable internet; and providing a video conferencing mobile application that uses peer-to-peer applications without degrading performance of the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing direct device-to-device peering with symmetrical throughput between at least two nodes of the mobile broadband routable internet; and providing a video conferencing mobile application co-operating on the at least two nodes, wherein the yyyy mobile application utilizes the symmetrical throughput between the at least two nodes.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; facilitating direct-to-device application deployment over the mobile broadband routable internet; and providing a video conferencing mobile application that is deployed directly to a device in the mobile broadband routable internet using direct-to-device application deployment.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing data among a plurality of mobile broadband routable internet devices; and providing a video conferencing mobile application, wherein the mobile application uses the facility to access distributed data that is associated with the yyyy mobile application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing application components among a plurality of mobile broadband routable internet devices; and providing a video conferencing mobile application, components of which are distributed by the facility.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multicast routing within the network by allowing a data object to be transmitted by a device to a plurality of destinations over a plurality of routes; and providing a video conferencing mobile application that uses the multicast routing to at least distribute application-related updates.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote monitoring through the network; and providing a video conferencing mobile application that facilitates remote monitoring over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote control over the network; and providing a video conferencing mobile application that facilitates remote control over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote upgrade of at least one of software and services associated with the network; and providing a video conferencing mobile application that uses the remote upgrade to maintain a portion of the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an adaptive transmit power control facility for a device within the network, the adaptive transmit power control facility adapted to adjust transmission power of the device based on at least one of the density of proximate devices in the network, the condition of a neighboring device on the network, a channel condition of the network, a service level condition, a network performance condition, an environmental condition of the device and an application requirement of the device; and providing a video conferencing mobile application that uses adaptive transmit power control to adapt the transmit power associated with the application based on at least a density of devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing forwarding error correction on at least long IP packets; and providing a video conferencing mobile application that is enabled at least in part by utilizing forwarding error correction on the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for enabling adaptation of the data rate provided for links among devices within the network, the adaptation based on at least one of the density of devices in the network, the condition neighboring devices in the network, a channel condition of the network, a service level condition, a network performance condition, an environmental condition and an application requirement; and providing a video conferencing mobile application that adapts application related data transmission and receiving parameters based on the adaptive link data rates within the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing dynamic spectrum access capabilities within the network by determining communication spectrum quality and adjusting use of time frequency rectangles within the communication spectrum based on the determination; and providing a video conferencing mobile application that uses the dynamic spectrum access capabilities to provide enhanced use of spectral bandwidth.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; communicating among the plurality of devices over a radio communication spectrum and reusing portions of the spectrum for communication based on availability of time frequency rectangles within portions of the spectrum; and providing a video conferencing mobile application that reuses spectrum allocated for at least one other application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; and communicating wirelessly among at least a portion of the plurality of mobile devices, wherein the at least a portion of the plurality of mobile devices communicate independent of which radio frequency is used for the wireless communication; and wherein a video conferencing mobile application operating on at least two of the mobile devices exchanges information over the mobile broadband routable internet independent of the radio frequency.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing geo-location coding of device nodes in the network, wherein geo-location is based at least in part on a network location of a device node relative to other devices in the network; and providing a video conferencing mobile application that uses geo-location of device nodes in the network to facilitate at least one location-based service.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multimedia support within the network through a hybrid frame structure that includes variable slot duration and sub-channelization of bandwidth; and providing a video conferencing mobile application that uses multimedia support to provide yyyy related multimedia services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing time synchronization among nodes of the network, wherein the time synchronization is provided by communicating a representation of network timing at all the nodes with sufficient accuracy to enable reliable communications; and providing a video conferencing mobile application that uses network node time synchronization in delivery of the application services to device nodes in the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing seamless outdoor and indoor operation over the network; and providing a video conferencing mobile application takes advantage of the seamless outdoor and indoor operation to deliver services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing fixed radio installations that facilitate connection of the plurality of mobile devices, wherein the fixed radio installations are based at least in part on meeting a criteria associated with network radio propagation and performance; and providing a video conferencing mobile application that uses the fixed radio installation for backhaul communication associated with the application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an IP-compatible plug connection to at least one wired infrastructure type; and providing a video conferencing mobile application that uses the connection.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multiple fixed-network gateway interfaces connecting the mobile ad hoc network to a fixed network; and providing a video conferencing mobile application that communicates between a mobile device and a device on the fixed network.

In an aspect of the invention, methods and systems may include providing a mobile, broadband, routable internet, in which a plurality of mobile devices interact as nodes in a mobile ad hoc network and in which packets are IP routable to each of the devices independent of fixed infrastructure elements; providing an automated network design tool to facilitate low cost and fast network design engineering and deployment planning of the fixed infrastructure elements of the network; and deploying a video conferencing mobile application configured to use the networked designed by the design tool.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; deploying a plurality of low cost mesh access points to provide network coverage in a geography; and providing a video conferencing mobile application that communicates at least in part via the mesh access points.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing small form factor nodes that allow for low cost and fast capacity expansion and network upgrade; and providing a video conferencing mobile application that communicates at least in part via the small form factor nodes.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing communications between a mobile device and a device on a remote network so as to substantially favor routes through the mobile, broadband, routable Internet that have fewer hops between the mobile device and a backhaul access point; and providing a video conferencing mobile application that uses said communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing a user deployable access point that connects to the network; and providing a video conferencing mobile application that uses said access point.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing at least one base station controller function in at least one subscriber device, the base station controller function including at least one of an air interface management function, a signaling function, a concentration logic function, and a signal propagation function; and providing a video conferencing mobile application employing the at least one base state controller functions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing service provider tools to manage resource consumption of at least one device on the ad hoc network, wherein the tools are deployed on at least one of the plurality of mobile devices and use at least one management path for reporting usage of the at least one device; and providing a video conferencing mobile application for which the management path is used to report usage of the application.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing full radio resource management functions in at least one device, the radio resource management functions including at least one of radio management, handover, handoff, and foreign device cooperation functions, wherein the at least one device is a subscriber device; and providing a video conferencing mobile application operating responsively to a state of a managed radio resource.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multi-session functions in at least one of the plurality of devices, wherein the at least one device is a subscriber device; and providing a video conferencing mobile application communicating via multiple sessions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing cost-based routing functions in the network through dynamic forming and reforming of links and routes, wherein the cost-based routing functions are provided in a plurality of subscriber devices; and providing a video conferencing mobile application that uses the cost-based routing functions to deliver a desired balance of cost and quality of service.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP router functions at individual mobile devices of the network, wherein the individual mobile devices are subscriber devices; and providing a video conferencing mobile application that uses the IP router functions to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing, in at least one of the plurality of mobile devices, media access control layer capabilities including sub-network layer convergence functions selected from a list consisting of segmentation and reassembly, quality of service, throughput fairness, adaptive data rate control, and transmit power control, wherein the at least one mobile device is a subscriber device; and providing a video conferencing mobile application that uses the MAC layer to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing route diversity within the network to facilitate assurance of packet communication, wherein route diversity is based at least on a number of network devices in a geographic area; and providing a video conferencing mobile application that uses the route diversity to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; allowing layer 2 forwarding among at least some of the plurality of mobile devices; and providing a video conferencing mobile application that communicates via the layer 2 forwarding.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing the routable internet to a node in the network, wherein the node also communicates with a cellular network through at least one of the fixed infrastructure elements and the routable internet is provided outside the cellular network; and providing a video conferencing mobile application that communicates both through the cellular network and the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP application deployment to a device in the network, wherein the device also communicates with a cellular network through at least one of the fixed infrastructure elements and the IP application is deployed outside the cellular network; and providing a video conferencing mobile application that is deployed over IP and that communicates via the cellular network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network; and providing a video conferencing mobile application that communicates via the data packets.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network absent communications with the fixed infrastructure elements; and providing a video conferencing mobile application that communicates solely within the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/sec during normal operation; and providing a video conferencing mobile application that uses the communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/set when the nodes are in motion at vehicular speeds; and providing a video conferencing mobile application that uses the communications.

In an aspect of the invention, methods and systems include providing a mobile, broadband, routable internet, in which a plurality of mobile devices interact as nodes in a mobile ad hoc network and in which packets are IP routable to each of mobile devices of fixed infrastructure elements; and providing a video conferencing mobile application that communicates via the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; applying swarm intelligence to determine at least some parts of at least some routes through the mobile, broadband, routable internet; and providing a video conferencing mobile application that communicates via the mobile ad hoc network.

In an aspect of the invention, methods and systems include providing a mobile, broadband, routable internet, in which a plurality of mobile devices interact as sending and receiving nodes in a mobile ad hoc network and in which packets are IP routable to the individual devices independent of fixed infrastructure elements; providing routing priority within the network, wherein the routing priority is provided by granting channel access to a node for which prioritized routing is identified and sending delay-sensitive data from the node before sending delay-tolerant data from the node; and providing an enterprise mobile application that uses the routing priority to manage routing of data within the mobile, broadband, routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing support for peer-to-peer traffic within the network; and providing an enterprise mobile application that provides fixed-network-independent capacity and service delivery by utilizing the peer-to-peer traffic network support.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer to peer connectivity within the mobile broadband routable internet; and providing an enterprise mobile application that uses the peer to peer connectivity to facilitate mobile, fixed-infrastructure-independent, peer-to-peer application connection among at least a subset of the plurality of mobile devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing file sharing over the mobile broadband routable internet; and providing an enterprise mobile application that uses file sharing without degrading system performance.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing user-generated applications over the mobile broadband routable internet; and providing an enterprise mobile application associated with the mobile broadband routable internet, wherein the yyyy mobile application includes a user-generated application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer-to-peer applications over the mobile broadband routable internet; and providing an enterprise mobile application that uses peer-to-peer applications without degrading performance of the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing direct device-to-device peering with symmetrical throughput between at least two nodes of the mobile broadband routable internet; and providing an enterprise mobile application co-operating on the at least two nodes, wherein the yyyy mobile application utilizes the symmetrical throughput between the at least two nodes.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; facilitating direct-to-device application deployment over the mobile broadband routable internet; and providing an enterprise mobile application that is deployed directly to a device in the mobile broadband routable internet using direct-to-device application deployment.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing data among a plurality of mobile broadband routable internet devices; and providing an enterprise mobile application, wherein the mobile application uses the facility to access distributed data that is associated with the yyyy mobile application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing application components among a plurality of mobile broadband routable internet devices; and providing an enterprise mobile application, components of which are distributed by the facility.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multicast routing within the network by allowing a data object to be transmitted by a device to a plurality of destinations over a plurality of routes; and providing an enterprise mobile application that uses the multicast routing to at least distribute application-related updates.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote monitoring through the network; and providing an enterprise mobile application that facilitates remote monitoring over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote control over the network; and providing an enterprise mobile application that facilitates remote control over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote upgrade of at least one of software and services associated with the network; and providing an enterprise mobile application that uses the remote upgrade to maintain a portion of the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an adaptive transmit power control facility for a device within the network, the adaptive transmit power control facility adapted to adjust transmission power of the device based on at least one of the density of proximate devices in the network, the condition of a neighboring device on the network, a channel condition of the network, a service level condition, a network performance condition, an environmental condition of the device and an application requirement of the device; and providing an enterprise mobile application that uses adaptive transmit power control to adapt the transmit power associated with the application based on at least a density of devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing forwarding error correction on at least long IP packets; and providing an enterprise mobile application that is enabled at least in part by utilizing forwarding error correction on the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for enabling adaptation of the data rate provided for links among devices within the network, the adaptation based on at least one of the density of devices in the network, the condition neighboring devices in the network, a channel condition of the network, a service level condition, a network performance condition, an environmental condition and an application requirement; and providing an enterprise mobile application that adapts application related data transmission and receiving parameters based on the adaptive link data rates within the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing dynamic spectrum access capabilities within the network by determining communication spectrum quality and adjusting use of time frequency rectangles within the communication spectrum based on the determination; and providing an enterprise mobile application that uses the dynamic spectrum access capabilities to provide enhanced use of spectral bandwidth.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; communicating among the plurality of devices over a radio communication spectrum and reusing portions of the spectrum for communication based on availability of time frequency rectangles within portions of the spectrum; and providing an enterprise mobile application that reuses spectrum allocated for at least one other application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; and communicating wirelessly among at least a portion of the plurality of mobile devices, wherein the at least a portion of the plurality of mobile devices communicate independent of which radio frequency is used for the wireless communication; and wherein an enterprise mobile application operating on at least two of the mobile devices exchanges information over the mobile broadband routable internet independent of the radio frequency.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing geo-location coding of device nodes in the network, wherein geo-location is based at least in part on a network location of a device node relative to other devices in the network; and providing an enterprise mobile application that uses geo-location of device nodes in the network to facilitate at least one location-based service.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multimedia support within the network through a hybrid frame structure that includes variable slot duration and sub-channelization of bandwidth; and providing an enterprise mobile application that uses multimedia support to provide yyyy related multimedia services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing time synchronization among nodes of the network, wherein the time synchronization is provided by communicating a representation of network timing at all the nodes with sufficient accuracy to enable reliable communications; and providing an enterprise mobile application that uses network node time synchronization in delivery of the application services to device nodes in the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing seamless outdoor and indoor operation over the network; and providing an enterprise mobile application takes advantage of the seamless outdoor and indoor operation to deliver services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing fixed radio installations that facilitate connection of the plurality of mobile devices, wherein the fixed radio installations are based at least in part on meeting a criteria associated with network radio propagation and performance; and providing an enterprise mobile application that uses the fixed radio installation for backhaul communication associated with the application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an IP-compatible plug connection to at least one wired infrastructure type; and providing an enterprise mobile application that uses the connection.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multiple fixed-network gateway interfaces connecting the mobile ad hoc network to a fixed network; and providing an enterprise mobile application that communicates between a mobile device and a device on the fixed network.

In an aspect of the invention, methods and systems may include providing a mobile, broadband, routable internet, in which a plurality of mobile devices interact as nodes in a mobile ad hoc network and in which packets are IP routable to each of the devices independent of fixed infrastructure elements; providing an automated network design tool to facilitate low cost and fast network design engineering and deployment planning of the fixed infrastructure elements of the network; and deploying an enterprise mobile application configured to use the networked designed by the design tool.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; deploying a plurality of low cost mesh access points to provide network coverage in a geography; and providing an enterprise mobile application that communicates at least in part via the mesh access points.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing small form factor nodes that allow for low cost and fast capacity expansion and network upgrade; and providing an enterprise mobile application that communicates at least in part via the small form factor nodes.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing communications between a mobile device and a device on a remote network so as to substantially favor routes through the mobile, broadband, routable Internet that have fewer hops between the mobile device and a backhaul access point; and providing an enterprise mobile application that uses said communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing a user deployable access point that connects to the network; and providing an enterprise mobile application that uses said access point.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing at least one base station controller function in at least one subscriber device, the base station controller function including at least one of an air interface management function, a signaling function, a concentration logic function, and a signal propagation function; and providing an enterprise mobile application employing the at least one base state controller functions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing service provider tools to manage resource consumption of at least one device on the ad hoc network, wherein the tools are deployed on at least one of the plurality of mobile devices and use at least one management path for reporting usage of the at least one device; and providing an enterprise mobile application for which the management path is used to report usage of the application.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing full radio resource management functions in at least one device, the radio resource management functions including at least one of radio management, handover, handoff, and foreign device cooperation functions, wherein the at least one device is a subscriber device; and providing an enterprise mobile application operating responsively to a state of a managed radio resource.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multi-session functions in at least one of the plurality of devices, wherein the at least one device is a subscriber device; and providing an enterprise mobile application communicating via multiple sessions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing cost-based routing functions in the network through dynamic forming and reforming of links and routes, wherein the cost-based routing functions are provided in a plurality of subscriber devices; and providing an enterprise mobile application that uses the cost-based routing functions to deliver a desired balance of cost and quality of service.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP router functions at individual mobile devices of the network, wherein the individual mobile devices are subscriber devices; and providing an enterprise mobile application that uses the IP router functions to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing, in at least one of the plurality of mobile devices, media access control layer capabilities including sub-network layer convergence functions selected from a list consisting of segmentation and reassembly, quality of service, throughput fairness, adaptive data rate control, and transmit power control, wherein the at least one mobile device is a subscriber device; and providing an enterprise mobile application that uses the MAC layer to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing route diversity within the network to facilitate assurance of packet communication, wherein route diversity is based at least on a number of network devices in a geographic area; and providing an enterprise mobile application that uses the route diversity to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; allowing layer 2 forwarding among at least some of the plurality of mobile devices; and providing an enterprise mobile application that communicates via the layer 2 forwarding.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing the routable internet to a node in the network, wherein the node also communicates with a cellular network through at least one of the fixed infrastructure elements and the routable internet is provided outside the cellular network; and providing an enterprise mobile application that communicates both through the cellular network and the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP application deployment to a device in the network, wherein the device also communicates with a cellular network through at least one of the fixed infrastructure elements and the IP application is deployed outside the cellular network; and providing an enterprise mobile application that is deployed over IP and that communicates via the cellular network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network; and providing an enterprise mobile application that communicates via the data packets.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network absent communications with the fixed infrastructure elements; and providing an enterprise mobile application that communicates solely within the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/sec during normal operation; and providing an enterprise mobile application that uses the communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/set when the nodes are in motion at vehicular speeds; and providing an enterprise mobile application that uses the communications.

In an aspect of the invention, methods and systems include providing a mobile, broadband, routable internet, in which a plurality of mobile devices interact as nodes in a mobile ad hoc network and in which packets are IP routable to each of mobile devices of fixed infrastructure elements; and providing an enterprise mobile application that communicates via the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; applying swarm intelligence to determine at least some parts of at least some routes through the mobile, broadband, routable internet; and providing an enterprise mobile application that communicates via the mobile ad hoc network.

In an aspect of the invention, methods and systems include providing a mobile, broadband, routable internet, in which a plurality of mobile devices interact as sending and receiving nodes in a mobile ad hoc network and in which packets are IP routable to the individual devices independent of fixed infrastructure elements; providing routing priority within the network, wherein the routing priority is provided by granting channel access to a node for which prioritized routing is identified and sending delay-sensitive data from the node before sending delay-tolerant data from the node; and providing a privacy/security mobile application that uses the routing priority to manage routing of data within the mobile, broadband, routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing support for peer-to-peer traffic within the network; and providing a privacy/security mobile application that provides fixed-network-independent capacity and service delivery by utilizing the peer-to-peer traffic network support.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer to peer connectivity within the mobile broadband routable internet; and providing a privacy/security mobile application that uses the peer to peer connectivity to facilitate mobile, fixed-infrastructure-independent, peer-to-peer application connection among at least a subset of the plurality of mobile devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing file sharing over the mobile broadband routable internet; and providing a privacy/security mobile application that uses file sharing without degrading system performance.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing user-generated applications over the mobile broadband routable internet; and providing a privacy/security mobile application associated with the mobile broadband routable internet, wherein the yyyy mobile application includes a user-generated application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer-to-peer applications over the mobile broadband routable internet; and providing a privacy/security mobile application that uses peer-to-peer applications without degrading performance of the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing direct device-to-device peering with symmetrical throughput between at least two nodes of the mobile broadband routable internet; and providing a privacy/security mobile application co-operating on the at least two nodes, wherein the yyyy mobile application utilizes the symmetrical throughput between the at least two nodes.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; facilitating direct-to-device application deployment over the mobile broadband routable internet; and providing a privacy/security mobile application that is deployed directly to a device in the mobile broadband routable internet using direct-to-device application deployment.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing data among a plurality of mobile broadband routable internet devices; and providing a privacy/security mobile application, wherein the mobile application uses the facility to access distributed data that is associated with the yyyy mobile application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing application components among a plurality of mobile broadband routable internet devices; and providing a privacy/security mobile application, components of which are distributed by the facility.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multicast routing within the network by allowing a data object to be transmitted by a device to a plurality of destinations over a plurality of routes; and providing a privacy/security mobile application that uses the multicast routing to at least distribute application-related updates.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote monitoring through the network; and providing a privacy/security mobile application that facilitates remote monitoring over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote control over the network; and providing a privacy/security mobile application that facilitates remote control over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote upgrade of at least one of software and services associated with the network; and providing a privacy/security mobile application that uses the remote upgrade to maintain a portion of the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an adaptive transmit power control facility for a device within the network, the adaptive transmit power control facility adapted to adjust transmission power of the device based on at least one of the density of proximate devices in the network, the condition of a neighboring device on the network, a channel condition of the network, a service level condition, a network performance condition, an environmental condition of the device and an application requirement of the device; and providing a privacy/security mobile application that uses adaptive transmit power control to adapt the transmit power associated with the application based on at least a density of devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing forwarding error correction on at least long IP packets; and providing a privacy/security mobile application that is enabled at least in part by utilizing forwarding error correction on the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for enabling adaptation of the data rate provided for links among devices within the network, the adaptation based on at least one of the density of devices in the network, the condition neighboring devices in the network, a channel condition of the network, a service level condition, a network performance condition, an environmental condition and an application requirement; and providing a privacy/security mobile application that adapts application related data transmission and receiving parameters based on the adaptive link data rates within the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing dynamic spectrum access capabilities within the network by determining communication spectrum quality and adjusting use of time frequency rectangles within the communication spectrum based on the determination; and providing a privacy/security mobile application that uses the dynamic spectrum access capabilities to provide enhanced use of spectral bandwidth.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; communicating among the plurality of devices over a radio communication spectrum and reusing portions of the spectrum for communication based on availability of time frequency rectangles within portions of the spectrum; and providing a privacy/security mobile application that reuses spectrum allocated for at least one other application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; and communicating wirelessly among at least a portion of the plurality of mobile devices, wherein the at least a portion of the plurality of mobile devices communicate independent of which radio frequency is used for the wireless communication; and wherein a privacy/security mobile application operating on at least two of the mobile devices exchanges information over the mobile broadband routable internet independent of the radio frequency.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing geo-location coding of device nodes in the network, wherein geo-location is based at least in part on a network location of a device node relative to other devices in the network; and providing a privacy/security mobile application that uses geo-location of device nodes in the network to facilitate at least one location-based service.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multimedia support within the network through a hybrid frame structure that includes variable slot duration and sub-channelization of bandwidth; and providing a privacy/security mobile application that uses multimedia support to provide yyyy related multimedia services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing time synchronization among nodes of the network, wherein the time synchronization is provided by communicating a representation of network timing at all the nodes with sufficient accuracy to enable reliable communications; and providing a privacy/security mobile application that uses network node time synchronization in delivery of the application services to device nodes in the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing seamless outdoor and indoor operation over the network; and providing a privacy/security mobile application takes advantage of the seamless outdoor and indoor operation to deliver services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing fixed radio installations that facilitate connection of the plurality of mobile devices, wherein the fixed radio installations are based at least in part on meeting a criteria associated with network radio propagation and performance; and providing a privacy/security mobile application that uses the fixed radio installation for backhaul communication associated with the application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an IP-compatible plug connection to at least one wired infrastructure type; and providing a privacy/security mobile application that uses the connection.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multiple fixed-network gateway interfaces connecting the mobile ad hoc network to a fixed network; and providing a privacy/security mobile application that communicates between a mobile device and a device on the fixed network.

In an aspect of the invention, methods and systems may include providing a mobile, broadband, routable internet, in which a plurality of mobile devices interact as nodes in a mobile ad hoc network and in which packets are IP routable to each of the devices independent of fixed infrastructure elements; providing an automated network design tool to facilitate low cost and fast network design engineering and deployment planning of the fixed infrastructure elements of the network; and deploying a privacy/security mobile application configured to use the networked designed by the design tool.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; deploying a plurality of low cost mesh access points to provide network coverage in a geography; and providing a privacy/security mobile application that communicates at least in part via the mesh access points.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing small form factor nodes that allow for low cost and fast capacity expansion and network upgrade; and providing a privacy/security mobile application that communicates at least in part via the small form factor nodes.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing communications between a mobile device and a device on a remote network so as to substantially favor routes through the mobile, broadband, routable Internet that have fewer hops between the mobile device and a backhaul access point; and providing a privacy/security mobile application that uses said communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing a user deployable access point that connects to the network; and providing a privacy/security mobile application that uses said access point.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing at least one base station controller function in at least one subscriber device, the base station controller function including at least one of an air interface management function, a signaling function, a concentration logic function, and a signal propagation function; and providing a privacy/security mobile application employing the at least one base state controller functions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing service provider tools to manage resource consumption of at least one device on the ad hoc network, wherein the tools are deployed on at least one of the plurality of mobile devices and use at least one management path for reporting usage of the at least one device; and providing a privacy/security mobile application for which the management path is used to report usage of the application.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing full radio resource management functions in at least one device, the radio resource management functions including at least one of radio management, handover, handoff, and foreign device cooperation functions, wherein the at least one device is a subscriber device; and providing a privacy/security mobile application operating responsively to a state of a managed radio resource.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multi-session functions in at least one of the plurality of devices, wherein the at least one device is a subscriber device; and providing a privacy/security mobile application communicating via multiple sessions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing cost-based routing functions in the network through dynamic forming and reforming of links and routes, wherein the cost-based routing functions are provided in a plurality of subscriber devices; and providing a privacy/security mobile application that uses the cost-based routing functions to deliver a desired balance of cost and quality of service.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP router functions at individual mobile devices of the network, wherein the individual mobile devices are subscriber devices; and providing a privacy/security mobile application that uses the IP router functions to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing, in at least one of the plurality of mobile devices, media access control layer capabilities including sub-network layer convergence functions selected from a list consisting of segmentation and reassembly, quality of service, throughput fairness, adaptive data rate control, and transmit power control, wherein the at least one mobile device is a subscriber device; and providing a privacy/security mobile application that uses the MAC layer to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing route diversity within the network to facilitate assurance of packet communication, wherein route diversity is based at least on a number of network devices in a geographic area; and providing a privacy/security mobile application that uses the route diversity to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; allowing layer 2 forwarding among at least some of the plurality of mobile devices; and providing a privacy/security mobile application that communicates via the layer 2 forwarding.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing the routable internet to a node in the network, wherein the node also communicates with a cellular network through at least one of the fixed infrastructure elements and the routable internet is provided outside the cellular network; and providing a privacy/security mobile application that communicates both through the cellular network and the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP application deployment to a device in the network, wherein the device also communicates with a cellular network through at least one of the fixed infrastructure elements and the IP application is deployed outside the cellular network; and providing a privacy/security mobile application that is deployed over IP and that communicates via the cellular network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network; and providing a privacy/security mobile application that communicates via the data packets.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network absent communications with the fixed infrastructure elements; and providing a privacy/security mobile application that communicates solely within the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/sec during normal operation; and providing a privacy/security mobile application that uses the communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/set when the nodes are in motion at vehicular speeds; and providing a privacy/security mobile application that uses the communications.

In an aspect of the invention, methods and systems include providing a mobile, broadband, routable internet, in which a plurality of mobile devices interact as nodes in a mobile ad hoc network and in which packets are IP routable to each of mobile devices of fixed infrastructure elements; and providing a privacy/security mobile application that communicates via the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; applying swarm intelligence to determine at least some parts of at least some routes through the mobile, broadband, routable internet; and providing a privacy/security mobile application that communicates via the mobile ad hoc network.

In an aspect of the invention, methods and systems include providing a mobile, broadband, routable internet, in which a plurality of mobile devices interact as sending and receiving nodes in a mobile ad hoc network and in which packets are IP routable to the individual devices independent of fixed infrastructure elements; providing routing priority within the network, wherein the routing priority is provided by granting channel access to a node for which prioritized routing is identified and sending delay-sensitive data from the node before sending delay-tolerant data from the node; and providing a machine to machine mobile application that uses the routing priority to manage routing of data within the mobile, broadband, routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing support for peer-to-peer traffic within the network; and providing a machine to machine mobile application that provides fixed-network-independent capacity and service delivery by utilizing the peer-to-peer traffic network support.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer to peer connectivity within the mobile broadband routable internet; and providing a machine to machine mobile application that uses the peer to peer connectivity to facilitate mobile, fixed-infrastructure-independent, peer-to-peer application connection among at least a subset of the plurality of mobile devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing file sharing over the mobile broadband routable internet; and providing a machine to machine mobile application that uses file sharing without degrading system performance.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing user-generated applications over the mobile broadband routable internet; and providing a machine to machine mobile application associated with the mobile broadband routable internet, wherein the yyyy mobile application includes a user-generated application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer-to-peer applications over the mobile broadband routable internet; and providing a machine to machine mobile application that uses peer-to-peer applications without degrading performance of the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing direct device-to-device peering with symmetrical throughput between at least two nodes of the mobile broadband routable internet; and providing a machine to machine mobile application co-operating on the at least two nodes, wherein the yyyy mobile application utilizes the symmetrical throughput between the at least two nodes.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; facilitating direct-to-device application deployment over the mobile broadband routable internet; and providing a machine to machine mobile application that is deployed directly to a device in the mobile broadband routable internet using direct-to-device application deployment.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing data among a plurality of mobile broadband routable internet devices; and providing a machine to machine mobile application, wherein the mobile application uses the facility to access distributed data that is associated with the yyyy mobile application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing application components among a plurality of mobile broadband routable internet devices; and providing a machine to machine mobile application, components of which are distributed by the facility.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multicast routing within the network by allowing a data object to be transmitted by a device to a plurality of destinations over a plurality of routes; and providing a machine to machine mobile application that uses the multicast routing to at least distribute application-related updates.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote monitoring through the network; and providing a machine to machine mobile application that facilitates remote monitoring over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote control over the network; and providing a machine to machine mobile application that facilitates remote control over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote upgrade of at least one of software and services associated with the network; and providing a machine to machine mobile application that uses the remote upgrade to maintain a portion of the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an adaptive transmit power control facility for a device within the network, the adaptive transmit power control facility adapted to adjust transmission power of the device based on at least one of the density of proximate devices in the network, the condition of a neighboring device on the network, a channel condition of the network, a service level condition, a network performance condition, an environmental condition of the device and an application requirement of the device; and providing a machine to machine mobile application that uses adaptive transmit power control to adapt the transmit power associated with the application based on at least a density of devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing forwarding error correction on at least long IP packets; and providing a machine to machine mobile application that is enabled at least in part by utilizing forwarding error correction on the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for enabling adaptation of the data rate provided for links among devices within the network, the adaptation based on at least one of the density of devices in the network, the condition neighboring devices in the network, a channel condition of the network, a service level condition, a network performance condition, an environmental condition and an application requirement; and providing a machine to machine mobile application that adapts application related data transmission and receiving parameters based on the adaptive link data rates within the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing dynamic spectrum access capabilities within the network by determining communication spectrum quality and adjusting use of time frequency rectangles within the communication spectrum based on the determination; and providing a machine to machine mobile application that uses the dynamic spectrum access capabilities to provide enhanced use of spectral bandwidth.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; communicating among the plurality of devices over a radio communication spectrum and reusing portions of the spectrum for communication based on availability of time frequency rectangles within portions of the spectrum; and providing a machine to machine mobile application that reuses spectrum allocated for at least one other application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; and communicating wirelessly among at least a portion of the plurality of mobile devices, wherein the at least a portion of the plurality of mobile devices communicate independent of which radio frequency is used for the wireless communication; and wherein a machine to machine mobile application operating on at least two of the mobile devices exchanges information over the mobile broadband routable internet independent of the radio frequency.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing geo-location coding of device nodes in the network, wherein geo-location is based at least in part on a network location of a device node relative to other devices in the network; and providing a machine to machine mobile application that uses geo-location of device nodes in the network to facilitate at least one location-based service.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multimedia support within the network through a hybrid frame structure that includes variable slot duration and sub-channelization of bandwidth; and providing a machine to machine mobile application that uses multimedia support to provide yyyy related multimedia services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing time synchronization among nodes of the network, wherein the time synchronization is provided by communicating a representation of network timing at all the nodes with sufficient accuracy to enable reliable communications; and providing a machine to machine mobile application that uses network node time synchronization in delivery of the application services to device nodes in the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing seamless outdoor and indoor operation over the network; and providing a machine to machine mobile application takes advantage of the seamless outdoor and indoor operation to deliver services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing fixed radio installations that facilitate connection of the plurality of mobile devices, wherein the fixed radio installations are based at least in part on meeting a criteria associated with network radio propagation and performance; and providing a machine to machine mobile application that uses the fixed radio installation for backhaul communication associated with the application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an IP-compatible plug connection to at least one wired infrastructure type; and providing a machine to machine mobile application that uses the connection.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multiple fixed-network gateway interfaces connecting the mobile ad hoc network to a fixed network; and providing a machine to machine mobile application that communicates between a mobile device and a device on the fixed network.

In an aspect of the invention, methods and systems may include providing a mobile, broadband, routable internet, in which a plurality of mobile devices interact as nodes in a mobile ad hoc network and in which packets are IP routable to each of the devices independent of fixed infrastructure elements; providing an automated network design tool to facilitate low cost and fast network design engineering and deployment planning of the fixed infrastructure elements of the network; and deploying a machine to machine mobile application configured to use the networked designed by the design tool.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; deploying a plurality of low cost mesh access points to provide network coverage in a geography; and providing a machine to machine mobile application that communicates at least in part via the mesh access points.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing small form factor nodes that allow for low cost and fast capacity expansion and network upgrade; and providing a machine to machine mobile application that communicates at least in part via the small form factor nodes.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing communications between a mobile device and a device on a remote network so as to substantially favor routes through the mobile, broadband, routable Internet that have fewer hops between the mobile device and a backhaul access point; and providing a machine to machine mobile application that uses said communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing a user deployable access point that connects to the network; and providing a machine to machine mobile application that uses said access point.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing at least one base station controller function in at least one subscriber device, the base station controller function including at least one of an air interface management function, a signaling function, a concentration logic function, and a signal propagation function; and providing a machine to machine mobile application employing the at least one base state controller functions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing service provider tools to manage resource consumption of at least one device on the ad hoc network, wherein the tools are deployed on at least one of the plurality of mobile devices and use at least one management path for reporting usage of the at least one device; and providing a machine to machine mobile application for which the management path is used to report usage of the application.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing full radio resource management functions in at least one device, the radio resource management functions including at least one of radio management, handover, handoff, and foreign device cooperation functions, wherein the at least one device is a subscriber device; and providing a machine to machine mobile application operating responsively to a state of a managed radio resource.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multi-session functions in at least one of the plurality of devices, wherein the at least one device is a subscriber device; and providing a machine to machine mobile application communicating via multiple sessions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing cost-based routing functions in the network through dynamic forming and reforming of links and routes, wherein the cost-based routing functions are provided in a plurality of subscriber devices; and providing a machine to machine mobile application that uses the cost-based routing functions to deliver a desired balance of cost and quality of service.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP router functions at individual mobile devices of the network, wherein the individual mobile devices are subscriber devices; and providing a machine to machine mobile application that uses the IP router functions to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing, in at least one of the plurality of mobile devices, media access control layer capabilities including sub-network layer convergence functions selected from a list consisting of segmentation and reassembly, quality of service, throughput fairness, adaptive data rate control, and transmit power control, wherein the at least one mobile device is a subscriber device; and providing a machine to machine mobile application that uses the MAC layer to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing route diversity within the network to facilitate assurance of packet communication, wherein route diversity is based at least on a number of network devices in a geographic area; and providing a machine to machine mobile application that uses the route diversity to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; allowing layer 2 forwarding among at least some of the plurality of mobile devices; and providing a machine to machine mobile application that communicates via the layer 2 forwarding.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing the routable internet to a node in the network, wherein the node also communicates with a cellular network through at least one of the fixed infrastructure elements and the routable internet is provided outside the cellular network; and providing a machine to machine mobile application that communicates both through the cellular network and the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP application deployment to a device in the network, wherein the device also communicates with a cellular network through at least one of the fixed infrastructure elements and the IP application is deployed outside the cellular network; and providing a machine to machine mobile application that is deployed over IP and that communicates via the cellular network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network; and providing a machine to machine mobile application that communicates via the data packets.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network absent communications with the fixed infrastructure elements; and providing a machine to machine mobile application that communicates solely within the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/sec during normal operation; and providing a machine to machine mobile application that uses the communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/set when the nodes are in motion at vehicular speeds; and providing a machine to machine mobile application that uses the communications.

In an aspect of the invention, methods and systems include providing a mobile, broadband, routable internet, in which a plurality of mobile devices interact as nodes in a mobile ad hoc network and in which packets are IP routable to each of mobile devices of fixed infrastructure elements; and providing a machine to machine mobile application that communicates via the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; applying swarm intelligence to determine at least some parts of at least some routes through the mobile, broadband, routable internet; and providing a machine to machine mobile application that communicates via the mobile ad hoc network.

In an aspect of the invention, methods and systems include providing a mobile, broadband, routable internet, in which a plurality of mobile devices interact as sending and receiving nodes in a mobile ad hoc network and in which packets are IP routable to the individual devices independent of fixed infrastructure elements; providing routing priority within the network, wherein the routing priority is provided by granting channel access to a node for which prioritized routing is identified and sending delay-sensitive data from the node before sending delay-tolerant data from the node; and providing a private mobile internet mobile application that uses the routing priority to manage routing of data within the mobile, broadband, routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing support for peer-to-peer traffic within the network; and providing a private mobile internet mobile application that provides fixed-network-independent capacity and service delivery by utilizing the peer-to-peer traffic network support.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer to peer connectivity within the mobile broadband routable internet; and providing a private mobile internet mobile application that uses the peer to peer connectivity to facilitate mobile, fixed-infrastructure-independent, peer-to-peer application connection among at least a subset of the plurality of mobile devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing file sharing over the mobile broadband routable internet; and providing a private mobile internet mobile application that uses file sharing without degrading system performance.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing user-generated applications over the mobile broadband routable internet; and providing a private mobile internet mobile application associated with the mobile broadband routable internet, wherein the yyyy mobile application includes a user-generated application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer-to-peer applications over the mobile broadband routable internet; and providing a private mobile internet mobile application that uses peer-to-peer applications without degrading performance of the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing direct device-to-device peering with symmetrical throughput between at least two nodes of the mobile broadband routable internet; and providing a private mobile internet mobile application co-operating on the at least two nodes, wherein the yyyy mobile application utilizes the symmetrical throughput between the at least two nodes.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; facilitating direct-to-device application deployment over the mobile broadband routable internet; and providing a private mobile internet mobile application that is deployed directly to a device in the mobile broadband routable internet using direct-to-device application deployment.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing data among a plurality of mobile broadband routable internet devices; and providing a private mobile internet mobile application, wherein the mobile application uses the facility to access distributed data that is associated with the yyyy mobile application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing application components among a plurality of mobile broadband routable internet devices; and providing a private mobile internet mobile application, components of which are distributed by the facility.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multicast routing within the network by allowing a data object to be transmitted by a device to a plurality of destinations over a plurality of routes; and providing a private mobile internet mobile application that uses the multicast routing to at least distribute application-related updates.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote monitoring through the network; and providing a private mobile internet mobile application that facilitates remote monitoring over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote control over the network; and providing a private mobile internet mobile application that facilitates remote control over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote upgrade of at least one of software and services associated with the network; and providing a private mobile internet mobile application that uses the remote upgrade to maintain a portion of the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an adaptive transmit power control facility for a device within the network, the adaptive transmit power control facility adapted to adjust transmission power of the device based on at least one of the density of proximate devices in the network, the condition of a neighboring device on the network, a channel condition of the network, a service level condition, a network performance condition, an environmental condition of the device and an application requirement of the device; and providing a private mobile internet mobile application that uses adaptive transmit power control to adapt the transmit power associated with the application based on at least a density of devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing forwarding error correction on at least long IP packets; and providing a private mobile internet mobile application that is enabled at least in part by utilizing forwarding error correction on the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for enabling adaptation of the data rate provided for links among devices within the network, the adaptation based on at least one of the density of devices in the network, the condition neighboring devices in the network, a channel condition of the network, a service level condition, a network performance condition, an environmental condition and an application requirement; and providing a private mobile internet mobile application that adapts application related data transmission and receiving parameters based on the adaptive link data rates within the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing dynamic spectrum access capabilities within the network by determining communication spectrum quality and adjusting use of time frequency rectangles within the communication spectrum based on the determination; and providing a private mobile internet mobile application that uses the dynamic spectrum access capabilities to provide enhanced use of spectral bandwidth.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; communicating among the plurality of devices over a radio communication spectrum and reusing portions of the spectrum for communication based on availability of time frequency rectangles within portions of the spectrum; and providing a private mobile internet mobile application that reuses spectrum allocated for at least one other application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; and communicating wirelessly among at least a portion of the plurality of mobile devices, wherein the at least a portion of the plurality of mobile devices communicate independent of which radio frequency is used for the wireless communication; and wherein a private mobile internet mobile application operating on at least two of the mobile devices exchanges information over the mobile broadband routable internet independent of the radio frequency.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing geo-location coding of device nodes in the network, wherein geo-location is based at least in part on a network location of a device node relative to other devices in the network; and providing a private mobile internet mobile application that uses geo-location of device nodes in the network to facilitate at least one location-based service.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multimedia support within the network through a hybrid frame structure that includes variable slot duration and sub-channelization of bandwidth; and providing a private mobile internet mobile application that uses multimedia support to provide yyyy related multimedia services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing time synchronization among nodes of the network, wherein the time synchronization is provided by communicating a representation of network timing at all the nodes with sufficient accuracy to enable reliable communications; and providing a private mobile internet mobile application that uses network node time synchronization in delivery of the application services to device nodes in the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing seamless outdoor and indoor operation over the network; and providing a private mobile internet mobile application takes advantage of the seamless outdoor and indoor operation to deliver services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing fixed radio installations that facilitate connection of the plurality of mobile devices, wherein the fixed radio installations are based at least in part on meeting a criteria associated with network radio propagation and performance; and providing a private mobile internet mobile application that uses the fixed radio installation for backhaul communication associated with the application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an IP-compatible plug connection to at least one wired infrastructure type; and providing a private mobile internet mobile application that uses the connection.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multiple fixed-network gateway interfaces connecting the mobile ad hoc network to a fixed network; and providing a private mobile internet mobile application that communicates between a mobile device and a device on the fixed network.

In an aspect of the invention, methods and systems may include providing a mobile, broadband, routable internet, in which a plurality of mobile devices interact as nodes in a mobile ad hoc network and in which packets are IP routable to each of the devices independent of fixed infrastructure elements; providing an automated network design tool to facilitate low cost and fast network design engineering and deployment planning of the fixed infrastructure elements of the network; and deploying a private mobile internet mobile application configured to use the networked designed by the design tool.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; deploying a plurality of low cost mesh access points to provide network coverage in a geography; and providing a private mobile internet mobile application that communicates at least in part via the mesh access points.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing small form factor nodes that allow for low cost and fast capacity expansion and network upgrade; and providing a private mobile internet mobile application that communicates at least in part via the small form factor nodes.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing communications between a mobile device and a device on a remote network so as to substantially favor routes through the mobile, broadband, routable Internet that have fewer hops between the mobile device and a backhaul access point; and providing a private mobile internet mobile application that uses said communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing a user deployable access point that connects to the network; and providing a private mobile internet mobile application that uses said access point.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing at least one base station controller function in at least one subscriber device, the base station controller function including at least one of an air interface management function, a signaling function, a concentration logic function, and a signal propagation function; and providing a private mobile internet mobile application employing the at least one base state controller functions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing service provider tools to manage resource consumption of at least one device on the ad hoc network, wherein the tools are deployed on at least one of the plurality of mobile devices and use at least one management path for reporting usage of the at least one device; and providing a private mobile internet mobile application for which the management path is used to report usage of the application.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing full radio resource management functions in at least one device, the radio resource management functions including at least one of radio management, handover, handoff, and foreign device cooperation functions, wherein the at least one device is a subscriber device; and providing a private mobile internet mobile application operating responsively to a state of a managed radio resource.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multi-session functions in at least one of the plurality of devices, wherein the at least one device is a subscriber device; and providing a private mobile internet mobile application communicating via multiple sessions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing cost-based routing functions in the network through dynamic forming and reforming of links and routes, wherein the cost-based routing functions are provided in a plurality of subscriber devices; and providing a private mobile internet mobile application that uses the cost-based routing functions to deliver a desired balance of cost and quality of service.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP router functions at individual mobile devices of the network, wherein the individual mobile devices are subscriber devices; and providing a private mobile internet mobile application that uses the IP router functions to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing, in at least one of the plurality of mobile devices, media access control layer capabilities including sub-network layer convergence functions selected from a list consisting of segmentation and reassembly, quality of service, throughput fairness, adaptive data rate control, and transmit power control, wherein the at least one mobile device is a subscriber device; and providing a private mobile internet mobile application that uses the MAC layer to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing route diversity within the network to facilitate assurance of packet communication, wherein route diversity is based at least on a number of network devices in a geographic area; and providing a private mobile internet mobile application that uses the route diversity to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; allowing layer 2 forwarding among at least some of the plurality of mobile devices; and providing a private mobile internet mobile application that communicates via the layer 2 forwarding.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing the routable internet to a node in the network, wherein the node also communicates with a cellular network through at least one of the fixed infrastructure elements and the routable internet is provided outside the cellular network; and providing a private mobile internet mobile application that communicates both through the cellular network and the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP application deployment to a device in the network, wherein the device also communicates with a cellular network through at least one of the fixed infrastructure elements and the IP application is deployed outside the cellular network; and providing a private mobile internet mobile application that is deployed over IP and that communicates via the cellular network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network; and providing a private mobile internet mobile application that communicates via the data packets.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network absent communications with the fixed infrastructure elements; and providing a private mobile internet mobile application that communicates solely within the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/sec during normal operation; and providing a private mobile internet mobile application that uses the communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/set when the nodes are in motion at vehicular speeds; and providing a private mobile internet mobile application that uses the communications.

In an aspect of the invention, methods and systems include providing a mobile, broadband, routable internet, in which a plurality of mobile devices interact as nodes in a mobile ad hoc network and in which packets are IP routable to each of mobile devices of fixed infrastructure elements; and providing a private mobile internet mobile application that communicates via the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; applying swarm intelligence to determine at least some parts of at least some routes through the mobile, broadband, routable internet; and providing a private mobile internet mobile application that communicates via the mobile ad hoc network.

In an aspect of the invention, methods and systems include providing a mobile, broadband, routable internet, in which a plurality of mobile devices interact as sending and receiving nodes in a mobile ad hoc network and in which packets are IP routable to the individual devices independent of fixed infrastructure elements; providing routing priority within the network, wherein the routing priority is provided by granting channel access to a node for which prioritized routing is identified and sending delay-sensitive data from the node before sending delay-tolerant data from the node; and providing a surveillance mobile application that uses the routing priority to manage routing of data within the mobile, broadband, routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing support for peer-to-peer traffic within the network; and providing a surveillance mobile application that provides fixed-network-independent capacity and service delivery by utilizing the peer-to-peer traffic network support.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer to peer connectivity within the mobile broadband routable internet; and providing a surveillance mobile application that uses the peer to peer connectivity to facilitate mobile, fixed-infrastructure-independent, peer-to-peer application connection among at least a subset of the plurality of mobile devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing file sharing over the mobile broadband routable internet; and providing a surveillance mobile application that uses file sharing without degrading system performance.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing user-generated applications over the mobile broadband routable internet; and providing a surveillance mobile application associated with the mobile broadband routable internet, wherein the yyyy mobile application includes a user-generated application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer-to-peer applications over the mobile broadband routable internet; and providing a surveillance mobile application that uses peer-to-peer applications without degrading performance of the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing direct device-to-device peering with symmetrical throughput between at least two nodes of the mobile broadband routable internet; and providing a surveillance mobile application co-operating on the at least two nodes, wherein the yyyy mobile application utilizes the symmetrical throughput between the at least two nodes.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; facilitating direct-to-device application deployment over the mobile broadband routable internet; and providing a surveillance mobile application that is deployed directly to a device in the mobile broadband routable internet using direct-to-device application deployment.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing data among a plurality of mobile broadband routable internet devices; and providing a surveillance mobile application, wherein the mobile application uses the facility to access distributed data that is associated with the yyyy mobile application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing application components among a plurality of mobile broadband routable internet devices; and providing a surveillance mobile application, components of which are distributed by the facility.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multicast routing within the network by allowing a data object to be transmitted by a device to a plurality of destinations over a plurality of routes; and providing a surveillance mobile application that uses the multicast routing to at least distribute application-related updates.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote monitoring through the network; and providing a surveillance mobile application that facilitates remote monitoring over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote control over the network; and providing a surveillance mobile application that facilitates remote control over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote upgrade of at least one of software and services associated with the network; and providing a surveillance mobile application that uses the remote upgrade to maintain a portion of the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an adaptive transmit power control facility for a device within the network, the adaptive transmit power control facility adapted to adjust transmission power of the device based on at least one of the density of proximate devices in the network, the condition of a neighboring device on the network, a channel condition of the network, a service level condition, a network performance condition, an environmental condition of the device and an application requirement of the device; and providing a surveillance mobile application that uses adaptive transmit power control to adapt the transmit power associated with the application based on at least a density of devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing forwarding error correction on at least long IP packets; and providing a surveillance mobile application that is enabled at least in part by utilizing forwarding error correction on the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for enabling adaptation of the data rate provided for links among devices within the network, the adaptation based on at least one of the density of devices in the network, the condition neighboring devices in the network, a channel condition of the network, a service level condition, a network performance condition, an environmental condition and an application requirement; and providing a surveillance mobile application that adapts application related data transmission and receiving parameters based on the adaptive link data rates within the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing dynamic spectrum access capabilities within the network by determining communication spectrum quality and adjusting use of time frequency rectangles within the communication spectrum based on the determination; and providing a surveillance mobile application that uses the dynamic spectrum access capabilities to provide enhanced use of spectral bandwidth.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; communicating among the plurality of devices over a radio communication spectrum and reusing portions of the spectrum for communication based on availability of time frequency rectangles within portions of the spectrum; and providing a surveillance mobile application that reuses spectrum allocated for at least one other application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; and communicating wirelessly among at least a portion of the plurality of mobile devices, wherein the at least a portion of the plurality of mobile devices communicate independent of which radio frequency is used for the wireless communication; and wherein a surveillance mobile application operating on at least two of the mobile devices exchanges information over the mobile broadband routable internet independent of the radio frequency.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing geo-location coding of device nodes in the network, wherein geo-location is based at least in part on a network location of a device node relative to other devices in the network; and providing a surveillance mobile application that uses geo-location of device nodes in the network to facilitate at least one location-based service.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multimedia support within the network through a hybrid frame structure that includes variable slot duration and sub-channelization of bandwidth; and providing a surveillance mobile application that uses multimedia support to provide yyyy related multimedia services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing time synchronization among nodes of the network, wherein the time synchronization is provided by communicating a representation of network timing at all the nodes with sufficient accuracy to enable reliable communications; and providing a surveillance mobile application that uses network node time synchronization in delivery of the application services to device nodes in the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing seamless outdoor and indoor operation over the network; and providing a surveillance mobile application takes advantage of the seamless outdoor and indoor operation to deliver services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing fixed radio installations that facilitate connection of the plurality of mobile devices, wherein the fixed radio installations are based at least in part on meeting a criteria associated with network radio propagation and performance; and providing a surveillance mobile application that uses the fixed radio installation for backhaul communication associated with the application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an IP-compatible plug connection to at least one wired infrastructure type; and providing a surveillance mobile application that uses the connection.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multiple fixed-network gateway interfaces connecting the mobile ad hoc network to a fixed network; and providing a surveillance mobile application that communicates between a mobile device and a device on the fixed network.

In an aspect of the invention, methods and systems may include providing a mobile, broadband, routable internet, in which a plurality of mobile devices interact as nodes in a mobile ad hoc network and in which packets are IP routable to each of the devices independent of fixed infrastructure elements; providing an automated network design tool to facilitate low cost and fast network design engineering and deployment planning of the fixed infrastructure elements of the network; and deploying a surveillance mobile application configured to use the networked designed by the design tool.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; deploying a plurality of low cost mesh access points to provide network coverage in a geography; and providing a surveillance mobile application that communicates at least in part via the mesh access points.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing small form factor nodes that allow for low cost and fast capacity expansion and network upgrade; and providing a surveillance mobile application that communicates at least in part via the small form factor nodes.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing communications between a mobile device and a device on a remote network so as to substantially favor routes through the mobile, broadband, routable Internet that have fewer hops between the mobile device and a backhaul access point; and providing a surveillance mobile application that uses said communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing a user deployable access point that connects to the network; and providing a surveillance mobile application that uses said access point.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing at least one base station controller function in at least one subscriber device, the base station controller function including at least one of an air interface management function, a signaling function, a concentration logic function, and a signal propagation function; and providing a surveillance mobile application employing the at least one base state controller functions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing service provider tools to manage resource consumption of at least one device on the ad hoc network, wherein the tools are deployed on at least one of the plurality of mobile devices and use at least one management path for reporting usage of the at least one device; and providing a surveillance mobile application for which the management path is used to report usage of the application.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing full radio resource management functions in at least one device, the radio resource management functions including at least one of radio management, handover, handoff, and foreign device cooperation functions, wherein the at least one device is a subscriber device; and providing a surveillance mobile application operating responsively to a state of a managed radio resource.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multi-session functions in at least one of the plurality of devices, wherein the at least one device is a subscriber device; and providing a surveillance mobile application communicating via multiple sessions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing cost-based routing functions in the network through dynamic forming and reforming of links and routes, wherein the cost-based routing functions are provided in a plurality of subscriber devices; and providing a surveillance mobile application that uses the cost-based routing functions to deliver a desired balance of cost and quality of service.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP router functions at individual mobile devices of the network, wherein the individual mobile devices are subscriber devices; and providing a surveillance mobile application that uses the IP router functions to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing, in at least one of the plurality of mobile devices, media access control layer capabilities including sub-network layer convergence functions selected from a list consisting of segmentation and reassembly, quality of service, throughput fairness, adaptive data rate control, and transmit power control, wherein the at least one mobile device is a subscriber device; and providing a surveillance mobile application that uses the MAC layer to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing route diversity within the network to facilitate assurance of packet communication, wherein route diversity is based at least on a number of network devices in a geographic area; and providing a surveillance mobile application that uses the route diversity to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; allowing layer 2 forwarding among at least some of the plurality of mobile devices; and providing a surveillance mobile application that communicates via the layer 2 forwarding.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing the routable internet to a node in the network, wherein the node also communicates with a cellular network through at least one of the fixed infrastructure elements and the routable internet is provided outside the cellular network; and providing a surveillance mobile application that communicates both through the cellular network and the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP application deployment to a device in the network, wherein the device also communicates with a cellular network through at least one of the fixed infrastructure elements and the IP application is deployed outside the cellular network; and providing a surveillance mobile application that is deployed over IP and that communicates via the cellular network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network; and providing a surveillance mobile application that communicates via the data packets.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network absent communications with the fixed infrastructure elements; and providing a surveillance mobile application that communicates solely within the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/sec during normal operation; and providing a surveillance mobile application that uses the communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/set when the nodes are in motion at vehicular speeds; and providing a surveillance mobile application that uses the communications.

In an aspect of the invention, methods and systems include providing a mobile, broadband, routable internet, in which a plurality of mobile devices interact as nodes in a mobile ad hoc network and in which packets are IP routable to each of mobile devices of fixed infrastructure elements; and providing a surveillance mobile application that communicates via the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; applying swarm intelligence to determine at least some parts of at least some routes through the mobile, broadband, routable internet; and providing a surveillance mobile application that communicates via the mobile ad hoc network.

In an aspect of the invention, methods and systems include providing a mobile, broadband, routable internet, in which a plurality of mobile devices interact as sending and receiving nodes in a mobile ad hoc network and in which packets are IP routable to the individual devices independent of fixed infrastructure elements; providing routing priority within the network, wherein the routing priority is provided by granting channel access to a node for which prioritized routing is identified and sending delay-sensitive data from the node before sending delay-tolerant data from the node; and providing a traffic management mobile application that uses the routing priority to manage routing of data within the mobile, broadband, routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing support for peer-to-peer traffic within the network; and providing a traffic management mobile application that provides fixed-network-independent capacity and service delivery by utilizing the peer-to-peer traffic network support.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer to peer connectivity within the mobile broadband routable internet; and providing a traffic management mobile application that uses the peer to peer connectivity to facilitate mobile, fixed-infrastructure-independent, peer-to-peer application connection among at least a subset of the plurality of mobile devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing file sharing over the mobile broadband routable internet; and providing a traffic management mobile application that uses file sharing without degrading system performance.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing user-generated applications over the mobile broadband routable internet; and providing a traffic management mobile application associated with the mobile broadband routable internet, wherein the yyyy mobile application includes a user-generated application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer-to-peer applications over the mobile broadband routable internet; and providing a traffic management mobile application that uses peer-to-peer applications without degrading performance of the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing direct device-to-device peering with symmetrical throughput between at least two nodes of the mobile broadband routable internet; and providing a traffic management mobile application co-operating on the at least two nodes, wherein the yyyy mobile application utilizes the symmetrical throughput between the at least two nodes.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; facilitating direct-to-device application deployment over the mobile broadband routable internet; and providing a traffic management mobile application that is deployed directly to a device in the mobile broadband routable internet using direct-to-device application deployment.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing data among a plurality of mobile broadband routable internet devices; and providing a traffic management mobile application, wherein the mobile application uses the facility to access distributed data that is associated with the yyyy mobile application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing application components among a plurality of mobile broadband routable internet devices; and providing a traffic management mobile application, components of which are distributed by the facility.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multicast routing within the network by allowing a data object to be transmitted by a device to a plurality of destinations over a plurality of routes; and providing a traffic management mobile application that uses the multicast routing to at least distribute application-related updates.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote monitoring through the network; and providing a traffic management mobile application that facilitates remote monitoring over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote control over the network; and providing a traffic management mobile application that facilitates remote control over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote upgrade of at least one of software and services associated with the network; and providing a traffic management mobile application that uses the remote upgrade to maintain a portion of the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an adaptive transmit power control facility for a device within the network, the adaptive transmit power control facility adapted to adjust transmission power of the device based on at least one of the density of proximate devices in the network, the condition of a neighboring device on the network, a channel condition of the network, a service level condition, a network performance condition, an environmental condition of the device and an application requirement of the device; and providing a traffic management mobile application that uses adaptive transmit power control to adapt the transmit power associated with the application based on at least a density of devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing forwarding error correction on at least long IP packets; and providing a traffic management mobile application that is enabled at least in part by utilizing forwarding error correction on the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for enabling adaptation of the data rate provided for links among devices within the network, the adaptation based on at least one of the density of devices in the network, the condition neighboring devices in the network, a channel condition of the network, a service level condition, a network performance condition, an environmental condition and an application requirement; and providing a traffic management mobile application that adapts application related data transmission and receiving parameters based on the adaptive link data rates within the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing dynamic spectrum access capabilities within the network by determining communication spectrum quality and adjusting use of time frequency rectangles within the communication spectrum based on the determination; and providing a traffic management mobile application that uses the dynamic spectrum access capabilities to provide enhanced use of spectral bandwidth.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; communicating among the plurality of devices over a radio communication spectrum and reusing portions of the spectrum for communication based on availability of time frequency rectangles within portions of the spectrum; and providing a traffic management mobile application that reuses spectrum allocated for at least one other application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; and communicating wirelessly among at least a portion of the plurality of mobile devices, wherein the at least a portion of the plurality of mobile devices communicate independent of which radio frequency is used for the wireless communication; and wherein a traffic management mobile application operating on at least two of the mobile devices exchanges information over the mobile broadband routable internet independent of the radio frequency.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing geo-location coding of device nodes in the network, wherein geo-location is based at least in part on a network location of a device node relative to other devices in the network; and providing a traffic management mobile application that uses geo-location of device nodes in the network to facilitate at least one location-based service.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multimedia support within the network through a hybrid frame structure that includes variable slot duration and sub-channelization of bandwidth; and providing a traffic management mobile application that uses multimedia support to provide yyyy related multimedia services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing time synchronization among nodes of the network, wherein the time synchronization is provided by communicating a representation of network timing at all the nodes with sufficient accuracy to enable reliable communications; and providing a traffic management mobile application that uses network node time synchronization in delivery of the application services to device nodes in the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing seamless outdoor and indoor operation over the network; and providing a traffic management mobile application takes advantage of the seamless outdoor and indoor operation to deliver services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing fixed radio installations that facilitate connection of the plurality of mobile devices, wherein the fixed radio installations are based at least in part on meeting a criteria associated with network radio propagation and performance; and providing a traffic management mobile application that uses the fixed radio installation for backhaul communication associated with the application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an IP-compatible plug connection to at least one wired infrastructure type; and providing a traffic management mobile application that uses the connection.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multiple fixed-network gateway interfaces connecting the mobile ad hoc network to a fixed network; and providing a traffic management mobile application that communicates between a mobile device and a device on the fixed network.

In an aspect of the invention, methods and systems may include providing a mobile, broadband, routable internet, in which a plurality of mobile devices interact as nodes in a mobile ad hoc network and in which packets are IP routable to each of the devices independent of fixed infrastructure elements; providing an automated network design tool to facilitate low cost and fast network design engineering and deployment planning of the fixed infrastructure elements of the network; and deploying a traffic management mobile application configured to use the networked designed by the design tool.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; deploying a plurality of low cost mesh access points to provide network coverage in a geography; and providing a traffic management mobile application that communicates at least in part via the mesh access points.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing small form factor nodes that allow for low cost and fast capacity expansion and network upgrade; and providing a traffic management mobile application that communicates at least in part via the small form factor nodes.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing communications between a mobile device and a device on a remote network so as to substantially favor routes through the mobile, broadband, routable Internet that have fewer hops between the mobile device and a backhaul access point; and providing a traffic management mobile application that uses said communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing a user deployable access point that connects to the network; and providing a traffic management mobile application that uses said access point.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing at least one base station controller function in at least one subscriber device, the base station controller function including at least one of an air interface management function, a signaling function, a concentration logic function, and a signal propagation function; and providing a traffic management mobile application employing the at least one base state controller functions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing service provider tools to manage resource consumption of at least one device on the ad hoc network, wherein the tools are deployed on at least one of the plurality of mobile devices and use at least one management path for reporting usage of the at least one device; and providing a traffic management mobile application for which the management path is used to report usage of the application.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing full radio resource management functions in at least one device, the radio resource management functions including at least one of radio management, handover, handoff, and foreign device cooperation functions, wherein the at least one device is a subscriber device; and providing a traffic management mobile application operating responsively to a state of a managed radio resource.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multi-session functions in at least one of the plurality of devices, wherein the at least one device is a subscriber device; and providing a traffic management mobile application communicating via multiple sessions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing cost-based routing functions in the network through dynamic forming and reforming of links and routes, wherein the cost-based routing functions are provided in a plurality of subscriber devices; and providing a traffic management mobile application that uses the cost-based routing functions to deliver a desired balance of cost and quality of service.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP router functions at individual mobile devices of the network, wherein the individual mobile devices are subscriber devices; and providing a traffic management mobile application that uses the IP router functions to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing, in at least one of the plurality of mobile devices, media access control layer capabilities including sub-network layer convergence functions selected from a list consisting of segmentation and reassembly, quality of service, throughput fairness, adaptive data rate control, and transmit power control, wherein the at least one mobile device is a subscriber device; and providing a traffic management mobile application that uses the MAC layer to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing route diversity within the network to facilitate assurance of packet communication, wherein route diversity is based at least on a number of network devices in a geographic area; and providing a traffic management mobile application that uses the route diversity to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; allowing layer 2 forwarding among at least some of the plurality of mobile devices; and providing a traffic management mobile application that communicates via the layer 2 forwarding.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing the routable internet to a node in the network, wherein the node also communicates with a cellular network through at least one of the fixed infrastructure elements and the routable internet is provided outside the cellular network; and providing a traffic management mobile application that communicates both through the cellular network and the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP application deployment to a device in the network, wherein the device also communicates with a cellular network through at least one of the fixed infrastructure elements and the IP application is deployed outside the cellular network; and providing a traffic management mobile application that is deployed over IP and that communicates via the cellular network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network; and providing a traffic management mobile application that communicates via the data packets.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network absent communications with the fixed infrastructure elements; and providing a traffic management mobile application that communicates solely within the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/sec during normal operation; and providing a traffic management mobile application that uses the communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/set when the nodes are in motion at vehicular speeds; and providing a traffic management mobile application that uses the communications.

In an aspect of the invention, methods and systems include providing a mobile, broadband, routable internet, in which a plurality of mobile devices interact as nodes in a mobile ad hoc network and in which packets are IP routable to each of mobile devices of fixed infrastructure elements; and providing a traffic management mobile application that communicates via the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; applying swarm intelligence to determine at least some parts of at least some routes through the mobile, broadband, routable internet; and providing a traffic management mobile application that communicates via the mobile ad hoc network.

In an aspect of the invention, methods and systems include providing a mobile, broadband, routable internet, in which a plurality of mobile devices interact as sending and receiving nodes in a mobile ad hoc network and in which packets are IP routable to the individual devices independent of fixed infrastructure elements; providing routing priority within the network, wherein the routing priority is provided by granting channel access to a node for which prioritized routing is identified and sending delay-sensitive data from the node before sending delay-tolerant data from the node; and providing a parking mobile application that uses the routing priority to manage routing of data within the mobile, broadband, routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing support for peer-to-peer traffic within the network; and providing a parking mobile application that provides fixed-network-independent capacity and service delivery by utilizing the peer-to-peer traffic network support.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer to peer connectivity within the mobile broadband routable internet; and providing a parking mobile application that uses the peer to peer connectivity to facilitate mobile, fixed-infrastructure-independent, peer-to-peer application connection among at least a subset of the plurality of mobile devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing file sharing over the mobile broadband routable internet; and providing a parking mobile application that uses file sharing without degrading system performance.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing user-generated applications over the mobile broadband routable internet; and providing a parking mobile application associated with the mobile broadband routable internet, wherein the yyyy mobile application includes a user-generated application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer-to-peer applications over the mobile broadband routable internet; and providing a parking mobile application that uses peer-to-peer applications without degrading performance of the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing direct device-to-device peering with symmetrical throughput between at least two nodes of the mobile broadband routable internet; and providing a parking mobile application co-operating on the at least two nodes, wherein the yyyy mobile application utilizes the symmetrical throughput between the at least two nodes.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; facilitating direct-to-device application deployment over the mobile broadband routable internet; and providing a parking mobile application that is deployed directly to a device in the mobile broadband routable internet using direct-to-device application deployment.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing data among a plurality of mobile broadband routable internet devices; and providing a parking mobile application, wherein the mobile application uses the facility to access distributed data that is associated with the yyyy mobile application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing application components among a plurality of mobile broadband routable internet devices; and providing a parking mobile application, components of which are distributed by the facility.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multicast routing within the network by allowing a data object to be transmitted by a device to a plurality of destinations over a plurality of routes; and providing a parking mobile application that uses the multicast routing to at least distribute application-related updates.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote monitoring through the network; and providing a parking mobile application that facilitates remote monitoring over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote control over the network; and providing a parking mobile application that facilitates remote control over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote upgrade of at least one of software and services associated with the network; and providing a parking mobile application that uses the remote upgrade to maintain a portion of the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an adaptive transmit power control facility for a device within the network, the adaptive transmit power control facility adapted to adjust transmission power of the device based on at least one of the density of proximate devices in the network, the condition of a neighboring device on the network, a channel condition of the network, a service level condition, a network performance condition, an environmental condition of the device and an application requirement of the device; and providing a parking mobile application that uses adaptive transmit power control to adapt the transmit power associated with the application based on at least a density of devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing forwarding error correction on at least long IP packets; and providing a parking mobile application that is enabled at least in part by utilizing forwarding error correction on the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for enabling adaptation of the data rate provided for links among devices within the network, the adaptation based on at least one of the density of devices in the network, the condition neighboring devices in the network, a channel condition of the network, a service level condition, a network performance condition, an environmental condition and an application requirement; and providing a parking mobile application that adapts application related data transmission and receiving parameters based on the adaptive link data rates within the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing dynamic spectrum access capabilities within the network by determining communication spectrum quality and adjusting use of time frequency rectangles within the communication spectrum based on the determination; and providing a parking mobile application that uses the dynamic spectrum access capabilities to provide enhanced use of spectral bandwidth.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; communicating among the plurality of devices over a radio communication spectrum and reusing portions of the spectrum for communication based on availability of time frequency rectangles within portions of the spectrum; and providing a parking mobile application that reuses spectrum allocated for at least one other application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; and communicating wirelessly among at least a portion of the plurality of mobile devices, wherein the at least a portion of the plurality of mobile devices communicate independent of which radio frequency is used for the wireless communication; and wherein a parking mobile application operating on at least two of the mobile devices exchanges information over the mobile broadband routable internet independent of the radio frequency.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing geo-location coding of device nodes in the network, wherein geo-location is based at least in part on a network location of a device node relative to other devices in the network; and providing a parking mobile application that uses geo-location of device nodes in the network to facilitate at least one location-based service.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multimedia support within the network through a hybrid frame structure that includes variable slot duration and sub-channelization of bandwidth; and providing a parking mobile application that uses multimedia support to provide yyyy related multimedia services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing time synchronization among nodes of the network, wherein the time synchronization is provided by communicating a representation of network timing at all the nodes with sufficient accuracy to enable reliable communications; and providing a parking mobile application that uses network node time synchronization in delivery of the application services to device nodes in the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing seamless outdoor and indoor operation over the network; and providing a parking mobile application takes advantage of the seamless outdoor and indoor operation to deliver services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing fixed radio installations that facilitate connection of the plurality of mobile devices, wherein the fixed radio installations are based at least in part on meeting a criteria associated with network radio propagation and performance; and providing a parking mobile application that uses the fixed radio installation for backhaul communication associated with the application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an IP-compatible plug connection to at least one wired infrastructure type; and providing a parking mobile application that uses the connection.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multiple fixed-network gateway interfaces connecting the mobile ad hoc network to a fixed network; and providing a parking mobile application that communicates between a mobile device and a device on the fixed network.

In an aspect of the invention, methods and systems may include providing a mobile, broadband, routable internet, in which a plurality of mobile devices interact as nodes in a mobile ad hoc network and in which packets are IP routable to each of the devices independent of fixed infrastructure elements; providing an automated network design tool to facilitate low cost and fast network design engineering and deployment planning of the fixed infrastructure elements of the network; and deploying a parking mobile application configured to use the networked designed by the design tool.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; deploying a plurality of low cost mesh access points to provide network coverage in a geography; and providing a parking mobile application that communicates at least in part via the mesh access points.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing small form factor nodes that allow for low cost and fast capacity expansion and network upgrade; and providing a parking mobile application that communicates at least in part via the small form factor nodes.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing communications between a mobile device and a device on a remote network so as to substantially favor routes through the mobile, broadband, routable Internet that have fewer hops between the mobile device and a backhaul access point; and providing a parking mobile application that uses said communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing a user deployable access point that connects to the network; and providing a parking mobile application that uses said access point.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing at least one base station controller function in at least one subscriber device, the base station controller function including at least one of an air interface management function, a signaling function, a concentration logic function, and a signal propagation function; and providing a parking mobile application employing the at least one base state controller functions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing service provider tools to manage resource consumption of at least one device on the ad hoc network, wherein the tools are deployed on at least one of the plurality of mobile devices and use at least one management path for reporting usage of the at least one device; and providing a parking mobile application for which the management path is used to report usage of the application.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing full radio resource management functions in at least one device, the radio resource management functions including at least one of radio management, handover, handoff, and foreign device cooperation functions, wherein the at least one device is a subscriber device; and providing a parking mobile application operating responsively to a state of a managed radio resource.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multi-session functions in at least one of the plurality of devices, wherein the at least one device is a subscriber device; and providing a parking mobile application communicating via multiple sessions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing cost-based routing functions in the network through dynamic forming and reforming of links and routes, wherein the cost-based routing functions are provided in a plurality of subscriber devices; and providing a parking mobile application that uses the cost-based routing functions to deliver a desired balance of cost and quality of service.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP router functions at individual mobile devices of the network, wherein the individual mobile devices are subscriber devices; and providing a parking mobile application that uses the IP router functions to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing, in at least one of the plurality of mobile devices, media access control layer capabilities including sub-network layer convergence functions selected from a list consisting of segmentation and reassembly, quality of service, throughput fairness, adaptive data rate control, and transmit power control, wherein the at least one mobile device is a subscriber device; and providing a parking mobile application that uses the MAC layer to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing route diversity within the network to facilitate assurance of packet communication, wherein route diversity is based at least on a number of network devices in a geographic area; and providing a parking mobile application that uses the route diversity to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; allowing layer 2 forwarding among at least some of the plurality of mobile devices; and providing a parking mobile application that communicates via the layer 2 forwarding.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing the routable internet to a node in the network, wherein the node also communicates with a cellular network through at least one of the fixed infrastructure elements and the routable internet is provided outside the cellular network; and providing a parking mobile application that communicates both through the cellular network and the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP application deployment to a device in the network, wherein the device also communicates with a cellular network through at least one of the fixed infrastructure elements and the IP application is deployed outside the cellular network; and providing a parking mobile application that is deployed over IP and that communicates via the cellular network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network; and providing a parking mobile application that communicates via the data packets.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network absent communications with the fixed infrastructure elements; and providing a parking mobile application that communicates solely within the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/sec during normal operation; and providing a parking mobile application that uses the communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/set when the nodes are in motion at vehicular speeds; and providing a parking mobile application that uses the communications.

In an aspect of the invention, methods and systems include providing a mobile, broadband, routable internet, in which a plurality of mobile devices interact as nodes in a mobile ad hoc network and in which packets are IP routable to each of mobile devices of fixed infrastructure elements; and providing a parking mobile application that communicates via the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; applying swarm intelligence to determine at least some parts of at least some routes through the mobile, broadband, routable internet; and providing a parking mobile application that communicates via the mobile ad hoc network.

In an aspect of the invention, methods and systems include providing a mobile, broadband, routable internet, in which a plurality of mobile devices interact as sending and receiving nodes in a mobile ad hoc network and in which packets are IP routable to the individual devices independent of fixed infrastructure elements; providing routing priority within the network, wherein the routing priority is provided by granting channel access to a node for which prioritized routing is identified and sending delay-sensitive data from the node before sending delay-tolerant data from the node; and providing a theme park mobile application that uses the routing priority to manage routing of data within the mobile, broadband, routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing support for peer-to-peer traffic within the network; and providing a theme park mobile application that provides fixed-network-independent capacity and service delivery by utilizing the peer-to-peer traffic network support.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer to peer connectivity within the mobile broadband routable internet; and providing a theme park mobile application that uses the peer to peer connectivity to facilitate mobile, fixed-infrastructure-independent, peer-to-peer application connection among at least a subset of the plurality of mobile devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing file sharing over the mobile broadband routable internet; and providing a theme park mobile application that uses file sharing without degrading system performance.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing user-generated applications over the mobile broadband routable internet; and providing a theme park mobile application associated with the mobile broadband routable internet, wherein the yyyy mobile application includes a user-generated application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer-to-peer applications over the mobile broadband routable internet; and providing a theme park mobile application that uses peer-to-peer applications without degrading performance of the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing direct device-to-device peering with symmetrical throughput between at least two nodes of the mobile broadband routable internet; and providing a theme park mobile application co-operating on the at least two nodes, wherein the yyyy mobile application utilizes the symmetrical throughput between the at least two nodes.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; facilitating direct-to-device application deployment over the mobile broadband routable internet; and providing a theme park mobile application that is deployed directly to a device in the mobile broadband routable internet using direct-to-device application deployment.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing data among a plurality of mobile broadband routable internet devices; and providing a theme park mobile application, wherein the mobile application uses the facility to access distributed data that is associated with the yyyy mobile application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing application components among a plurality of mobile broadband routable internet devices; and providing a theme park mobile application, components of which are distributed by the facility.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multicast routing within the network by allowing a data object to be transmitted by a device to a plurality of destinations over a plurality of routes; and providing a theme park mobile application that uses the multicast routing to at least distribute application-related updates.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote monitoring through the network; and providing a theme park mobile application that facilitates remote monitoring over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote control over the network; and providing a theme park mobile application that facilitates remote control over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote upgrade of at least one of software and services associated with the network; and providing a theme park mobile application that uses the remote upgrade to maintain a portion of the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an adaptive transmit power control facility for a device within the network, the adaptive transmit power control facility adapted to adjust transmission power of the device based on at least one of the density of proximate devices in the network, the condition of a neighboring device on the network, a channel condition of the network, a service level condition, a network performance condition, an environmental condition of the device and an application requirement of the device; and providing a theme park mobile application that uses adaptive transmit power control to adapt the transmit power associated with the application based on at least a density of devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing forwarding error correction on at least long IP packets; and providing a theme park mobile application that is enabled at least in part by utilizing forwarding error correction on the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for enabling adaptation of the data rate provided for links among devices within the network, the adaptation based on at least one of the density of devices in the network, the condition neighboring devices in the network, a channel condition of the network, a service level condition, a network performance condition, an environmental condition and an application requirement; and providing a theme park mobile application that adapts application related data transmission and receiving parameters based on the adaptive link data rates within the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing dynamic spectrum access capabilities within the network by determining communication spectrum quality and adjusting use of time frequency rectangles within the communication spectrum based on the determination; and providing a theme park mobile application that uses the dynamic spectrum access capabilities to provide enhanced use of spectral bandwidth.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; communicating among the plurality of devices over a radio communication spectrum and reusing portions of the spectrum for communication based on availability of time frequency rectangles within portions of the spectrum; and providing a theme park mobile application that reuses spectrum allocated for at least one other application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; and communicating wirelessly among at least a portion of the plurality of mobile devices, wherein the at least a portion of the plurality of mobile devices communicate independent of which radio frequency is used for the wireless communication; and wherein a theme park mobile application operating on at least two of the mobile devices exchanges information over the mobile broadband routable internet independent of the radio frequency.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing geo-location coding of device nodes in the network, wherein geo-location is based at least in part on a network location of a device node relative to other devices in the network; and providing a theme park mobile application that uses geo-location of device nodes in the network to facilitate at least one location-based service.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multimedia support within the network through a hybrid frame structure that includes variable slot duration and sub-channelization of bandwidth; and providing a theme park mobile application that uses multimedia support to provide yyyy related multimedia services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing time synchronization among nodes of the network, wherein the time synchronization is provided by communicating a representation of network timing at all the nodes with sufficient accuracy to enable reliable communications; and providing a theme park mobile application that uses network node time synchronization in delivery of the application services to device nodes in the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing seamless outdoor and indoor operation over the network; and providing a theme park mobile application takes advantage of the seamless outdoor and indoor operation to deliver services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing fixed radio installations that facilitate connection of the plurality of mobile devices, wherein the fixed radio installations are based at least in part on meeting a criteria associated with network radio propagation and performance; and providing a theme park mobile application that uses the fixed radio installation for backhaul communication associated with the application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an IP-compatible plug connection to at least one wired infrastructure type; and providing a theme park mobile application that uses the connection.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multiple fixed-network gateway interfaces connecting the mobile ad hoc network to a fixed network; and providing a theme park mobile application that communicates between a mobile device and a device on the fixed network.

In an aspect of the invention, methods and systems may include providing a mobile, broadband, routable internet, in which a plurality of mobile devices interact as nodes in a mobile ad hoc network and in which packets are IP routable to each of the devices independent of fixed infrastructure elements; providing an automated network design tool to facilitate low cost and fast network design engineering and deployment planning of the fixed infrastructure elements of the network; and deploying a theme park mobile application configured to use the networked designed by the design tool.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; deploying a plurality of low cost mesh access points to provide network coverage in a geography; and providing a theme park mobile application that communicates at least in part via the mesh access points.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing small form factor nodes that allow for low cost and fast capacity expansion and network upgrade; and providing a theme park mobile application that communicates at least in part via the small form factor nodes.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing communications between a mobile device and a device on a remote network so as to substantially favor routes through the mobile, broadband, routable Internet that have fewer hops between the mobile device and a backhaul access point; and providing a theme park mobile application that uses said communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing a user deployable access point that connects to the network; and providing a theme park mobile application that uses said access point.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing at least one base station controller function in at least one subscriber device, the base station controller function including at least one of an air interface management function, a signaling function, a concentration logic function, and a signal propagation function; and providing a theme park mobile application employing the at least one base state controller functions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing service provider tools to manage resource consumption of at least one device on the ad hoc network, wherein the tools are deployed on at least one of the plurality of mobile devices and use at least one management path for reporting usage of the at least one device; and providing a theme park mobile application for which the management path is used to report usage of the application.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing full radio resource management functions in at least one device, the radio resource management functions including at least one of radio management, handover, handoff, and foreign device cooperation functions, wherein the at least one device is a subscriber device; and providing a theme park mobile application operating responsively to a state of a managed radio resource.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multi-session functions in at least one of the plurality of devices, wherein the at least one device is a subscriber device; and providing a theme park mobile application communicating via multiple sessions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing cost-based routing functions in the network through dynamic forming and reforming of links and routes, wherein the cost-based routing functions are provided in a plurality of subscriber devices; and providing a theme park mobile application that uses the cost-based routing functions to deliver a desired balance of cost and quality of service.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP router functions at individual mobile devices of the network, wherein the individual mobile devices are subscriber devices; and providing a theme park mobile application that uses the IP router functions to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing, in at least one of the plurality of mobile devices, media access control layer capabilities including sub-network layer convergence functions selected from a list consisting of segmentation and reassembly, quality of service, throughput fairness, adaptive data rate control, and transmit power control, wherein the at least one mobile device is a subscriber device; and providing a theme park mobile application that uses the MAC layer to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing route diversity within the network to facilitate assurance of packet communication, wherein route diversity is based at least on a number of network devices in a geographic area; and providing a theme park mobile application that uses the route diversity to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; allowing layer 2 forwarding among at least some of the plurality of mobile devices; and providing a theme park mobile application that communicates via the layer 2 forwarding.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing the routable internet to a node in the network, wherein the node also communicates with a cellular network through at least one of the fixed infrastructure elements and the routable internet is provided outside the cellular network; and providing a theme park mobile application that communicates both through the cellular network and the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP application deployment to a device in the network, wherein the device also communicates with a cellular network through at least one of the fixed infrastructure elements and the IP application is deployed outside the cellular network; and providing a theme park mobile application that is deployed over IP and that communicates via the cellular network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network; and providing a theme park mobile application that communicates via the data packets.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network absent communications with the fixed infrastructure elements; and providing a theme park mobile application that communicates solely within the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/sec during normal operation; and providing a theme park mobile application that uses the communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/set when the nodes are in motion at vehicular speeds; and providing a theme park mobile application that uses the communications.

In an aspect of the invention, methods and systems include providing a mobile, broadband, routable internet, in which a plurality of mobile devices interact as nodes in a mobile ad hoc network and in which packets are IP routable to each of mobile devices of fixed infrastructure elements; and providing a theme park mobile application that communicates via the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; applying swarm intelligence to determine at least some parts of at least some routes through the mobile, broadband, routable internet; and providing a theme park mobile application that communicates via the mobile ad hoc network.

In an aspect of the invention, methods and systems include providing a mobile, broadband, routable internet, in which a plurality of mobile devices interact as sending and receiving nodes in a mobile ad hoc network and in which packets are IP routable to the individual devices independent of fixed infrastructure elements; providing routing priority within the network, wherein the routing priority is provided by granting channel access to a node for which prioritized routing is identified and sending delay-sensitive data from the node before sending delay-tolerant data from the node; and providing a quality of service mobile application that uses the routing priority to manage routing of data within the mobile, broadband, routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing support for peer-to-peer traffic within the network; and providing a quality of service mobile application that provides fixed-network-independent capacity and service delivery by utilizing the peer-to-peer traffic network support.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer to peer connectivity within the mobile broadband routable internet; and providing a quality of service mobile application that uses the peer to peer connectivity to facilitate mobile, fixed-infrastructure-independent, peer-to-peer application connection among at least a subset of the plurality of mobile devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing file sharing over the mobile broadband routable internet; and providing a quality of service mobile application that uses file sharing without degrading system performance.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing user-generated applications over the mobile broadband routable internet; and providing a quality of service mobile application associated with the mobile broadband routable internet, wherein the yyyy mobile application includes a user-generated application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing peer-to-peer applications over the mobile broadband routable internet; and providing a quality of service mobile application that uses peer-to-peer applications without degrading performance of the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing direct device-to-device peering with symmetrical throughput between at least two nodes of the mobile broadband routable internet; and providing a quality of service mobile application co-operating on the at least two nodes, wherein the yyyy mobile application utilizes the symmetrical throughput between the at least two nodes.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; facilitating direct-to-device application deployment over the mobile broadband routable internet; and providing a quality of service mobile application that is deployed directly to a device in the mobile broadband routable internet using direct-to-device application deployment.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing data among a plurality of mobile broadband routable internet devices; and providing a quality of service mobile application, wherein the mobile application uses the facility to access distributed data that is associated with the yyyy mobile application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for distributing application components among a plurality of mobile broadband routable internet devices; and providing a quality of service mobile application, components of which are distributed by the facility.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multicast routing within the network by allowing a data object to be transmitted by a device to a plurality of destinations over a plurality of routes; and providing a quality of service mobile application that uses the multicast routing to at least distribute application-related updates.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote monitoring through the network; and providing a quality of service mobile application that facilitates remote monitoring over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote control over the network; and providing a quality of service mobile application that facilitates remote control over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing remote upgrade of at least one of software and services associated with the network; and providing a quality of service mobile application that uses the remote upgrade to maintain a portion of the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an adaptive transmit power control facility for a device within the network, the adaptive transmit power control facility adapted to adjust transmission power of the device based on at least one of the density of proximate devices in the network, the condition of a neighboring device on the network, a channel condition of the network, a service level condition, a network performance condition, an environmental condition of the device and an application requirement of the device; and providing a quality of service mobile application that uses adaptive transmit power control to adapt the transmit power associated with the application based on at least a density of devices.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing forwarding error correction on at least long IP packets; and providing a quality of service mobile application that is enabled at least in part by utilizing forwarding error correction on the mobile broadband routable internet.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing a facility for enabling adaptation of the data rate provided for links among devices within the network, the adaptation based on at least one of the density of devices in the network, the condition neighboring devices in the network, a channel condition of the network, a service level condition, a network performance condition, an environmental condition and an application requirement; and providing a quality of service mobile application that adapts application related data transmission and receiving parameters based on the adaptive link data rates within the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing dynamic spectrum access capabilities within the network by determining communication spectrum quality and adjusting use of time frequency rectangles within the communication spectrum based on the determination; and providing a quality of service mobile application that uses the dynamic spectrum access capabilities to provide enhanced use of spectral bandwidth.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; communicating among the plurality of devices over a radio communication spectrum and reusing portions of the spectrum for communication based on availability of time frequency rectangles within portions of the spectrum; and providing a quality of service mobile application that reuses spectrum allocated for at least one other application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; and communicating wirelessly among at least a portion of the plurality of mobile devices, wherein the at least a portion of the plurality of mobile devices communicate independent of which radio frequency is used for the wireless communication; and wherein a quality of service mobile application operating on at least two of the mobile devices exchanges information over the mobile broadband routable internet independent of the radio frequency.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing geo-location coding of device nodes in the network, wherein geo-location is based at least in part on a network location of a device node relative to other devices in the network; and providing a quality of service mobile application that uses geo-location of device nodes in the network to facilitate at least one location-based service.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing multimedia support within the network through a hybrid frame structure that includes variable slot duration and sub-channelization of bandwidth; and providing a quality of service mobile application that uses multimedia support to provide yyyy related multimedia services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing time synchronization among nodes of the network, wherein the time synchronization is provided by communicating a representation of network timing at all the nodes with sufficient accuracy to enable reliable communications; and providing a quality of service mobile application that uses network node time synchronization in delivery of the application services to device nodes in the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing seamless outdoor and indoor operation over the network; and providing a quality of service mobile application takes advantage of the seamless outdoor and indoor operation to deliver services over the network.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing fixed radio installations that facilitate connection of the plurality of mobile devices, wherein the fixed radio installations are based at least in part on meeting a criteria associated with network radio propagation and performance; and providing a quality of service mobile application that uses the fixed radio installation for backhaul communication associated with the application.

In an aspect of the invention, methods and systems include providing a mobile, broadband, routable internet, in which a plurality of mobile devices interact as nodes in a mobile ad hoc network and in which packets are IP routable to the individual device independent of fixed infrastructure elements; providing an IP-compatible plug connection to at least one wired infrastructure type; and providing a quality of service mobile application that uses the connection.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multiple fixed-network gateway interfaces connecting the mobile ad hoc network to a fixed network; and providing a quality of service mobile application that communicates between a mobile device and a device on the fixed network.

In an aspect of the invention, methods and systems may include providing a mobile, broadband, routable internet, in which a plurality of mobile devices interact as nodes in a mobile ad hoc network and in which packets are IP routable to each of the devices independent of fixed infrastructure elements; providing an automated network design tool to facilitate low cost and fast network design engineering and deployment planning of the fixed infrastructure elements of the network; and deploying a quality of service mobile application configured to use the networked designed by the design tool.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; deploying a plurality of low cost mesh access points to provide network coverage in a geography; and providing a quality of service mobile application that communicates at least in part via the mesh access points.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing small form factor nodes that allow for low cost and fast capacity expansion and network upgrade; and providing a quality of service mobile application that communicates at least in part via the small form factor nodes.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing communications between a mobile device and a device on a remote network so as to substantially favor routes through the mobile, broadband, routable Internet that have fewer hops between the mobile device and a backhaul access point; and providing a quality of service mobile application that uses said communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing a user deployable access point that connects to the network; and providing a quality of service mobile application that uses said access point.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing at least one base station controller function in at least one subscriber device, the base station controller function including at least one of an air interface management function, a signaling function, a concentration logic function, and a signal propagation function; and providing a quality of service mobile application employing the at least one base state controller functions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing service provider tools to manage resource consumption of at least one device on the ad hoc network, wherein the tools are deployed on at least one of the plurality of mobile devices and use at least one management path for reporting usage of the at least one device; and providing a quality of service mobile application for which the management path is used to report usage of the application.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing full radio resource management functions in at least one device, the radio resource management functions including at least one of radio management, handover, handoff, and foreign device cooperation functions, wherein the at least one device is a subscriber device; and providing a quality of service mobile application operating responsively to a state of a managed radio resource.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing multi-session functions in at least one of the plurality of devices, wherein the at least one device is a subscriber device; and providing a quality of service mobile application communicating via multiple sessions.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing cost-based routing functions in the network through dynamic forming and reforming of links and routes, wherein the cost-based routing functions are provided in a plurality of subscriber devices; and providing a quality of service mobile application that uses the cost-based routing functions to deliver a desired balance of cost and quality of service.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP router functions at individual mobile devices of the network, wherein the individual mobile devices are subscriber devices; and providing a quality of service mobile application that uses the IP router functions to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing, in at least one of the plurality of mobile devices, media access control layer capabilities including sub-network layer convergence functions selected from a list consisting of segmentation and reassembly, quality of service, throughput fairness, adaptive data rate control, and transmit power control, wherein the at least one mobile device is a subscriber device; and providing a quality of service mobile application that uses the MAC layer to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing route diversity within the network to facilitate assurance of packet communication, wherein route diversity is based at least on a number of network devices in a geographic area; and providing a quality of service mobile application that uses the route diversity to communicate via the ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; allowing layer 2 forwarding among at least some of the plurality of mobile devices; and providing a quality of service mobile application that communicates via the layer 2 forwarding.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing the routable internet to a node in the network, wherein the node also communicates with a cellular network through at least one of the fixed infrastructure elements and the routable internet is provided outside the cellular network; and providing a quality of service mobile application that communicates both through the cellular network and the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; providing IP application deployment to a device in the network, wherein the device also communicates with a cellular network through at least one of the fixed infrastructure elements and the IP application is deployed outside the cellular network; and providing a quality of service mobile application that is deployed over IP and that communicates via the cellular network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network; and providing a quality of service mobile application that communicates via the data packets.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; routing data packets through the mobile ad hoc network absent communications with the fixed infrastructure elements; and providing a quality of service mobile application that communicates solely within the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/sec during normal operation; and providing a quality of service mobile application that uses the communications.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements, communications to the nodes having a throughput of at least 768 kbit/set when the nodes are in motion at vehicular speeds; and providing a quality of service mobile application that uses the communications.

In an aspect of the invention, methods and systems include providing a mobile, broadband, routable internet, in which a plurality of mobile devices interact as nodes in a mobile ad hoc network and in which packets are IP routable to each of mobile devices of fixed infrastructure elements; and providing a quality of service mobile application that communicates via the mobile ad hoc network.

In an aspect of the invention, methods and systems include providing a mobile, broadband, routable internet, in which a plurality of mobile devices interact as nodes in a mobile ad hoc network and in which packets are IP routable to each of the devices independent of fixed infrastructure elements; applying swarm intelligence to determine at least some parts of at least some routes through the mobile, broadband, routable internet; and providing a quality of service mobile application that communicates via the mobile ad hoc network.

### BRIEF DESCRIPTION OF THE FIGURES

The invention and the following detailed description of certain embodiments thereof may be understood by reference to the following figures:

FIGS. 1A and 1B depict an embodiment of a mobile ad-hoc wireless network according to an embodiment of the present invention.

FIGS. 2A and 2B depict an embodiment of a wireless mesh network according to an embodiment of the present invention.

FIG. 3 depicts an embodiment of a wireless network with access points back to the fixed Internet.

FIG. 4 depicts an embodiment of a wireless network showing multiple pathways from a particular mobile network node to the fixed Internet.

FIG. 5 depicts an embodiment of the MBRI stack showing layers from device down to physical layer.

FIG. 6 depicts an embodiment of the MBRI stack showing the addition of DYSAN capabilities.

FIG. 7 depicts an embodiment of the use of dynamic spectrum access technology to wireless communication according to an embodiment of the present invention.

FIG. 8 depicts an embodiment of the mobile ad-hoc wireless network using dynamic spectrum access technology according to an embodiment of the present invention.

FIG. 9 depicts an embodiment of DYSAN spectrum aware routing.

FIG. 10 depicts an embodiment for providing prioritization of delay-sensitive traffic across the network protocol stack in a mobile ad-hoc wireless network according to an embodiment of the present invention.

FIG. 11 depicts a graphical representative embodiment for providing network support for peer-to peer traffic in a MANET according to an embodiment of the present invention.

FIG. 12 depicts an embodiment for providing a peer-to-peer routing between nodes in a MANET.

FIG. 13 depicts an embodiment for providing multiple fixed network gateway interfaces in a mobile ad-hoc wireless according to an embodiment of the present invention.

FIG. 14 depicts an embodiment for providing multicast routing in a mobile ad-hoc wireless according to an embodiment of the present invention.

FIG. 15 depicts an embodiment representation of a receiver oriented multicast.

FIG. 16 depicts an embodiment representation of a receiver oriented multicast with multiple mode queues.

FIG. 17 depicts an embodiment of basic peer-to-peer communications including internet access.

FIG. 18 depicts an embodiment of a node to node multicast routing configuration.

FIG. 19 depicts an embodiment of various multicast routing paths through the MBRI network.

FIG. 20 depicts an embodiment for providing remote network monitoring, control and upgrade in a mobile ad-hoc wireless network according to an embodiment of the present invention.

FIG. 21 depicts an embodiment of sample network topology for adaptive transmit power control.

FIG. 22 depicts an embodiment of a one-hop and two-hop neighborhood adaptive transmit power control configuration.

FIG. 23 depicts a second embodiment of a one-hop and two-hop neighborhood adaptive transmit power control configuration.

FIG. 24 depicts an embodiment for providing adaptive transmit power control in a mobile ad-hoc wireless network according to an embodiment of the present invention.

FIG. 25 depicts an embodiment of adaptive transmit power control showing the overlap of two-hop neighborhoods of two nodes when operating full power.

FIG. 26 depicts an embodiment of adaptive transmit power control showing the overlap of two-hop neighborhoods of two nodes when operating a 10 dB below full power.

FIG. 27 depicts an embodiment of adaptive transmit power control showing the overlap of two-hop neighborhoods of two nodes when operating a 20 dB below full power

FIG. 28 depicts an embodiment for providing adaptive link data rate in a mobile ad-hoc wireless network according to an embodiment of the present invention.

FIG. 29 depicts an embodiment for adaptive link data rate where the waveform mode of each link may be determined independently.

FIG. 30 depicts an embodiment for providing location information of network nodes to neighboring nodes in a mobile ad-hoc wireless network according to an embodiment of the present invention.

FIG. 31 depicts an embodiment of different time slot widths in relation to a multimedia data stream.

FIG. 32 depicts an embodiment of a hybrid slot structure in relation to the transmission of a diversity of media streams.

FIG. 33 depicts a mobile ad-hoc wireless network embodiment of the present invention for implementing for time synchronization.

FIG. 34 depicts a mobile ad-hoc wireless network embodiment of the present invention for implementing for time synchronization, where some of the communications between nodes are illustrated.

FIGS. 35 through 35H depict an embodiment of a time synchronization algorithm.

FIG. 36 depicts an embodiment of radio resource management in a subscriber device.

FIG. 37 depicts an embodiment of a multi-session enabled subscriber device.

FIG. 38 depicts an embodiment of a subscriber device with enhanced performance.

FIG. 39 depicts an embodiment of a fully enabled IP router in a subscriber device.

FIG. 40 depicts an embodiment of a subscriber device with enhanced power control, such as a whisper mode.

FIG. 41 depicts an embodiment of a subscriber device with enhanced adaptive data rate capabilities.

FIG. 42 depicts an embodiment of how nodes may communicate in association with adaptive data link rate.

FIG. 43 depicts an embodiment of a route cost function.

FIG. 44 depicts an embodiment of a least cost routing function.

FIG. 45 depicts an embodiment of quality of service priority queuing.

FIG. 46 depicts an embodiment of quality of service de-queuing order to maintain quality of service using strict priority de-queuing discipline.

FIG. 47 depicts an embodiment of quality of service priority channel access.

FIG. 48 depicts an embodiment of quality of service priority-based routing.

FIG. 49 depicts an embodiment of quality of service priority-based differentiated quality of service.

FIG. 50 depicts an embodiment of local IP-based swarming

FIG. 51 depicts an embodiment of the MBRI layered stack.

FIG. 52 depicts an embodiment of SLSR link cost based routing domain concept.

FIG. 53 depicts an embodiment of SLSR link cost based routing protocol with extra information.

FIG. 54 depicts an embodiment of SLSR link cost based routing different topology based on different criteria.

FIG. 55 depicts an embodiment of distributed data and applications within MBRI.

FIG. 56 depicts an embodiment of a local mobile application, with all data links shown.

FIG. 57 depicts an embodiment of a local mobile application, with the mobile based application shown common to all four subscriber devices.

FIG. 58 depicts an embodiment for admission control MANET to Internet data flow.

FIG. 59 depicts an embodiment for admission control MANET data flow.

FIG. 60 depicts an embodiment for admission control data flow across different BAP domains.

FIG. 61 depicts an embodiment for admission control messages for admission control.

FIG. 62 depicts an embodiment of a layer 3 fast pipe handling of data flows through layer 3.

FIG. 63 depicts an embodiment for forward error correction associated with multi-layer FEC encoding of IP packets for transmission over a wireless link.

FIG. 64 depicts an embodiment for forward error correction associated with burst errors upon reception.

FIG. 65 depicts an embodiment for forward error correction associated with packet length.

FIG. 66 depicts an embodiment for proactive router handoff.

FIG. 67 depicts an embodiment for proactive router handoff showing a preferred route associated with a first BAP encountered.

FIG. 68 depicts an embodiment for proactive router handoff showing a preferred route associated with a second BAP encountered.

FIG. 69 depicts an embodiment for vehicular mobility.

FIG. 70 depicts an embodiment for logic associated with layer 3 fast pipe handling payload data.

FIG. 71 depicts an embodiment for layer 2 forwarding.

FIG. 72 depicts an embodiment for layer 2 forwarding associated with forwarding a table update from a router.

FIG. 73 depicts an embodiment of a header table for layer 2 forwarding.

FIG. 74 depicts an embodiment for segmentation and reassembly associated with transmission across multiple TDMA time slots.

FIG. 75 depicts an embodiment for segmentation and reassembly associated with reassembly of received segments into the original IP packet.

FIG. 76 depicts an embodiment for Multi-channel for MAC associated with TDMA time slot structure.

FIG. 77 depicts an embodiment for Multi-channel for MAC associated with scheduling of sub-channels.

FIG. 78 depicts an embodiment associated with MBRI being Web 2.0 capable.

FIG. 79 depicts a first embodiment for seamless indoor/outdoor broadband coverage.

FIG. 80 depicts a second embodiment for seamless indoor/outdoor broadband coverage.

FIG. 81 depicts a third embodiment for seamless indoor/outdoor broadband coverage, showing the node topology.

FIG. 82 depicts mobile applications enabled on an mobile broadband routable internet.

### DETAILED DESCRIPTION

The features of the present invention, which are believed to be novel, are set forth with particularity in the appended claims. The invention may best be understood by reference to the following description, taken in conjunction with the accompanying drawings.

While the specification concludes with the claims defining the features of the invention that are regarded as novel, it is believed that the invention will be better understood from a consideration of the following description in conjunction with the drawings figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an”, as used herein, are defied as one or more than one. The term “another”, as used herein, is defined as at least a second or more. The terms “including” and/or “having” as used herein, are defined as comprising (i.e. open transition). The term “coupled” or “operatively coupled” as used herein, is defined as connected, although not necessarily directly, and not necessarily mechanically.

The present disclosure provides a mobile broadband routable internet (MBRI) for providing carrier-grade, networked, broadband, IP-routable communication among a plurality of mobile devices, where the mobile devices may represent a plurality of nodes that are linked together through a mobile ad-hoc network (MANET). Mobile devices, also referred to herein where context permits as subscriber devices, may operate as peers in a peer-to-peer network, with full IP routing capabilities enabled within each subscriber device, thereby allowing routing of IP-based traffic, including deployment of applications, to the subscriber device without need for infrastructure conventionally required for mobile ad hoc networks, such as cellular telephony infrastructure. Full IP-routing to subscriber devices allows seamless integration to the fixed Internet, such as through fixed or mobile access points, such as for backhaul purposes. Thus, the MBRI may function as a standalone mobile Internet, without connection to the fixed Internet, or as an IP-routable extension of another network, whether it be the Internet, a local area network, a wide area network, a cellular network, a personal area network, or some other type of network that is capable of integration with an IP-based network. The capabilities that enable the MBRI are disclosed herein, such capabilities including the software, technology components and processes for physical layer, MAC layer, and routing layer capabilities that allow all IP-based traffic types and applications to use the MBRI, embodied across a set of mobile devices, as if it were an 802.1 through 802.3 compliant fixed network, without reliance on, or intervention by, fixed network infrastructure components such as application-specific Internet servers or cellular infrastructure components.

In contrast to existing wireless and fixed wired access networks, MBRI may provide a solution where every subscriber device and infrastructure node may have routing capabilities to allow for intelligent routing decisions, enabling intra-network peer to peer communications. Traffic between nodes of the MBRI may not need to leave the MANET network for routing or switching purposes. Instead, because MBRI is routing enabled, local traffic including required signaling may stay within the MBRI. In addition, because of its neighbor discovery management, adaptive data rate power management, and the like capabilities as described further herein, the MBRI may enable local intelligence to be shared across its member nodes, leading to the creation and deployment of new classes of services and applications. Further, because of its MANET characteristic the MBRI may be independent of fixed traffic aggregation points such as base stations or cell towers, and instead may leverage multiple backhaul access points in a load leveling and self-healing manner. Because of the MANET waveform characteristics and the MANET architectural flexibility to deploy additional backhaul access points (BAP) or to upgrade existing MANET Access Points with backhaul capability, the MBRI may better assure broadband bandwidth to the individual nodes, such as in excess of conventional 3G/4G networks. Further, if combined with dynamic spectrum access (DYSAN) technology the MBRI may coexist within existing defined spectrum with associated active network operations.

In embodiments, the MBRI may be implemented in a plurality of configurations, such as an MBRI basic configuration including the MANET protocol stack that may bring Internet access and routing capability to a subscriber device; an MBRI enhanced configuration that takes the MBRI basic configuration and combines it with selected media transport enhancements, such as to improve multimedia transport of the MBRI network; an MBRI comprehensive configuration that may consist of a the MBRI basic configuration with transport enhancements targeted at high quality service, such as for multimedia, multi-session applications, and the like; an MBRI comprehensive configuration with dynamic spectrum awareness, which may consist of enhancements to the MANET protocol stack to allow for spectrum co-sharing between non-cooperative spectrum users or dissimilar spectrum technologies, and coordination between cooperative systems; and the like.

In embodiments, the MBRI basic configuration may include a plurality of capabilities, such as ad-hoc network creation and self forming, self healing, load leveling, packet size indifference, unicast, routing enabled, peer-to-peer communications, mobility, broadband, Internet protocol plug compatible, neighbor aware, geo location, radio resource management, openness for Java web applications, enablement for private and public networks, security, spectrum independence, scalability (e.g., for bandwidth, backhaul, users, and the like), structured or unstructured network architecture, different levels of network spanning, waveform variants (e.g., such as slotted/half duplex, synchronization on each slot separately, and the like), multi-session capability, and the like.

In embodiments, the MBRI enhanced configuration may include MBRI basic capabilities, plus a plurality of enhancements, such as adaptive data rate (ADR), quality of service (QoS), flexible transport (such as for both sensitive and delay tolerant traffic, sub-queues, traffic based scheduling, optimized short/medium/large packet support, and the like), scoped link state routing (SLSR) link cost based routing, SLSR domain management, multicasting, layer 2 forwarding, layer 3 fast pipe, segmentation and reassembly (SAR), hybrid slot structure, multi-channel MAC, adaptive power control (APC), distributed data for web applications in an MBRI device, local intelligence (such as through caching, local content and services, and the like), distributed applications, vehicular mobility vector based routing, sleep mode, assured bandwidth, admission control, traffic policing, traffic shaping (such as per flow, per node, per MAP, per BAP, and the like), automatic retransmission request (ARQ), forward error correction (FEC) on long IP packets, proactive router handoff, and the like.

In embodiments, mobile devices, and other hardware devices, may be enabled by MBRI, such as chips, chip sets, a personal computer manufacturer interface adaptor (PCMIA) card, network components, a personal portal (e.g., a chip that may go in any device), an ASIC, and the like. In embodiments the MBRI may be provided connectivity to fixed communication facilities through a backhaul access point (BAP). In addition, connections from the MBRI network to the BAP may be made through a MANET or mesh access point (MAP), a customer access point (CAP), and the like. In addition, the BAP may attach to a fiber access point (FAP), and the like, In embodiments, a BAP may be a network access point with wire-line backhaul capabilities, such as via fiber, wired, microwave, and the like; a MAP may be a network access point with wireless relay capabilities, such as to a BAP; a CAP may be a customer device with mains power and capable of connecting to a BAP; and the like. In embodiments, the MBRI may provide significant advantages over current mobile network systems, where MBRI capabilities, MBRI enabled devices, and MBRI access point facilities may enable improved performance and quality of service to users.

In embodiments, the use of CAPs may provide for a more robust MBRI system, where a CAP may be owned by a customer but remains an integral part of the MANET network. The CAP may allow ‘hopping’ of other network traffic through it, and thus providing additional route diversity for network traffic. This system of CAPS may extend the network coverage into new areas and also enable new traffic routes that can avoid occlusions and provide additional route diversity security. The CAP may contain a MANET radio, power supply, antennae, power outlet, and the like. In embodiments, the CAP may be an indoor unit and thus provide coverage in the customer premises as well as access to other MANET radios. By utilizing a customer-owned device for a CAP, the cost of deploying a network for the network builder may be reduced at the same time as the coverage is extended to places where the customer particularly wants coverage. In embodiments, the CAP may be self-installed by the customer, self-configured to operate on a MANET network, act as a node on the network by allowing network traffic from other sources to ‘hop’ through the CAP, provide greater network coverage and route diversity that improves quality of service, and the like.

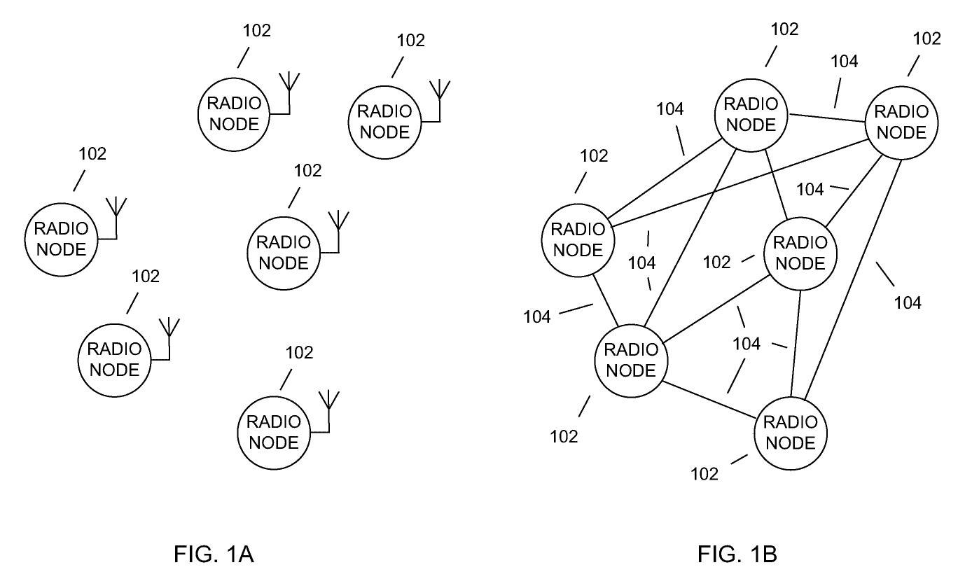

FIG. 1 illustrates a mobile ad-hoc wireless network according to an embodiment of the present invention. As shown in FIG. 1, the wireless network may have a set of wireless devices capable of communicating wirelessly. Each wireless device may be termed as a node. A node may communicate with any other node, and links may be formed between nodes. The mobile ad-hoc network may include nodes that are mobile, as well as nodes that are fixed. In embodiments, the fixed nodes may enable the creating of a spanning network to establish initial wireless coverage across a geographic area. In addition, a subset of these nodes may have connectivity to a fixed (i.e., wired) network. In a mobile ad-hoc wireless network, routing through the network may find the ‘best’ path to destination including ‘multi-hop’ relay across multiple wireless nodes. The wireless network may be capable of autonomously forming and re-forming links and routes through the network. This dynamic forming and re-forming of links and routes may be made to adjust to changing conditions resulting from node mobility, environmental conditions, traffic loading, and the like. Thus, mobile ad-hoc wireless network's wireless topology may change rapidly and unpredictably.

Establishing a quality of service may be an essential quality for the mobile ad-hoc wireless network. In embodiments, quality of service for a mobile ad-hoc wireless network may be measured in terms of the amount of data which the network successfully transfers from one place to another over a period of time. Currently used mobile ad-hoc networks may have a number of issues with respect to network quality of service, such as application routing-focused communication without the ability to provide service-level agreements for quality-of-service, providing only unicast services, link-focused power control, providing a single data rate only, providing contention-based access (e.g., focus on inefficient unlicensed band radios), focused on military or public safety applications, congestion and dynamic and unpredictable latency (especially with multi-hop scenarios), and the like. In embodiments the present invention may provide for a mobile ad-hoc network that significantly improves on the shortcomings of current systems.

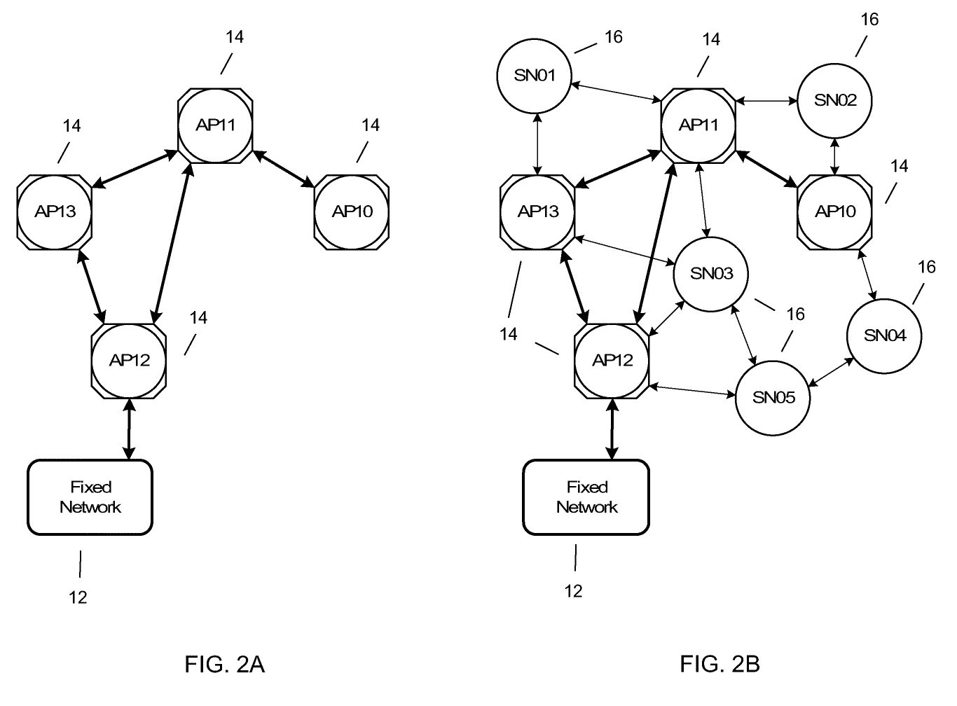

FIG. 2 illustrates a wireless mesh network according to an embodiment of the present invention. As shown in FIG. 2, the wireless mesh network may be a type of wireless ad-hoc network which allows multi-hop routing. A wireless mesh network architecture may sustain communications by breaking long distances into a series of shorter hops. The wireless mesh network may have a subset of nodes designated as access points to form a spanning network to establish initial wireless network coverage across a geographical area. In an embodiment, one or more access points may have a connection interface to a fixed network. In embodiments, the fixed network that the access points connect to may be any known fixed network, such as the Internet, a LAN, a WAN, a cell network, and the like. As shown, a subset of nodes may be designated as ‘subscriber nodes’ that may form links among themselves and to the spanning network to augment wireless coverage. This may allow nodes connectivity to the fixed network via multiple hops across wireless topology. This topology may also change with node mobility. In embodiments, a wireless mesh network may be termed as a mobile ad-hoc network if the nodes in a wireless mesh network are mobile.

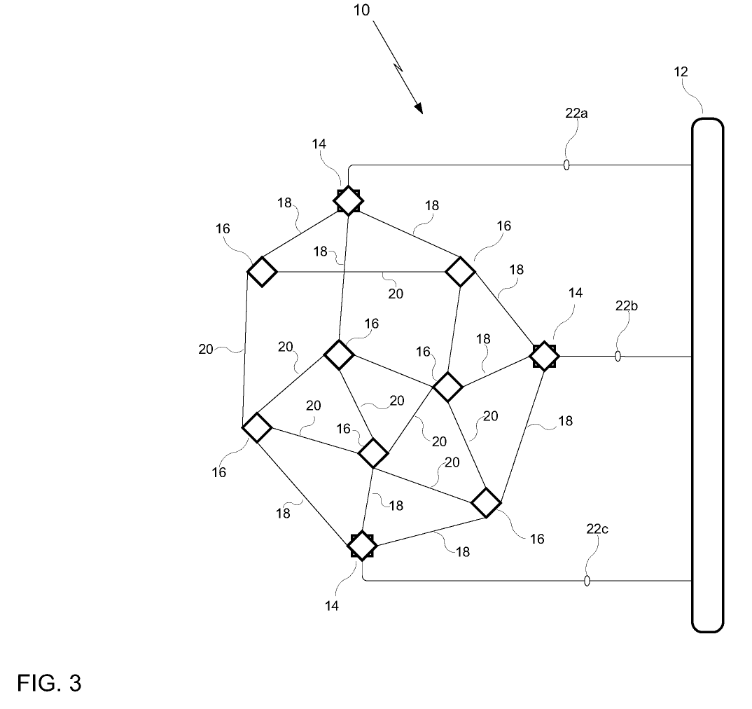

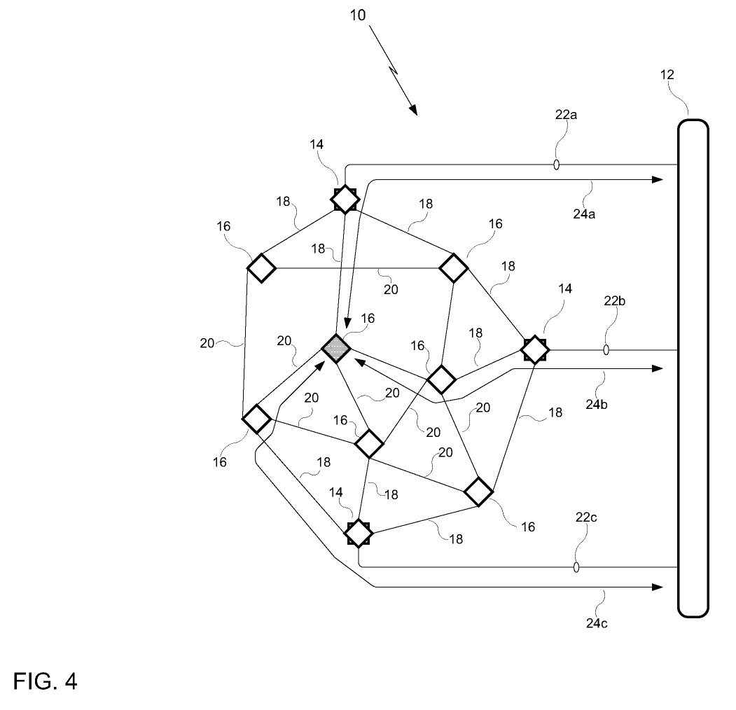

FIG. 3 depicts a mobile ad-hoc network with backhaul to a fixed network. Here, the mobile ad-hoc network is shown to include a plurality of mobile nodes 16, a plurality of fixed nodes 14, a plurality of access points 14, a plurality of mobile node to fixed node links 18, a plurality of mobile node to mobile node links 20, the fixed network 12, and a plurality of fixed node to fixed network links 22a-c. In embodiments, the fixed nodes 14 may provide network structure, such as to provide a spanning network that enables the establishment of the ad-hoc network, as well as connectivity to the fixed network. Mobile nodes 16 may then establish links 18 to both fixed nodes 14 and to other mobile nodes 20, where all of the nodes 14,16 and links 18, 20 establish the mobile ad-hoc network with links 22a-c to the fixed network 12. FIG. 4 illustrates three example network pathway routings 24a-c for a mobile node 16 establishing connectivity to the fixed network 12, including a link combination 24a from the fixed network 12 to a fixed node 14 and then to the destination mobile node 16, a link combination 22b to a fixed node 14 through an intermediate mobile node 16 and then to the destination mobile node, and an alternate link combination 22c to a fixed node 14 through an intermediate mobile node 16 and then to the destination mobile node. In embodiments, the link combinations may include any number of mobile nodes 16, fixed nodes 14, subscriber nodes, access points, and the like.

In embodiments, the mobile ad-hoc network may also provide a plurality of network services and attributes, such as autonomous neighbor discovery and maintenance, distributed network timing reference dissemination, dynamic frame structure, distributed scheduling with dynamic selection of scheduling algorithms (e.g., such as based on network topology, traffic load, spectrum availability), link-by-link autonomous data rate selection, traffic differentiation across the protocol stack (e.g. priority queuing and priority channel access), ARQ automatic repeat and request capability, geo-location capability for E-911 and location-based services, power control for intra-network interference management and spectrum reuse, unicast and multicast routing, interfacing in a standard way to existing IP core network nodes, encryption and authentication, OSS with EMS and NMS, and the like.

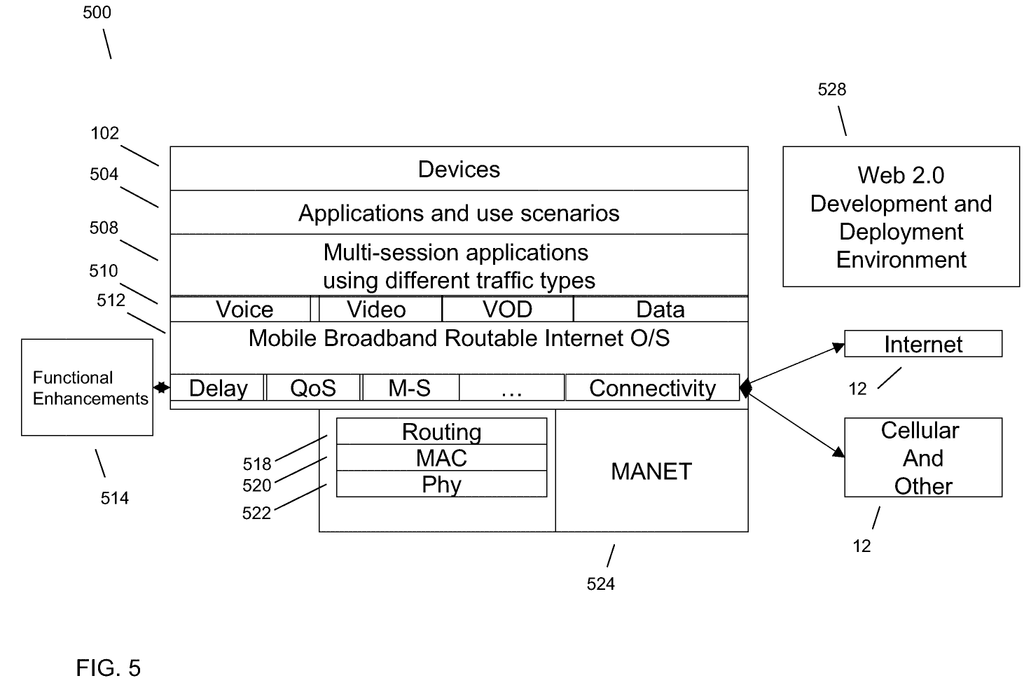

FIG. 5 depicts the MBRI as a hierarchical stack. At the top of the MBRI stack are the devices, including mobile subscriber devices (SD), fixed node communication devices, access points, and the like. The next two layers down represent applications and use scenarios, and multi-session applications using different traffic types, which may be utilized or executed by the devices in conjunction with the MBRI. Continuing down to the next layer, are data applications that may be carried across the MBRI, including data, voice, video, video on demand (VOD), and the like. Next, the MBRI stack shows a representative subset of the MBRI functional enhancements, as described herein, which may be provided as optional elements in the MBRI system. The MBRI thus far, may then be enabled from the stack elements below, including a core stack of routing, MAC, and physical layers, as shown in the middle, which may provide fixed Internet equivalency in a mobile network. In addition, connectivity is also shown to other communication facilities, such as the fixed networks as described herein. In embodiments, the MBRI may be built up from various combinations and sub-combinations of the various components of the MBRI stack, which may enable various applications, devices, and the like, the ability to deploy applications directly to the device. In embodiments, the MBRI stack may provide a solution with high quality of service transport for multi-session applications, replicate functions that may be effectively analogous to the foundation standards of the IETF defined internet within the mobility sector, enable functions analogous to each of the functions in the IETF 802.1-3 fixed Internet stack, and the like. In embodiments, the MBRI may represent a mobile ad-hoc network with true Internet routing capability.

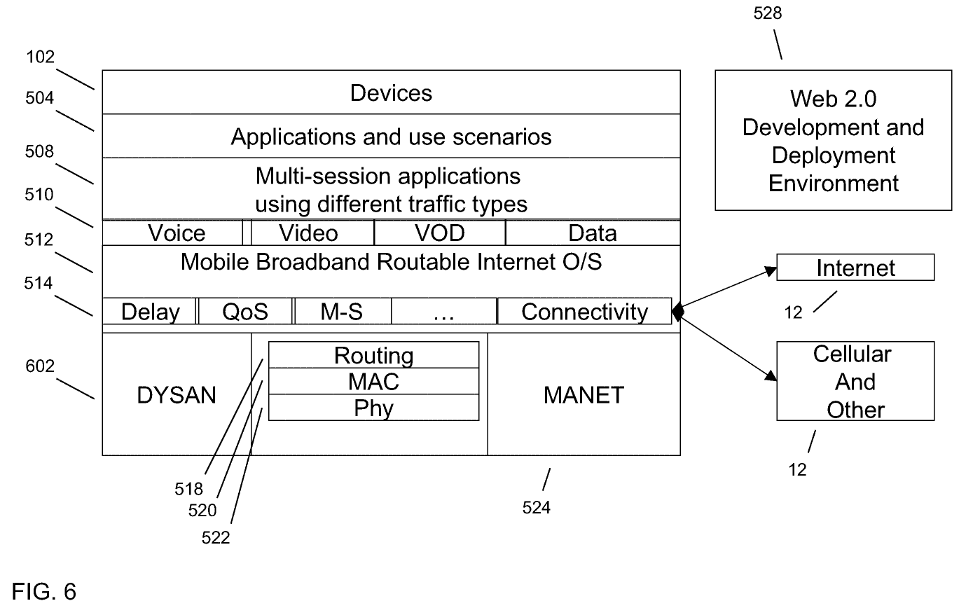

FIG. 6 shows the MBRI stack as introduced in FIG. 5, but with dynamic spectrum access (DYSAN) added as an option. Currently dynamic spectrum access technologies may be focused on limited aspects of network performance, such as on TV bands, finding spectrum for the whole network, trying to avoid interference through power control, and the like. Dynamic spectrum access, as a part of MBRI may provide spectrum used to communicate wirelessly between nodes changes in a non-pre-determined manner in response to changing network and spectrum conditions. In embodiments, the time scale of dynamics may be typically less than can be supported by engineering analysis, network re-planning, optimization, and the like. For instance, in response to manual or automated decisions, where there may be centralized decisions (e.g., network partitioning) or distributed local decisions of the individual nodes. Dynamic spectrum access may be able to avoid interference to/from geographically proximate spectrum users internal or external to their own wireless network. Dynamic spectrum access may also be able to access and utilize spectrum otherwise unavailable for wireless network use. In embodiments, local spectrum decisions may be coordinated and/or communicated using a fixed or logical control channel in an over-the-air wireless network.

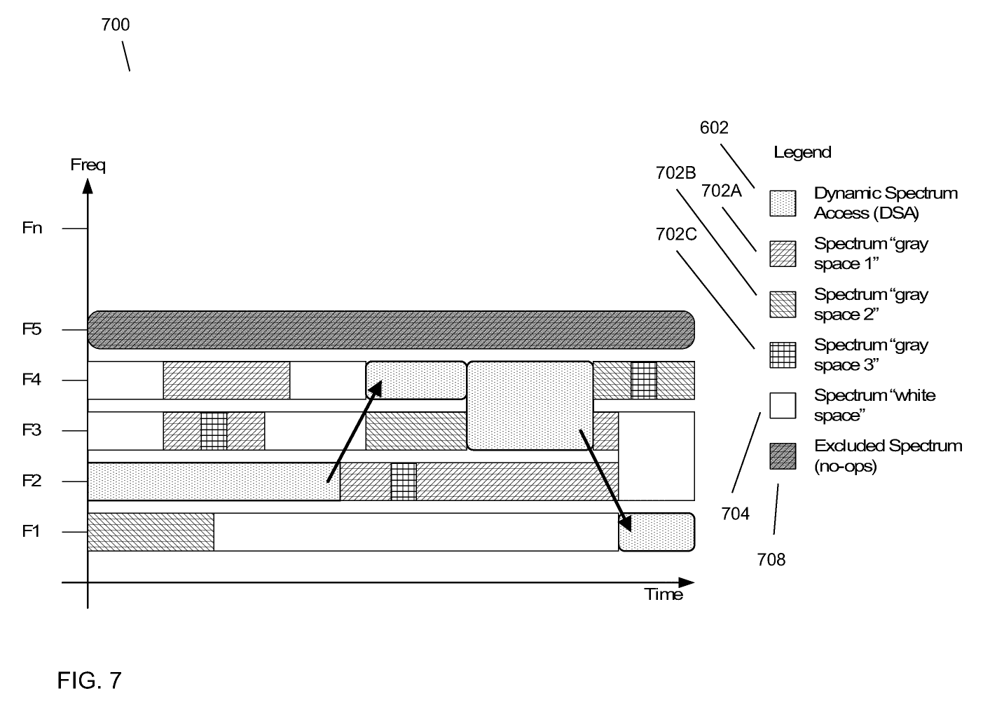

FIG. 7 illustrates the use of dynamic spectrum access technology to wireless communication according to an embodiment of the present invention. A wireless network may use dynamic spectrum access that provides a dynamic allocation of wireless spectrum to network nodes. The spectrum may be used to communicate wirelessly between nodes in a non-pre-determined manner in response to changing network and spectrum conditions. Dynamic spectrum access technology may use the methodology of coordination of a collection of wireless nodes to adjust their use of the available RF spectrum. In embodiments, the spectrum may be allocated in response to manual or automated decisions. The spectrum may be allocated in a centralized manner (e.g., network partitioning) or in a distributed manner between individual nodes. The spectrum may be allocated dynamically such that interference to/from geographically proximate spectrum users internal or external to the wireless network may be avoided. The local spectrum decisions may be coordinated/communicated using a fixed or logical control channel in the over-the-air wireless network. This may increase the performance of wireless networks by intelligently distributing segments of available radio frequency spectrum to wireless nodes. Dynamic spectrum access may provide an improvement to wireless communications and spectrum management in terms of spectrum access, capacity, planning requirements, ease of use, reliability, avoiding congestion, and the like.

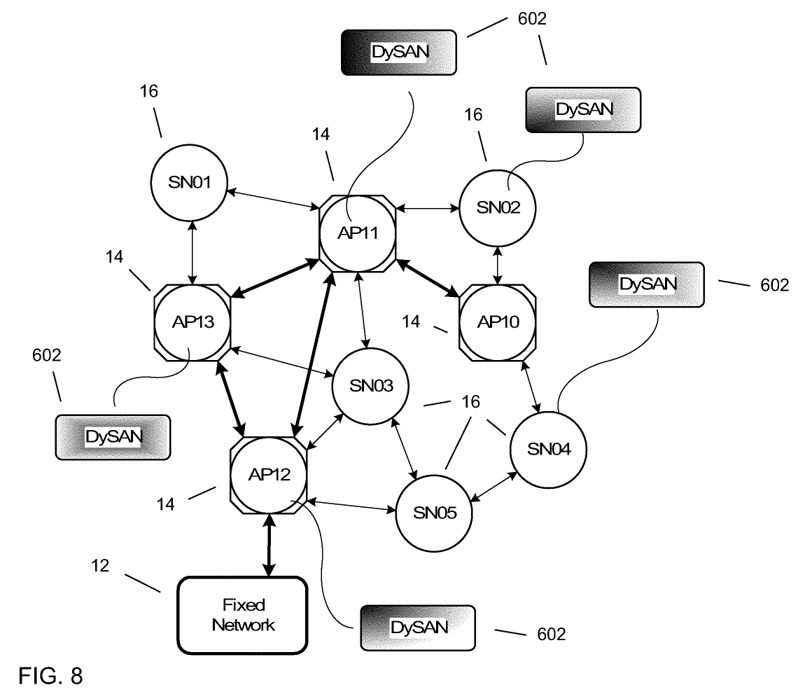

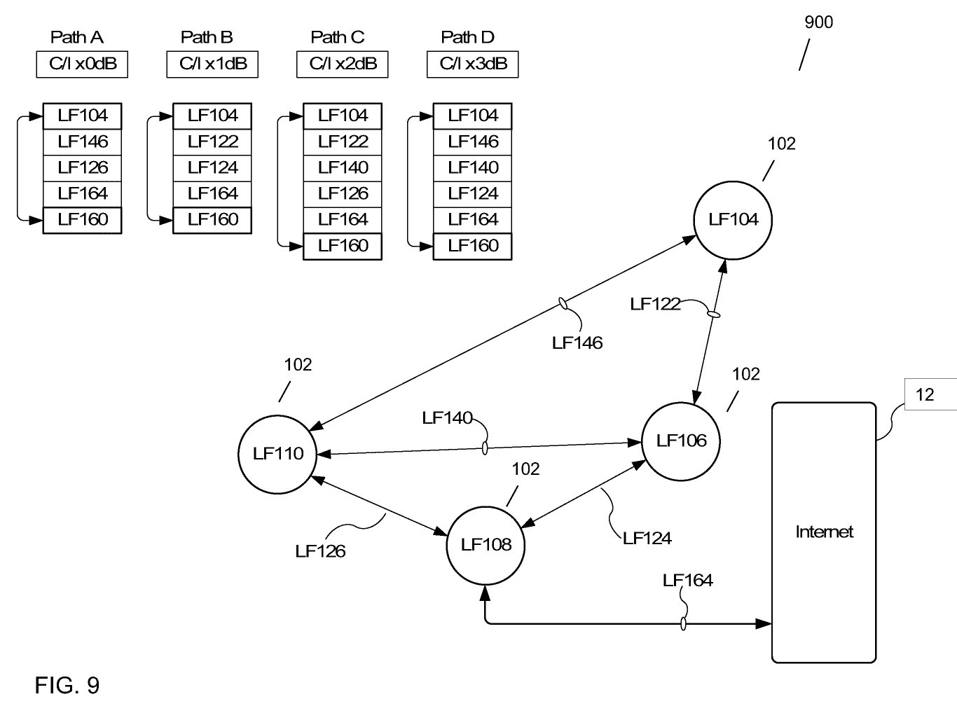

FIG. 8 illustrates a mobile ad-hoc wireless network using dynamic spectrum access technology according to an embodiment of the present invention. In this embodiment, a mobile ad-hoc wireless network may be used in conjunction with dynamic spectrum access technology to provide carrier grade quality of service. A collection of wireless nodes in a mobile ad-hoc network is shown dynamically adapting spectrum usage according to network and spectrum conditions. Individual nodes in the mobile ad-hoc wireless network may make distributed decisions regarding local spectrum usage. In embodiments, quality of service for a mobile ad-hoc wireless network may be measured in terms of the amount of data which the network may successfully transfer from one place to another in a given period of time, and DYSAN may provide this through greater utilization of the available spectrum. In embodiments, the dynamic spectrum access technology may provide a plurality of network services and attributes such as, coordinated and uncoordinated distributed frequency assignment, fixed or dynamic network coordination control channel, assisted spectrum awareness (knowledge of available spectrum), tunable aggressiveness for co-existence with uncoordinated external networks, policy-driven for time-of-day frequency and geography, partitioning with coordinated external networks, integrated and/or external RF sensor, and the like. FIG. 9 shows how a spectrum aware path may be selected based on carrier to inter-modulation ratio, in this instance measured in db (x0 to x3). BER may be used as well.

In embodiments, the MBRI may provide enhancements that better enable carrier-grade service, such as through prioritization of latency-sensitive traffic across multiple layers of the networking protocols to reduce end-to-end latency and jitter (such as by providing priority queuing within node, priority channel access at MAC across nodes and priority routing across topology), providing network support for peer-to-peer connections bypassing network infrastructure, unicast and multicast routing with multiple gateway interfaces to fixed (i.e., wired) network, providing security to protect control-plane and user data and prevent unauthorized network access, traffic shaping and policing to prevent users from exceeding authorized network usage, remote monitoring, control, and upgrade of network devices, automatic re-transmission of loss-sensitive traffic, transparent link and route maintenance during periods of spectrum adaptation, rapid autonomous spectrum adaptation to maintain service quality, avoid interference, and maximize capacity, scalability of network protocols for reliable operation with node densities (e.g., hundreds to thousands of nodes per sq. km.) and node mobilities (e.g., to 100 mph) consistent with commercial wireless networks, using adaptive wireless network techniques to maximize scalable network capacity (e.g., adaptive transmit power control to reduce node interference footprint, adaptive link data rate, dynamic hybrid frame structure, dynamic distributed scheduling techniques, multi-channel operation using sub-channels and super-channels, load-leveling routing), simultaneous support of multiple broadband, high mobility network subscribers, interfaces with fixed carrier network (e.g., to support VoIP, SIP, etc.), and the like.

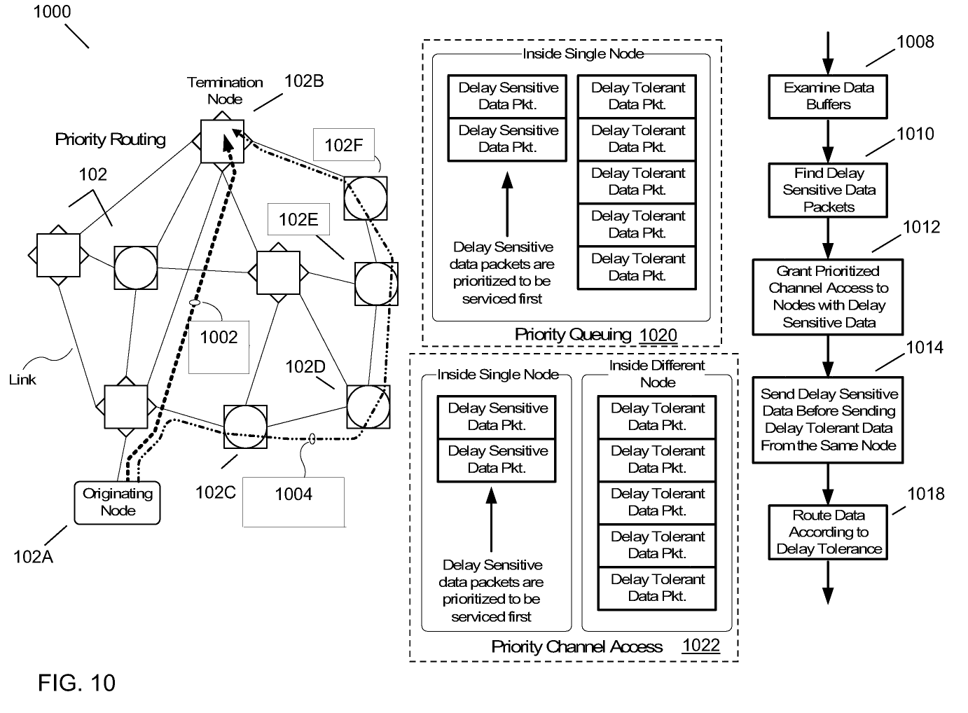

In embodiments, an enhancement may be prioritization. FIG. 10 illustrates a method of providing prioritization of delay-sensitive traffic across the network protocol stack in a mobile ad-hoc wireless network according to an embodiment of the present invention. As shown, the prioritization of delay-sensitive traffic may be done by granting prioritized channel access to nodes with delay-sensitive data and sending the delay sensitive data before sending the delay tolerant data from the same node. This may enable the provision of service level performance agreements.

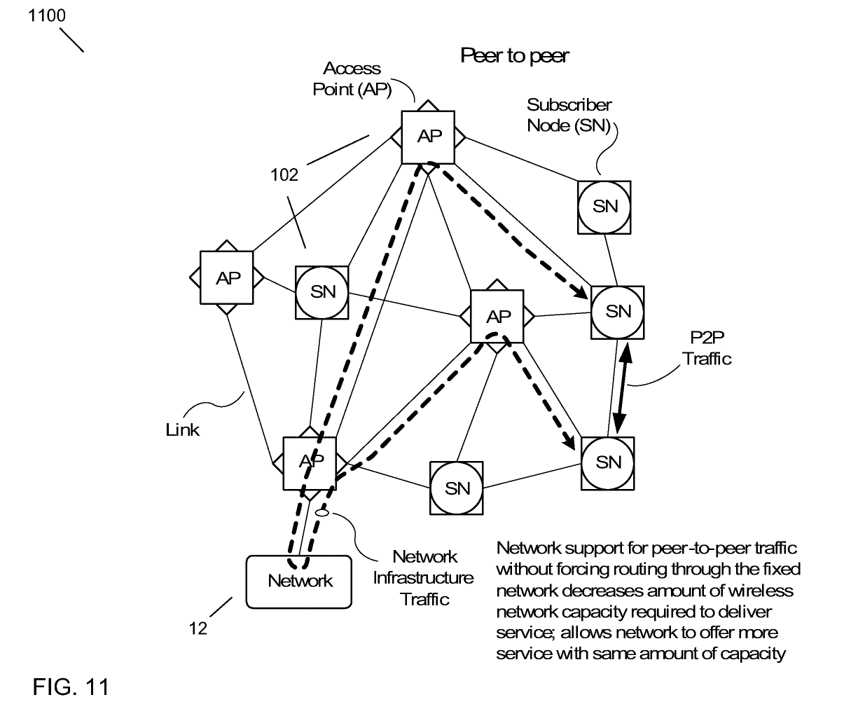

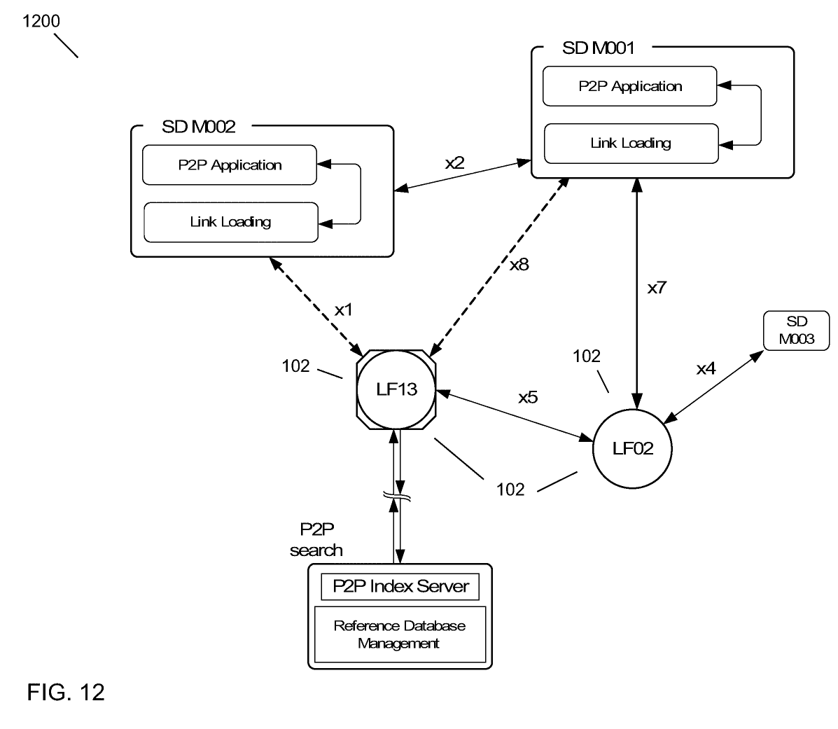

In embodiments, an enhancement may be network support for peer-to-peer traffic. FIG. 11 illustrates a method of providing network support for peer-to peer traffic in a mobile ad-hoc wireless network according to an embodiment of the present invention. Providing network support for peer-to-peer traffic without forcing routing through the fixed network may decrease the amount of wireless network capacity required to deliver service. This may allow the network to offer more service with the same amount of capacity. FIG. 12 illustrates one embodiment of how peer to peer MANET may be utilized in MBRI.

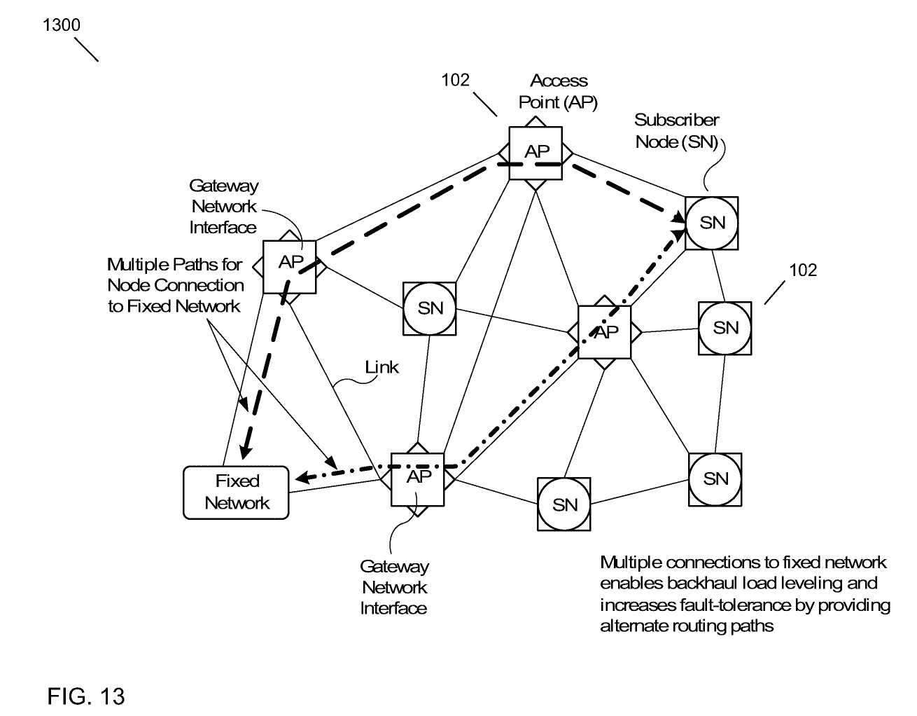

In embodiments, an enhancement may be multiple fixed network gateway interfaces. FIG. 13 illustrates providing multiple fixed network gateway interfaces in a mobile ad-hoc wireless according to an embodiment of the present invention. In this embodiment, multiple connections to the fixed network may enable backhaul load leveling, and increases fault-tolerance by providing alternate routing paths.

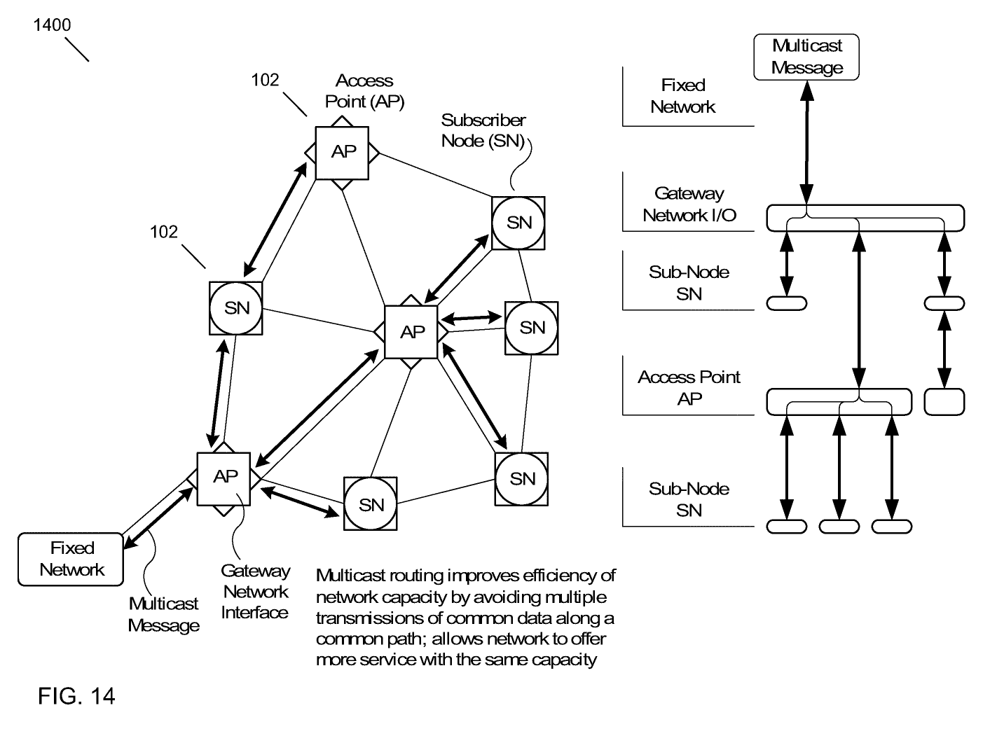

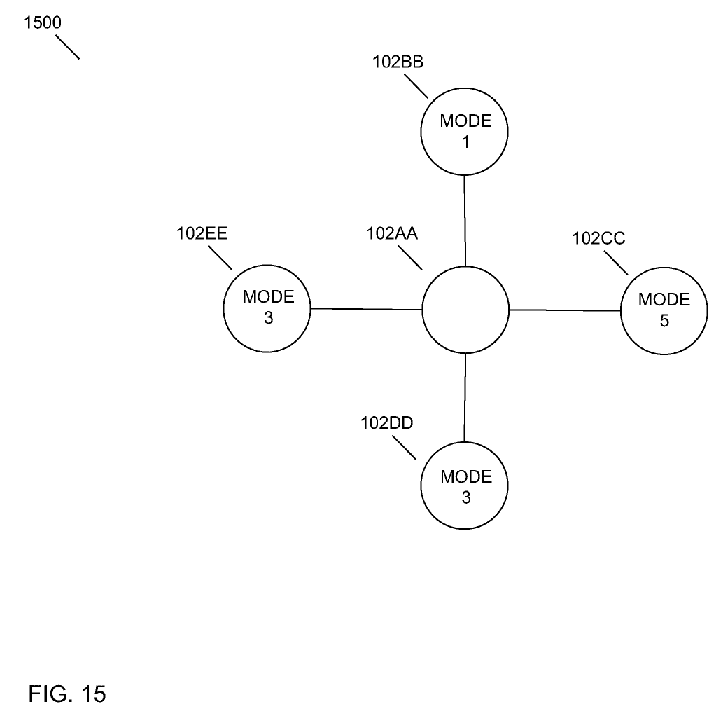

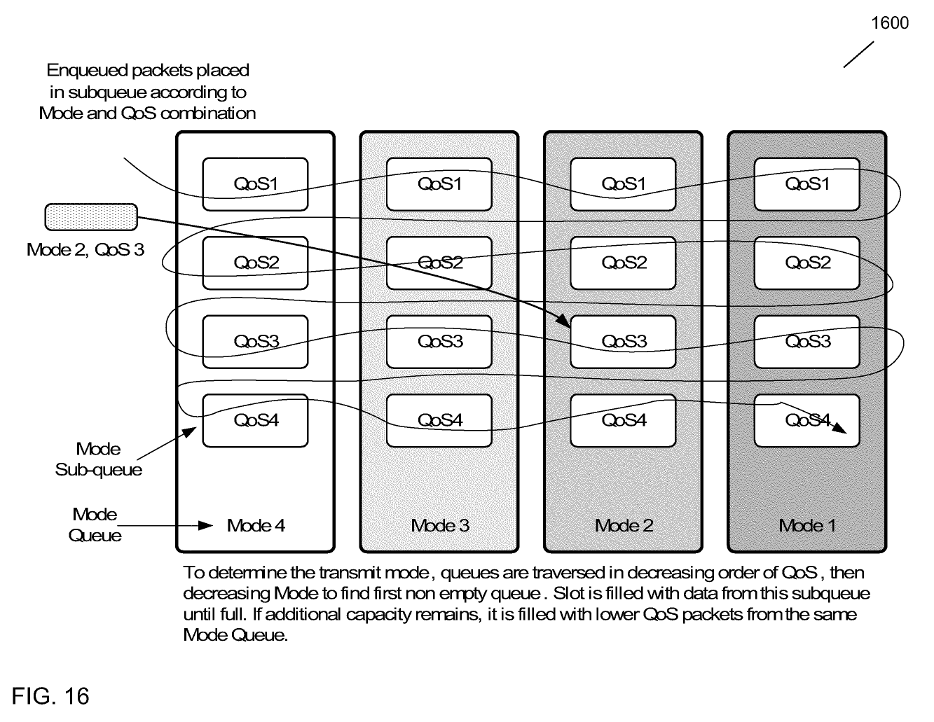

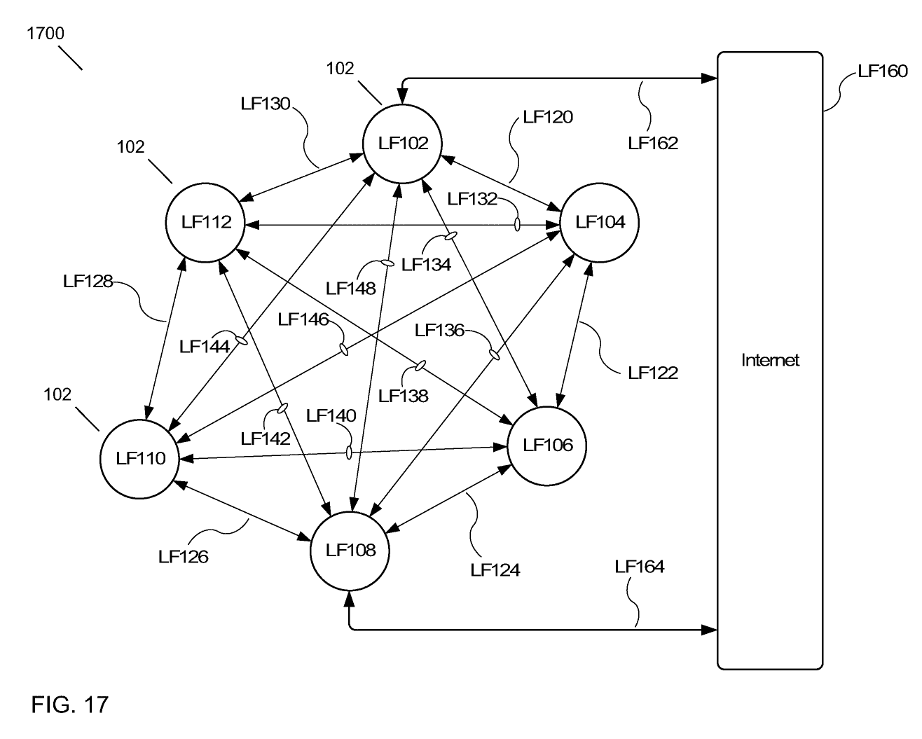

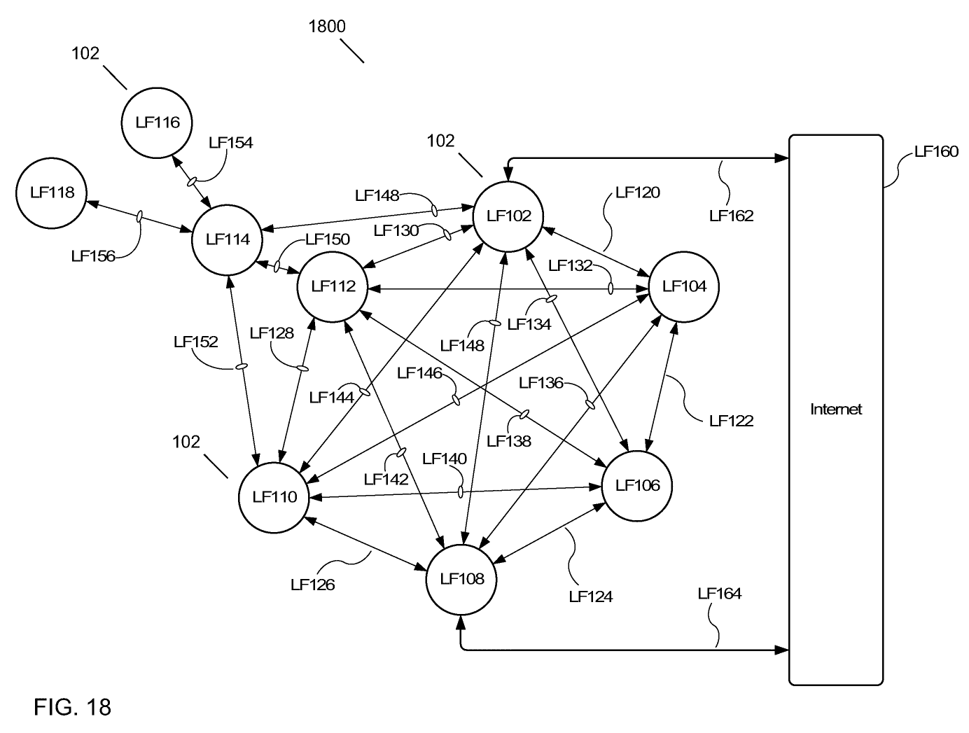

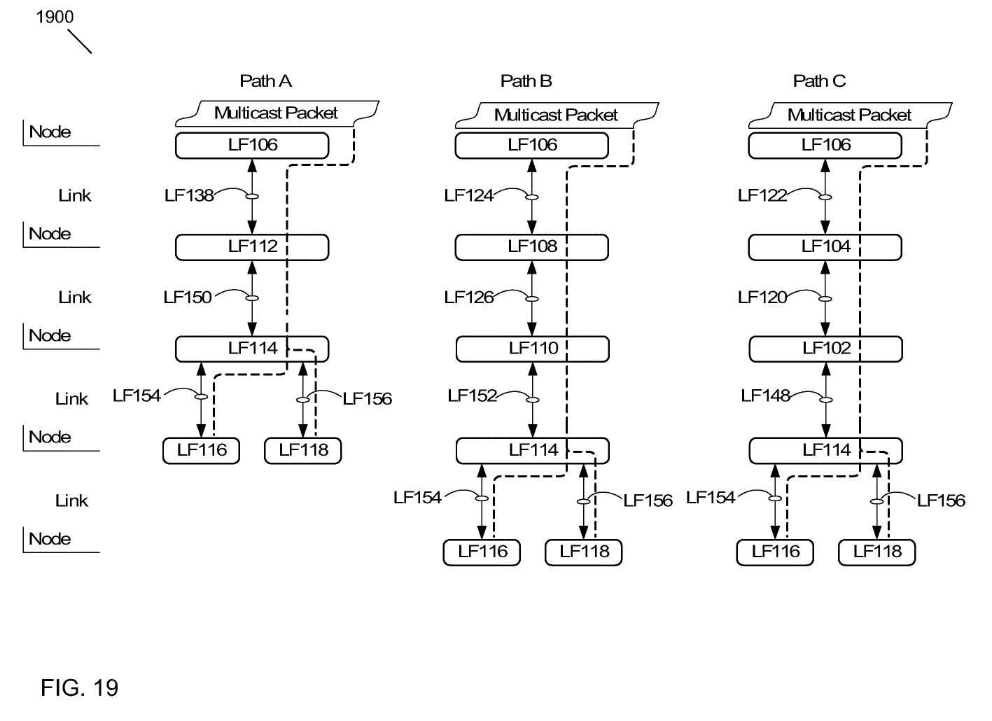

In embodiments, an enhancement may be multicast routing. FIG. 14 illustrates providing multicast routing in a mobile ad-hoc wireless according to an embodiment of the present invention. In this embodiment, multicast routing may improve efficiency of network capacity by avoiding multiple transmissions of common data along a common path. This may allow the network to offer more service with the same capacity. In embodiments, MBRI may implement receiver oriented multicast (ROM). ROM may be a modified version of the On-Demand Multicast Routing Protocol (ODMRP) with three significant changes. First, ROM may be Receiver Oriented rather than Sender Oriented. That is to say that the receivers in a multicast group may initiate the process of forming the multicast routes. Second, ROM may construct a multicast tree, whereas ODMRP is a mesh protocol. Third, ROM may not generally operate in On-Demand mode; rather it sets up the required multicast groups and then maintains them on a periodic basis. ROM may be designed to reduce overall control message traffic on the network when a network has more source nodes than receiver nodes. This is because the ROM protocol may flood JRP control packets from the receivers of a multicast group rather than from senders. For instance, if there are 20 nodes in the network, 20 nodes are senders, and 1 node is a receiver, then there will be one JRP flood versus 20 JRP floods with ODMRP. To route the multicast traffic of a certain multicast group, ROM enabled nodes may create a tree that comprises a forwarding group. First, receiver nodes belonging to the multicast group flood the entire network with Join Request Packets (JRP's). When the JRP's are received by nodes sourcing multicast data, Join Table Packets (JTP's) are transmitted back towards the receiver nodes through the same paths of the JRP's. The nodes that are part of the path between receivers and senders are designated as Forwarders in the Forwarding Group for that particular multicast group's traffic. In embodiments, when a set of nodes form a multicast group, they may use their data link mode queues to send multicast traffic. Multicast traffic may use most common highest mode queues to send the traffic; this may reduces traffic replication by each node as all one hop neighbors supporting that mode see the traffic at the same time. Highest mode queue may ensure that multicast traffic travels at the best possible rate without overwhelming nodes to replicate traffic for different nodes. In embodiments, MANET domains may be used to limit the scope of multicasting network thus partitioning the multicast traffic. In addition, BAP may backhaul the multicast traffic to the other BAP domains that need that multicast traffic, thus further optimizing multicast traffic. For example, consider the node configuration in FIG. 15. In this example A is connected to B, C, D and E with their modes listed next to nodes. When A broadcasts information to B, C, D and E, the least common mode is 1, so broadcast packet is put on Mode 1 queue. When A wants to multicast to B, C, D, and E (assuming they all are in receive group). A will copy the packet to Modes 1, 3, and 5. This copy may be done using smart pointer (reference counts) so it saves on some extra copies. FIG. 16 shows multiple mode queues supporting different levels of QoS. FIG. 17 provides a more detailed view of a basic peer to peer interconnection of mobile nodes. FIG. 18 now shows how the peer to peer network may accommodate multicast routing, and where FIG. 19 provides a flow diagram for several possible routes through the network shown in FIG. 18. In this example, multicasting is shown from LF106 to a group of nodes interconnected via LF116 and LF118. Alternate paths are shown as paths B and C, as well as other possible routings.

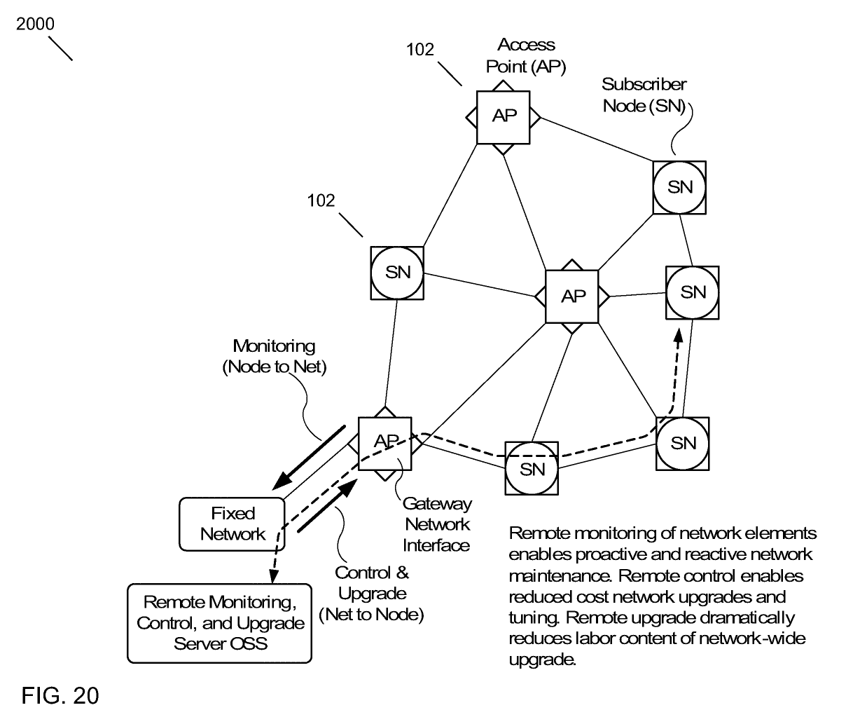

In embodiments, an enhancement may be remote network monitoring, control, and upgrade. FIG. 20 illustrates providing remote network monitoring, control and upgrade in a mobile ad-hoc wireless network according to an embodiment of the present invention. In this embodiment, remote monitoring of network elements may enable proactive and reactive network maintenance. Remote control may enable reduced cost network upgrades and tuning Remote upgrade may dramatically reduce labor content of network-wide upgrade.

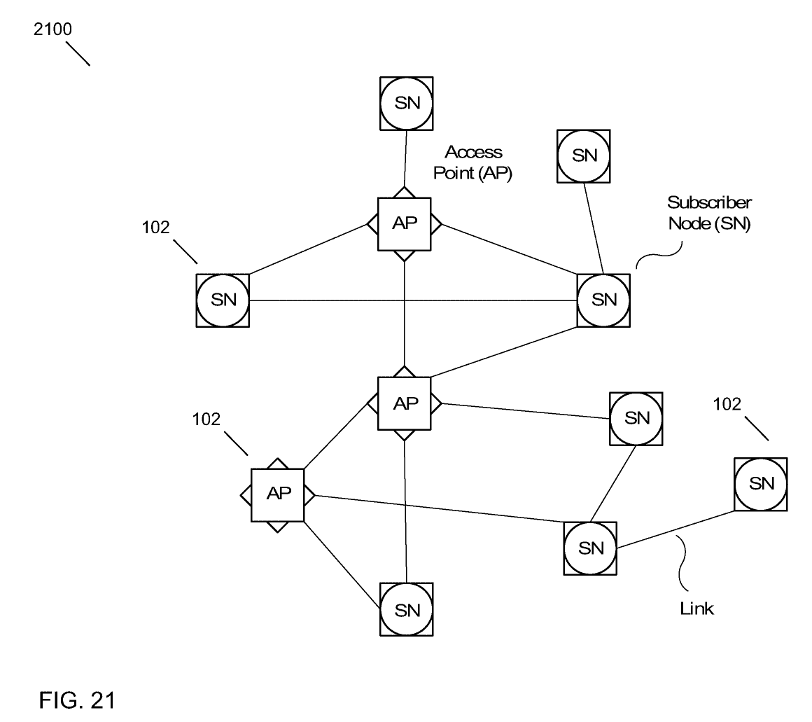

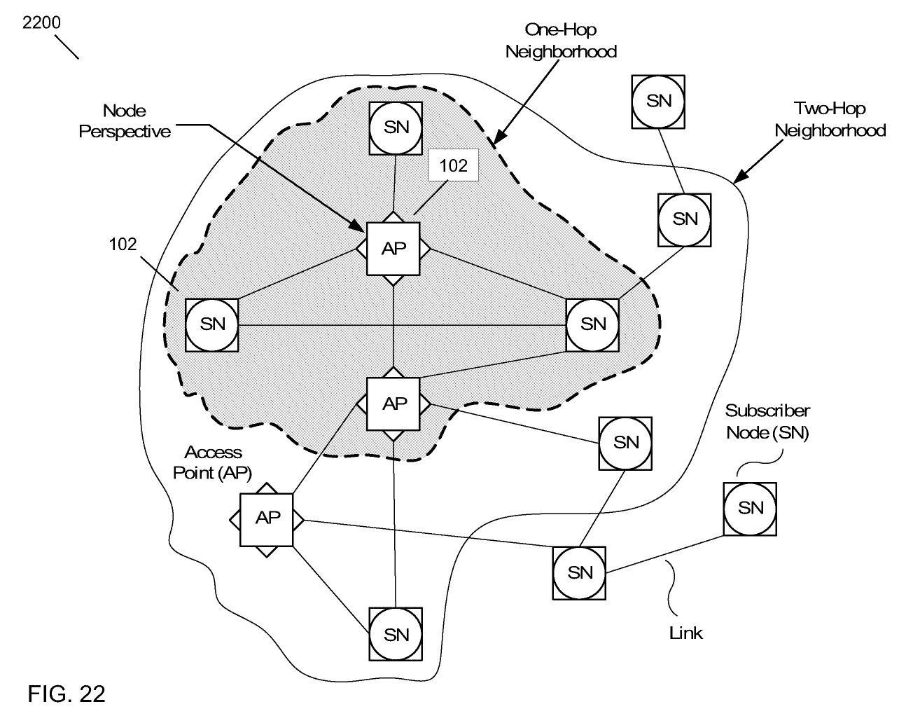

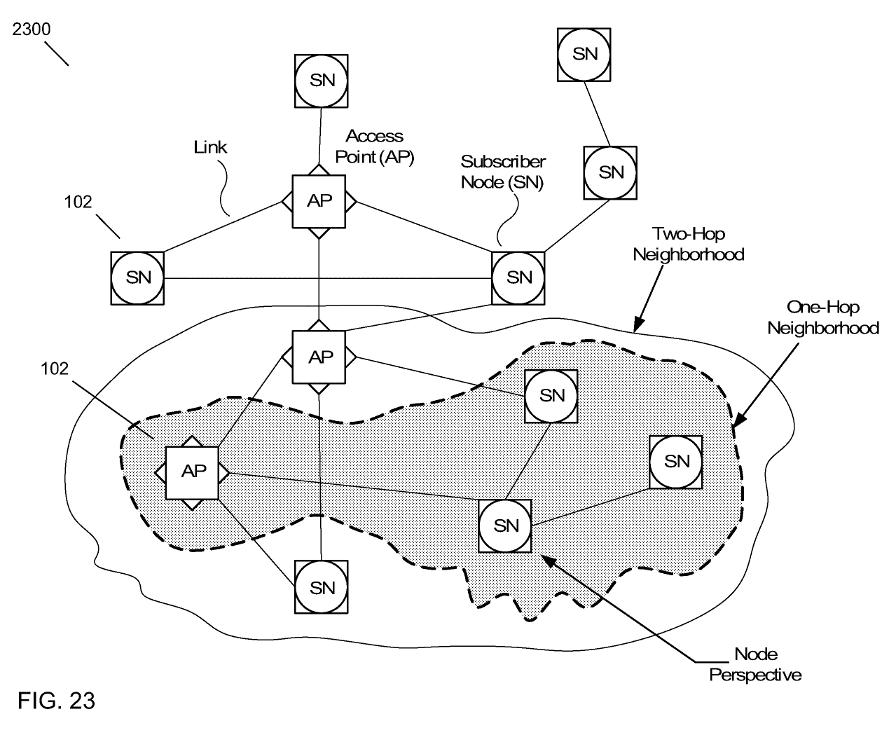

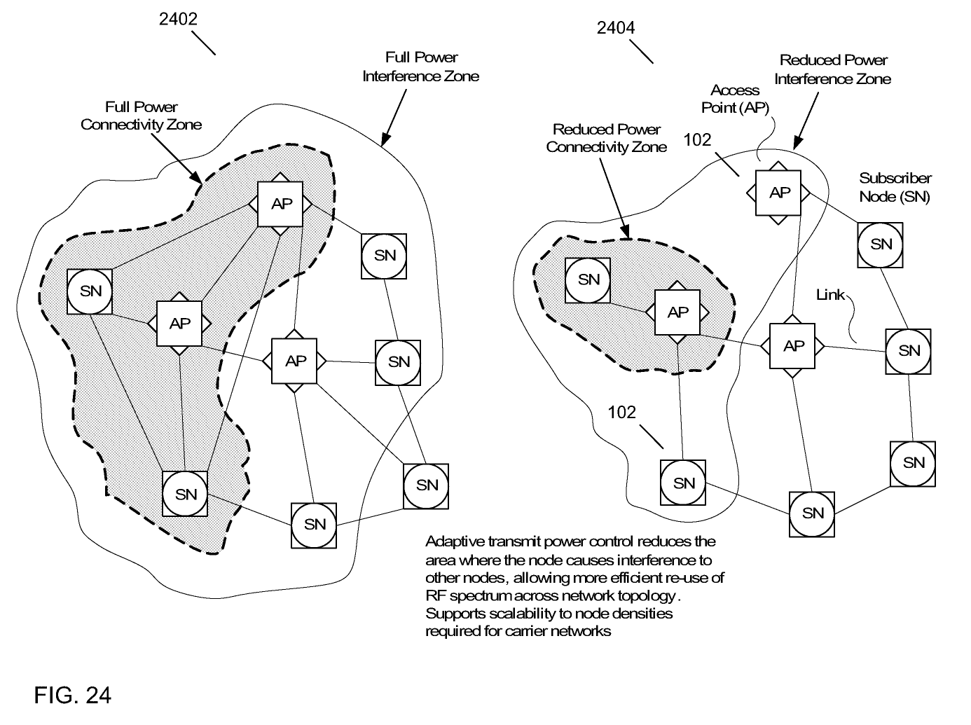

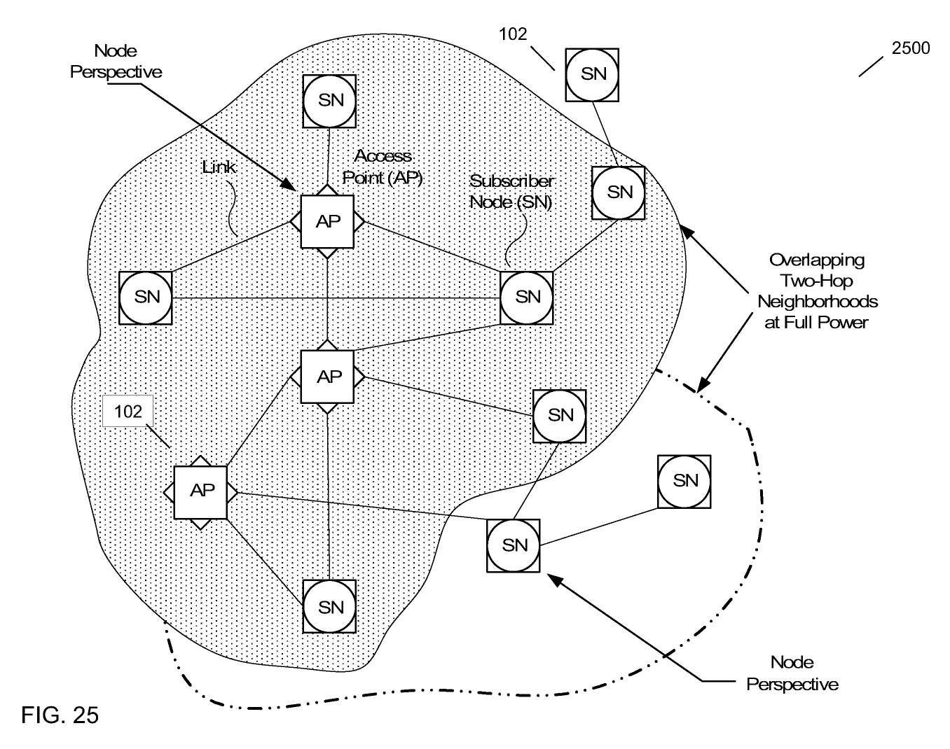

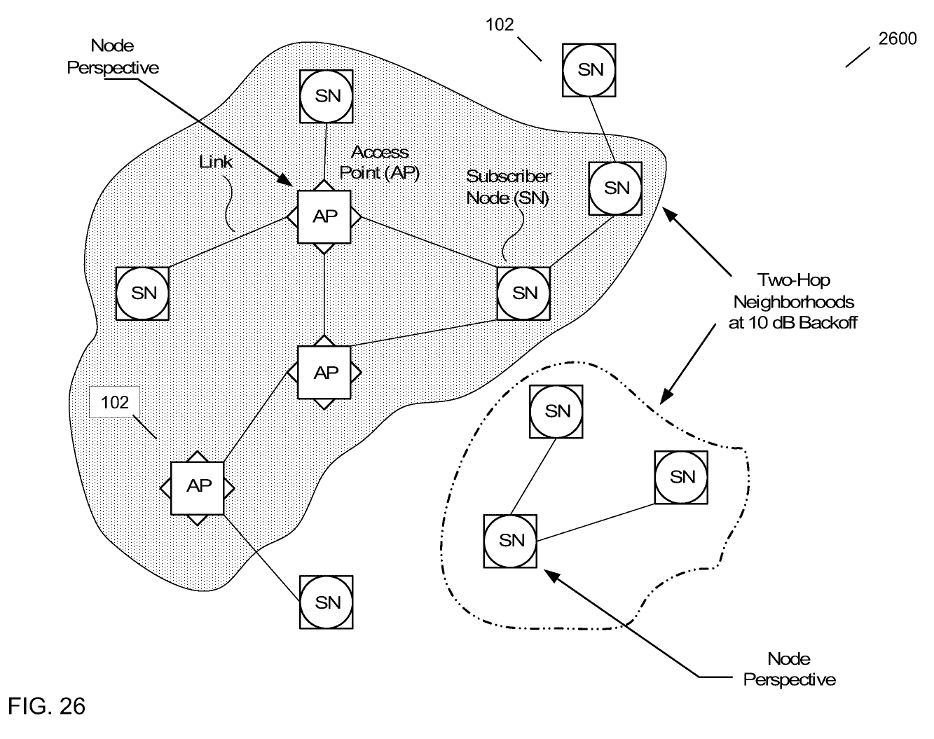

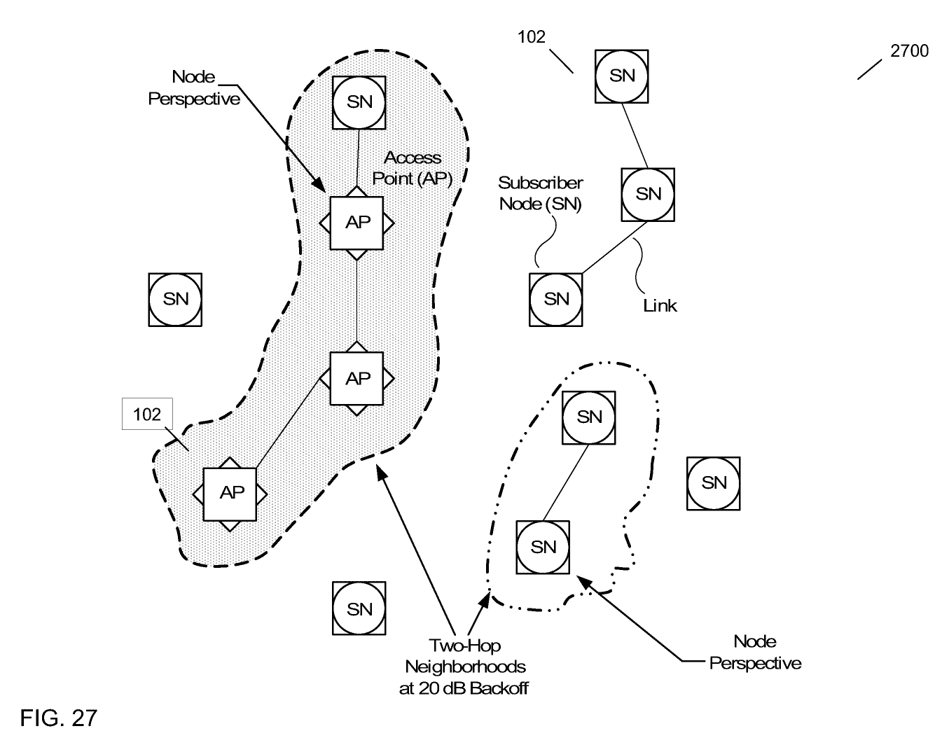

In embodiments, an MBRI enhancement may include adaptive transmit power control. For instance, a MANET may provide transmissions that may typically occur at a fixed transmit power. The slot capacity depends on the modulation, coding, bandwidth, and TDMA time slot duration. Consider a sample network topology as shown in FIG. 21. Yellow Circles indicate nodes, and gray lines indicate links between nodes in the MANET. A link exists if two nodes are within direct communications range of one another. These nodes are called one-hop neighbors. Similarly, a collection of nodes within two hops of a node form its two-hop neighborhood. FIG. 22 and FIG. 23 show the one-hop and two-hop neighborhoods from the differing perspectives of two nodes in the network—highlighted in red in each picture. The two-hop neighborhood may be an important concept for some channel access scheduling algorithms. These channel access scheduling algorithms coordinate the transmissions considering all nodes in the two-hop neighborhood. Nodes outside the two-hop neighborhood may be scheduled independently. On average, a node may transmit proportionally once for every N2 slots where N2 is the number of nodes in the two-hop neighborhood. Hence, the smaller the two-hop neighborhood, the more often each node can transmit, resulting in increased network capacity. Adjusting the transmit power can be an effective way to reduce the size of the two-hop neighborhood. This concept is illustrated in FIG. 24 where the connectivity zone and the interference zone are shown for full power (left) and reduced power (right). FIG. 25 shows the outlines of the two-hop neighborhoods for the two nodes for links operating at full power. Notice that the neighborhoods overlap, resulting in relatively poor slot scheduling efficiency. When the transmit power is reduced, some links between nodes remain, and others disappear. FIG. 26 shows the link topology for the same network when the transmit power is reduced, such as by 10 dB. The two-hop neighborhoods are reduced and no longer overlap, allowing the different neighborhoods to be scheduled independently. This results in an increased number of simultaneous transmissions in the network. Effectively, the reuse distance has been decreased due to the reduction in transmit power. FIG. 27 shows the further reduction and isolation between two-hop neighborhoods that may be possible when the transmitter power is reduced further, say by 20 dB. The trade-off is that as the power is reduced, the set of nodes that are viable receivers (i.e., possible links) is also reduced. Some nodes have no links that can be supported at all at the lower power. As a result, a combination of transmit power levels for different TDMA time slots are used in order to maintain full end-to-end routability across the network. The router maintains “next hop” options for each of the different transmit power levels and uses the “first available” transmission opportunity that gets the data closer to its destination, subject to QoS constraints.

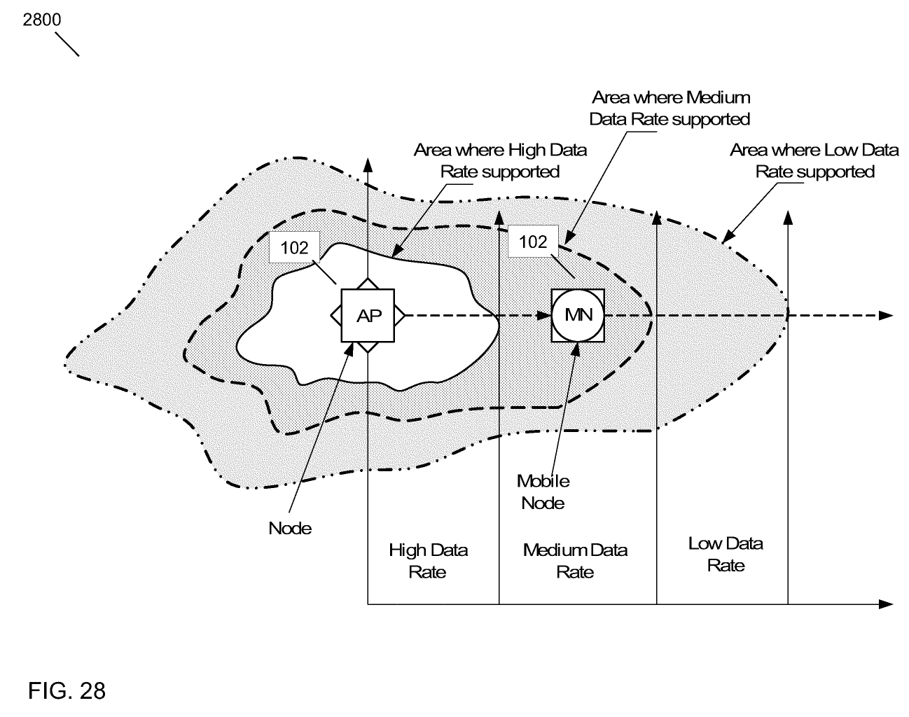

In embodiments, an MBRI enhancement may include adaptive data rate (ADR). For instance, a MANET may autonomously discover links between neighboring nodes in order to exchange data over the network. Initial link establishment may occur using a fixed data rate. Links may be established when two nodes are within communications range of one another. The data rate that can be supported over a link may be roughly proportional to the distance between the transmitter and receiver, as determined by the path loss. Over shorter links (i.e., smaller path loss), increased data rates can be supported. In a cellular network, mobile nodes always communicate only with a base station. This allows the base station to act as a central controller for adjusting the link data rates for the nodes it is communicating with. In a MANET, all nodes may be able to communicate with all other nodes, and there may be no centralized controller. A distributed protocol may be needed to adjust link rates. Once neighbors are discovered and links established, an ADR adjustment algorithm may adjust the data rate on the link to the maximum rate that can be reliably sustained (i.e., low slot error rate) based on link conditions. FIG. 28 shows a depiction of how different data rates may be supported for different link conditions (e.g., range and blockage) based on relative node locations. The red circles indicate two nodes in a MANET. The blue shaded areas indicate the nominal locations where different data rates can be supported between the left-most red node and any other node in the MANET. The darker shaded areas indicate higher data rate that can be supported. For example, in a network with three available data rates, suppose the right-most red node is traveling along the dotted line path (to the right) away from the left-most red node. When the two nodes are nearby, a “high data rate” can be supported (dark blue). As the node moves away, a “medium data rate” can be supported (medium blue) as shown in the FIG. 28. With continued motion, a “low data rate” is supported. At distances beyond where the low data rate can be supported, the link is dropped and a multi-hop route through the MANET is needed to exchange data between the nodes.

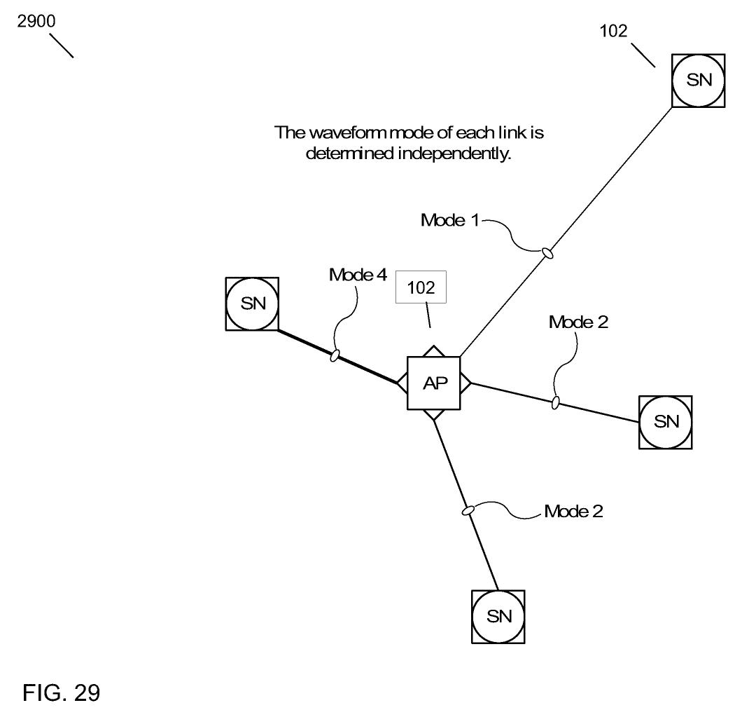

In relation to ADR, each waveform mode may be parameterized by a combination of parameters that represent a trade-off between data rate and demodulation performance. The link data rate may be adjusted to maintain adequate demodulation performance in the presence of changing link conditions. When link conditions degrade below a certain threshold, the ADR algorithm may rapidly decrease the link rate to a reliable mode to reduce the amount of data that is lost. When link conditions support higher data rates, the ADR algorithm may increase the link data rate to increase payload delivered by each slot. The multiple possible combinations of waveform parameters may be organized into a one-dimensional ordered list of monotonically increasing data rate with correspondingly decreasing signal robustness. The ADR algorithm may “walk up and down” the list dynamically as a function of observed link performance. A combination of measurements characterizing link performance may be used to drive adjustments. For each received time slot, the modem may return estimates of received signal strength (RSSI), Eb/No (SNR), pre-FEC bit-error rate (BER), and the like, along with the slot payload data, transmitting node ID, transmitted waveform mode and the like. An Adaptive Data Rate Control Message (ADRCM) may include the number of slots transmitted during each interval (e.g. one second) for each waveform mode, allowing the receiving node to calculate the slot error rate for each waveform mode. These link observation statistics may be grouped by transmitting node and mode to adjust the receiving node's suggested waveform mode for each link. The waveform mode of each link may be adjusted independently in each link direction. FIG. 29 shows different waveform modes from the node in the center to each of the surrounding one-hop neighbor nodes. Once a link is established, the ADR algorithm may adjust the waveform mode on the link to optimize the data rate. Relative link quality is a measure of link quality relative to the link quality needed to maintain the selected link data rate. As two nodes move closer together or farther apart, the ADR algorithm adjusts the link rate in order to maintain sufficient relative link quality. At the lowest data rate (most robust) waveform mode, relative and absolute link qualities are identical. Once nodes become too far apart to maintain their direct link, they must route through a relay node to exchange data.

In an example, an ADR algorithm runs concurrently for all one-hop links, but is computed independently for each receiver-transmitter pair. The ADR algorithm processes measured SNR data and computes a weighted average value on one second intervals. The algorithm then determines if the new value supports an increase in “mode”, or no change. The “suggested” mode value and packet reception counts are relayed back to the transmitter in an ADRCM. If sufficient data were transmitted during the one second interval, the transmitter compares the number of received slots counted at the receiver to the number of slots transmitted to compute a reliability estimate. In this example, three cases may be possible: 1) the reliability was acceptable; 2) the reliability was unacceptable; or 3) no decision can be made because there are insufficient measurements. If reliability is acceptable, then ADR uses the suggested mode value for the next one-second interval. If reliability is unacceptable, then ADR compares the suggested mode to the current mode. If the suggested mode is inferior to the current mode, it is put to use. Otherwise it is ignored. As part of the process for determining whether ADR can “step up” in mode, it is sometimes necessary to insert ADR Maintenance Messages into the data queues to “force” transmissions at waveform modes needed to determine whether that mode can be supported over the link.

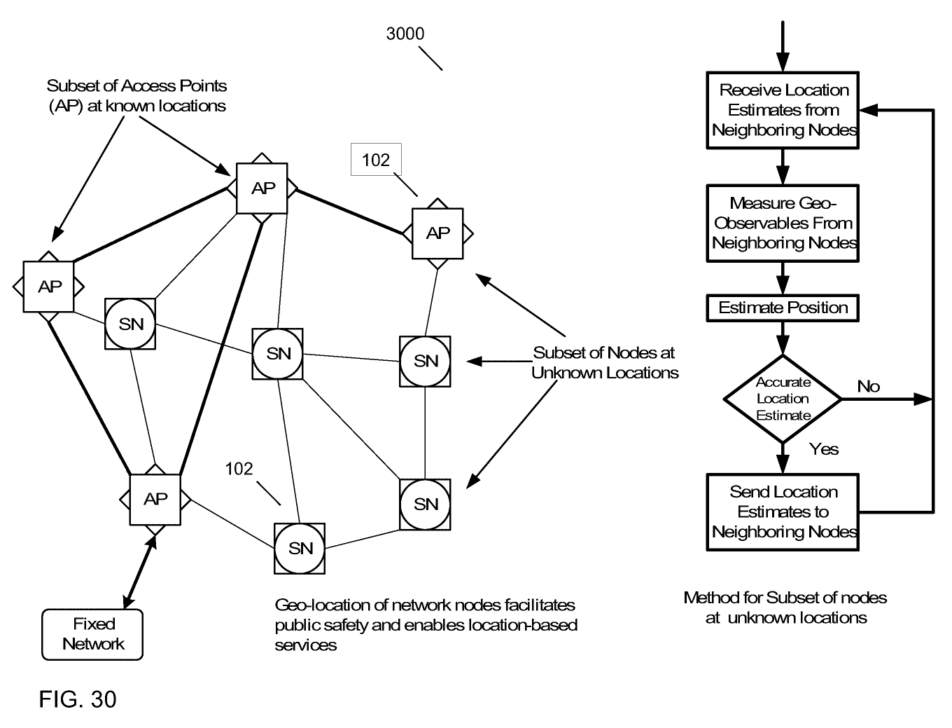

In embodiments, an enhancement may be network geo-location. FIG. 30 illustrates providing location information of network nodes to neighboring nodes in a mobile ad-hoc wireless network according to an embodiment of the present invention. In this embodiment, providing geo-location of network nodes to the neighboring nodes may facilitate public safety and may enable location-based services.

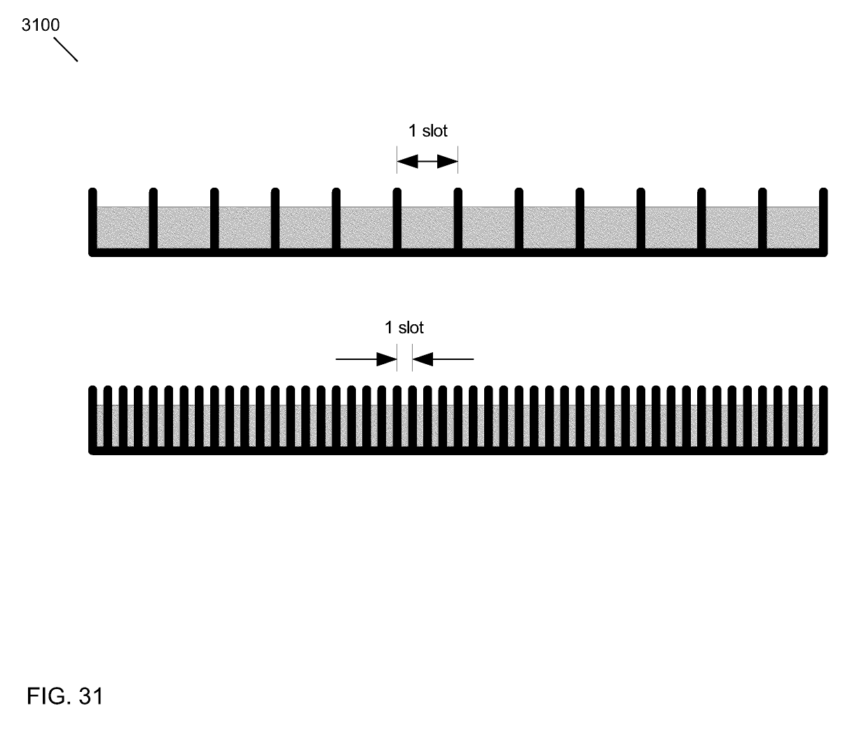

In embodiments, an enhancement may be multimedia capability. FIG. 31 depicts the use of increased slot rate in communication in a mobile ad-hoc wireless network as a means of better accommodating carrier grade service delivery of multimedia content in mobile ad-hoc networks. In embodiments, slot time is defined as the duration of a single opportunity that may be used for transmission. In an embodiment, an increased slot rate may be used to transmit data in a mobile ad-hoc wireless network. In an example, the slot rate used may be 1000-2000 slots/sec. As shown, an increased slot rate may allow more distinct opportunities for multiple nodes to access the channel. An increased slot rate may also reduce the delay between the opportunities available for the mobile nodes. An increased slot rate means a reduced slot time. A reduced slot time results in more number of devices sharing the network. The reduced slot time also reduces jitter in the network.

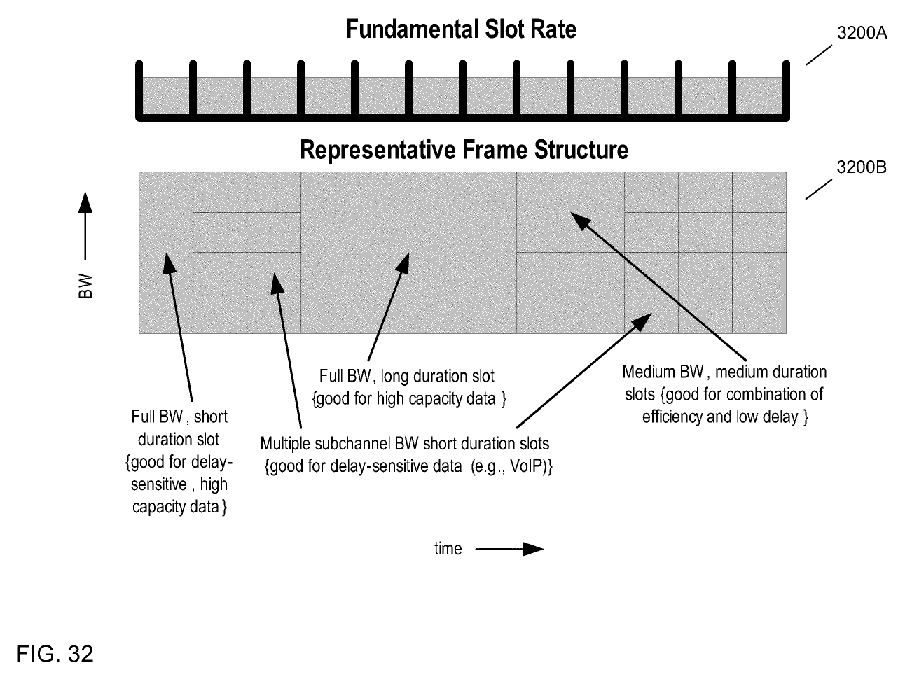

Continuing with multimedia capabilities as a MBRI enhancement. In a network running TDMA in the MBRI, transmissions may typically occur with fixed duration time bursts running at the fundamental slot rate. The slot capacity may depend on the modulation, coding, bandwidth, TDMA time slot duration, and the like. The TDMA time slots are shown at the top of FIG. 32. Multimedia internet data can have widely varying characteristics and delivery requirements including data rate, latency, jitter requirements, and the like. While a TDMA time slot structure with a single slot duration and bandwidth can effectively transport this data, efficiency improvements can be achieved by providing a more flexible transport structure that is better matched to the different types of data being carried by the network. The method described here to achieve improved efficiency is to create a hybrid frame structure that utilizes a combination of time slot durations and bandwidth sub-channels. The bottom of FIG. 32 shows an example hybrid frame structure for short (1× the fundamental slot rate), medium (2×), and long (4×) slot durations and bandwidth sub-channelization into 1, 2, or 4 sub-channels. This represents just an example, the method is generally expandable into any number of slot durations and sub-channels, not necessarily integer multiples of the fundamental slot rate. Both high capacity and scalability may be needed to enable the MBRI. Network design is a balance between providing high transport capacity and enabling methods that allow that capacity to be shared among a large number of simultaneous users. The hybrid frame structure may accomplish this by creating both high capacity transport slots and a larger number of schedulable transmissions (i.e., slot and sub-channel combinations) during a fixed interval. Note that a length 2× transmission may be more than twice as efficient as a length 1× transmission due to the elimination of slot timeline overhead for propagation guard time and preamble acquisition sequence. At the top of FIG. 32, the fundamental slot rate shows 12 individual full bandwidth schedulable transmissions at the fundamental slot rate. By moving to the hybrid frame structure shown at the bottom of FIG. 32, the number of schedulable transmissions in the network has increased to 24, allowing more nodes to transmit data during the same time interval. This may improve the latency characteristics of the network. Additionally, some of the slots are longer than the fundamental slot duration, allowing a few nodes to transmit more data more efficiently than with a fixed slot rate. This approach simultaneously enables both capacity and scalability across the network. This approach is analogous to shipping a large number of various size items in different size boxes, rather than always using the same size box to package every item. Different channel access scheduling algorithms may be matched to the different slot duration and sub-channel configurations. Full bandwidth slots are well-matched for scheduling using algorithms that select the transmitting node. Slots with multiple sub-channels are well-matched for scheduling algorithms that first select the receiving node, and then select the multiple transmitters for the different sub-channels.

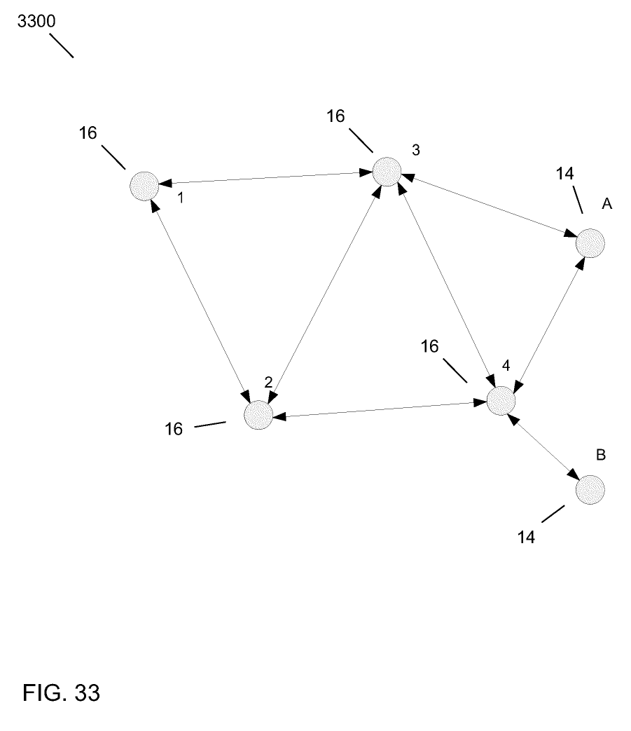

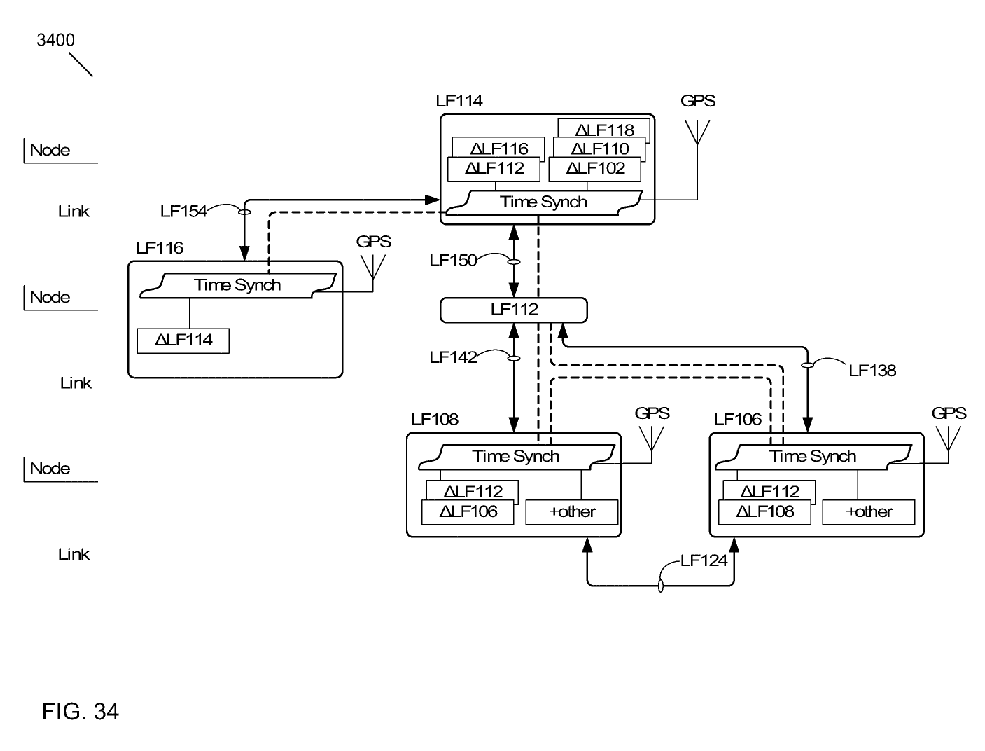

In embodiments, an enhancement may be time synchronization. FIG. 33 depicts a mobile ad-hoc wireless network is shown where embodiments of the present invention may be implemented for providing time synchronization. The network shown is a simple mobile ad-hoc network where nodes 1-4 are user nodes and the nodes A, B are access point (AP's). The AP's may have knowledge of network timing to insignificant levels compared to the timing needs. A method for enabling timing synchronization may include communicating a sense of network timing at all the nodes with sufficient accuracy to enable reliable communications. The network timing may include slot timing and carrier frequency timing. In an aspect of the present invention, it may be assumed that each node may be designed so that the slot timing and the carrier frequency is derived from the same local reference. In an example, frequency error in the slot timing may be directly proportional to the carrier frequency error. The carrier frequency may be an integer multiple of slot rate. In an example, the slot rate may be 1 kHz. Referring to FIG. 1, the nodes 3 and 4 may use the APs ‘A’ and ‘B’ for obtaining timing information for synchronization. The nodes 1 and 2 may use an indirect approach by obtaining the timing information derived from the nodes 3 and 4 for synchronization. In an embodiment, the timing information may be obtained by comparing the incoming packet timing relative to the local timing reference. In this embodiment, the relative timing of all of the neighbor nodes may be tracked and the local node timing is set to match the mean of these tracked times. The tracking may be accomplished using a Kalman filter with two states. In an example, the two states may be the time offset of the slot and the incoming carrier frequency (the number of states may be increased and the delay as an additional state may be introduced later). This method may be used by each node to synchronize to the network time and estimate the error in this local timing reference. FIG. 34 illustrates how time synchronization may be based on the time difference between synchronization packets and GPS based time reference. Delta time lookup table may be maintained for each node within MBRI and updated as required.

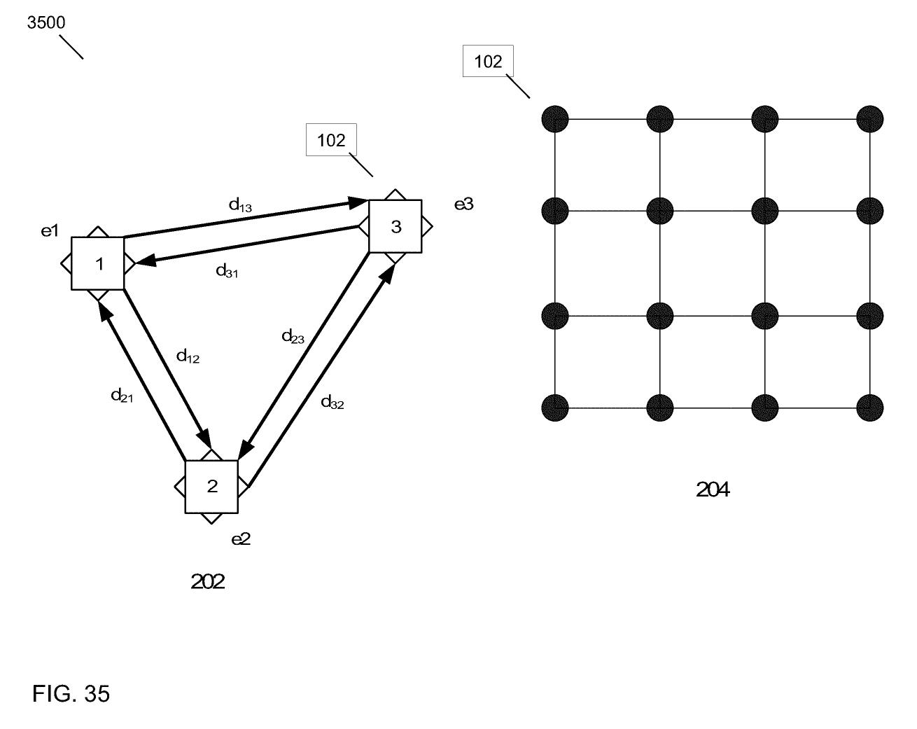

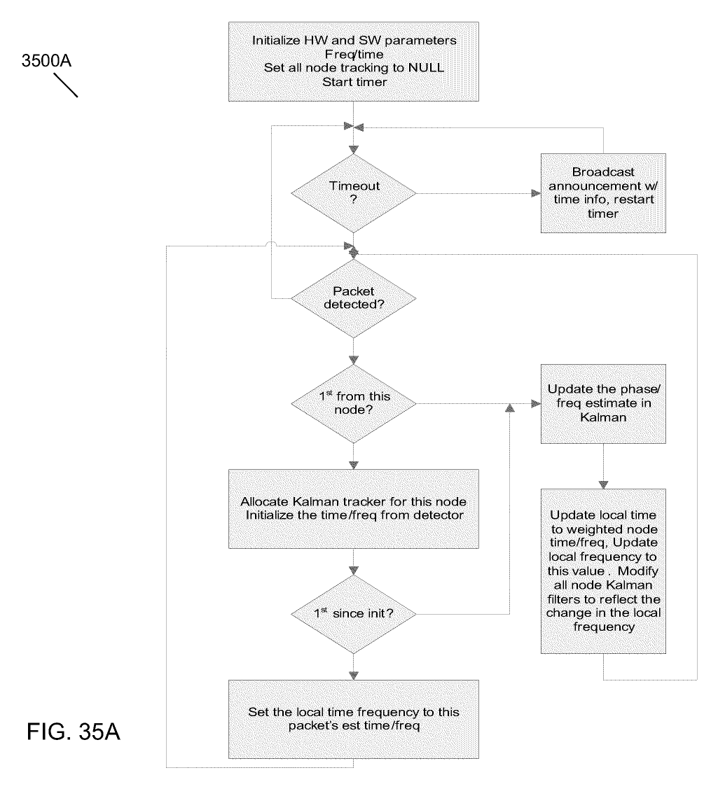

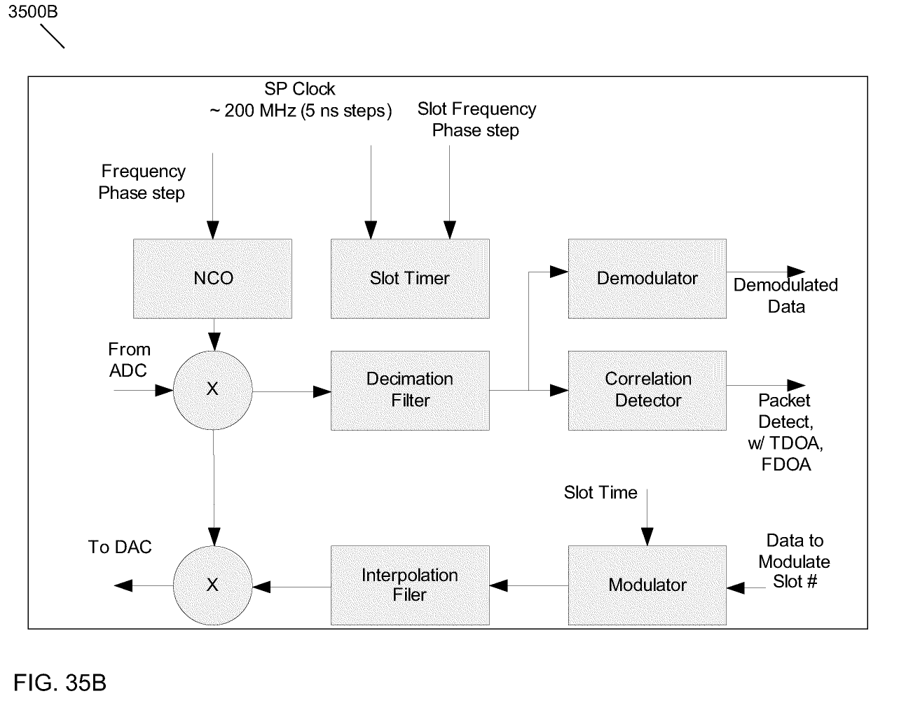

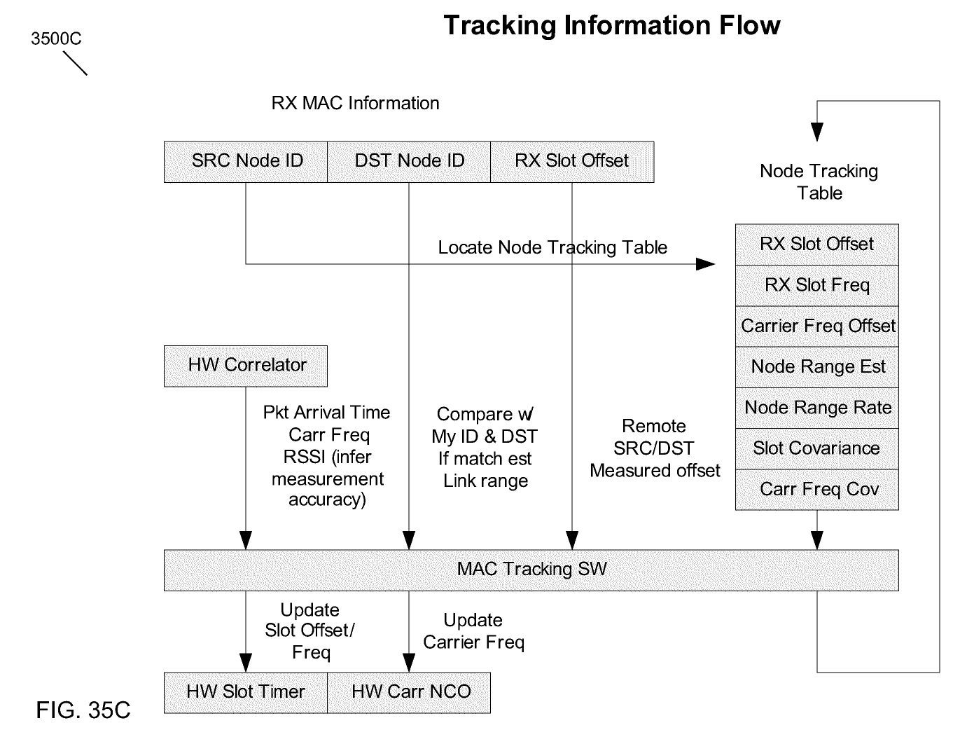

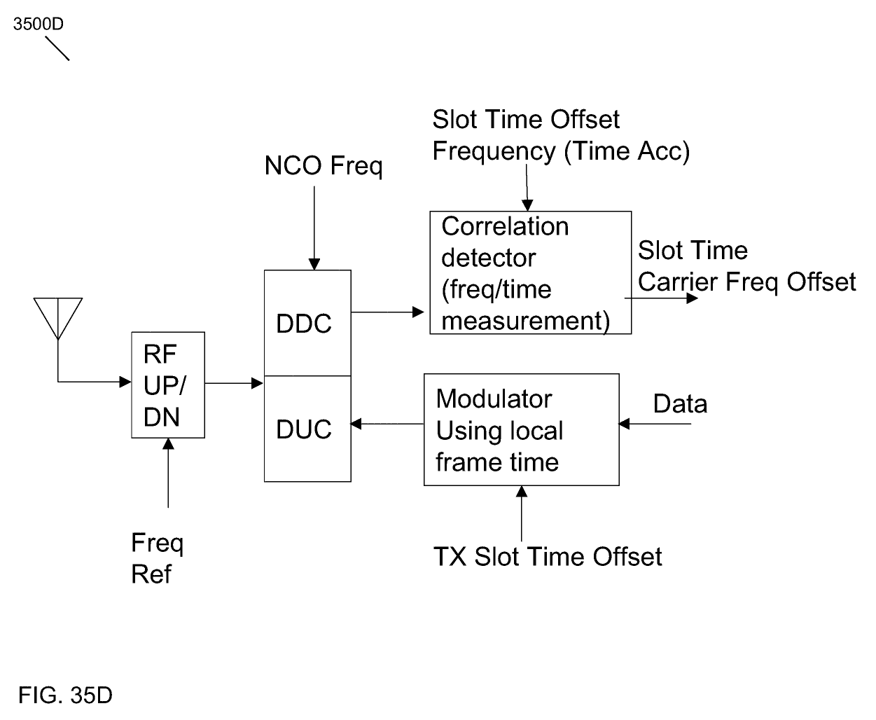

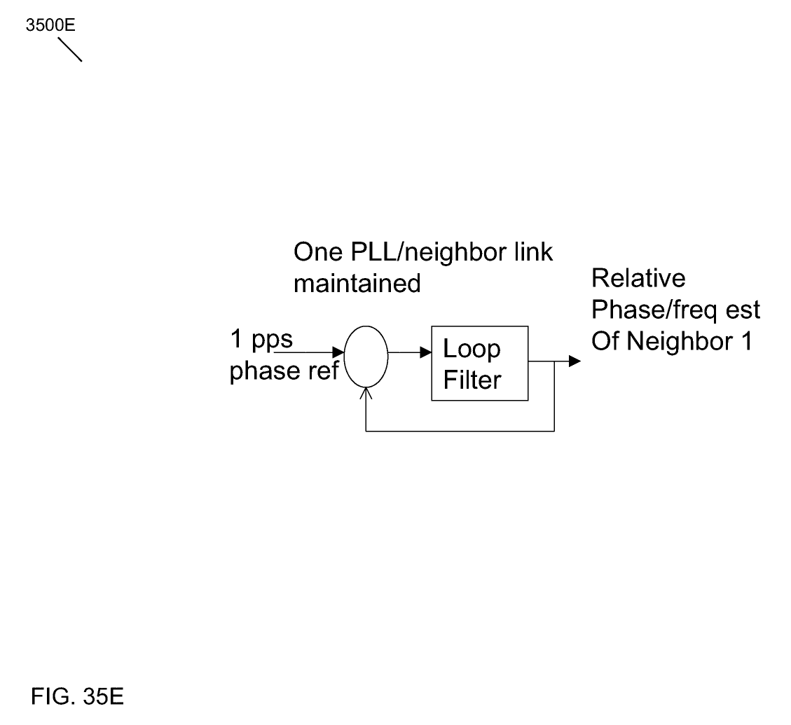

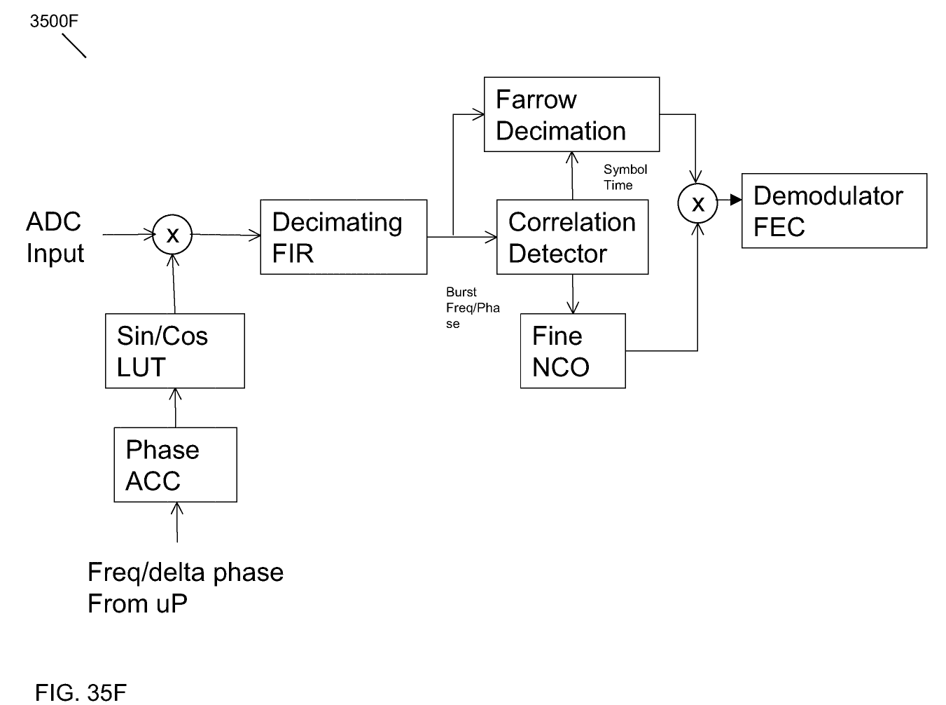

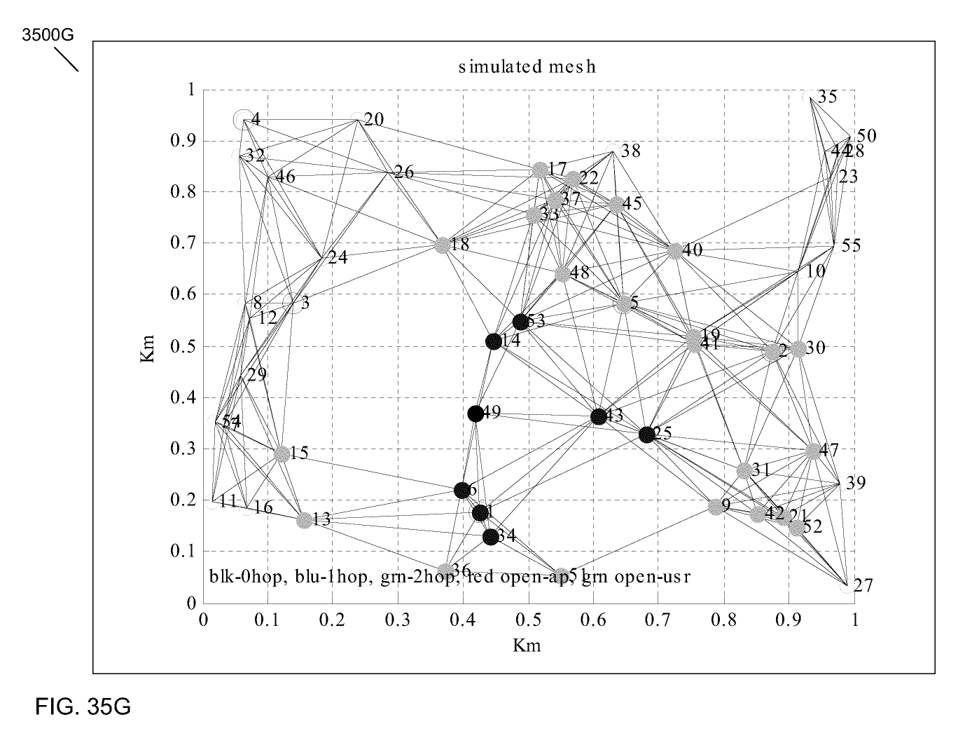

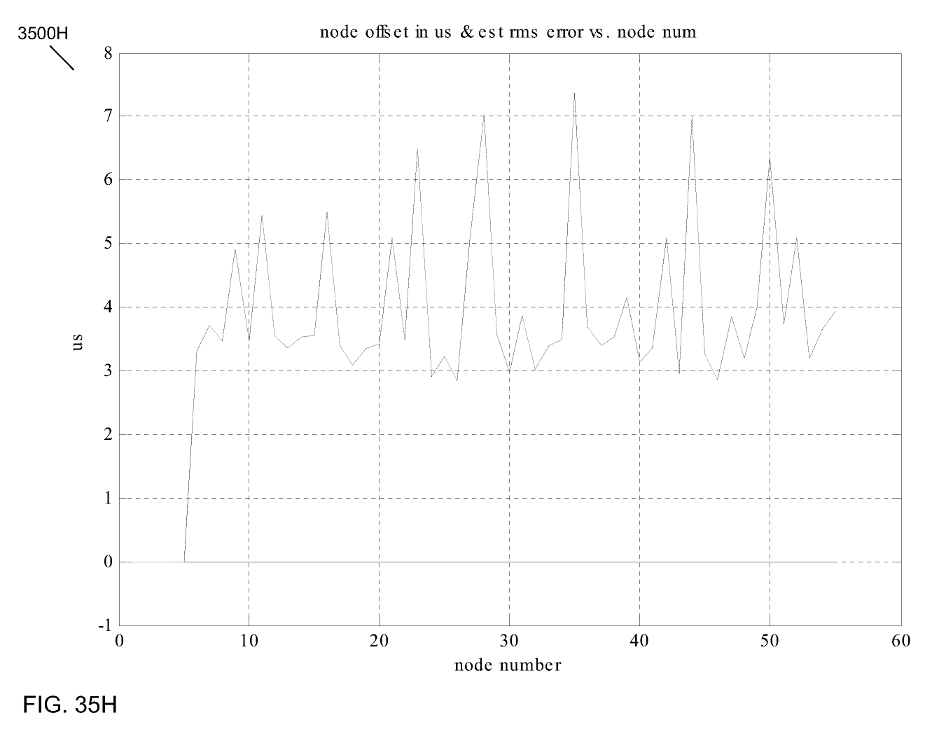

Continuing with multimedia capabilities as a MBRI enhancement, FIG. 35 illustrates an example topology for evaluating the algorithm. Estimating the relative time of each node, correcting for time offsets and estimating delay of each link in two mobile ad-hoc networks in accordance with an embodiment of the present invention is discussed. As shown, a simple three-node mobile ad-hoc network 202 and a mesh network 204 that was also used for evaluating the algorithm performance. The algorithm estimates the relative time of each node, corrects for time offsets and estimates the delays of each link in the network.

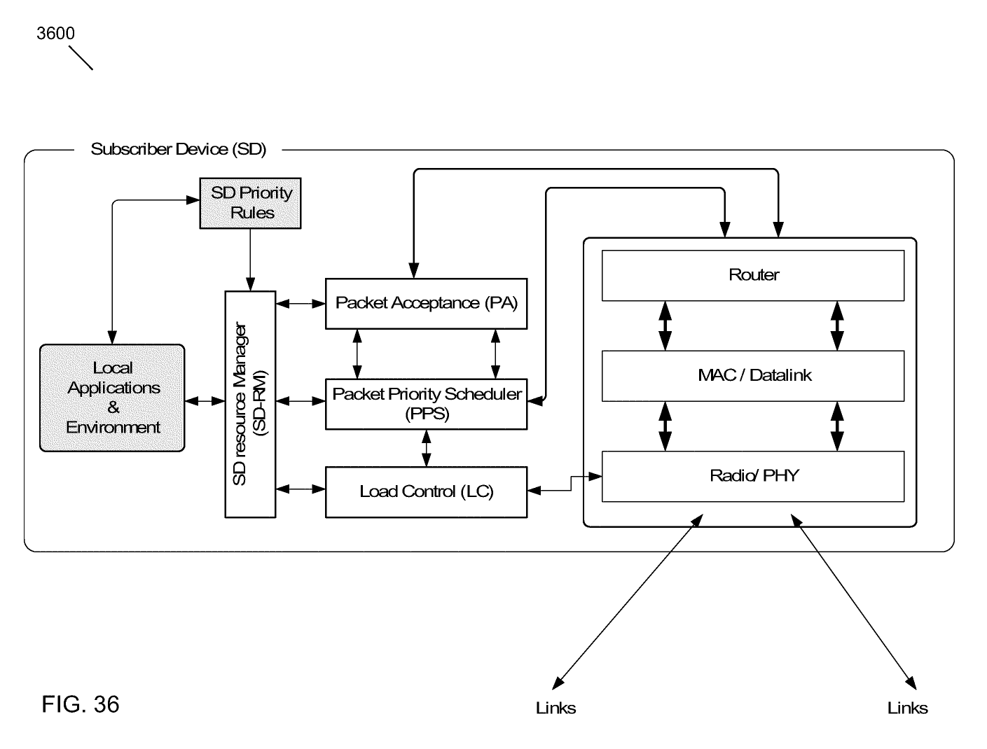

In embodiments, the MBRI may provide functions and capabilities that enable improvements over existing systems. For instance, MBRI may provide functions and capabilities in the subscriber device that may ordinarily be a part of a base station, such as air interface management, signaling, concentration logic, signal propagation algorithms, and the like. MBRI may enable the creation of a mobile Internet, including routing implemented in the subscriber device, MAC layer functionality in the subscriber device, peer-to-peer communication (e.g., communications between subscriber devices), and the like, that may provide a communications protocol stack equivalency within the subscriber device. MBRI may enable full radio resource management in the subscriber device, such as the subscriber device acting unilaterally, the subscriber device cooperating with other nodes, interference mitigation, handover/handoff functionality, backhaul capabilities such as access to the public Internet, IP-RAN capabilities, and the like. FIG. 36 provides one embodiment of how radio resource management may be implemented in an MBRI subscriber device. In addition, MBRI may be OFDMA enabled, and subscriber devices may be multisession enabled, where a node may perform multiple transmissions simultaneously, such as with a session-tagged interleaving of packets to identify one session transmission from the other. In embodiments, multisession transmissions may be the result of multiple applications on the node, performing tasks simultaneously, sending out communications across the network, and the like, where the simultaneous transmission of the data is sent in a multisession transmission.

In embodiments, performance of the MBRI may be enhanced over current systems, such as through adaptive power control, intelligent route diversity, least cost routing on the subscriber device, warranted service level agreements (SLA), node neighbor discovery and awareness, no need for a home location register (HLR) or visitor location register (VLR), geo-location of devices, openness to web applications on the subscriber device, subscriber device unicast and multicast capabilities, increased radio saturation, graceful degradation, and the like.

In embodiments, methods and systems are provided herein for operating an all IP mobile ad hoc network with carrier grade network performance and improved spectrum utilization through IP transparent routing, media access control and physical layer convergence protocols including a plurality of wireless mobile nodes and a plurality of wireless communication links connecting the plurality of nodes. The methods and systems may include a range of features, including, for example, one or more of: (1) facilitating node level, network wide and interoperable time synchronization for packet level and frame level transmission/reception peer to peer, peer to network and network to peer; (2) supporting a variety of wireless access protocols using TDD or FDD transmission based on symmetrical waveforms optimized for peer to peer communications in a mobile ad-hoc network; (3) supporting a physical layer convergence protocol that allows for symmetrically optimized waveforms based on OFDM, OFDMA, SC-OFDMA, QAM, CDMA and TDMA protocols; (4) facilitating link-by-link autonomous data rate selection; (5) providing a slotted MAC protocol for peer to peer, peer to network and network to peer frame transmission/reception; (6) providing for autonomous network entry/exit for nodes entering or exiting the network, and transparently allowing new nodes to utilize ARP for end route translation, DHCP for authentication, authorization and IP address resolution; (7) providing peer to peer packet routing with facilities for packet segmentation and reassembly, Quality of Service based routing and traffic type based routing; (8) MAC layer and network layer fairness algorithms designed to optimize and prioritize traffic based on nodal queue build-up, traffic type latencies, bandwidth optimization and spectrum optimization; (9) providing unicast and multicast routing of packet data through the mobile ad hoc network; (10) facilitating peer-to-peer connections to selectively bypass network infrastructure; (11) providing for remote monitoring, control, and upgrade of the wireless mobile nodes; (12) providing location estimates of neighboring nodes to each node in the network; (13) facilitating adaptive control of transmission power of a node based on location of the node; (14) dynamically adapting packet routing according to network and spectrum conditions; (15) prioritizing delay sensitive traffic across the mobile ad hoc network; (16) providing multiple connections of the mobile ad hoc network to a fixed network; (17) enabling automatic re-transmission of loss-sensitive traffic; (18) providing secure connections and supporting existing IP security standards; (19) facilitating spectrum independence; and/or (20) Supporting multi-session support at individual node.

In embodiments, the present invention may include a plurality of other functions and capabilities in association with MBRI, such as prioritizing delay sensitive traffic across the network protocol through priority queuing and priority channel access by differentiating data traffic across the protocol stack, dynamically adapting bandwidth usage according to network and backhaul conditions through distributed decisions regarding local bandwidth usage by individual wireless nodes, dynamically assigning IP addresses to new entry nodes or terminating IP addresses for exiting nodes according to network requests for service through distributed decisions regarding local resource usage by individual wireless nodes, and the like.

In embodiments the present invention may provide improved capabilities associated with MBRI associated with facilitating adaptive control of the transmission power of a node based on the location of a node in the mobile ad hoc network, mobile ad hoc network creation and self-forming networks made up of individual nodes based on their relative position with respect to each other in the mobile ad hoc network, mobile ad hoc self healing networks made up of individual nodes based on their relative position with respect to each other in the mobile ad hoc network, mobile ad hoc load leveling networks according to network requests for service and comprises making distributed decisions regarding local resource usage by individual wireless nodes, mobile ad hoc networks where the nodes and network are packet size indifferent and comprises making distributed decisions regarding local resource usage by individual wireless nodes, unicast routing in mobile ad networks according to network requests for service and comprises making distributed decisions regarding local resource usage by individual wireless nodes, mobile ad hoc networks that are Internet Protocol Plug Compatible, mobile ad hoc networks that are neighbor aware to requests for service and comprises making distributed decisions regarding local resource usage by individual wireless nodes, mobile ad hoc networks according that are geo location aware for network requests for geo location information, mobile ad hoc networks that are unconditionally open for Java Web applications, mobile ad hoc networks that are configured for private or public network usage, and the like.

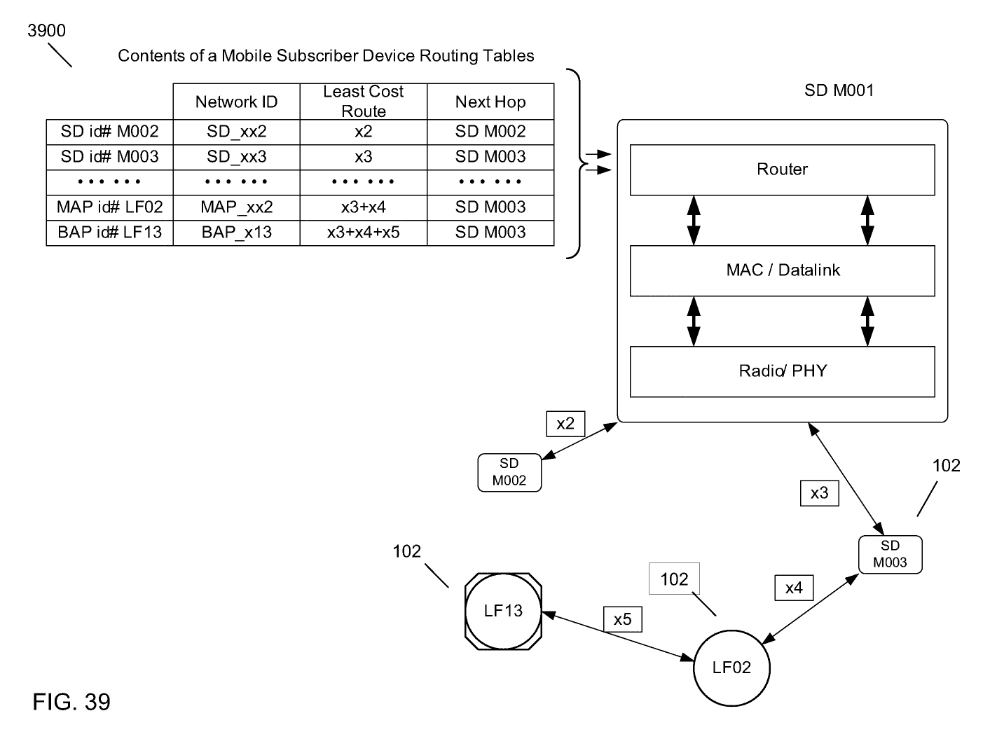

In embodiments, the MBRI may distribute network, routing and switching intelligence to the subscriber device and to spanning network elements that enable subscriber devices to interconnect with the “wired” Internet. By doing this each subscriber device can autonomously determine its own path to transmitting/receiving information to/from other peer devices in the network and with the Internet. In addition, route diversity increases exponentially commensurate with the number of devices in a given geographic area thereby increasing Quality of Service, increasing bandwidth switching capability through improved spectrum reuse and increased spectrum tele-density. Furthermore, MBRI automatically load levels the access side traffic across all the available backhaul points of presence (which are also MBRI nodes that have fixed wired connections to the Internet). FIG. 39 provides one embodiment of a fully enabled IP router in a subscriber device and how it may be implemented within MBRI.

In embodiments, benefits of MBRI may include improved quality of service, better scalability for traffic carrying capacity, an ability to increase spectrum reuse for a given geography by an order of magnitude more than cellular systems used over the same geography, and the like. MBRI may allow each node to optimize the network resources and each other on a packet by packet basis for sending/receiving traffic from one device to another or to/from the wired Internet. The technology takes advantage of access side hopping/routing and backhaul hopping/routing to optimize packet forwarding.

In embodiments, the MBRI may scale, commercialize, and optimize both unlicensed and licensed spectrum band operations for the public communications marketplace including voice, video and data services through an all IP mobile ad-hoc routing network, where each node is a standalone router able to make unilateral routing decisions through unique mobile ad-hoc protocols that are equivalent and transparent to the standard IP protocols used in the public wired Internet.

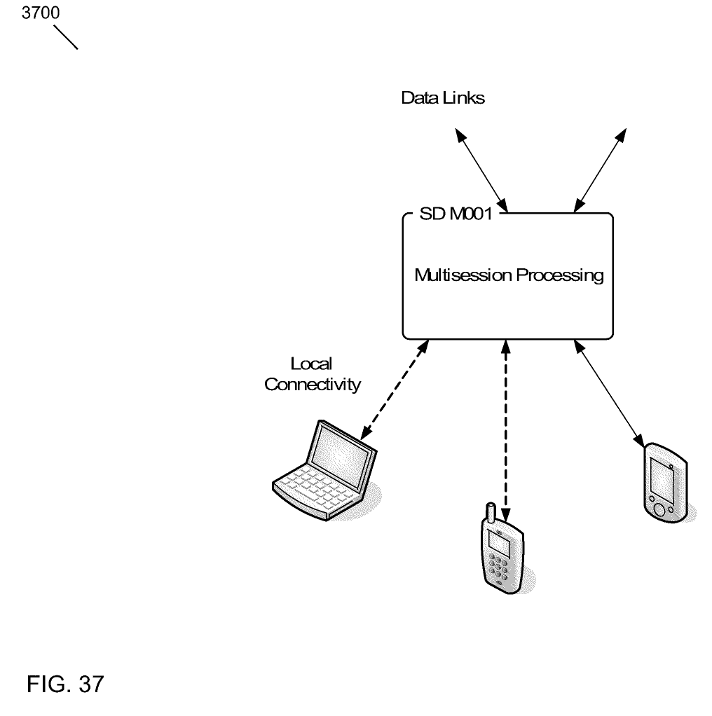

In embodiments, the MBRI may have the capability to move routability into a mobile access network, in turn allowing intelligent routing, optionally including providing a network that is routable, such as IP-routable, down to the individual device in a mobile ad hoc network, without necessity of a base station to perform the routing. Thus, the methods and systems disclosed herein may allow peer-to-peer Internet communications in a mobile ad hoc network without the need for intervention by a base station or similar controller. In addition, the MBRI may allow disposing a MAC layer in a mobile subscriber device, mobile networks in which the subscriber device is both multicast and unicast, providing multi-session subscriber devices, and the like. FIG. 37 provides an embodiment of a multi-session enabled subscriber device and how it may be implemented in MBRI.

In embodiments, methods and systems disclosed herein also include providing a range of functions that have historically been provided as part of a base station in the handset or subscriber device in a mobile ad hoc network work, optionally including one or more of an air interface management facility, signaling intelligence, concentration logic, signal propagation algorithms, interference mitigation between devices, and the like. Methods and systems disclosed herein may include full radio resource management capabilities in a subscriber device, such as a handset, including management of the radio of the device itself, management of how the device cooperates with foreign devices, and handover and handoff by the subscriber device.

In embodiments, methods and systems disclosed herein may also include providing an architecture with fixed radios associated with mobile radios. The fixed radios may include various access points to nodes of an MBRI. Methods and systems disclosed herein include methods and systems for providing backhaul to the Internet from a mobile ad-hoc network, such as an MBRI. Backhaul may include a diversity of backhaul types, including connection to the Internet backbone, as well as optional interconnection into a FAP. Pre-deployment design for maximum bandwidth demand may identify where a FAP exists for backhaul and allocate MANET radios to these sites in a pattern that provides optimum backhaul capacity for all the MANET radios in the network. Other MANET radios that are not at a FAP may transmit their backhaul to those MANET radios that do have fiber and thus reduce the number of fibered points required to cover a region. In embodiments, FAPs may be successively activated as bandwidth demand grows in the network. This process of identifying where the FAPs are may require the development of specific data from multiple sources and the development of bandwidth planning in order to predict which FAPs are activated in which period. This may reduce the number of FAPs needed for a MANET network and thus reduce cost. It also may allow for the concentration of backhaul bandwidth and thus enable volume discounts on fiber backhaul. By bringing the radios to the FAPs, the time to deploy a network may be substantially reduced. In addition, it may provide a wider selection of Fiber Access Points to increase the flexibility of a MANET network design. Most wireless networks and network planning software programs design a network for coverage and rely on backhaul to be brought to every wireless site. This innovation reverses that process by the acquisition and unification of multiple data sources to identify FAPs prior to actual deployment and by software that enables systematic selection of the best FAPs for the network as demand grows. Benefits of the process may include network design for end state bandwidth capacity, network design for bringing MANET nodes to FAPS, data development to identify where FAPs are located, activation of pre-determined FAPs as bandwidth demand across the network grows, and the like.

In embodiments, backhaul-driven MANET network design may provide network design for improved end state capacity. Current network design software may be limited to executing algorithms that design a network for coverage, usually working out from a single fixed point and then locating new network nodes to provide contiguous network coverage. In embodiments of the present invention, MANET networks may enhance this software by first establishing where the network's forecast capacity would be concentrated and then selecting FAPs that correspond to this concentration of end state bandwidth demand FAP data development may be provided through the purchase of multiple data sets that identify the location of fiber terminating equipment are combined and cross-checked against each other. Additional proprietary data may also be added, for instance from a fiber connectivity carrier or the municipality. Together, this data may provide a listing of all FAPs that could be used in the region. MANET network design may be undertaken using the FAPs as starting locations for MANET radios. Any gaps in coverage in the network may then be filled by deploying additional MANET radios that backhaul their traffic via a wireless ad hoc mesh. Fiber backhaul for the MANET radios located at FAPs may be activated as and when overall network traffic demand requires this additional backhaul. The overall result may be a network design optimized to the pre-existing FAPs and thus avoids the cost and time required to provide fiber backhaul to every MANET radio site. By successive activation of fiber backhaul so the cost of this fiber backhaul, transport may be deferred until the network bandwidth demand requires it.

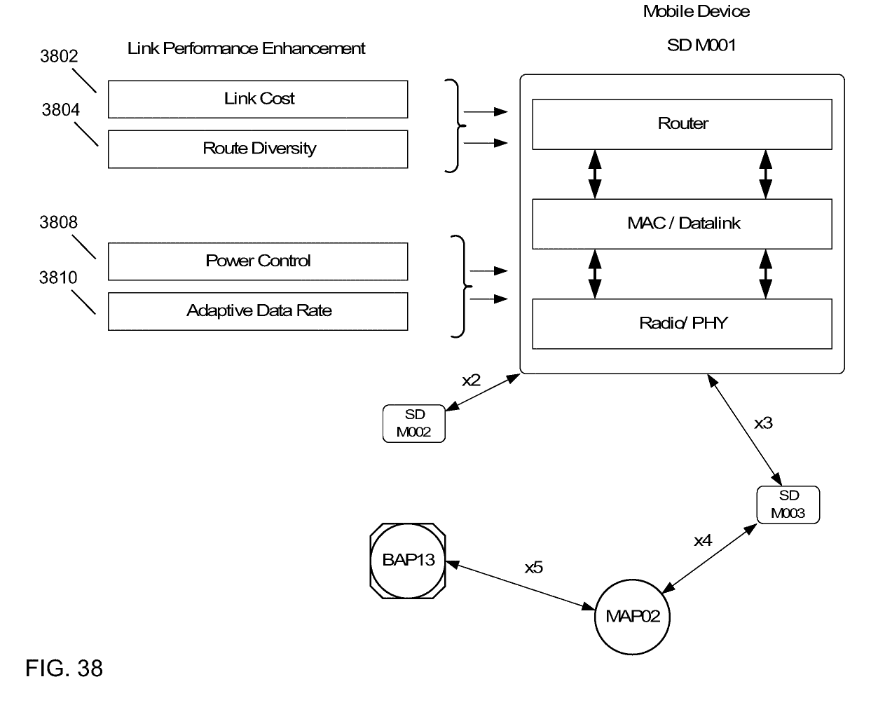

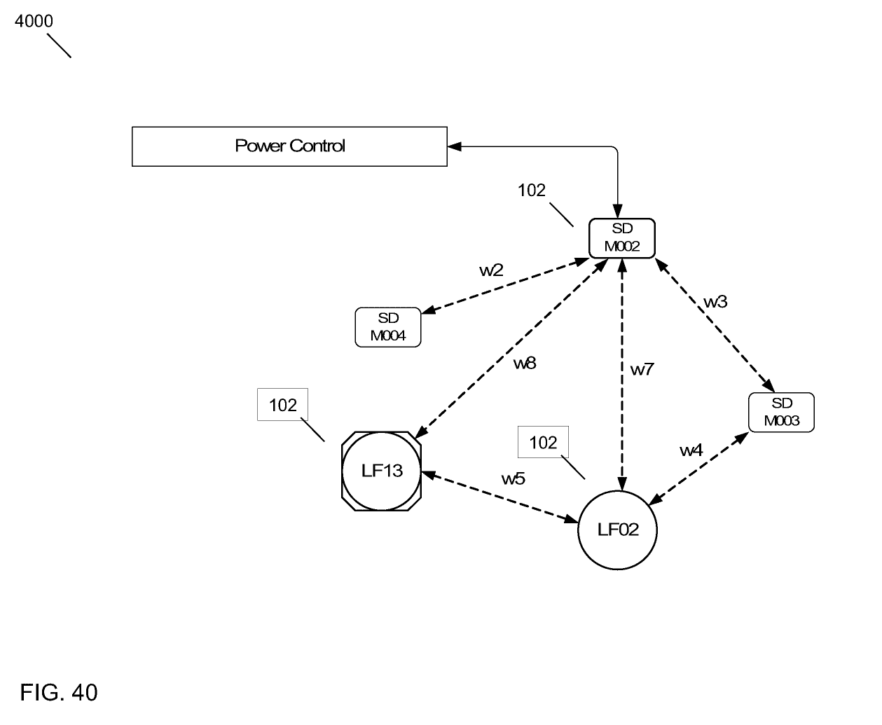

In embodiments, methods and systems disclosed herein may include a range of performance improvement facilities, including, without limitation power control facilities, adaptive data rate facilities, cost-based routing algorithms, route diversity facilities, independence from a pre-set route list or need to retrieve a route list, warrantable service levels, neighbor discovery, awareness facilities, and the like, as shown in FIG. 38. In embodiments, power control facilities optionally may include adaptive power control of radio transmission power from a mobile device, such as for increasing radio saturation and for graceful degradation of network performance. Power control facilities, such as shown in FIG. 40, may provide for nearby devices whispering (w2, w5, w7, w8?) to each other at low power, optionally based on channel conditions or other factors, so that they have minimal impact on the rest of the network. Power management in the MBRI system may be enabled through both a managed interface and from autonomous action at the node level. For instance, a node may individually sense power requirements to neighbor nodes through neighbor awareness, and be able to dynamically adjust power levels so that they are not to great, as to cause interference to other nodes in the neighborhood, or too low, as to reduce link quality. In another instance, power management may be provided in a more centralized manner, such as to declare certain links, services, data streams, and the like, certain power levels, such as for quality of service requirements or dedicated link assignments. In embodiments, the fixed MAPs and BAPs may also participate in power control algorithms.

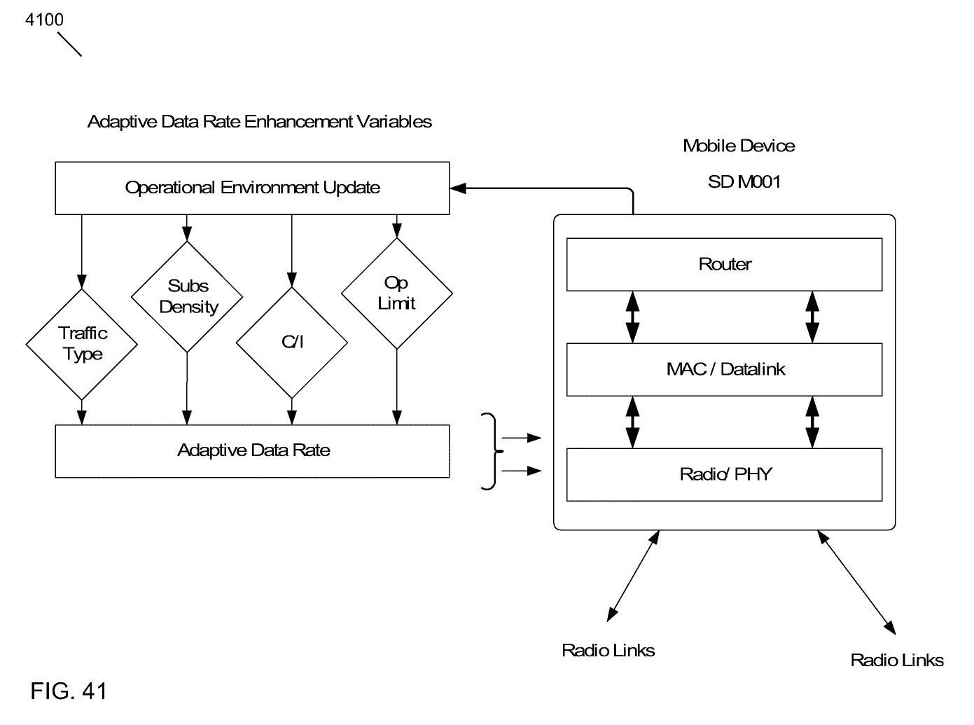

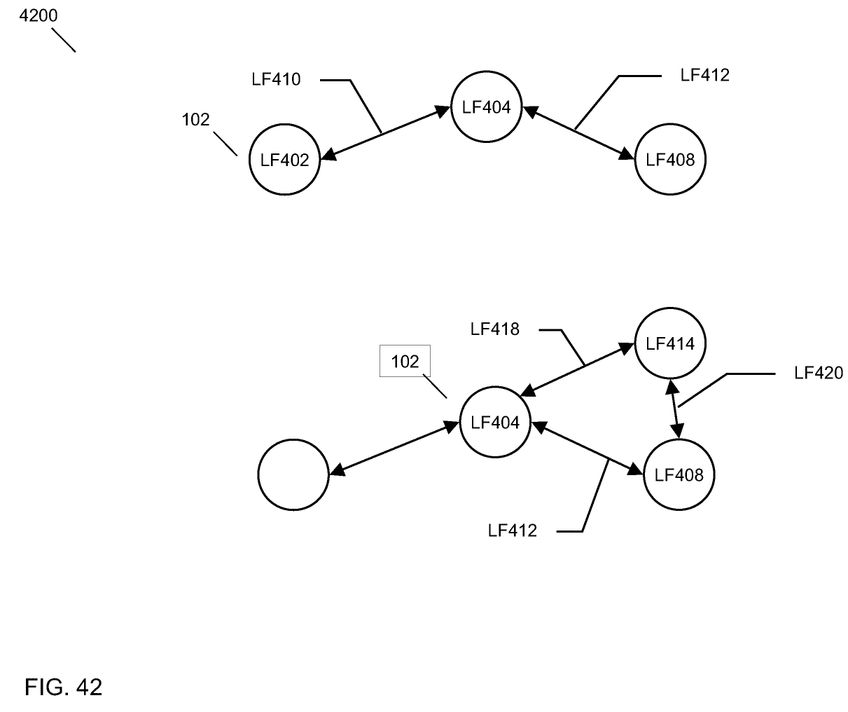

In embodiments, ADR (adaptive data rate) facilities, such as shown in FIG. 41, may include methods and systems for varying data rates delivered to or from a device based on a variety of factors, including traffic type, density of subscriber devices in an area, spectral conditions in an environment, terms and conditions of a subscription plan, and others. MBRI may enable dynamic ADR facilities through link-by-link autonomous data rate selection, neighbor awareness, network management services, and the like. For instance, a node may detect that a type of data traffic is requesting routing on a particular link, and the node, enabled through the ability to select data rates for individual links, may be able to automatically adjust the data rate allocation provided to the link to meet the requirements of the new traffic type. FIG. 42 illustrates one method of how adaptive data rate may be utilized.

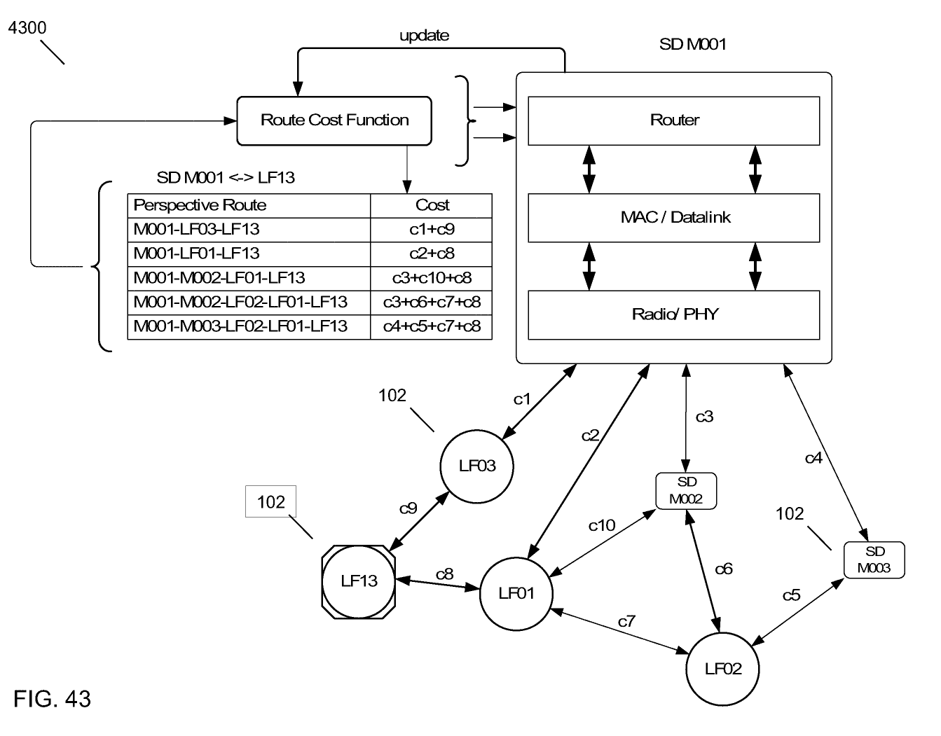

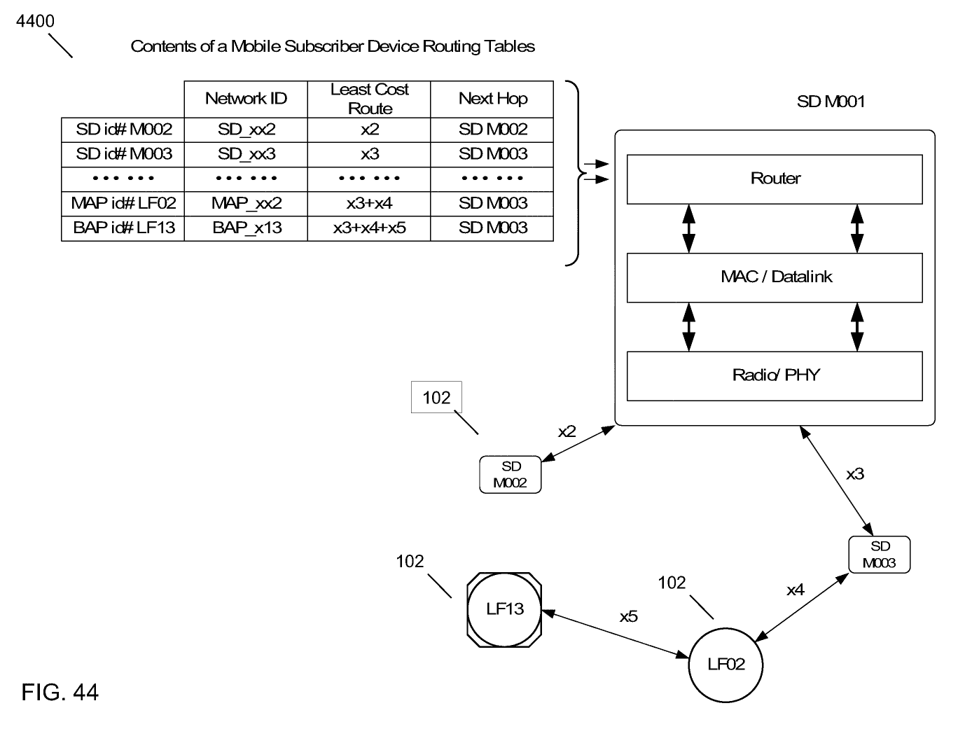

In embodiments, Cost-based routing algorithms may include algorithms that assign “costs” to links involved in a route, and with different links being assigned costs optionally based on a variety of factors, such as the number of hops involved in a series of links, the density or type of traffic being handled by a particular link, terms and conditions of service applicable to a particular link, quality of spectrum or channel conditions for a particular link, power required to communicate to a particular link, or the like, such as shown in FIG. 43. Costs of different available routes can then be compared with costs of different routes being calculated by considering overall cost of a plurality of links in a prospective route. Calculation of the cost may be based on a sum of costs, or based on a weighted average or other type of calculation. Calculation of cost can be subscriber-specific (or subscriber plan specific). For example, a subscriber plan might dictate finding “least cost” routes as to overall network performance (allowing the subscriber to have a less expensive subscription plan), or the subscriber might have a “high performance” plan that finds routes with the highest level of bandwidth or quality of service. Routing algorithms embodied in software on subscriber devices can thus take into account these various factors and route traffic in a way that accounts for the costs of routing, defined in whatever terms a network service provider prefers. Cost based routing may be enabled through MBRI capabilities, such as intelligent routing, neighbor awareness, peer-to-peer communications, link-by-link autonomous data rate selection, and the like. For instance, the cost of a route may be determined through both a node's ability to discern available routes through awareness of neighbor link availability and current traffic loading, but also on the ability of nodes in the network to alter their data rate per the changing routing requirements of the network. For example, a high quality of service route through the network may be called for, such as to provide a data stream pipeline from a mobile network node to BAP connection point. The source node may be able to determine, through an awareness of network node availability and loading, a route that best provides the needs of the route. In addition, the source node, perhaps in conjunction with management facilities, may be able to alter power and data rate levels to improve the conditions under which the route costs are determined. In embodiments, MBRI may provide a dynamic and flexible way for optimal routes to be discovered and enhanced. FIG. 44 illustrates one embodiment of how least cost routing may be implemented within MBRI.

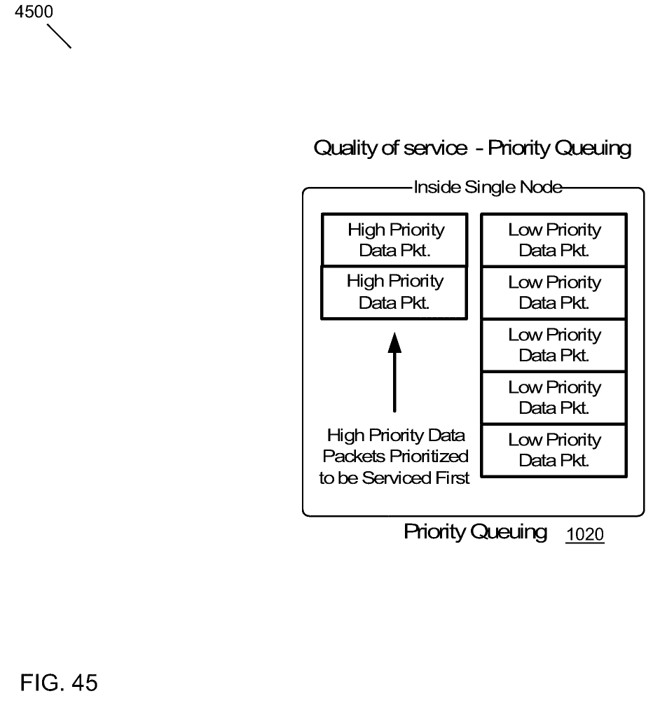

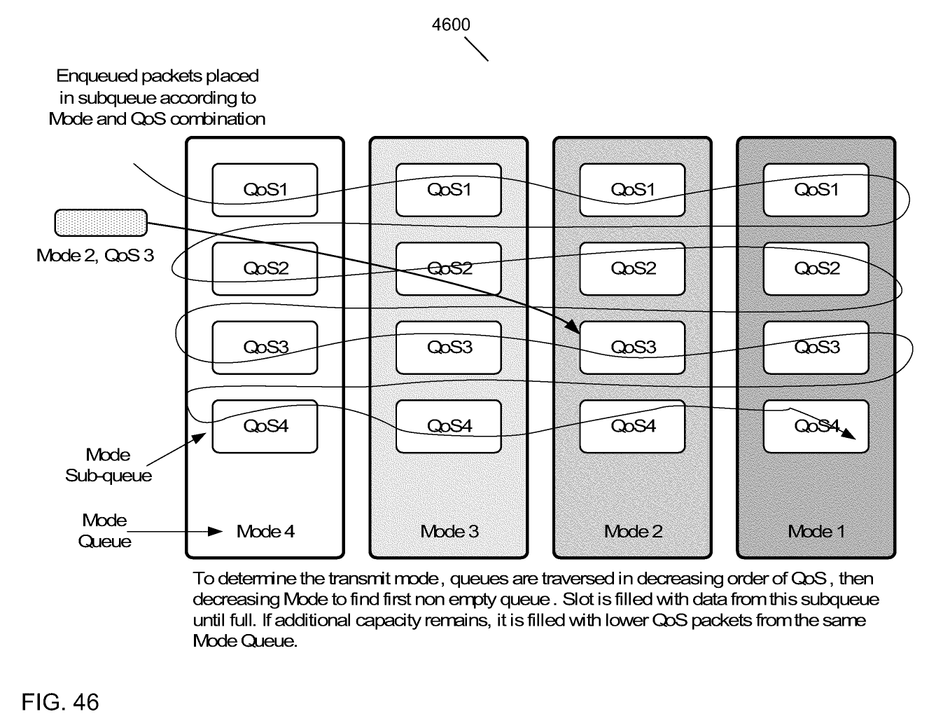

In embodiments, MBRI may provide for QoS for differentiated levels of service. There are multiple ways in which QoS is provided for differentiated levels of service for different traffic priorities, such as priority queuing, priority channel access, priority routing, and the like. Priority queuing may utilize the data queues within each node to create a system of “passing lanes” that can be used to give the traffic that is generated by some applications an advantage over others. Data queues may be organized by transmitted waveform mode and QoS setting. Priority channel access may use traffic priority settings to adjust the channel access schedule to give prioritized channel access to nodes transmitting higher priority data. A priority routing method is to route data along different paths according to priority level. High priority data may be routed along the most direct path, while lower priority data may be routed over multiple hops to balance the load level across the network. Multiple levels of priority queuing for user data within each waveform mode queue may provide a range of differentiated service levels. Additionally, a dedicated queue at the highest priority level may be reserved for routing protocol messages. This may help to make sure that data is following a suitable route through the network. Data packets may be queued on the basis of priority settings in a header. Within each sub-queue (such as a combination of waveform mode and QoS level), data may be served in a FIFO (first in, first out) manner. High priority data may be transmitted before lower priority data as shown in FIG. 45. Data packets may be en-queued according to selected waveform mode for the link corresponding to the next hop and QoS setting in the header. When a transmission opportunity is approaching, data may be selected to be de-queued for transmission. De-queuing may be based on QoS setting first, then waveform mode as shown in FIG. 46 for an example of strict priority de-queuing.

In embodiments, MBRI may enable QoS based routing, providing mobile nodes capability to route MANET traffic based on QoS information to optimize traffic, CPU load, mobile node's battery power usage, and the like. The mobile node's network layer may broadcast router control information to the MANET domain. This route control information has several components to it, including link cost, route cost, power cost, CPU cost, configurable cost, adaptive data rate (ADR) information, and the like. This information may be added to a given MANET routing protocols and broadcasted. Receiving nodes may create different routes to the destination based on different criteria such as power, link cost, and the like. Once a MANET routing protocol converges with this additional information, all nodes would have different routing topologies based on these criteria, and then tagging the traffic to determine which criteria to use for routing the traffic. Host traffic may be tagged and assigned a set of QoS value based on programmable application awareness logic. This application awareness logic may essentially determine traffic requirements for a given data flow (e.g. VoIP call vs. mp3 download). Once traffic is tagged, relay nodes may use this information to route the traffic. Other examples of routing based on QoS may include relay nodes deciding to route based on power utilization (instead of link cost) to save battery power.

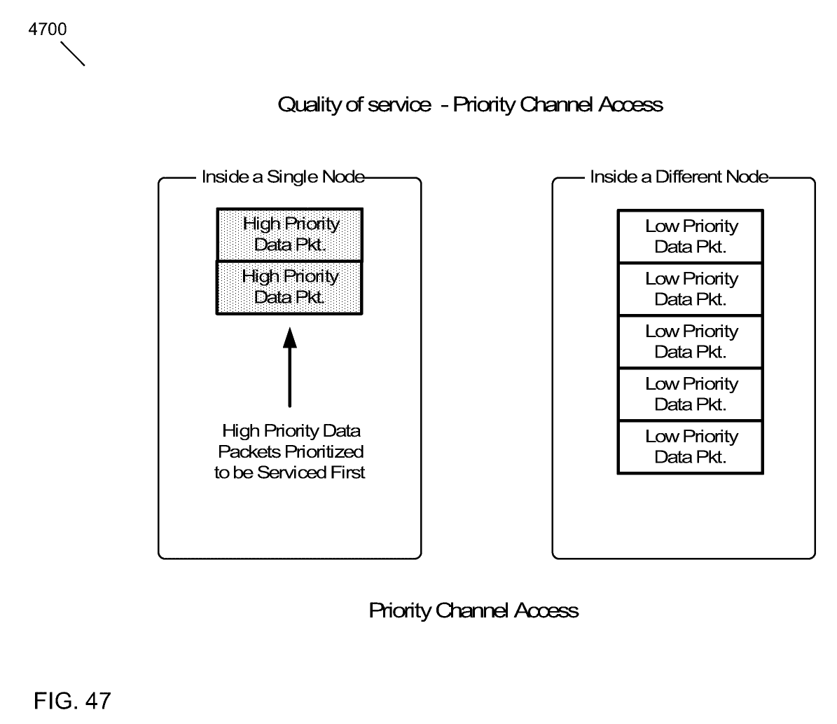

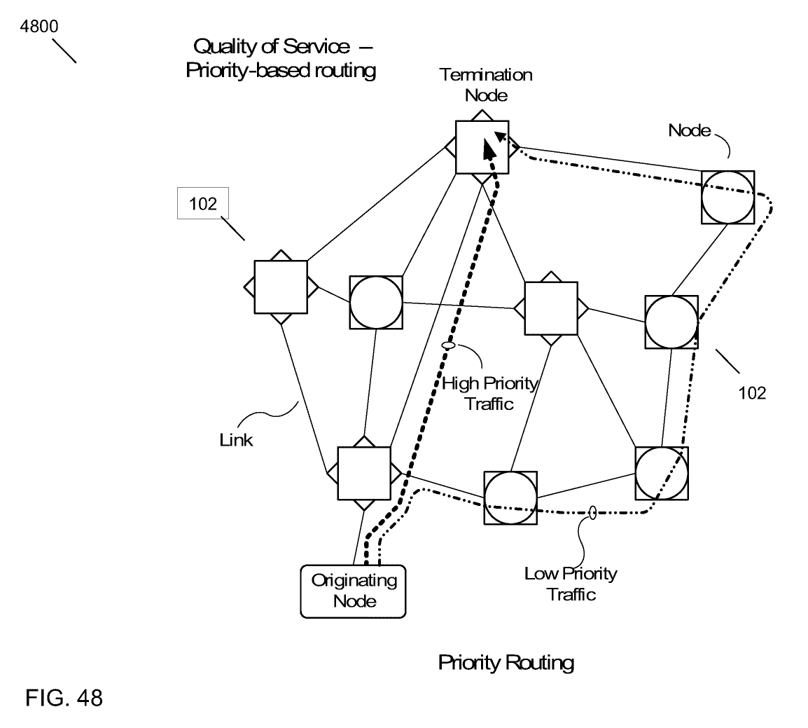

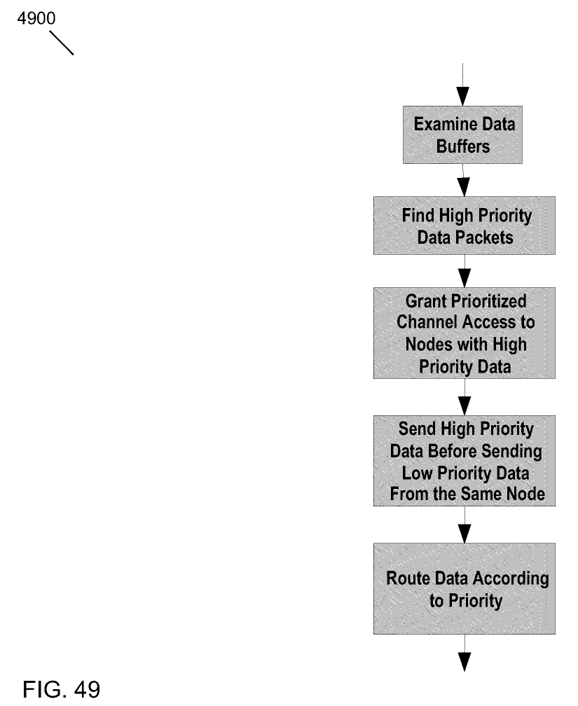

In embodiments, multiple queuing disciplines can be used, including strict priority, weighted round robin (WRR), and the like. Alternate methods of en-queuing and de-queuing, such as by next hop link instead of by mode may also be supported while maintaining the QoS sub-queues within each queue. The queue depths may be monitored to allow a node to indicate when it is experiencing congestion and needs more transmit slots to satisfy its offered load. The queue depths may be transformed into calculation of a “Node Weight” that is used to adjust transmit scheduling. The Channel Access module may be responsible for determining which node transmits during each time slot. When the node “wins” a time slot, it transmits. Channel access is partitioned into individual time slots. Without differentiated data priority levels, all nodes may have statistically equal opportunity to transmit during a given slot. When multiple levels of priority are enabled, a series of node weights corresponding to a combination of priority levels and data queue depth may be used to adjust the transmit schedule. This may allow nodes with higher node weights to win statistically more slots per second in order to meet their need for increased channel access and high priority transmission. FIG. 47 shows differing priority data inside the node queues inside two different nodes. Differentiated routing may send data along different paths across the network topology according to data priority. High priority data may be sent along the quickest, most direct route over the network, while lower priority data may be sent along a path that balances the data traffic across the network topology. An example is shown below in FIG. 48. The multiple levels of providing QoS prioritization are shown below in FIG. 49. High priority data packets within a node may be transmitted before lower priority data packets. A node with high priority data packets may be granted preferred channel access over a node containing lower priority data. Multiple routes between source and destination may be set up to allow high priority data to take the quickest, most direct path, while lower priority data may take a longer path in order to balance network load across the topology.

In embodiments, route diversity facilities may include software and technology on subscriber devices that enable selection of routes among a plurality of diverse routes, optionally including routing packets across diverse routes to ensure a very high or specified level of QoS. For example, if a subscriber plan calls for a particular level of quality of service, IP traffic packets to and from that subscriber device may be routed redundantly across various routes, ensuring that if there is failure of one route, packets can nevertheless be assembled for the intended traffic. Coupled with the other capabilities described herein (adaptive transmit power control and data rate based on channel conditions, for example), route diversity may allow a service provider to ensure high (or desired level) of quality of service; thus, a service provider may warrant service levels, guaranteeing the delivery of service to a pre-committed service level in an entirely mobile network (such service level commitments being impractical in conventional cellular networks, where quality of service is highly dependent on density and traffic of mobile devices in proximity to a given base station). Route diversity may also include capabilities for SAR, such as using error correction techniques associated with packet segmentation and reassembly in the fixed Internet or other IP-based networks. In embodiments the MBRI, by having true IP-based routing, may allow independence from a pre-set route list and therefore independence of the need to retrieve a route list from a server or fixed infrastructure component, thereby simplifying routing as compared to conventional mobile networks. Neighbor discovery and awareness facilities may include software and components for identifying nearby MBRI-enabled subscriber devices and automatically establishing links with the other devices.

In embodiments, methods and systems may include facilities for registration of users, such as using DHCP for registration, optionally including registration independent of the need for HLR or VLR as required in mobile cellular networks. Management facilities may include management independent of cellular back office, such as for billing for data, authentication, provisioning, switching, and the like. In embodiments, a management path may be established for managing back office functions, distinct from the traffic path used to pass various types of traffic among subscriber devices. The management path may be implemented in various configurations, depending on the desires of the service provider or network operator. For example, a real-time continuous management path may be provided, in which the activities of individual subscriber devices are tracked, recorded, and managed at all times, including facilities for tracking the load of traffic handled to and/or from a subscriber device, the type of traffic, and even the content of the traffic (subject to regulatory and other privacy constraints). The real time management path may be provided as an IP-based management path, using all of the IP-routing capabilities described herein, and the management path may allow a service provider to interact with applications on the subscriber device, such as to deploy applications to a subscriber devices, enable or disable applications or capabilities on the subscriber devices (such as to allow higher performance capabilities, to alter service plans, or the like), to monitor traffic for purposes of administering service plans, and many other functions. Any of those activities may alternatively be provided in a batch-mode management path, with subscriber devices provided with applications for recording their activities and periodically reporting activity levels, traffic types and the like to a service provider or network operator.

In another alternative embodiment, a subscriber-administered management path may be provided, in which a subscriber (such as an enterprise, educational institution, government entity, organization, or even a family or individual) may operate and manage subscriber devices without intervention of a conventional network operator. For example, a company could manage devices in a company headquarters, deploying applications, enabling or disabling capabilities, or the like, without the need to monitor traffic or usage, because the network bandwidth is provided entirely by the combination of the local swarm of IP-enabled subscriber devices and the enterprises' own local area network.

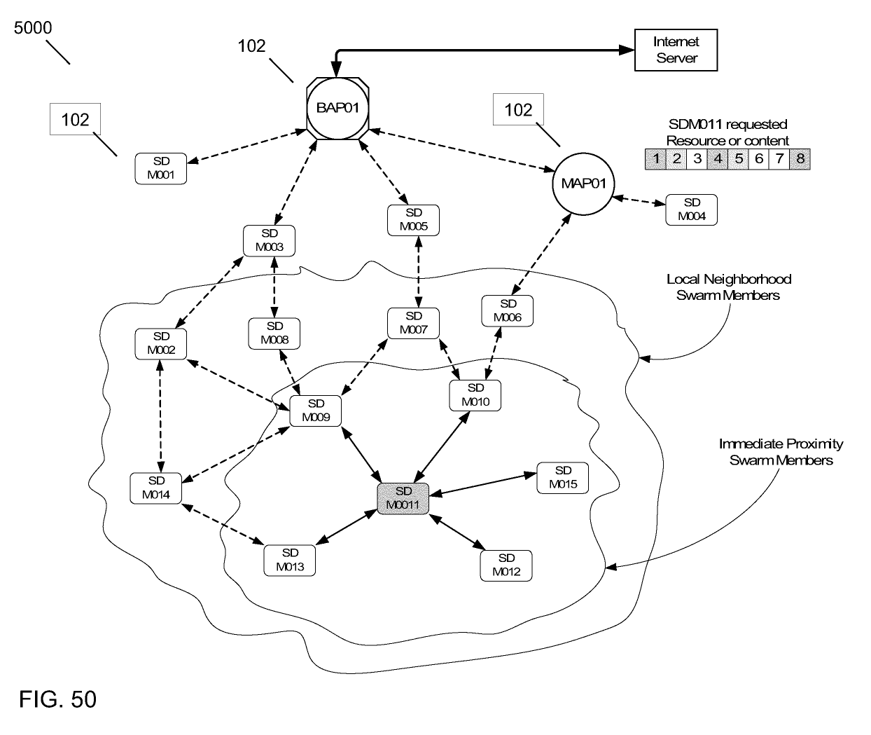

The existence of a subscriber-only management path may support, among other things, establishment of an entirely local IP-enabled network (a local Internet), consisting of a swarm of mobile devices in geographic proximity to each other, optionally extended or supported by local fixed assets such as local area networks. Such a network may allow internal traffic that is highly secure as compared to Internet or cellular traffic, in which traffic and content are transmitted, and often stored, on servers owned and operated by unknown entities distributed around the world. Such a local or geographically focused network swarm may also be provided by a service provider or network operator, using a more conventional management path, still offering an increased degree of security by virtue of its being optionally segregated from the Internet or cellular networks. A locally focused mobile swarm may also enable various value-added applications and capabilities, such as applications relating to local commerce, local news and entertainment content, local government, local public safety, local traffic, local weather, local operation of an enterprise, interpersonal communication with local friends, family and neighbors, and many others. The local swarm can enable an entire class of applications that can use very high bandwidth (e.g., at broadband video rates), that can be offered at low cost (due to low demands on network infrastructure for reasons described herein), that are highly secure (due to diminished use of unsecured network servers), and that are geographically aware (using geo-location facilities described herein). FIG. 50 provides an embodiment of local IP-based swarming, where content may be distributed within an immediate proximity swarm before requesting for external sources of the same.

In embodiments, methods and systems disclosed herein may allow effective equivalency between the MBRI core stack and the fixed Internet OSI stack. Thus, applications designed for the fixed Internet may be deployed on the MBRI, and vice versa, without requiring intervention, such as of a carrier or service provider. The MBRI core stack allows two different networked devices to communicate with each other regardless of the underlying architecture. In addition, the MBRI core stack provides a basis for understanding and designing a network architecture that is flexible, robust, and interoperable. The overall MBRI model consists of seven layers, the three layers of the MBRI stack, including the physical layer (layer 1), the MAC layer (layer 2), and the router layer (layer 3), and the four higher layers of the fixed Internet OSI stack, including a transport layer (layer 4), a session layer (layer 5), a presentation layer (layer 6), and an application layer (layer 7). A sending or receiving device may implement one or more of the seven layers of the model. In embodiments, device A may be networked with device B through a transmission channel. The transmission channel may include one or more intermediate nodes between the connected devices A and B. In embodiments, the intermediate nodes may implement at least three layers of the model: the physical layer, the MAC layer, and the routing layer. In embodiments, the intermediate nodes connecting two devices A and B may process, transform, and modify the received data before retransmitting. In another embodiment, the intermediate node may retransmit the data between devices A and B without any modification or transformation. For example, the functionality of each of the layers may be pruned to meet specific requirements without deviating from the scope of the invention. In embodiments, all functions specific to a particular layer may be implemented in software and/or hardware without deviating from the scope of the invention.

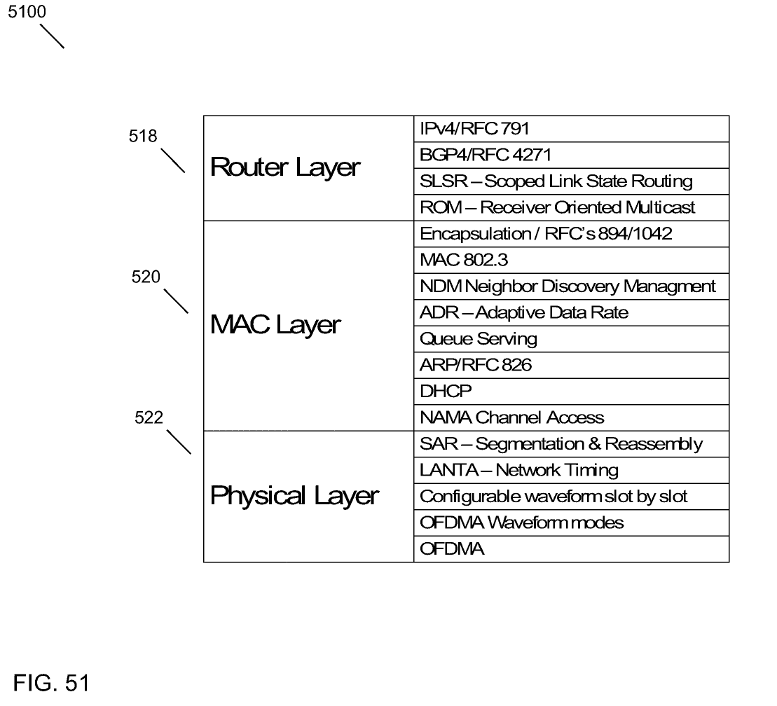

FIG. 51 provides a breakout of the MBRI core stack, including the routing layer, the MAC layer, and the physical layer. As shown in this embodiment, the MBRI routing layer may include the sub-layers IPv4/RFC 791, BGP4/RFC 4271, SLSR (scoped link state routing) and ROM (receiver oriented multicast). The MBRI MAC layer may include the sub-layers for encapsulation/RFC's 894/1042, MAC 802.3, ARP/RFC 826, DHCP, NDM (neighbor discovery management), ADR (adaptive data rate), and NAMA channel access. The MBRI physical layer may provide for the sub-layers SAR, LANTA network timing, and configurable waveform slot by slot; PLCP being replaced by the equivalent OFDMA waveform modes; and waveform discovery being replaced by OFDMA. In embodiments, the MBRI set of layers may provide a core stack that enables MBRI to facilitate the behavior and functionality of the fixed Internet in a MANET environment.

In embodiments, the physical layer may be associated with transmission of a bit stream over a channel. The physical layer may define the physical characteristics of the interface between a sending device and the transmission media. For example, the physical layer may delineate the characteristics of the interface between a receiving device and the transmission media. The MBRI may support segmentation and reassembly (SAR) of packets into physical timeslots in the physical payload, such as over the air payload, and therefore may be unique to MANET systems. In embodiments, most SAR functions in the stack may take place at the packet/MAC boundary. SAR may improve data delivery efficiency and allow packet lengths greater than single slot capacity. With respect to transmission, SAR may segment layer 2 data grams (essentially IP packets with an additional datalink header) to efficiently fit available payload capacity of a single time slot transmission. This may improve slot packing efficiency, where some of the SDUs may be segmented into fragments. The fully formed data link PDU may be sent to the physical layer controller for forwarding to the modem. With respect to interfaces, the physical layer controller may send fully formed slot payload ready for transmission and waveform mode definition, and data queues may pull data from a specified queue for segmentation. SAR may reassemble individual segments to form the original layer 2 data grams at the receiver node. The reassembly module may receive SAR SDUs (fragments) and reassemble them into data SDUs. The fragments may then be buffered and ordered according to SAR sequence numbers. When all the fragments that correspond to a data SDU are buffered, then the complete SDU may be sent to the L2 Forwarding switch to determine its next destination. When the reassembly process is started for any SDU, a configurable timer may be set. If this timer expires before reassembly is complete, then the reassembly process may be aborted in order to prevent the reassembly process from “hanging” when fragments are dropped or delayed. Un-segmented data and control SDUs may be passed directly through to the L2 Forwarding Switch. In embodiments, the SAR process may execute in a variety of ways, such as independently for each link in a multi-hop path through the wireless MANET, on the end-to-end route over the wireless portion of the network, and the like. In embodiments, there may be an SAR L2 Forwarding Switch that sends assembled data SDUs for further processing; a data link PDU De-capsulation that receives SAR SDUs, Data SDUs, and Control SDUs once data link PDU is broken into its constituent parts; a physical controller that receives demodulated data fragments for reassembly into original SDUs, and then IP packets; and the like.

The MBRI physical layer may provide for a local area node tracking algorithm (LANTA), a local node based timing algorithm that relies on distributed data across the MANET to derive actual network time (as opposed to a centralized time source for the standard Internet). In the MBRI MANET system, the system clocking may be a bit more complex than many systems in that the node must establish a network clock reference from the data received from other nodes. The local node may derive its clock offsets from its neighbors. Each node may estimate on receive the time offset and updates this estimate relative to the local clock on all observable links. Each node on transmit may send information to the receiver(s) its accumulated time shift since the last transmission so that this change since the last transmission can be subtracted from the local estimate at each receiver node. If a node has observed a packet from the AP, this node may reset its local reference to match the AP for network time and this change may get reflected in the next transmission to the other neighbor nodes. In embodiments, LANTA may interface with the other blocks in the physical modem to extract the time information from the received slots.

The MBRI physical layer may provide for a configurable waveform slot by slot, where each slot of every frame may be modulated independently of other slots in the frame depending upon the node destination and link characteristics for the end node. The modem at the receiver may detect the signal, demodulates a few bits of self-discovery data indicating which waveform mode was transmitted, and then demodulate the data payload sent during that time slot. To enable adaptive data rate (ADR) link adjustment across the MANET, the receiver may need to be able to decode and demodulate the transmitted data without knowing in advance which waveform mode was used to encode the data. Self-discovery bits may be encoded in every waveform burst so that once the signal is detected, these bits may be decoded to identify the signal processing needed to demodulate the transmitted waveform mode. This may occur independently on a slot by slot basis, and may be enabled by the independent slot configurability. In embodiments, this process may interface with the MAC's physical controller to essentially receive “slot commands” indicating whether to transmit or receive and the associated frequency and bandwidth and waveform mode (on transmit).

The MBRI physical layer may provide for OFDMA/OFDMA waveform modes, where a family of waveform modes may be implemented to provide an adaptive modulation capability that balances waveform capacity and demodulation robustness. Each waveform mode may be parameterized by a combination of parameters, such as occupied bandwidth, error-correcting code rate, modulation technique, and the like. In embodiments, the choice of these parameters may represent a trade-off between slot payload carrying capacity (i.e., data rate) and demodulation performance.

In embodiments, the physical layer may be associated with the MAC layer, where the MAC layer is provided to help impede the condition of collision of data (packets). The MBRI MAC layer may provide a high quality peer to peer packet transmission/reception protocol for passing frames between nodes and for distinguishing between peer to peer, peer to network, and network to peer traffic. The MAC layer may also manage the radio resources of a single node and control sub-network layer convergence functions such as segmentation and reassembly, QoS, throughput fairness, adaptive data rate control and transmit power control. The MBRI MAC layer may utilize encapsulation/RFCs 894/1042, where channel access and segmentation, and transmission may be used to determine which packets to transmit over the air and how to break them up for over the air transmission. In embodiments, the standards may only be relevant at a nodal boundary between L3 and L2 and controlled by MTU size constraints at the layer boundary. A downward path (from L3) module may receive payload messages (packets) from the routing layer with a MANET Header already attached to them. This header may tell the data link about source, destination, and next hop route information as well as IP protocol type (e.g. TCP/UDP/ICMP), and the assigned QoS parameter for queue selection. An additional layer of forward error correction (FEC) may be applied to long IP packets (such as >1000 bytes) replacing the native cyclic redundancy check (CRC) in IP to provide improved performance over the wireless interface. This module may also be responsible for mapping the information in the MANET header into appropriate transmission modes and queues. There may be an upward path (to L3) module, which may remove the MANET Header and pass the packet to layer three. If the MANET Header indicates that the received SDU is a Control SDU received from the corresponding data link process in another node, the data link Control Message may be sent to the Neighbor Management and ADR module for interpretation. In addition, any FEC applied at the IP layer may be removed. There may be a number of interfaces, such as the L2/L3 API that may send and receive payload messages (packets) to/from the router layer with a MANET header already attached to them; an L2 Forwarding Switch that may receive data that is not eligible for L2 Forwarding, including payload data headed for L3; Data Queues that may en-queue the packets onto the message queues for transmission on the air interface based on the QoS level in the MANET Header and the ADR Mode on the link to the next hop; Queue Management that may provide the translation between next hop and proper mode queue; Neighbor Management and ADR that may forward data link control messages received from other nodes to the neighbor management and ADR module; and the like. Similarly, de-capsulation may be the reverse process of stripping off headers to recover the original IP packet after traversing the wireless network.

The MBRI MAC layer may utilize MAC 802.3, a standard function meaning that MBRI obeys the rules for MAC transport. That is, MBRI uses MTU sizes and buffering akin to the MAC standard. In embodiment, some MBRI functions may be different, for example, an MBRI state machines not retransmitting lost frames. MBRI may also utilize other standard stack functionality, such as ARP/RFC 826, DHCP, and the like.

The MBRI MAC layer may utilize neighbor discovery and management (NDM) protocol to develop and maintain a list of nearby nodes called “neighbors”. NDM may discover and maintain the neighbor information and makes this information available for other processes (e.g., Channel Access, Routing, etc.) to make their decisions based on this information. Nodes are considered one-hop neighbors if they can communicate directly over the wireless link. Nodes are considered two-hop neighbors if they communicate over two hops across the wireless topology using exactly one relay node. The collection of one-hop neighbors may be called the “one-hop neighborhood”, while the collection of all one-hop and two-hop nodes combined may be called the “two-hop neighborhood”. In a distributed network topology, each node may have its own unique two-hop neighborhood. The two-hop neighborhoods of two nearby nodes may be often partially overlapping. Nodes may discover each other's presence and maintain timely knowledge of their link status by exchanging data link control messages (DCMs). DCMs may be sent using a pre-defined waveform mode (typically the most robust mode available) in order to form a richly connected neighborhood topology. The neighbor management portion of this module may be responsible for interpreting the received DCMs to form and update a neighbor table containing this link-state information. Conceptually, the neighbor table may contain a row of entries corresponding to each neighbor. A neighbor node may be added to the neighbor table when this module receives a DCM from the neighbor. A link quality measure may also be maintained for each neighbor, where the link quality may be incremented upon successful data reception from a node and decremented when the node was expecting a transmission from the neighbor but did not successfully receive one. In addition, nodes may be deleted when their DCMs are not received for some period of time, such as they are ‘aged out’ as their link quality measure drops to zero. A collection of network entry and formation protocols may control network formation, where a “network” in this context may be a collection of nodes that have discovered each other. Upon boot-up, a node may enter a listen-only mode for a short period of time to obtain time synchronization and begin forming its neighbor table. After some configurable period of time, the node may broadcast its DCM containing its one-hop neighbor table information. Other nodes receiving this information may add this node to their own neighbor tables. This updated information may then be reflected in the neighbor nodes' subsequent DCM transmissions received by the node entering the network. Once link quality measures reach a certain level, a “link” may be declared and the router notified, thus allowing the node to begin sending payload data over the network. In embodiments, there may be associated interfaces, such as Packet En(De)capsulation that may receive data link Control Message transmitted by a neighbor node; L2/L3 Link Manager Helper that may send an indication of neighbor link state change to notify router; Neighbor Table that may read Neighbor Table information and write Neighbor Table updates; Queue Management that receives an indication of queue depths by QoS level for determination of Node Weight for inclusion in transmitted DCMs; and the like.

The MBRI MAC layer may utilize adaptive data rate (ADR), a link by link matching of over the air capacity to the needs of capacity for packet forwarding. This function may not be needed in the Internet, since the underlying media does not change in capacity characteristics, unlike the spectrum between two nodes on a packet by packet basis. In ADR, once neighbors are discovered and links established may be made by using the lowest (lowest capacity, most robust) waveform mode. An ADR adjustment algorithm may be applied to increase the data rate on the link to the maximum rate that can be reliably sustained (i.e., low slot error rate) based on link conditions. The system may be able to adjust link data rate to maintain adequate demodulation performance in the presence of changing link conditions. When link conditions degrade below a certain threshold, the ADR algorithm may be able to rapidly decrease the link rate to a reliable mode to reduce the amount of data that is lost. When link conditions support higher data rates, the ADR algorithm may increase the link data rate to increase payload delivered by each slot. Otherwise, more slots may be needed to deliver the same amount of data, reducing the overall capacity carried by the network. The multiple possible combinations of waveform parameters may be organized into a one-dimensional ordered list of monotonically increasing data rate with correspondingly decreasing signal robustness. The ADR algorithm may “walk up and down” the list dynamically as a function of observed link performance A combination of measurements characterizing link performance may be available. For each received time slot, the modem may return estimates of received signal strength (RSSI), Eb/No (SNR), and pre-FEC bit-error rate (BER) along with the slot payload data, transmitting node ID, and transmitted waveform mode. The data link control message may include the number of slots transmitted during each time period, such as 1 second intervals, for each waveform mode, allowing the receiving node to calculate the slot error rate for each waveform mode. These link observation statistics may be grouped by transmitting node and mode to adjust the receiving node's suggested waveform mode for each link. In embodiments, there may be associated interfaces, such as data link PDU de-capsulation that receives slot counts by neighbor node and ADR mode, neighbor table that reads neighbor table information and writes neighbor table updates, and the like.

The MBRI MAC layer may utilize queue serving, inbuilt ToS and QoS prioritization at a MAC Layer. This function may not be needed in the Internet, as they may not be resolved at the edge boundary because of MPLS types of algorithms, such as because the media is constant in its QoS. The queue management module may determine queue selection when packets are en-queued and de-queued and monitors queue utilization. Data packets may be en-queued according to ADR mode of the next hop and QoS setting in the MANET header. This module may forward the current link waveform mode from the neighbor table to the packet en(De)capsulation module to allow the data to be placed in the proper queue. When a transmit slot is approaching, data may be selected to be de-queued for transmission. De-queuing may be based on QoS setting first, then waveform. Multiple queuing disciplines may be supported, including strict priority and weighted round robin (WRR). Mode-based queuing may be used since the NAMA channel access protocol may schedule node transmissions without specifying the destination. In this way, a transmitting node may send data to multiple neighbors using the same time slot. Queuing by waveform mode may allow the network to select the most efficient link rate that has data to send. The queue depths may be monitored to allow a node to indicate when it is experiencing congestion and needs more transmit slots to satisfy its offered load. The queue depths may be transformed into calculation of a “Node Weight” that may be used to adjust transmit scheduling in the two-hop neighborhood. In embodiments, there may be associated interfaces, such as packet en(de)capsulation that may send translation between next hop and waveform mode; data queues that may observe queue depths by mode and QoS level; Neighbor Management and ADR that may send node weight; neighbor table that may pull a waveform mode by one-hop neighbor; segmentation and transmission that may send de-queue selection; and the like.

The MBRI MAC layer may utilize node activated multiple access (NAMA) channel access, a protocol for the MBRI MAC layer that manages the slotted TDMA architecture that is the base control and data protocol between MANET nodes. The standard Internet has a very simple layer 2 state machine that relies on CSMA/CD or CSMA/CA at the physical layer to effect processing at the MAC level. However in an MBRI MANET there may be a need for a more feature rich MAC to take into account the variability and lack of uniform media quality at the physical layer (i.e. there may be a need to take into account the spectrum quality between nodes at any instant in time. In embodiments, NAMA may be the MBRI control and data protocol. The schedules for control slots and data slots may be computed in a statistically fair random manner based on two-hop neighborhood and time. The NAMA protocol may define the schedule. NAMA may run in a distributed fashion across the MANET topology to establish a coordinated collision-free schedule that manages the partially overlapping two-hop neighborhoods. Rather than compute the schedule explicitly like a WiMax base station would, each node may use a consistent data set (e.g., the two-hop neighborhood node ID, node weight, and time slot ID) to perform identical computations using a hashing function. The hash function may compute a “node priority” to each node for the time slot. The node with the highest priority in the two-hop neighborhood may then be elected the transmitter for that slot. In embodiments, all other nodes may be commanded to receive during that slot. A subset of the time slots may be designated as control slots, and a subset of the time slots may be designated as data slots. Nodes may use NAMA to compute the control slot schedule. In NAMA, all nodes may have statistically equal opportunity to win the slot for transmission. When the slot is won, the node may transmit its DCM and fill the remainder of the slot with payload data, space permitting. Control slots may be transmitted using the lowest (most robust) waveform mode so that all nodes (including nodes that are not yet neighbors) may have the opportunity to successfully receive the DCM and update their neighbor table. Each node may maintain a counter of the number of slots since its last transmitted a DCM. When this counter exceeds a configured value, the next slot a node wins for transmission may be treated as a control slot where a DCM may broadcast using the lowest waveform mode. The counter may then be reset. Data slots may be scheduled using “weighted NAMA” to compute the schedule. With weighted NAMA, the data slots may be divided into different weight levels for the purposes of scheduling. Only nodes with node weights meeting or exceeding the weight level of the slot may participate in the schedule computation for that slot. This may allow nodes with higher node weights to win more slots per second in order to meet their need for increased channel access. In embodiments, there may be associated interfaces, such as a neighbor table that may pull a list of nodes and node weights in two-hop neighborhood, segmentation and transmission that may send an indication of upcoming transmit slot command, a physical controller that may send an indication of transmit or receive slot command to some number of slots in advance (e.g., two slots).

The MBRI MAC layer may utilize layer 2 forwarding (L2F), which may be responsible for packet forwarding per L2F table rules. If the received L2 SDU matches the rules in the L2F table, this module may send that packet to the next hop after modifying the PCOG MANET Header with next hop and TTL information. If instructed by the L2F table or no matches are found in the L2F table, this module may pass that packet towards the routing layer. In embodiments, there may be associated interfaces, such as an L2F table that may read table data to determine next hop for the packets received from reassembly module, data queues that may en-queues the messages to the message queues for transmission on the air interface after modifying the MANET Header to reflect the new next hop and TTL information, packet en(de)capsulation that may send a packet when a L2F table rule instructs this or no entry is found, reassembly that receives packet data after completion of the SAR process, and the like.

The MBRI MAC layer may utilize layer 2/layer 3 link manager helper, a module that may convert one-hop link costs computed by ADR into L3 metrics and sends them to the Link Interface Manager in the routing layer. ADR link costs may be computed based on a combination of the waveform mode for the link, the size of the two-hop neighborhood, and the node weight distribution in the two-hop neighborhood. The L3 metrics may have a courser granularity (such as four or five different values) than the L2 costs, and they may not change as frequently in order to reduce downstream computation and overhead transmission impacts on SLSR. L2 metrics may reflect radio “reality” on a short-term basis, while L3 metrics may represent a more stable, coarser representation of link capacity to prevent excess routing protocol traffic. In embodiments, there may be associated interfaces, such as neighbor management and ADR that may receive an indication of major state change in neighbor table, a neighbor table that may pull one-hop Neighbor Table information, a layer 2/layer 3 API that may send smoothed L3 link costs through API to router layer, and the like.

In embodiments, the MAC layer may be associated with the routing layer. In embodiments, the routing layer may enable logical addressing and routing. Logical addressing is a mechanism of adding an address for identifying the source and the destination when these are on different networks. The routing layer may provide for full transparency with the Internet through a border gateway protocol edge router, and make transparent all TCP/IP and UDP functions at the routing level via OSPF, open shortest path first protocol, an interior protocol for link state management, within a regional network. The router may also be responsible for application awareness, multicast and unicast operations, multicast OSPF, IPv4 and IPv6 transparency, and the like. The MBRI routing layer may utilize standard routing functionality, such as IPV4/RFC 791, BGP4/RFC 4271, and the like. The MBRI routing layer may utilize scoped link state routing (SLSR) algorithms that may scope the amount of nodes and links evaluated for transport. In embodiments, the nearer the packet is to the end destination the more the routes may be pruned. The pruning may take into account link measures, which is not the case for standard Internet routing. That is, MBRI may map routes to the Internet routing only after evaluating and processing the availability within the MANET. The SLSR algorithm may be a unicast routing protocol used to determine routes within the wireless MANET portion of the network. The concept of multilevel “scoping” may be used to reduce routing update overhead in large networks. Each node may broadcast multiple types of SLSR control messages to provide link state updates, such as an intra-scope message, an inter-scope message, and the like. A maximum hop count or ‘scope’ may be specified over which routing protocol messages are exchanged. Multiple scope tiers may be maintained with different message exchange rates, where the most frequent, shortest distance messages may be called intra-scope messages, and less frequent, longer distance messages may be called inter-scope messages. These messages may be broadcast periodically with differing frequencies. In embodiments, a nominal update rate may be five seconds for intra-scope, and fifteen seconds for inter-scope. From state updates, nodes may construct the topology map of the entire network and compute efficient routes. SLSR may propagate link state updates as aggregates instead of flooding individually from each source. The result is that the route on which the packet travels may become progressively more accurate as the packet approaches its destination. As the network size grows large, multiple scopes with progressively increasing ranges (and decreasing update rates) may be used to keep routing overhead low. Since one-hop neighbor link state information is maintained by the data link, the “hello” packets typically sent by routers to establish one-hop neighbors may be suppressed to reduce routing overhead. Instead, the layer 2 link manager helper in the data link may forward this information to the link interface manager in layer 3. The link interface manager may continually forward this one-hop information to the SLSR process. In embodiments, SLSR may forward its MANET route information to the route table manager.

Finally, the MBRI routing layer may utilize receive oriented multicasting (ROM), a wireless routing protocol that may be optimized for determining the “spanning nodes” of a multicast tree prior to packet forwarding of a data stream that may require multicast where the tree can be updated on a packet by packet transmission. ROM may be the functional equivalent of SLSR for multicast routing, and in embodiments, ROM may have similar interfaces as SLSR. In embodiments, the MBRI stack may allow effective equivalency with the fixed Internet OSI stack. Thus, applications designed for the fixed Internet may be deployed on the MBRI, and vice versa, without requiring intervention, such as of a carrier or service provider. In addition, the MBRI stack may provide greater capabilities to a user of an MBRI enabled subscriber device, through the mobile environment that MBRI enables. In embodiments, methods and systems may include openness to a wide range of applications, including capability, for example, to download an Internet application directly on the subscriber device. Methods and systems may also include facilities for geo-location, thereby enabling location with respect to a global position, including location of a mobile device within a swarm of mobile devices.

In embodiments, in contrast to conventional wireless and fixed wired access networks, methods and systems may be provided for a mobile broadband internet network solution where every subscriber device and infrastructure node has routing capabilities to allow for intelligent routing decisions enabling intra-network peer to peer communications. Traffic between nodes of the MBRI may not need to leave the mobile ad-hoc network for routing or switching purposes. Instead, because MBRI may be routing enabled, local traffic including required signaling may stay within the MBRI. In addition, because of its unique neighbor discovery management and Adaptive Data Rate and Power Management Capabilities the MBRI enables local intelligence to be shared across its member nodes leading to the creation and deployment of new classes of services and applications. Further, because of its mobile ad-hoc network characteristic the MBRI is independent of fixed traffic aggregation points such as base stations or cell towers, and instead can leverage multiple backhaul access points in a load leveling and self-healing manner. Because of the mobile ad-hoc network waveform characteristics and the mobile ad-hoc network architectural flexibility to deploy additional Backhaul Access Points or to upgrade existing mobile ad-hoc network access points with backhaul capability the MBRI assures broadband bandwidth to the individual SD/MAP nodes in excess of conventional 3G/4G networks. If combined with dynamic spectrum access technology the MBRI can coexist within existing defined spectrum with associated active network operations.

In embodiments, there may be distinct MBRI variants, having various sub-sets or supersets of the capabilities disclosed herein. For example, a basic MBRI may contain the mobile ad-hoc network protocol stack that brings Internet access and routing capability to the Subscriber Device (SD). Various enhanced versions of MBRI may include one or more of the enhancements described herein, such as individual selected media transport enhancements conceived to improve multimedia transport of the MBRI network. A more comprehensive, commercial grade MBRI may collect a plurality (or even all) of the enhancements, offering the full extent of benefits described herein. For example, a comprehensive MBRI may include a basic MBRI coupled with the cumulative conceived transport enhancements targeted at high quality service for multimedia, multi-session applications. A version of the MBRI using dynamic spectrum awareness may allow for management of traffic based on channel conditions, including enhancements to the mobile ad-hoc network protocol stack that allow for spectrum co-sharing between non-cooperative spectrum users or dissimilar spectrum technologies, and coordination between cooperative systems.

In embodiments, an MBRI may include ad-hoc network creation and self forming capabilities, self healing capabilities, and load leveling capabilities. An MBRI may be packet size indifferent, that is, it need not be constrained to particular packet sizes or types. The MBRI may use various routing capabilities, such as unicast and/or multicast routing, routing enabled and peer-to-peer communication and the like. The MBRI, as noted above, may be Internet protocol plug compatible, allowing it to seamlessly integrate with fixed IP-routing networks. Subscriber devices in the MBRI may be neighbor aware. In embodiments subscriber devices may include geo-location capabilities. Geo location capabilities may include conventional facilities, such as GPS facilities located in subscriber devices. Geo location capabilities may also include enhanced geo location, such as locating a particular subscriber device within a swarm (such as based on the number of hops required to reach the device within the swarm from other subscriber devices of known location, based on the power levels received from a subscriber device by other nearby subscriber devices of known location, based on time-based techniques, or the like). By locating devices within a swarm, local, swarm-based applications may use the location of a subscriber device, such as for the various locally focused applications described above. For example, a commercial offer can be made to a subscriber device if the subscriber appears to be near a merchant, or the like. Subscriber devices may include radio resource management capabilities, including managing power levels, data rates, use of spectrum (optionally for channel or spectrum-aware radio resource usage with dynamic spectrum access networking (DYSAN)). Being IP-routable, MBRI devices may be unconditionally open for IP-based applications, such as web 2.0 applications, Java web applications, and the like, without requiring fixed Internet or cellular network infrastructure, such as specialized servers or device-specific application development. An MBRI may be provided in or associated with a private or public network, optionally separated from the Internet or integrated with the Internet. The MBRI may be provided with security features, applications and components used with the fixed Internet or cellular networks, including security at the routing layer and other layers of the MBRI stack. By being unconditionally open to applications, MBRI devices may be provided with security applications developed and used for any other IP-enabled device, such as anti-virus, firewall, anti-spam, unified threat management, device access security, network access control, application access control, device behavior profile monitoring, data leakage prevention, parental access control, software compliance detection, and other applications.

The MBRI may be spectrum independent; that is, it may be deployed at any spectrum location, even within small spectrum bands. With DYSAN capabilities the MBRI may offer enhanced usage of existing spectrum, such as by using available time-frequency rectangles within channels or bands not fully consumed by other usage of the same spectrum (such as by cellular networks). In embodiments, the combination of spectrum independence (e.g. the ability to operate at any frequency), and the capabilities of DYSAN (e.g. the ability to dynamically switch frequencies while transmitting between nodes), may allow MBRI to provide a high degree of frequency spectral reuse with a high level of throughput. A DYSAN enabled MBRI may be able to efficiently utilize a selected set of frequencies to operate with, allowing communications to both effectively utilize the spectrum as it becomes available, and change frequencies as the environment changes to the advantage or disadvantage of certain frequencies. In addition, the ability of MBRI to operate at any frequency may allow local MBRI configurations to be operated at frequencies that are optimized for the area. In embodiments, MBRI's ability to operate on any frequency, coupled with MBRI's DYSAN capabilities, may provide MBRI with a robust operating frequency strategy that may be unique to MBRI.

The MBRI may be provided in a highly scalable configuration (e.g. leveraging incremental increases in spectral bandwidth that become available to a service provider/operator, leveraging incremental addition of fixed or mobile backhaul or connection points to fixed Internet and other networks, and leveraging addition of increased bandwidth due to increased peering (such as in whispering modes that don't degrade the network with new users in local swarms). In embodiments, for example, mobile access points can be added, such as to enhance bandwidth to a swarm at a concert or event, and the large number of peers at such an event may allow high bandwidth peering among them, thereby enabling broadband performance in usage environments that seriously degrade conventional cellular networks. The MBRI may be provided in a structured or unstructured network architecture, according to operator design, with varying management paths as described above. For example, a city park may be configured with fixed access points that help guarantee a complete coverage of the park grounds, even when there are few mobile device nodes present. In this instance, management paths may be provided from the fixed access points to the mobile device without the need for the presence of other mobile devices. Alternately, a park in the country may be supplied with a minimum set of fixed access points, thereby providing a more unstructured network access to mobile devices. In this instance, the area network may be designed to provide an extension of the fixed internet as a function of device density. Management paths may then be developed in an ad-hoc manner, as mobile device density and placement varies. In embodiments, the fixed access points placement and capabilities may be optimized based on the degree to which the network architecture is meant to be structured.

The MBRI may be provided with varying levels of spanning network capability, including mobile access points, backhaul access points, and other access points that optionally connect a swarm of subscriber devices to fixed Internet assets, as described in more detail below. For instance, a geographic area may be found to include areas of varying mobile device density, where areas of high density are separated by areas of low density. In this instance it may be desirable to span across the low density areas with access points in order to enable the greater benefits that may be provided by a larger area of interconnectivity. Alternately, it may be desirable to have a swarm of subscriber devices not connected, say to fixed Internet assets. This may be for the sake of security, such as in the case of an enterprise, or for the sake of flexibility, such as in the case of an impromptu network arrangement in a remote area where application services are locally provided, and no need for fixed Internet connectivity may exist. In embodiments, the ability to provide varying levels of spanning network capability may enable network designers to customize the capabilities of the network to the requirements of the network application.

The MBRI may use various physical layer wave form variants, including OFDMA wave forms, slotted wave forms, half duplex wave forms, wave forms synchronized by slot, waveform variants (e.g. slotted/half duplex, synchronization on each slot separately), multi-session, and the like.

In embodiments an enhanced MBRI may include adaptive data rate capabilities and may allow high quality of service, using flexible transport for both time sensitive and delay tolerant traffic. In embodiments, adaptive data rate capabilities may be device specific, application specific, time flexible or time dependent, adjustable as a function of available frequency spectrum, configurable by the individual or service provider as a function of service cost, and the like. Time sensitive traffic may include voice services, real-time streaming media services, real-time data collection, and the like, and may require that delivery of data be uninterrupted. Delay tolerant traffic on the other hand, may be data services that may not require that data is delivered in an uninterrupted manner, such as the download of an application from the network, the transfer of a data file between peers, access to a website, and the like. In embodiments, an enhanced MBRI may provide flexibility with respect to the needs of these various data services, while maintaining a high quality of service, through adaptive data rate capabilities. In embodiments, quality of service may be maintained through prioritized queuing and priority-based channel access that may explicitly provide the differential service level. Adaptive data rate may try to maximize the data rate on the link, though it may not be necessarily visible to the end-user experience. In embodiments, the amount of data the end-user receives may be based on both link rate and time slot scheduling. At a higher link rate, fewer time slots may be needed to send a constant amount of data, leaving more time slots available for the network to service other nodes.

In embodiments, MBRI routing may use sub-queues, traffic based scheduling, optimized short/medium/large packet support, and the like, to manage routing traffic. MBRI routing may perform routing traffic management in order to improve throughput, improve quality of service, avoid bottlenecks, and the like. For example, when a node experiences a high volume of data routing requests, the node may begin prioritizing traffic throughput, such as by time sensitivity, service agreed quality of service, message size, and the like. In addition, in order to better facilitate routing flexibility, the node may begin to vary the packet size, such as making them smaller. In this way, the node may be able to better interleave the data streams, and thus better meet their varying requirements. Alternately, packet sizes may be made larger in order to reduce the overhead associated with individual packets. In embodiments, the MBRI node may provide different strategies for different data stream combinations, such as one strategy for a highly diverse data traffic set, and another for a homogeneous data traffic set.

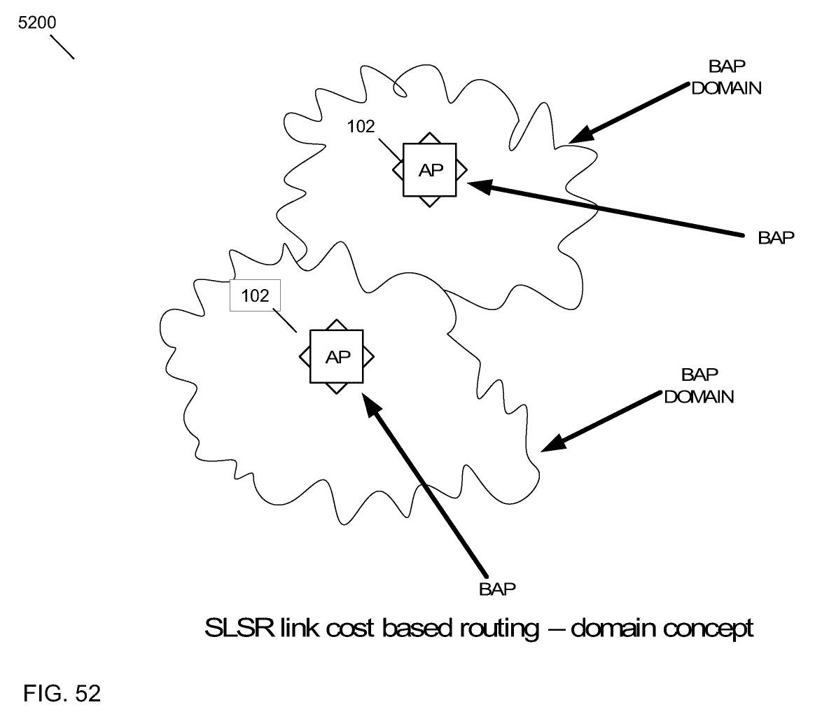

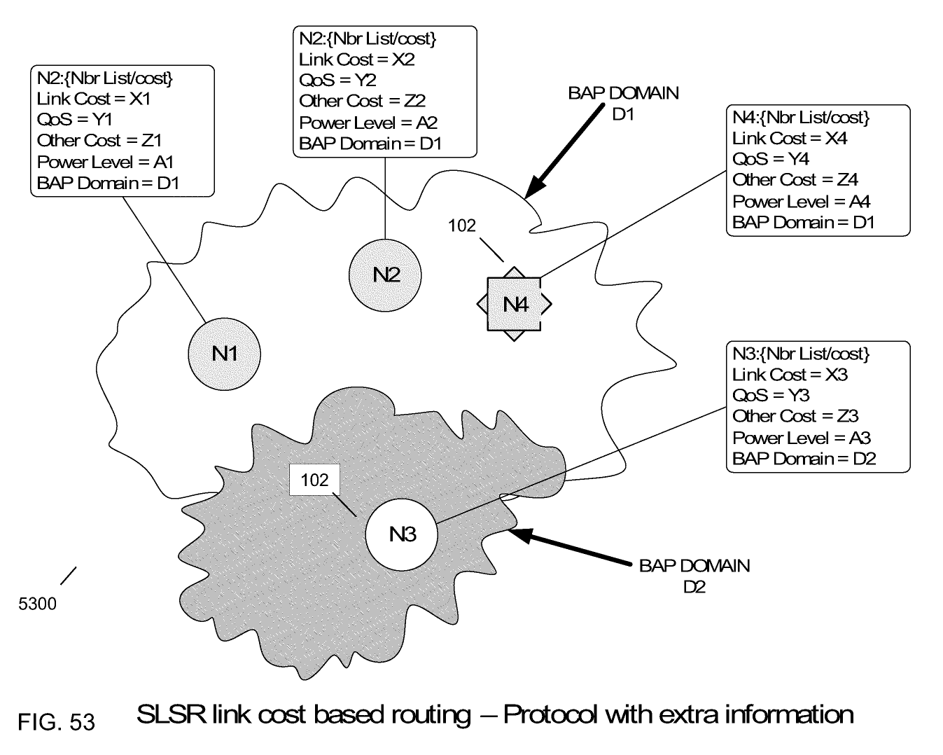

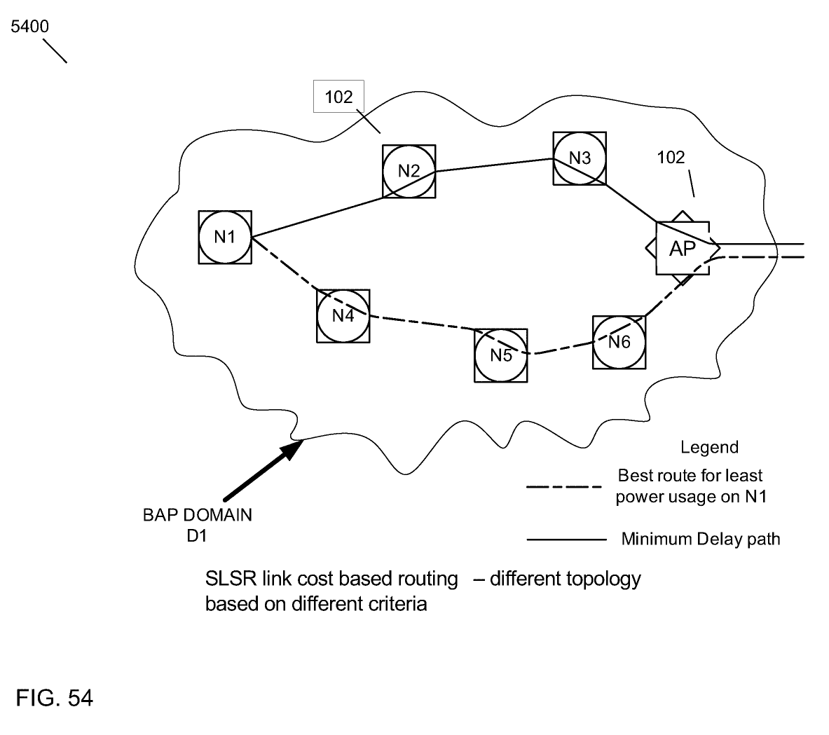

In embodiments, scoped link state routing (SLSR) link cost based routing and/or SLSR domain management may be utilized by MBRI nodes in order to improve routing efficiency, where mobile nodes may be provided a capability to determine an optimum path through mobile network by utilizing different types of cost/QoS information over any MANET routing protocol and by utilizing backhaul domain management for MBRI. Mobile nodes may use different information to calculate link cost, such as ADR, two hop neighborhood size, link data rate, and the like. Mobile nodes may provide many parameters to minimize MANET routing algorithm cost, e.g. route/link cost, QoS, power level, etc. Other mobile nodes may see MANET routing information, along with these parameters, and determine the minimal cost. For instance, a mobile node that advertises it is a low power device may not be best choice for routing even though the device has better link/route cost. Mobile nodes may use the information provided by a MANET routing protocol, along with extra information, to determine optimum network routes. Mobile nodes may create multiple paths to their destination based on different criteria. MBRI may provide a mechanism to create MANET domains when additional backhaul access points are deployed. The MANET domain concept may be similar to the cellular “cell” concept. These MANET domains may limit the scope of MANET routing, thus partitioning the network for an optimum route towards the internet. Once MANET domains are created, they may provide a backhaul exit point for MANET traffic. MANET domains may work together with other MANET domains and MANET routing protocols. This may help provide alternate routes information in the case of a backhaul failure. MANET domains may be automatically created when backhaul access points are deployed, thus adding capacity without a site survey and re-provisioning of an existing system. FIG. 52 shows a MANET domain concept, where an arbitrary MANET cloud is formed around a BAP. As shown, MANET domains may intersect each other and BAPs may not need to be at the exact center of the BAP domain. FIG. 53 shows three mobile nodes (N1, N2 and N3) and a BAP (N4) in BAP domain D1. Mobile node N3 belongs to an overlapping BAP domain D2 and co-exists with other nodes N1 and N2. All these nodes may advertise their link state (per MANET protocols) along with “extra” information such as cost, QoS, power level and BAP domains. Mobile nodes may use this information to create different topology based on different criteria. For example, some set of nodes may be used to determine a BAP's shortest path optimizing QoS, but a different set of nodes may be used to calculate the same BAP's shortest path using optimizing power usage. Mobile nodes would advertise the following properties on top of a MANET routing protocol. These nodes may use information when received from other nodes, such as cost (as provisioned), cost (as discovered), QoS (as provisioned), QoS (as discovered), power usage, hops (cost) to BAP, mobility (vehicular, pedestrian node or fixed), and the like. FIG. 54 shows determination of BAP shortest path using optimization of minimum delay versus power usage options. In embodiments, SLSR link cost based routing and/or SLSR domain management may better enable MBRI to provide efficient routing strategies for communications across the network.

In embodiments, multicasting within the MBRI network may be enabled through a node's IP routable capabilities. Multicast is the delivery of information to a group of destination nodes simultaneously using the most efficient strategy to deliver the messages over each link of the network only once, creating copies only when the links to the multiple destinations split. MBRI nodes, being IP routable, may have the capability to provide multicast transmissions across the network. In this way, the MBRI may increase routing efficiency through the network by taking advantage of node distribution and density to transmit messages to a plurality of locations, while minimizing the need for duplicate transfers.

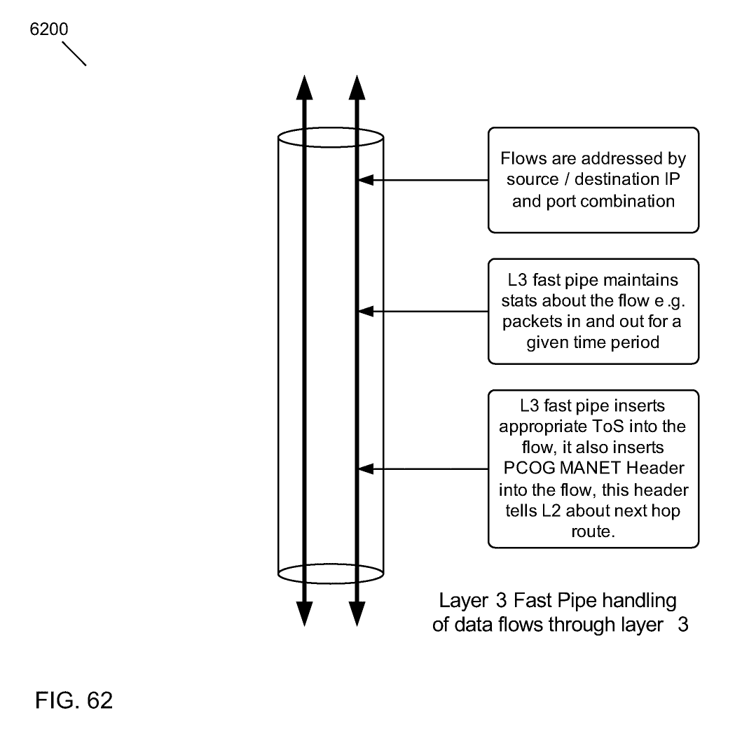

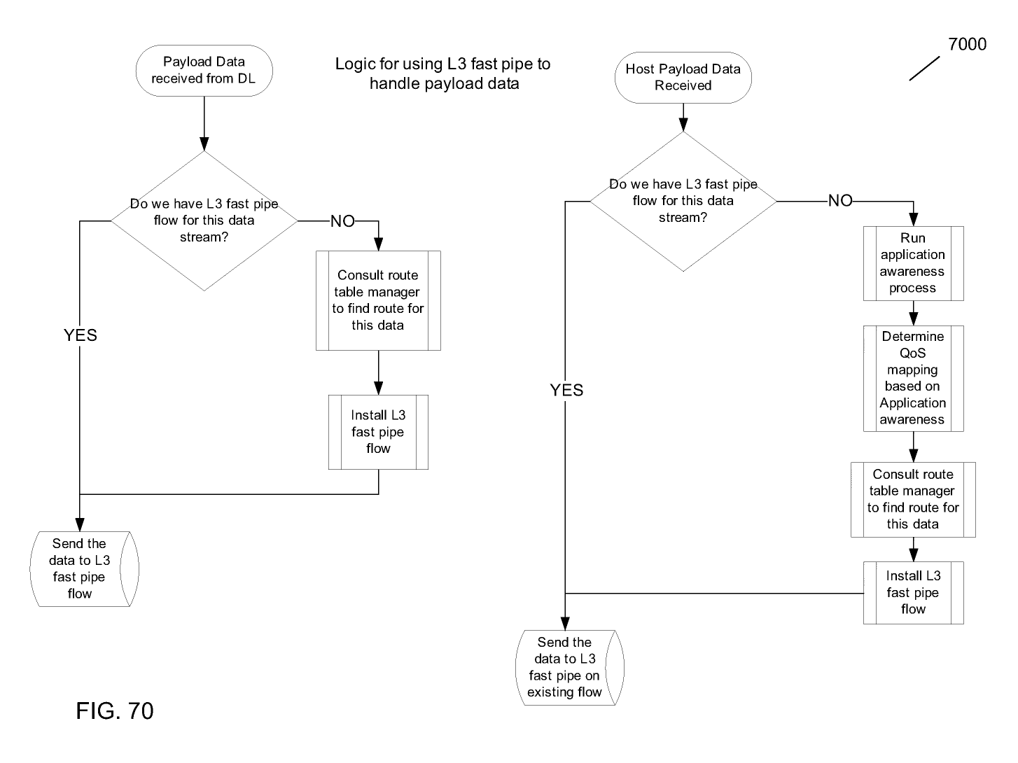

In embodiments, layer 2 forwarding (L2F) and layer 3 fast pipe may be associated with increasing the speed in communicating across the MBRI network, and may be protocols implemented inside the node. The data path through Layer 3 (L3) may be based on the concept of a L3 Fast Pipe as depicted in FIG. 62. The Application Awareness, QoS Translation, and L3 Fast Pipe modules may work together to handle bi-directional data flows between the wired interface and the data link. A list of data flows may be compiled and maintained. Each flow may be uniquely identified using the 4-way combination of source IP address, source port, destination IP address, and destination port. When data is presented to L3 over either the wired interface or the data link, these four parameters may be checked to determine whether an L3 Fast Pipe flow has been established. If it has been established, the data may be inserted into the L3 Fast Pipe with the parameters for the corresponding flow. The Ethernet header data may then replaced with a header that may contain the next hop information for the route and QoS level for the flow. When data packets with source and destination parameters that don't match an installed flow arrive at a Layer 3 interface, these modules may work together to install a new flow in the L3 Fast Pipe. An embodiment for the business logic for this process is shown in FIG. 70. The left side shows the logic for payload data received across the data link interface, and the right side shows the logic for payload data received across the wired interface. When data packets arrive at the data link interface, the Route Table Manager may be used to obtain the next hop identification for insertion into the PCOG MANET Header. Additionally, the flow may be installed into the L3 Fast Pipe. When data packets arrive at the host interface, an Application Awareness module may examine the terms of service (ToS) settings and packet statistics to identify a suitable QoS level for the flow. A ToS to QoS translation table may also be used to determine the QoS level through the MANET, and the Route Table Manager identifies the next hop. This information may be inserted into the PCOG MANET Header and the flow installed into the L3 Fast Pipe. When the next hop for the route changes, the L3 Fast Pipe may be quickly adjusted to point to the new next hop. Flows may be removed from the L3 Fast Pipe when data is not received for some period of time, such as 30 seconds, and may be configurable.

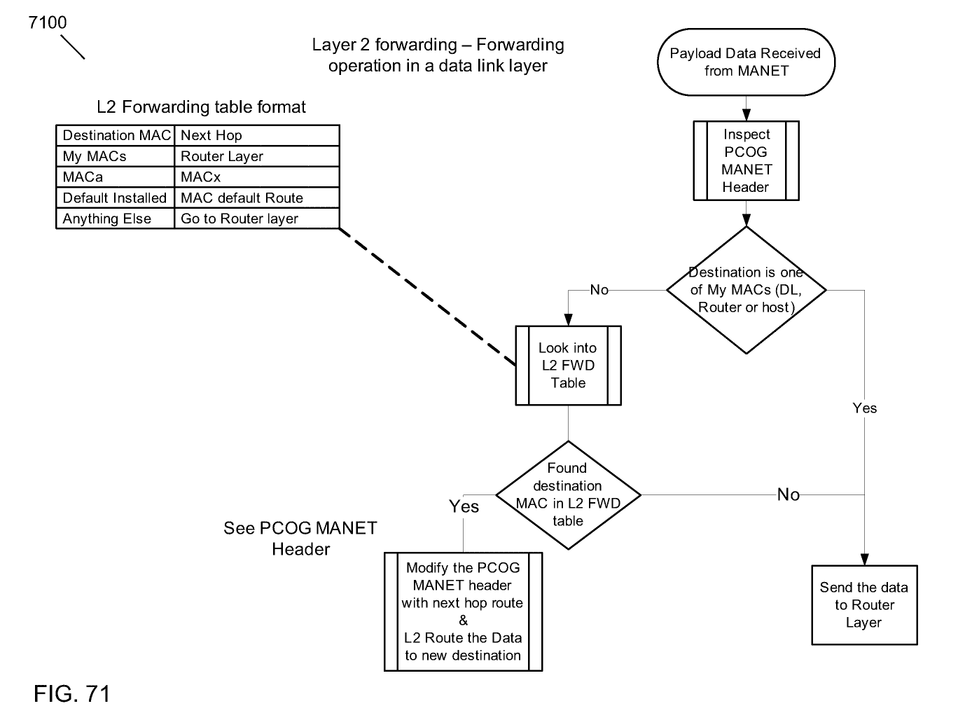

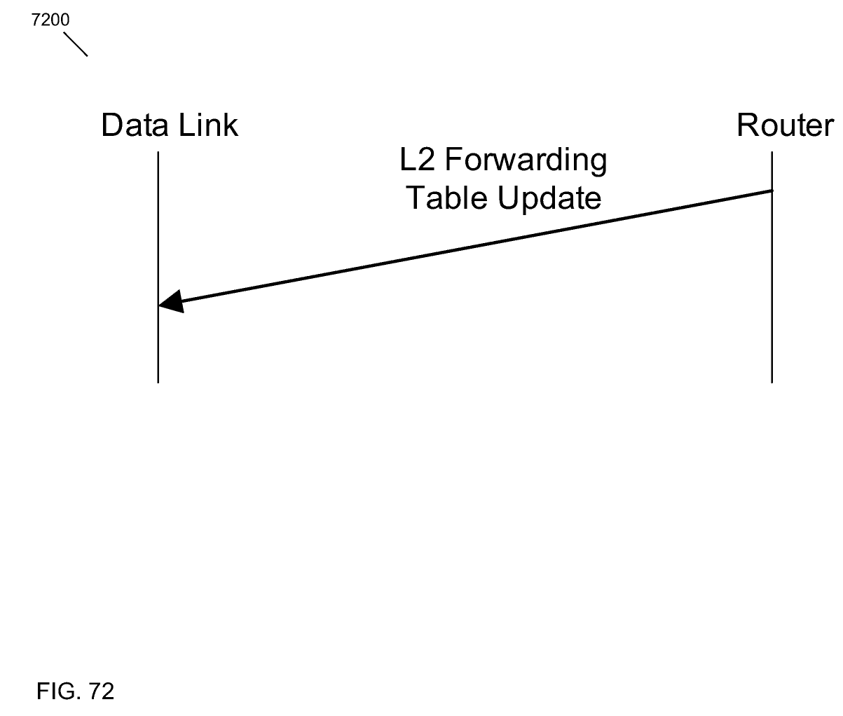

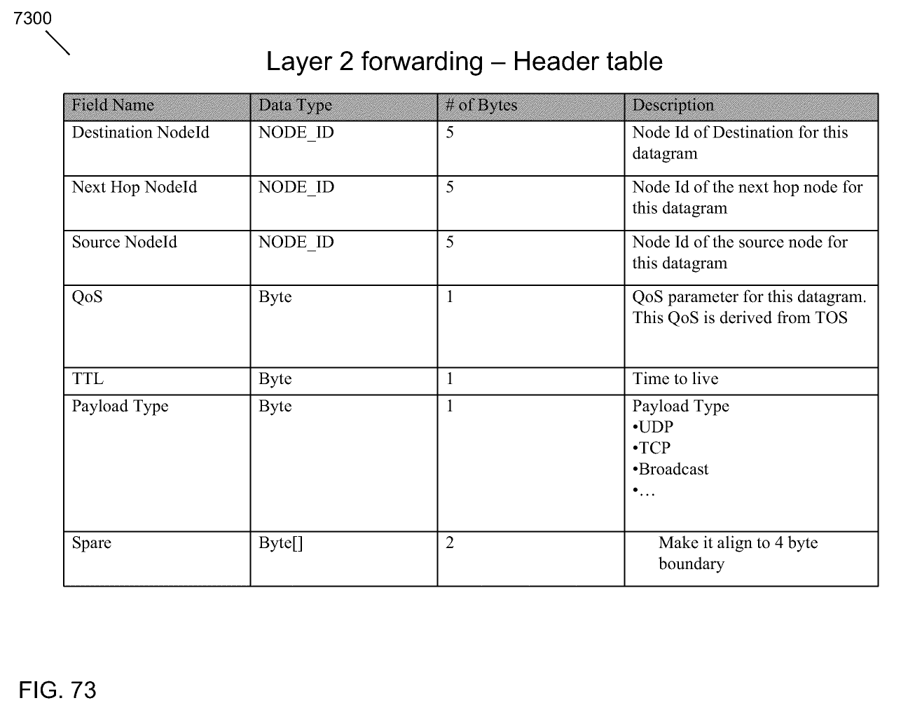

In embodiments, L2F may act as a sub-network protocol used by the MBRI nodes to circumvent routing operations taking place at layer 3 and thereby prevent timely and resource expensive routing functions from operating on incoming packets at a node. This may then provide header information that may be resolved at layer 2 to make smart routing decisions, thereby increasing the speed of decision making and increasing network throughput and efficiency. The mobile node's network layer sends router control information to the data link layer that helps prepare the layer two forwarding table. The mobile traffic may have a special fixed header, such as with source, destination, next hop routing information, and the like. Once a data link layer receives mobile traffic, it may examine the header, consult with the layer two forwarding table, and forward the traffic to next hop as determined by the layer two forwarding table. The layer two forwarding table may instruct layer two to pass the packet up to the network layer for routing. In embodiments, the networking may layer prepare and sends layer two forwarding table information to data link layer based on various MANET routing protocols, such as shown in FIG. 72. The networking layer may apply a special header to traffic, such as including source, destination, next hop and related QoS related information, and the like, such as shown in FIG. 73. The data link layer may use the layer two forwarding table information to route the packets to a destination by using special header information as identified, such as illustrated in FIG. 71. In embodiments, this may reduce latency on multi-hop paths by keeping the data from going all the way up to the router at each hop.

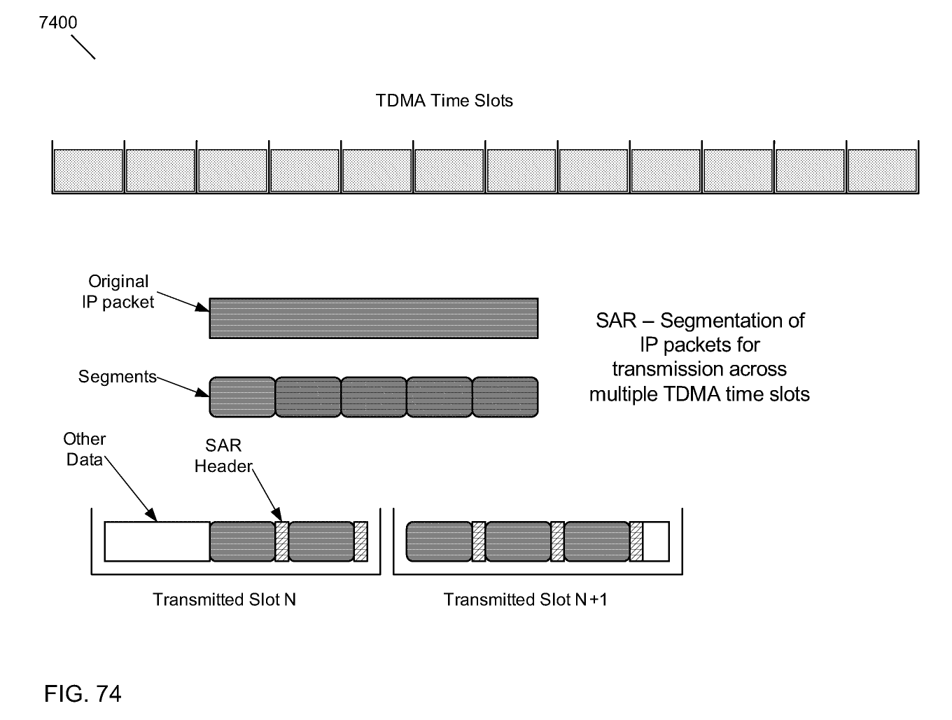

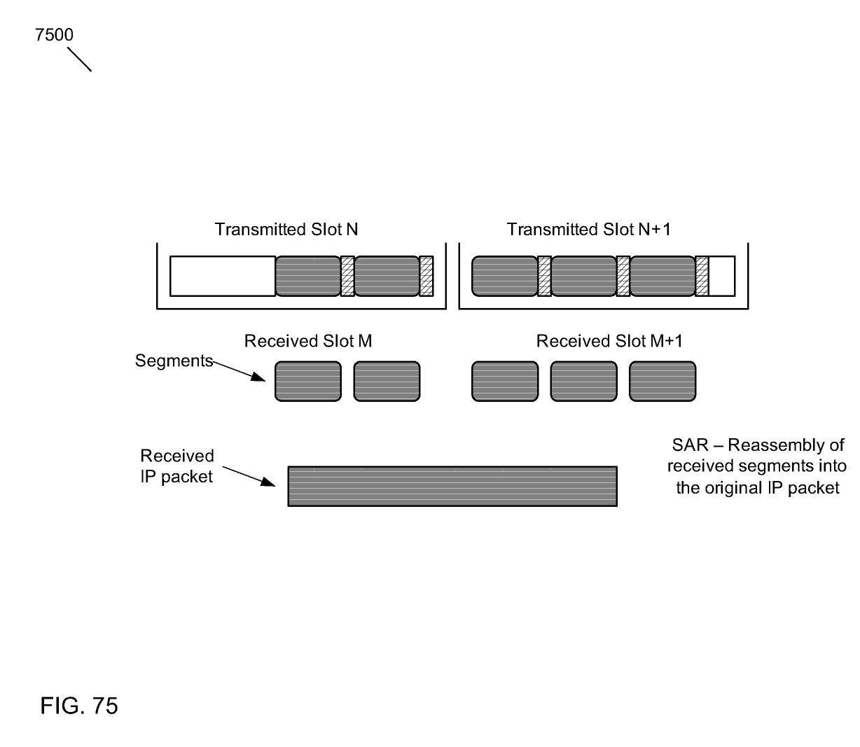

In embodiments, MBRI may support SAR, a process used to fragment and reassemble packets so as to allow them to be transported across networks, such as asynchronous transfer mode (ATM) compatible networks. In SAR, an incoming packet from another protocol to be transmitted across the network is chopped up into segments that fit into fixed byte chunks carried as cell payloads. At the far end, these chunks are fitted back together to reconstitute the original packet. In embodiments, The SAR function may perform a large packet to small packet transformation and reassemble the packet at the next hop destination for efficiency at the data link layer. In embodiments, packet size may be determined dynamically in response to the real-time data-rate available over each individual data link. In a network running TDMA in the MBRI, transmissions may occur with fixed duration time bursts. The slot capacity may depend upon the modulation, coding, bandwidth, TDMA time slot duration, and the like. A depiction of TDMA time slots is provided at the top of FIG. 74, where capacity is filled with payload data. Typically, the IP packets that make up the payload data do not always fit evenly into the slot capacity. Rather than allow the remaining slot capacity to go unused, IP packets may be segmented into smaller pieces to fill the available slot capacity efficiently, such as show in FIG. 28. The original IP packet is divided into multiple segments, and a SAR Header is added to tag each segment and enable reassembly at the receiver. The individual segments are transmitted using multiple TDMA time slots. Upon reception, the data from the individual TDMA time slots containing the SAR fragments is reassembled into the original IP packet as depicted in FIG. 75. The fragments may be buffered and ordered according to SAR sequence numbers contained in the SAR Header. Once all the fragments that correspond to a single IP packet are buffered, the complete IP packet is formed and sent up the protocol stack. When the reassembly process is started for any packet, a configurable timer may be set. If this timer expires before reassembly is complete, then the reassembly process may be aborted in order to prevent the reassembly process from “hanging” when fragments are dropped or delayed. Un-segmented IP packets may be passed directly up the protocol stack. In embodiments, the SAR process may be executed independently for each link over a multi-hop path through the wireless MANET or over the complete end-to-end route over the wireless portion of the network.

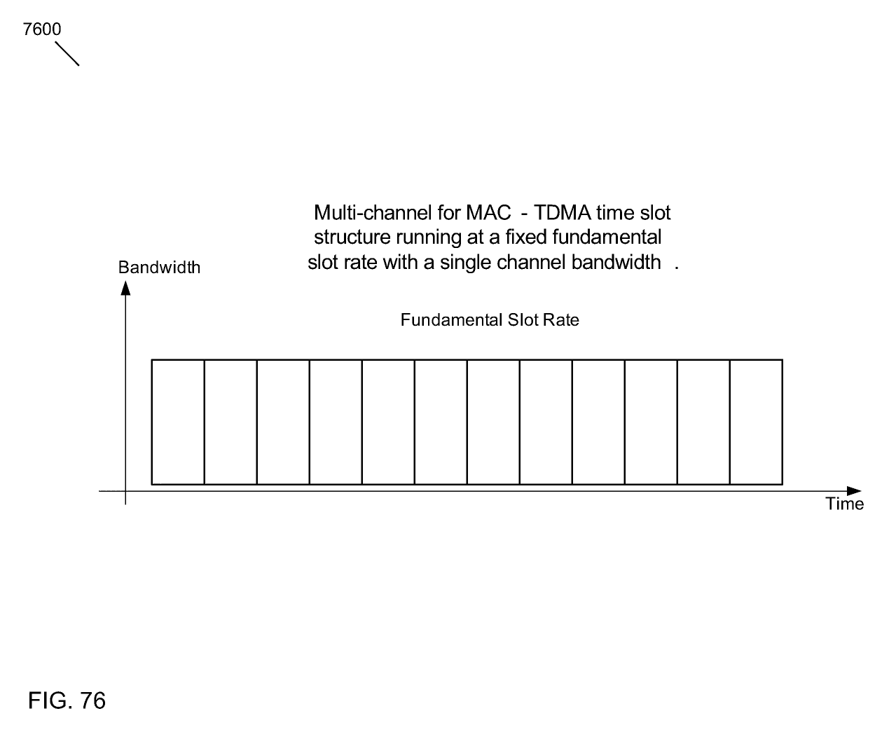

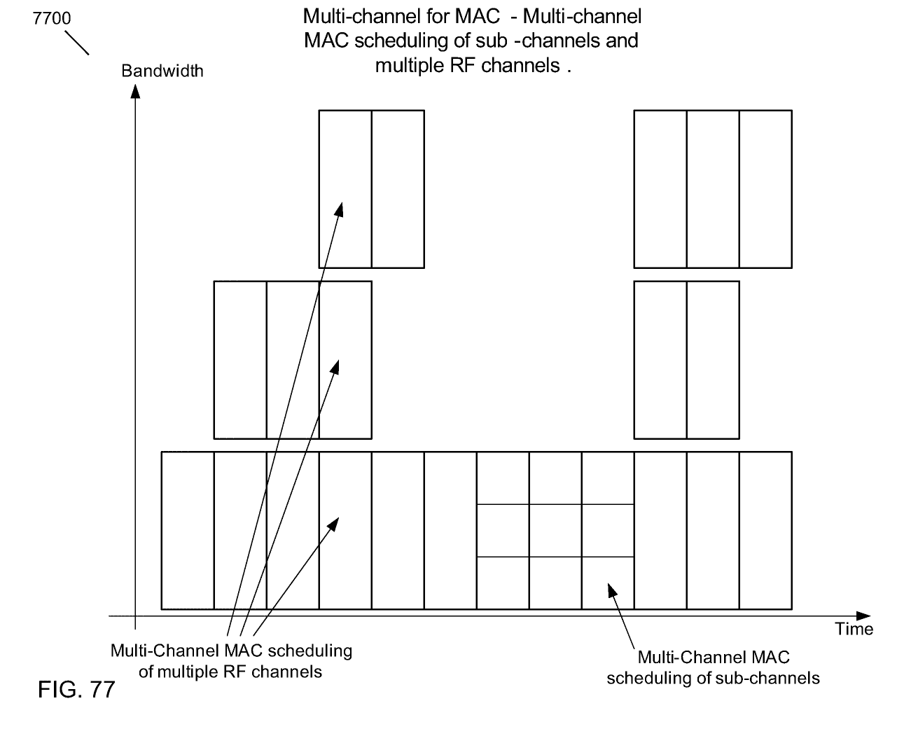

In embodiments, MBRI may support multi-channel MAC. In a network running TDMA in the MBRI, transmissions may typically occur using a single channel. The slot capacity depends on the modulation, coding, bandwidth, and TDMA time slot duration. A representation of the TDMA time slots are shown in FIG. 76. In a multi-channel environment, control-plane cooperation may enable neighboring nodes to notify transmitter-receiver pairs of channel conflicts and deaf terminals to prevent collisions and retransmissions. MBRI, though full OSI functionality, may provide the facility for multi-channel MAC in order to improve packet transfer throughout the MBRI network. Multimedia internet data can have widely varying characteristics and delivery requirements including data rate, latency, and jitter requirements. In some instantiations, the bandwidth may be divided into sub-channels. In others, the radio may be able to access multiple channels over a bandwidth that may be greater than the modem's single channel bandwidth. In both cases, a multi-channel MAC increases the number of transmission opportunities in the network for exchanging data. When multiple distinct RF channels are accessed and scheduled, the overall network capacity is increased beyond that achievable using a single channel. FIG. 77 shows both examples of using a multi-channel MAC. The multi-channel MAC may use knowledge of the distributed network topology and spectrum availability. One method for scheduling sub-channels is to first select which node in the topology is the receiving node, and then select the multiple transmitters for the different sub-channels. Similarly, multiple RF channels may be scheduled where the spectrum availability is used to determine number of channels to be scheduled simultaneously. The spectrum availability may be defined prior to network operation, or may be based on local sensing of the RF channel utilization. In embodiments, the transmit power of the individual nodes may be adjusted to minimize the variation of received power over the different sub-channels at the receiver. Another method for scheduling sub-channels may be to schedule transmissions based on pairs of nodes in the network topology and select sub-channels to avoid causing interference between the transmissions internal to the network. In embodiments, transmit power control may be used to manage interference levels.

In embodiments, MBRI may support adaptive power control, which may provide the ability to manage power based on network performance, spectrum reuse, emergency needs, spectrum conditions, environmental conditions, service level commitments, subscriber rate plan, traffic type, application type, and the like. In embodiments, adaptive power control may be used to support “whispering” as much as possible, such as to increase the number of parallel conversations to promote better spectrum reuse. The MBRI node may be able to adjust power based on an established need or changing conditions. For example, a user may subscribe to a high quality of service, and the user's device node may need to boost power in order to help guarantee the quality of the transmission to the next node. In a more general case, the node may find itself transmitting in an environment that requires more or less power to accommodate its links to adjacent nodes, where through adaptive power control the node may be able to dynamically adjust the power level based on changing environmental conditions. In embodiments, MBRI may also be able to adjust power levels on certain frequencies, such as in association with DYSAN capabilities. In embodiments, the MBRI ability to support adaptive power control may contribute to longer battery operation of mobile nodes while extending the data transmission capabilities of the node within varying network and subscriber conditions.

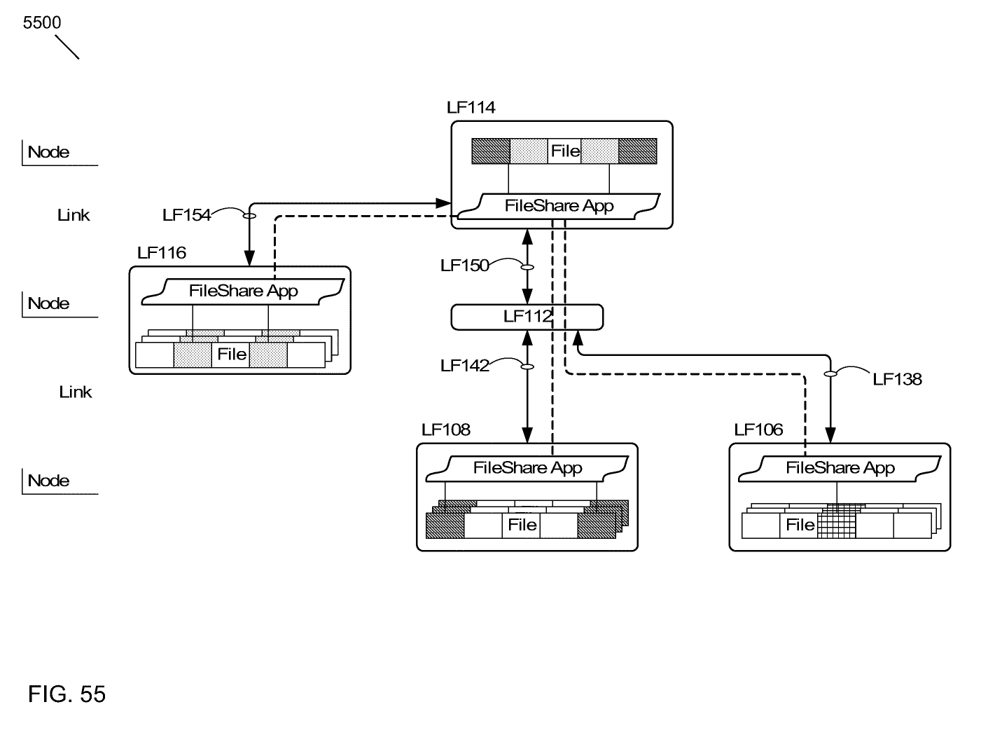

In embodiments, MBRI may provide the necessary requirements for distributed data services, such as for storage, schema persistence, low latency data transfer, and the like. MBRI may enable a new category of wireless web and device applications by providing mechanisms that spread data across many nodes, exchange information to bind the data together as a whole, and respond quickly when the data is requested. FIG. 55 illustrates one embodiment of distributed data and applications within MBRI.

In embodiments, in MBRI a distributed data store may be created when users can save information on a network node (device) other than their own. These nodes are known as peers. Peers collaborate with another by allowing data to be stored on each other, and a peer-to-peer network may save data using this distributed mechanism. MBRI supports peer-to-peer network architecture because it is a routable IP network, providing multiple diverse paths for communication between nodes. A peer-to-peer network may assume diverse connections between nodes in a network and ad hoc connections between peers. The usefulness of peer-to-peer networks is well established, and such networks are commonly used for sharing content files containing location, audio, video, or even real time data such as telephony. The size of the data need not be large, nor need it persist for very long to nonetheless be useful to an application. In addition to data sharing, more complex applications may use distributed or federated databases, where each peer contains a small part of a database (such as a table or record, as appropriate for the form factor of the device), and also maintains logical pointers to data parts that exist on other devices. The pointers link together separate data parts to form a larger logical database, spread across the MBRI network. Such a solution may only be workable in a low-latency, high-bandwidth IP network, making MBRI a unique platform for this kind of scalable storage solution in the wireless arena.

In embodiments, MBRI may provide for schema persistence. A schema describes the logical structure or view of some data. When nodes exchange data, some common schema is at work, so that the data matches up. In the simplest view of distributed data, a Web application may execute locally on a node, and provides a description of the data it uses, with enough contextual information about what the data contains, so that another Web application on a different node can decode the description and also work with it. In a mobile network such as MBRI, peers may join and leave the network. Simple data schema solutions suffer from the problem of persistence, where a large distributed data store may lose an essential, small portion of the whole data view. To be persistent, data in the individual peers is replicated. To be readily available, small embedded distributed data services (or applications) may exchange information called hash maps, which are distributed metadata structures that permit reassembly in real time of the missing data.

In embodiments, MBRI may provide for low latency data transfer through data distribution. In hub-and-spoke wireless and wired topologies, the movement of data is constrained by available path bandwidth and number of paths from source to sink. In MBRI, bandwidth is a cumulative function of the number of available nodes through which data can be transferred. The low latency of MBRI makes distributed storage possible; data joins would otherwise be too slow to be of practical use. The MBRI topology and latency may enable resilient large file transfers, using techniques such as parity files. Large files may be split into multiple smaller ones; parity files may be generated that are then transferred along with the original data files. MBRI may provide routing mechanisms to optimize the transfer of these small files, which are then reassembled. If any of the data files were damaged or lost whilst being propagated, parity files are used to reconstruct the damaged or missing files. These techniques may be of particular benefit in secure or hostile environments.

In embodiments, MBRI has the essential characteristics for distributing, saving and moving data across a network. These characteristics include ad hoc nodes, low latency IP over diverse connections, multiple paths for increased bandwidth, and the like. MBRI may enable incremental scaling of data capacity, fault tolerance, high availability in a low-latency network, and the like, through distributed storage and processing. Depending on the form factor and processing capacity of the node, standard IP network storage services are possible, making MBRI a transparent substitute for some fixed networks.

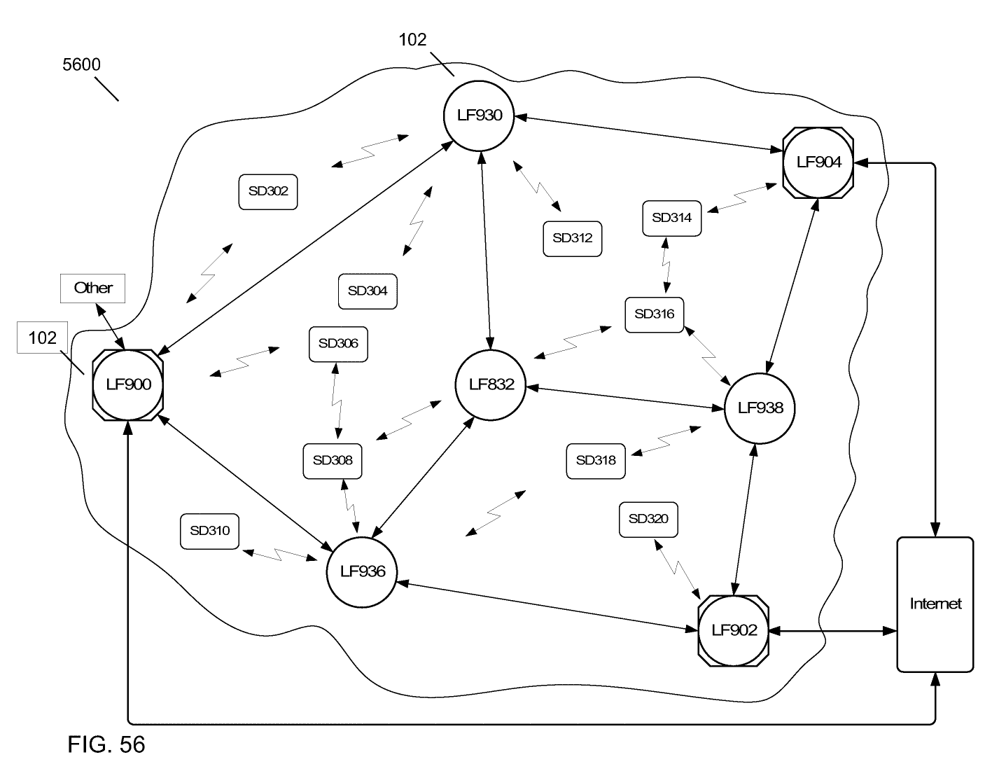

In embodiments, MBRI may provide for local intelligence, such as caching, local content and services, and the like. In embodiments, local intelligence may provide for a number of different applications, but be based on MBRI's ability for nodes to have a local awareness. For instance, information from the local area may be circulated, such as within the local geographic area, within the local swarm of mobile nodes, associated with local access points, and the like. An application that has large data storage requirements, such as video or image applications, may store or cache data in surrounding nodes. A local application, such as in association with a local store, may provide content and services throughout the local network through storing the content and user service access interfaces on user device nodes. In embodiments, MBRI's ability to share and store information amongst nodes in the local area may provide a local intelligence that is unique to the capabilities of MBRI, and for which user's and services may benefit through shared resources. FIG. 56 and FIG. 57 illustrate an embodiment of how local mobile applications may be implemented within MBRI.

In embodiments, MBRI may provide support for distributed applications, non server based applications, and the like. MBRI, through local awareness capabilities and on-device storage capabilities, may enable the storage of applications, including applications that may be provided in a distributed manner, such as amongst a number of device nodes. MBRI nodes may then share data back and forth within the MBRI network. In embodiments, applications running on network nodes may provide application use within the MBRI network apart from any application support from the fixed Internet. For example, an auction support application, set up and distributed to user device nodes in a remote location, may execute application functions within the MBRI network in a manner completely separate from any fixed internet access point. As such, the auction application may provide for a distributed or non-server based application that may provide an application environment that is unique to MBRI.

In embodiments, MBRI may provide for nodes to enter a sleep mode, where sleep mode may be a way to conserve battery power on the node. In embodiments, there may be multiple different kinds of sleep modes with different time scales, where, for instance, some may be as short as 500 microseconds and don't necessarily rely on detecting network activity. Sleep mode may reduce functionality of the node, while maintaining an awareness of neighbor activity, such as detected neighbor traffic, request for routing, a neighbor leaving sleep mode, and the like. In this way, a node in sleep mode may exit sleep mode when it detects activity from a neighbor. In embodiments, the ability for a node to exit sleep mode upon detection of neighbor activity may allow for a number of nodes to be in sleep mode, and for them to reawaken sequentially or serially upon the initiation of network activity.

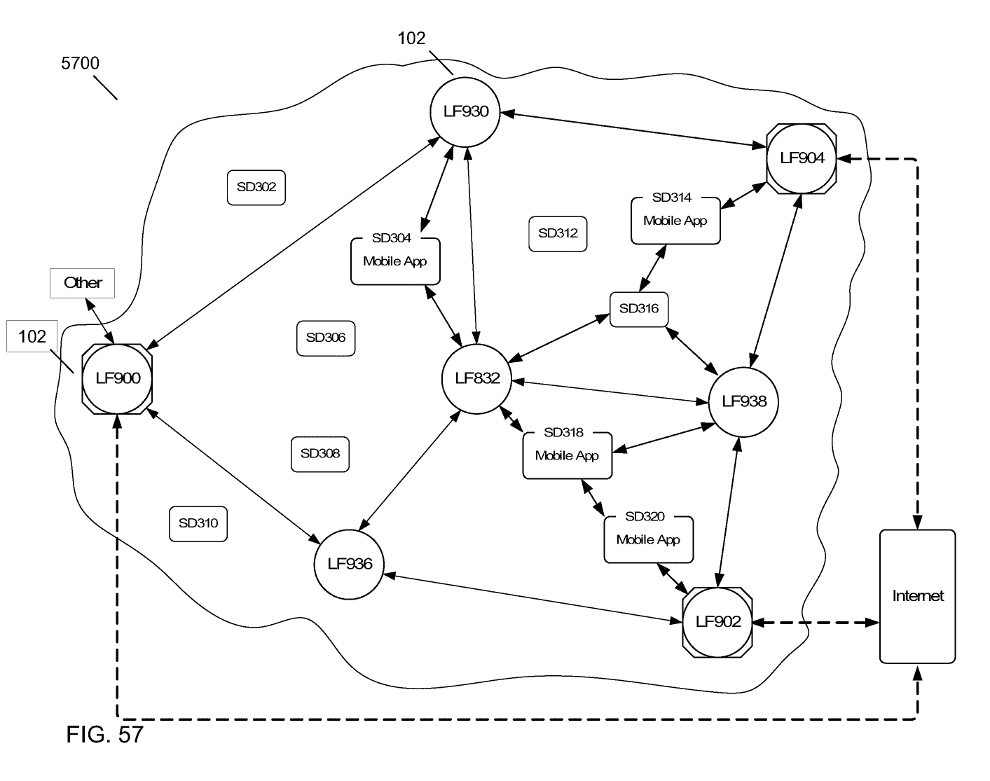

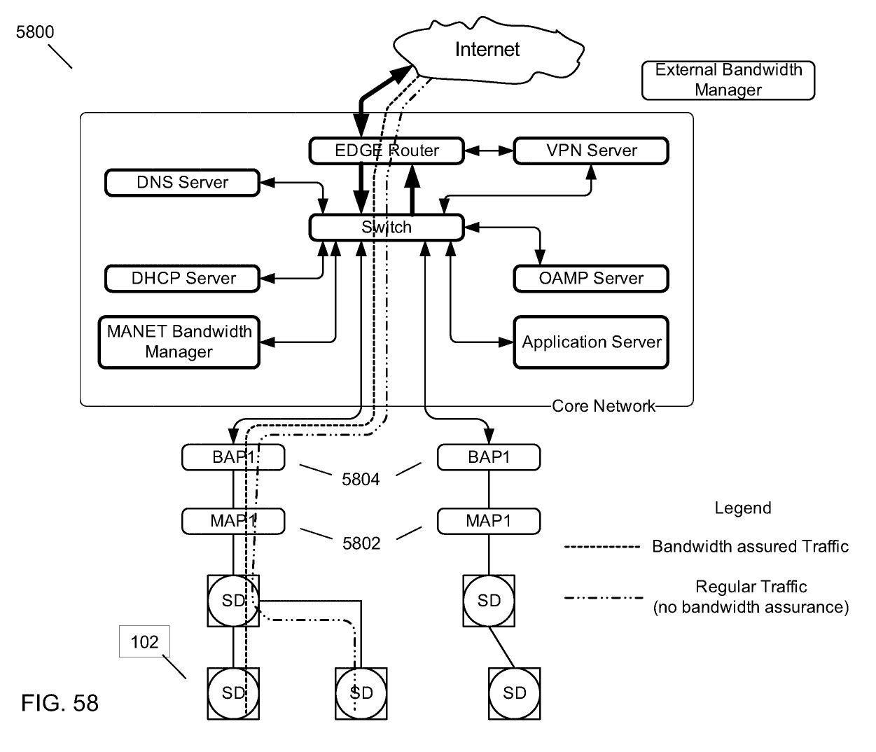

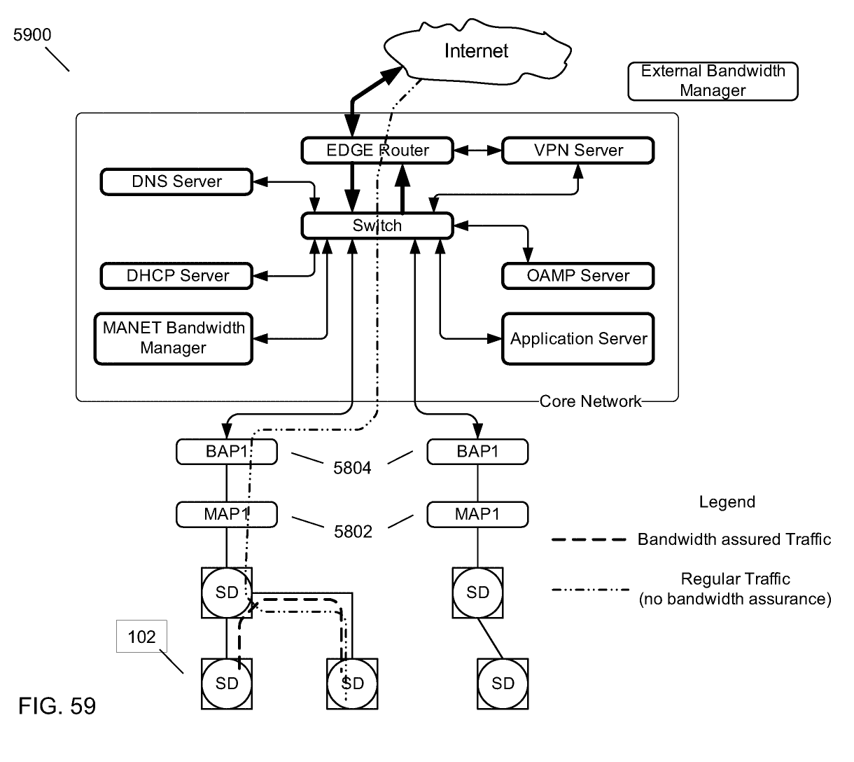

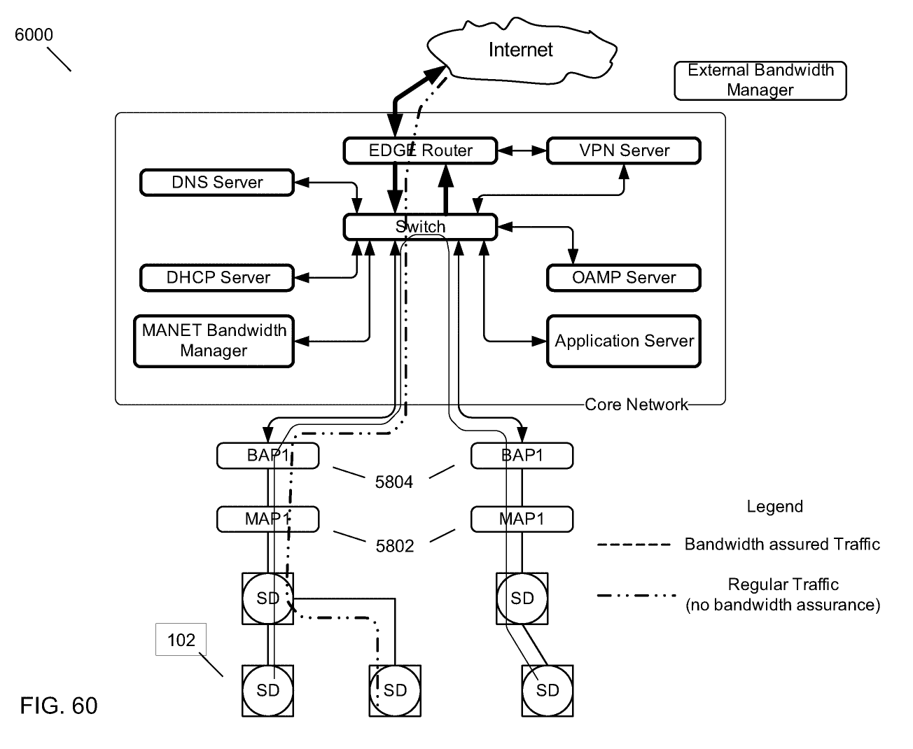

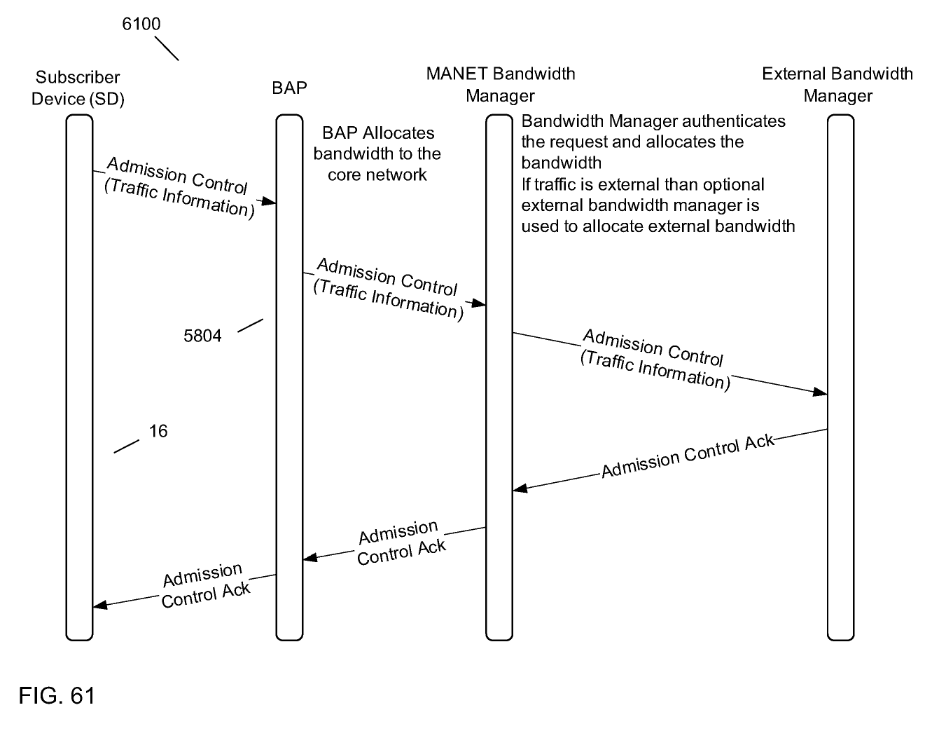

In embodiments, MBRI may support assured bandwidth/admission control, providing traffic admission control capability to the MBRI enabled network, where upon request a subscriber device may be provisioned with assured bandwidth for a session on the MBRI network. A subscriber device requiring guaranteed bandwidth for a specific session or all the session may request the desired bandwidth by sending a control message, such as to a MANET bandwidth manager via BAP. The BAP may allocate the bandwidth towards the core network and pass the request to the MANET bandwidth manager. The MANET bandwidth manager may authenticate the request against a subscriber's class of service and the bandwidth available, if needed it may contact the external bandwidth manager to assure external bandwidth towards the ISPs backbone to the internet. Once the request is verified and resources allocated, it may acknowledge the subscriber device with a specific QoS value. Now the subscriber device may use this special QoS value for the traffic, relay nodes may honor this QoS value to assure the bandwidth. The MANET side of the network has a reserved range of QoS values for assured bandwidth applications and each node in the network may honor these QoS values. FIG. 58 shows and example of two different traffic flows, one with bandwidth assured and the other one without. The relay nodes, MAP and BAPs may prioritize the bandwidth assured traffic. FIG. 59 shows assured bandwidth between two mobile nodes. In this example a relay node uses QoS values to discriminate between regular traffic and bandwidth assured traffic. FIG. 60 shows assured bandwidth between two different BAP domains. In this example data flow relay nodes assure bandwidth by honoring the special QoS values. In this scenario BAPs involved allocated bandwidth on the core network for this traffic. FIG. 61 shows an example control protocol for a subscriber device going through a bandwidth request.

In embodiments, MBRI may support MANET address resolution protocol (MARP), a mechanism that tracks the dynamic bindings between IP addresses and data link addresses in MANETs. Each device in this type of network may have two addresses: an IP address and a data link address. In this instance, the IP addresses may be static, whereas the data link addresses may be assigned dynamically, and can change over time when devices move from one location to another. Whenever an IP datagram is to be sent by one device to another, it may be encapsulated with a data link header that specifies the current data link address that corresponds to the destination IP address. MARP helps to ensure that the correct destination data link addresses are available when IP data grams are forwarded in MANETs. In embodiments, the Internet protocol ARP (RFC 826) may provide an IP address to data link address binding service for broadcast LANs, such as the Ethernet. However, MANET technologies may not provide the broadcast data link service that ARP requires for correct operation, consequently, ARP may not be used by MANETs. MARP may provide ARP services for MANETs.

In embodiments, MARP may maintain dynamic databases of the bindings between data link and IP addresses. An authoritative, master database may be maintained on a server that is accessible by all devices via the MANET's data link unicast service. Entries from this database may be cached on each device for the purpose of assigning data link addresses when IP data grams are encapsulated in preparation for forwarding to their destinations. In embodiments, MARP may use an aging process that discards entries when they are not refreshed, where aging may prevent the retention of bindings from nodes that have lost network connectivity. The protocol may be invoked when certain events occur, such as a registration, where each time a device is assigned a data link address it registers its new binding by sending a message that contains the current binding to the master database (the master database time may stamp the binding and store it); resolution, where a device needs a binding that is not available in its local cache, it retrieves the current one from the authoritative cache, by sending a request and receiving a response (he up-to-date binding may then be time-stamped by the device and stored in its cache); aging, where each device, and the master database, ages out the entries in its cache by examining their time stamps and discarding any bindings that exceed a specified life time; and the like. MARP, when run on a device, may update its cached bindings by issuing proactive resolution requests before entries expire, and repeating its own registration before its entry in the master database expires. Aging may be necessary for the elimination of cache entries that refer to hosts that are no longer reachable. Registration may need to be repeated at a rate that exceeds the aging rate. In embodiments, MARP may replace the ARP protocol (RFC 826) that was designed to provide an address binding service for Ethernet LANs. MARP may operate on a data link that provides a basic unicast service, that supports dynamic IP address to data link address bindings thereby increasing scalability, that supports dynamic IP address to data link address bindings thereby increasing scalability.

In embodiments, MBRI may support traffic policing, where nodes on the network may monitor, adjust, and take action with respect to network traffic. Network traffic policing may be for the purposes of security, quality of service, maintenance, contract compliance, and the like. For instance, policing may occur within a single node at its ingress point to the MBRI. The device may police the amount of traffic that is trying to enter the network. If the traffic exceeds the negotiated contract, the device may prevent some of the data from entering the network.

In embodiments, MBRI may provide traffic shaping on the network, such as per flow, per node, per MAP/BAP, and the like. In a similar fashion as for traffic policing, as described herein, traffic shaping may be realized through monitoring network activity, such as by an individual node, by neighboring nodes, throughout the network, and the like. For example, traffic shaping may be associated with the process of smoothing the burstiness in time of offered traffic so that a more uniform offered load is presented to the ingress point of the network. In embodiments, traffic in MBRI components may go through an L3 fast pipe, such as described herein, and shown in FIG. 62. In embodiments, host traffic may be inspected on two edges of the network, such as at the subscriber device and at the BAP. Based on subscriber class of service traffic type the L3 fast pipe may offer traffic shaping to optimize the network load. Traffic types (e.g. real time voice/video or mp3 streaming etc.) may be used to calculate traffic priorities, and higher priority traffic (e.g. real time voice) may then take preference over non real time type traffic (e.g. mp3 download via FTP). Policy enforcement logic may be used to decide if a certain type of traffic is allowed via MBRI, such as a subscriber signing up for a WAP-only plan, and not being allowed an mp3 download via FTP. In addition, policy enforcement may also restrict bandwidth usage by a certain subscriber to optimize network load.

In embodiments, MBRI may provide automatic retransmission request (ARQ) functionality, where a node may receive a transmission from a node and request a retransmission because of a detected anomaly. For instance, the receiving node may detect a checksum error or the like, and as a result may request a retransmission from the sending node. In embodiments, automatic retransmission request functionality may improve transmission reliability and overall quality of service.

In embodiments, MBRI may provide for forward error correction (FEC) on long IP packets. FEC is a system of error control for data transmission, whereby the sender node adds redundant data to its messages, also known as an error correction code. This allows the receiving node to detect and correct errors (within some bound) without the need to ask the sender node for additional data. The advantage of forward error correction is that a back-channel is not required, or that retransmission of data can often be avoided, at the cost of higher bandwidth requirements on average. In embodiments, FEC may be applied in situations where retransmissions are relatively costly or impossible.

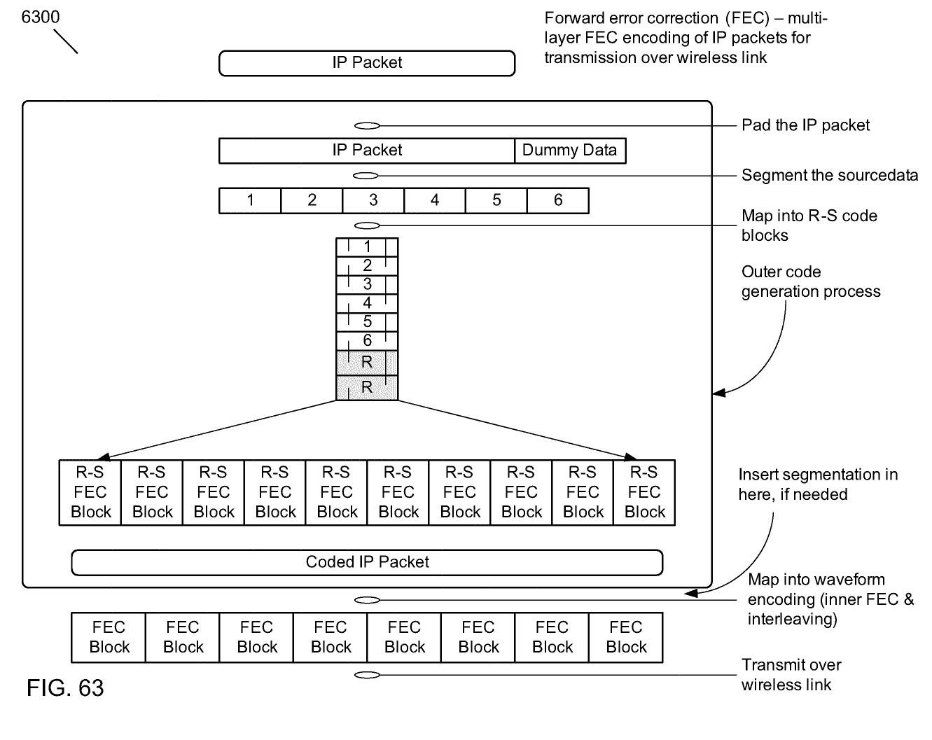

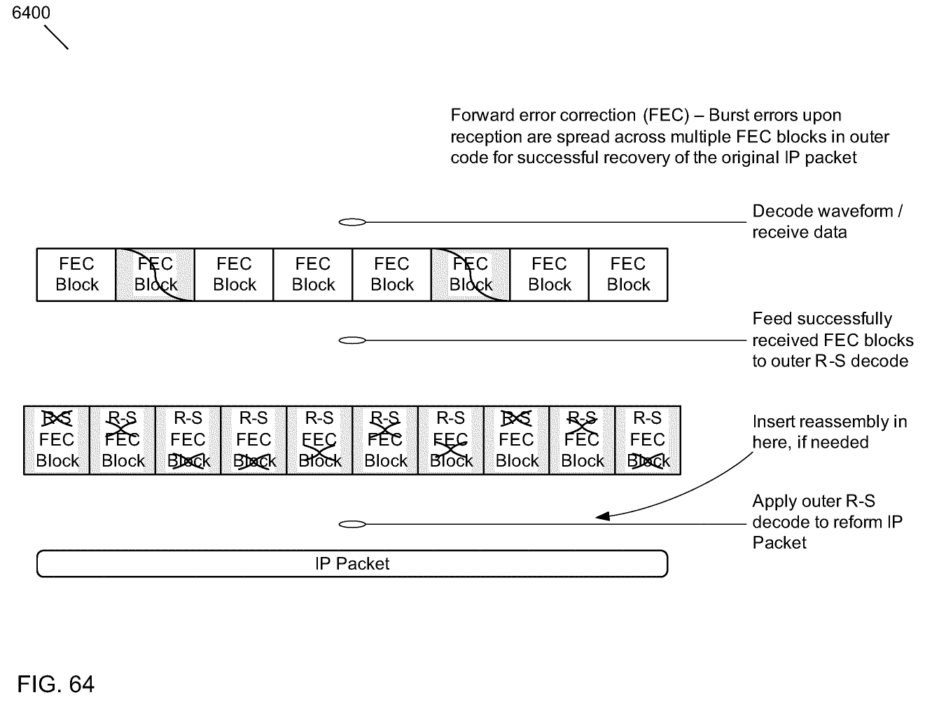

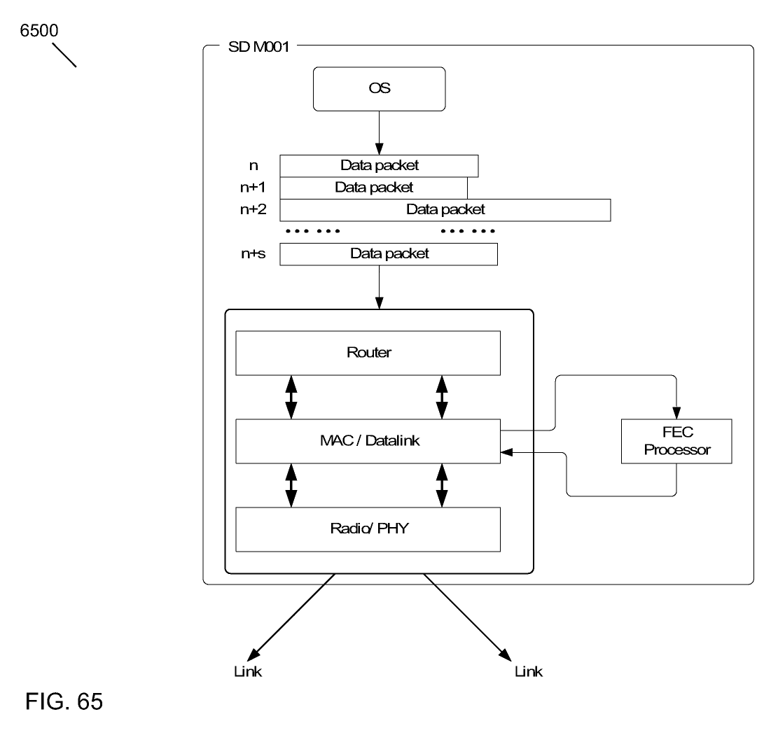

In embodiments, MBRI transmissions may occur in units of slots, where each slot may contain multiple data blocks that are forward error correction (FEC) encoded to provide robustness to bit errors. In multipath propagation, some bursts may contain residual errors for a slot error rate (SLER), such as on the order of 1-5%, even after the inner FEC is applied. In MBRI, IP packets may be often divided up into multiple segments for transmission over multiple TDMA time slots. Even when the packet is not divided across multiple time slots, the packet may be divided across multiple FEC blocks. If one segment (or inner FEC block) is lost due to burst errors, the entire IP packet may be lost. This results in the transport layer (e.g., TCP) experiencing a higher loss rate. The TCP protocol may react by reducing the offered load on the network and consequently the throughput experienced by the user. This problem may be solved by applying an additional layer of FEC (i.e., an outer code) to long IP packets (longer than 1000 Bytes) so that slots experiencing residual errors can be corrected to construct the full IP packet before being sent up the protocol stack for interpretation by TCP. For the purposes of illustration, the encoding process is shown for a single IP Packet in FIG. 63. The method may be applied to any length or grouping of payload data for transmission over a wireless link. In this example, first the IP packet is segmented. Dummy data may be appended to form an integer number of segments. Next, an outer FEC code is applied across the data segments—a Reed-Solomon (R-S) code is depicted in the figure, but the approach is general to accept any FEC code. Multiple R-S blocks are combined to form a coded representation of the original IP packet. This data is then encoded according to the defined waveform format that includes interleaving and FEC (an inner code) for transmission over a wireless link. The coded IP packets may be segmented prior to waveform encoding as part of a Segmentation & Reassembly (SAR) process for aligning data payload with TDMA slot payload. The receive process is shown in FIG. 64. The individual waveform FEC blocks contain some residual burst errors (indicated by a red ‘X’). The bursty error bits are disbursed across the multiple blocks in the outer code. Each code block contains a small enough quantity of errored bits such that the data is recovered error-free. Reassembly (if applicable) is applied after successful data recovery to form the original IP Packet. As an extension, the individual blocks that comprise the coded data may be routed over different paths between a common source and destination in order to provide route diversity for performance improvements. Additionally, the code rate of the outer code may be dynamically adjusted to compensate for varying link burst error rate conditions. FIG. 65 provides one embodiment of how packet length dependent FEC may be implemented in MBRI.

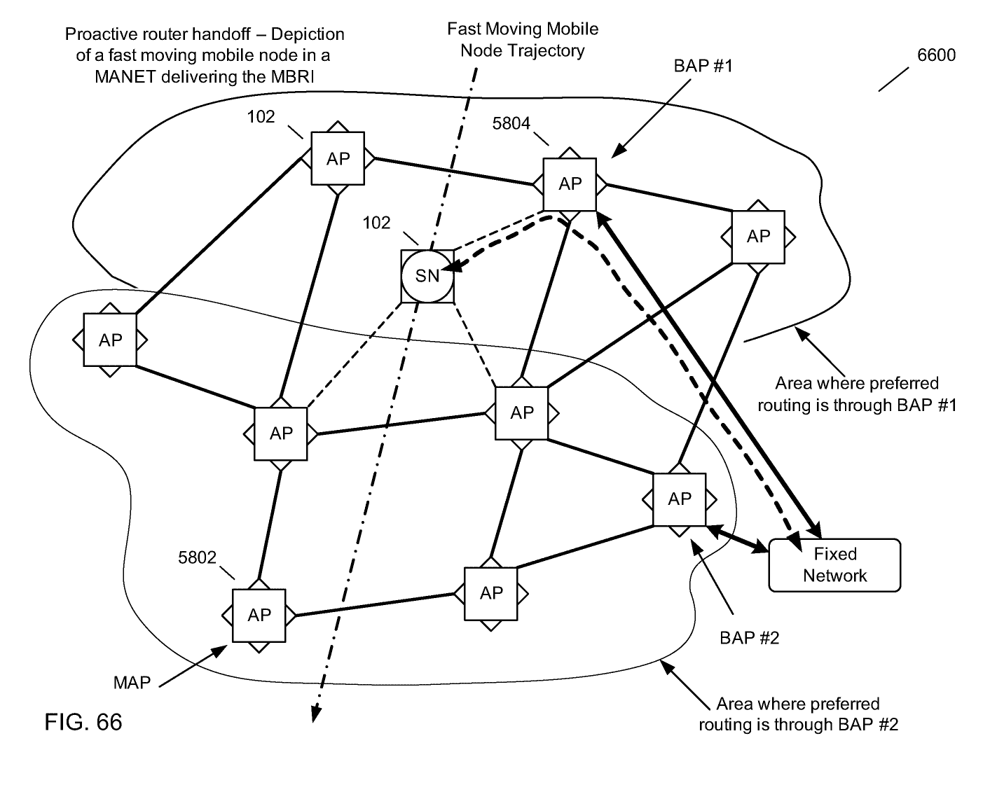

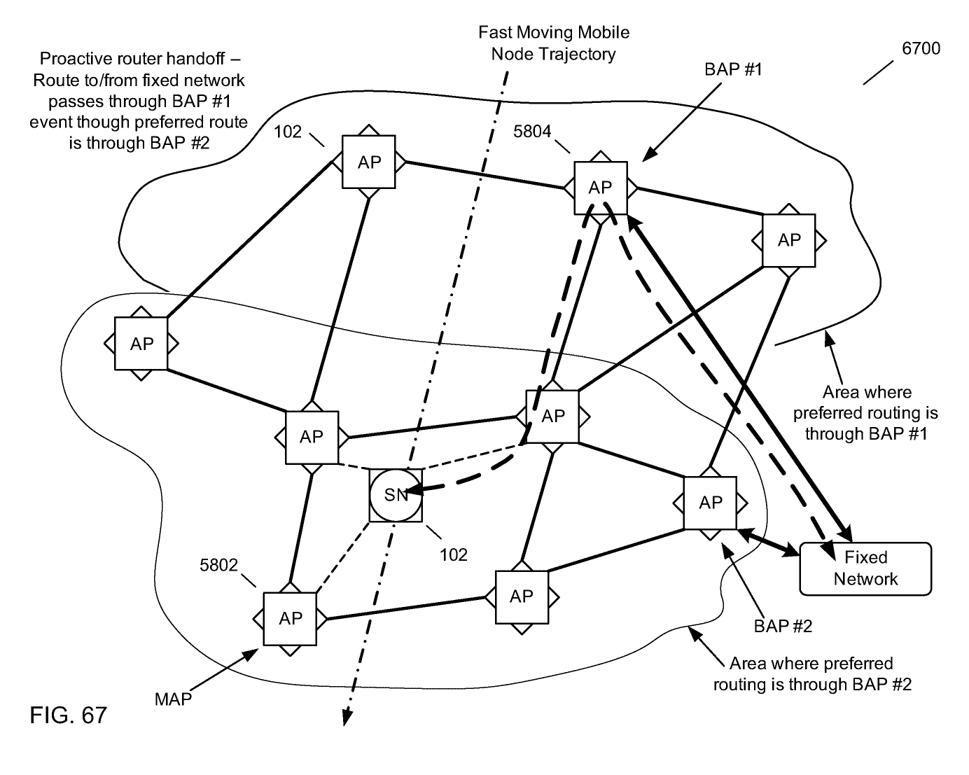

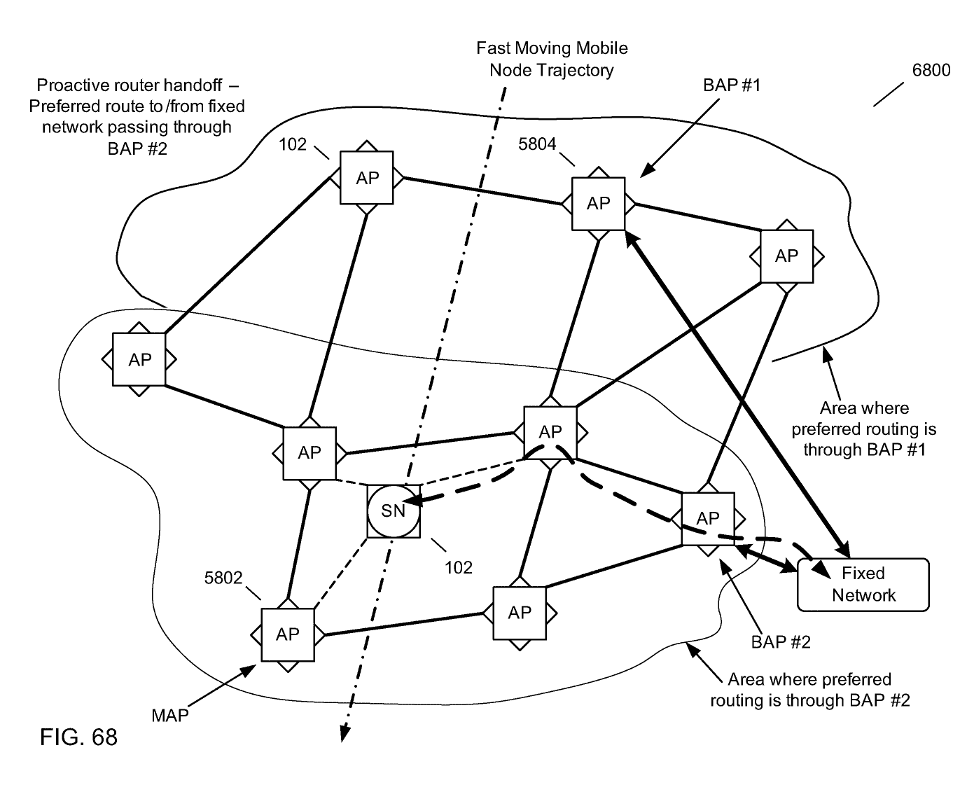

In embodiments, MBRI may provide proactive router handoff capabilities in order to accommodate fast moving nodes. Consider the following example, without limitation, of a fast moving mobile node in the network shown in FIG. 66. Multiple fixed (MAPs and two BAPs are shown to form a spanning network to provide coverage in a region. Links between access points are indicated by the light blue solid lines. A fast moving mobile node (yellow circle) follows a trajectory indicated by the thin dotted line. Links to nearby access points are indicated by magenta solid lines. A route that connects the mobile to the fixed network is formed through a BAP (indicated by thick dashed line). Based on node location in the region, connectivity through one or the other of the BAPs is preferred (for network efficiency). As the node traverses the region where the network is deployed, links change. In the basic MBRI, routes reactively update to link state changes. This necessarily leads to a delay between when the links change and when the routes are updated. FIG. 67 shows the mobile node after it has crossed over into the area where the preferred routing is through BAP #2. However, due to the reactive routing updates, the route to/from the fixed network remains through BAP #1. Depending on node velocity and routing update rate, the links may change again before route updates are completed. This results in data from the fixed network traversing an inefficient path that is always trying to “catch up” to the mobile node as it moves through the network. The impact is additional hopping leading to increased latency and decreased network capacity. The preferred route through BAP #2 is shown in FIG. 68. Rather than waiting for reactive routes to adjust, proactive routes are formed. The first step is to identify fast moving mobile nodes in the network that might require proactive routing updates. Identification can occur in a variety of ways to include Doppler estimates from the received signals, geo-location estimates of mobile node location, and interpretation of the rate of change of link state variables. The predictive routing algorithms may use knowledge of the location of fixed infrastructure (MAPs and BAPs) and the anticipated location of the fast moving mobile node to adjust routes based on the predicted link states/costs in the network. In this manner, the route may be updated before waiting for the link cost to reflect the change indicating that a route update is needed, and further waiting for the route to actually be updated. In embodiments, proactive router handoff may provide a way for MBRI to be extended to nodes in vehicles, and so, out onto a road network.

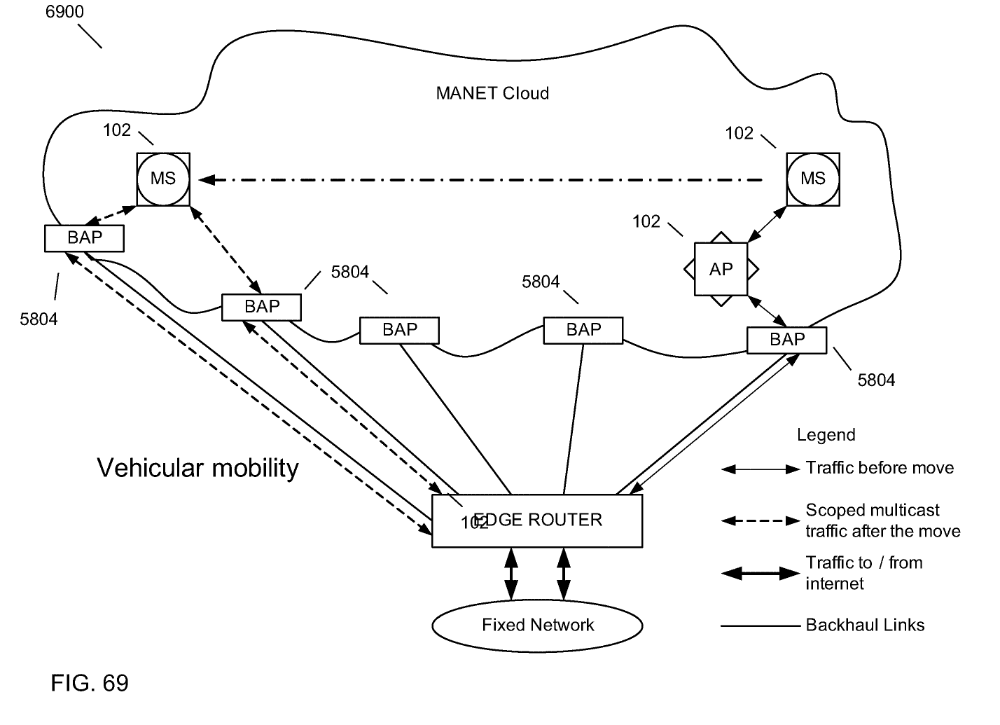

In embodiments, MBRI may provide for vehicular mobility-vector based routing, providing optimum routing of traffic to and from nodes moving at vehicular speeds for MBRI network, such as shown in FIG. 69. When mobile nodes travel at a faster speed than it takes MANET networks to converge, it may cause a mobile node to miss data as the data is routed via nodes that are no longer reachable. A node, in a vehicle may be able to determine a mobility-vector for the sake of establishing and/or maintaining routing within an MBRI network structure as the node moves. In embodiments, a node may be in a vehicle as a result of being mounted in the vehicle, carried into the vehicle by a user of a mobile device, temporarily mounted on the vehicle, and the like. The node in the vehicle may determine the vehicular mobility-vector in a plurality of ways, such as detecting and monitoring link parameters, including power level, data rate capabilities, and the like; through relative or absolute directionality associated with the motion of the vehicle or surrounding nodes; through information supplied by neighboring nodes; and the like. In embodiments MBRI may provide certain rules or capabilities associated with routing in association with nodes in rapid motion, such as vehicular mobile nodes may not participate in relay of traffic of stationary (or lower speed) nodes, minimize the ripple in topology caused by fast moving node; preferentially directing the communications of vehicular mobile nodes with AP as long as power requirements are met (i.e. it may not need high power to transmit); vehicular mobile nodes may hand off to an overlay cellular network if the only routing choice available is high power transmission; vehicular mobile nodes may attempt to relay thru other vehicular mobile nodes if the other mobile nodes are travelling in the same direction and towards AP; an edge router (ER) may calculate the speed and vector of the mobile node by using GPS and/or TDOA; ER anticipates a scoped region where a mobile node is for the return traffic; ER may send scoped multicast traffic to the nodes in that anticipated area where the vehicle is expected; nodes when discovering a vehicle in their area may relay that traffic to the vehicular mobile node; and the like. In embodiments, vehicular mobile-vectoring may enable an AP predicting the possible mobile node location based on mobility, GPS, speed, vector and other characteristics; AP using scoped multicasting to send data to all the possible locations; Mobile nodes discriminating highly mobile nodes from routing calculations to avoid excessive route ripple; and the like. In embodiments, vehicular mobility-vector based routing may better enable MBRI to extend connectivity to nodes moving at vehicle speeds, and thus across a road system.

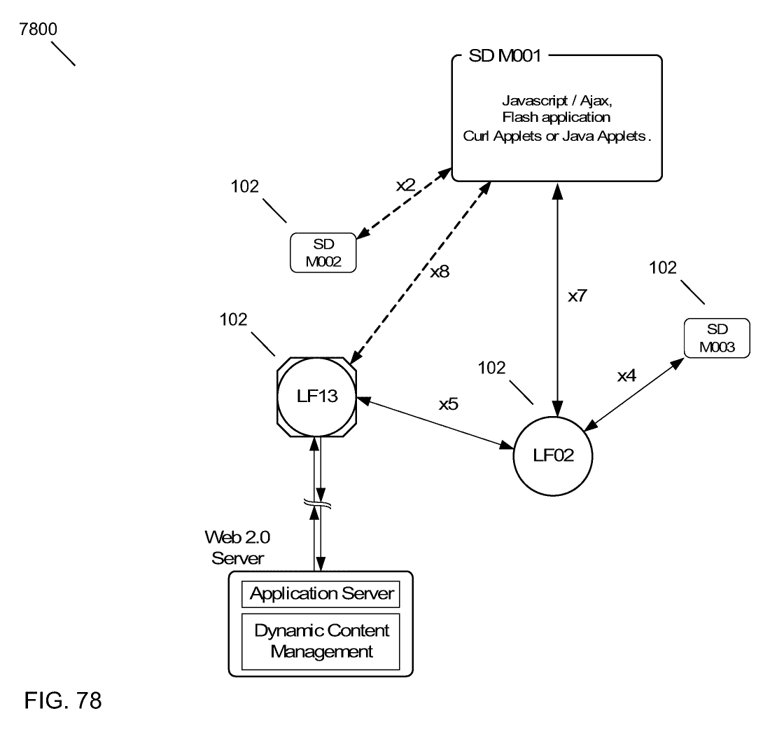

In embodiments, MBRI may provide a device to device environment where files and applications may be generated, shared, deployed, transferred, downloaded, distributed amongst a plurality of devices, and the like. For instance, MBRI may provide benefits associated with being Web 2.0 ready. Web 2.0 is a term describing the trend in the use of World Wide Web technology and web design that aims to enhance creativity, information sharing, collaboration among users, and the like. These concepts have led to the development and evolution of web-based communities and hosted services, such as social-networking sites, wilds, blogs, folksonomies, and the like. MBRI, representing a mobile extension of the Internet, may better enable these services. In addition, MBRI may provide aspects of a local distributed computing presence, which better enables these services at a local level. In embodiments, MBRI, through device node capabilities and MBRI neighbor node awareness capabilities, may provide the facility for these direct-to-device application deployments, distributed processing, application file sharing, and the like. In addition, MBRI nodes, having the capability to manage transfer and routing of this data along with throughput traffic, may be able to provide this peer to peer distributed processing and file sharing in a manner that does not degrade system performance. Because of MBRI's ability to control, manage, and shape data traffic amongst network nodes, these nodes may also be able provide direct device-to-device peering with symmetrical throughput, where traffic and data transfers are managed to maintain an even flow of data amongst the nodes of the MBRI network. FIG. 78 illustrates one embodiments of how Web 2.0 applications may be implemented within MBRI.

MBRI, being Web 2.0 ready, may provide for new end user applications, and entirely local mobile Internet applications, where applications may be created that are unique to the mobile Internet environment that MBRI creates. For instance, an instant picture sharing application could be created that takes advantage of many users taking pictures of an event or location at the same time. In this instance, MBRI may allow the real-time, or near real-time sharing and distribution of photos to the users within a swarm or local area. In embodiments, new end user applications may be created that are unique to MBRI, where users may be able to share, utilize, distribute data in ways only available to a mobile Internet environment, such as with MBRI's self managed node routing and neighbor awareness.

In embodiments, MBRI may provide broadband throughput data rates to mobile subscriber devices, such as enabled by high data rate backhaul access points to the fixed internet, and high data rate inter-node links. Broadband access for a user may be additionally enabled by high data rate MAP and CAP connections. In embodiments, quality of service may be better ensured through MBRI by way of multiple high data rate access points for any given local swarm of user nodes.

In embodiments, an end-user may participate in the deployment of a device onto the network, such as when the user enters the MBRI network, first connects to the MBRI network, and the like. That is, a user may want to, or have to, perform some act or function in order for their device to begin acting as a node on the network, and thereby be provided the services and access available from the Internet through MBRI. For example, the user may be charged a fee for access to the mobile Internet, and so the user may want a function that manually enables or disables their access. Alternatively, a user may have to provide some form of identification, whether manually or automatically, in order to gain access to the mobile network. In embodiments, this process may be provided in a transparent manner, where the user has previously set up a profile for the conditions under which they connect, and under these conditions, the user may be automatically connected.

In embodiments, a combination of enhancements and capabilities may be provided in a given configuration of the invention. For example, a more comprehensive, commercial-grade MBRI may include the totality of MBRI-Enhancements and MBRI Basic capabilities. In addition, any of the MBRI capabilities may be combined with dynamic spectrum access capabilities. In embodiments, combinations of enhancements and capabilities may be made available to service providers in the form of tools to manage operation and consumption of resources in a mobile Internet environment. For example, certain resources may be made to be restricted, such as bandwidth, application accessibility, multi-session capability, shared resource capabilities, quality of service level, and the like. In this way, service providers may be able to establish different costs for different access to resources, and control the use of resources in a given environment, network, device, and the like.

In embodiments, the design and deployment of field radio network infrastructure for outdoor and indoor environments may be a complex, costly, and time consuming process. Some of the design and deployment considerations that may need to be addressed for effective field radio network system design engineering and deployment planning to meet field system performance specifications may include physical factors such as geographic topology, area building infrastructure, line-of-site, available telecom infrastructure, radio frequency interference and propagation factors (e.g. foliage, occlusion), suitable radio installation site availability, network volume demand profile, outdoor and indoor coverage requirements, and the like. The MBRI system of the present invention may address these environmental conditions in a manner that may simplify the complexity and substantially lessen the cost and time required to design a radio network for the field, plan for its deployment and execute deployment where the MBRI technology platform is employed.

In embodiments, the MBRI system may enable network engineers and deployment managers to change the nature of the field network design, deployment planning and deployment process in a plurality of areas, including 1.) efficient use of real estate required for fixed radio installation, 2.) efficient connection to other wired telecom infrastructure required for connection to other networks, 3.) low cost and fast network design engineering and deployment planning, 4.) low cost, fast deployment and network turn-up, 5.) low cost and fast capacity expansion and network upgrade, 6.) seamless outdoor and indoor operation, 7.) network end-user deployment participation, and the like. In embodiments, this present invention may change the logic of field radio network design deployment and management from up-front complex, high-cost and time consuming network design and field based RF engineering and installation, to highly automated, low cost and rapid up-front network design and deployment planning with a rapid and low cost deployment and network installation process.

In embodiments, the present invention may provide for efficient use of existing real estate for fixed radio installation. Physical sites may be required to deploy fixed radios that connect to end-user devices and backhaul traffic to and from end-user devices and other networks. The availability of suitable real estate sites in the relevant geography to accommodate sufficient fixed radio installation may be a function of radio size, weight, power requirements, the inter-radio networking scheme including, radiated power, propagation and routing, and the like, all of which may be inherent in the radio system design. The MBRI MAP and BAP access side and backhaul side mesh routing capabilities, backhaul load balancing, RF propagation and routing capabilities, size, weight, form-factors, antennae options and powering options may allow an MBRI network to be deployable to a range of many more candidate real estate locations for fixed site installation in any given geography than other field deployed radio networks. Thus, an optimal subset from this larger set of candidate locations may be selected that may meet the lowest cost, easiest to install and also satisfy network radio propagation and performance requirements.

In embodiments, the present invention may provide for efficient connection to other wired telecom infrastructure required for connection to other networks, including field deployed radio networks, tower-based assets (e.g. backup batteries and antennas), and the like. Field deployed radio networks may require connection to other wired telecom infrastructure to effectuate traffic transfer with other networks such as the Internet, the PSTN, other wireless networks, and the like. The availability, location, complexity and cost associated with accessing and equipping the wired telecom infrastructure connection points, such as fiber, copper, coax of Telcos, MSOs, and the like, to accept connection to the field deployed radio network may be a significant factor affecting field radio network architecture design, deployment planning, deployment, and installation. The MBRI MAP and BAP access side and backhaul side mesh routing capabilities, backhaul load balancing, RF propagation and routing capabilities, size, weight, form-factors, antennae options and powering options may allow an MBRI network to be deployable to a range of many more candidate real estate locations for fixed site installation in any given geography than other field deployed radio networks while also concurrently satisfying radio propagation and network performance requirements. Thus, the selection of optimal wired network connection points may be made easier in that the optimal, lowest cost, easiest to access and upgrade wired infrastructure connection points may be selected from among those available in any given geography. In embodiments, an MBRI field network design may start with the optimal selection of the required wired telecom infrastructure BAP connection points for the specified network backhaul capacity in any given geography and then proceed to the selection of the remainder of optimal MAP points. This may is the reverse of how field radio network systems are designed today, where optimal radio propagation coverage is determined first and then the network backhaul is constructed to meet it at optimal RF based location selections, adding complexity, cost and time. The MBRI system flexibility may significantly increase the options for inexpensive fixed radio location design and deployment, thus allowing for optimal backhaul BAP location selection first and then solving for meeting propagation specifications by deploying the number of MAPs needed at the most efficient locations to do so.

In embodiments, the present invention may provide for low cost and fast network design engineering and deployment planning. The availability of information and data regarding the geographic topology, area building infrastructure, line-of-site, available telecom infrastructure, radio frequency interference and propagation (e.g. foliage, occlusion), and the like, may be available in a variety of data based information sources from municipalities and private enterprise sources. This data may be organized and structured in a manner that may be evaluated to solve the multidimensional network design problem for the geographic specific network architecture design that is optimized concurrently and equally for low cost deployment and ongoing operations, addressing these complex environmental factors with a flexible network technology, in addition to achieving economically efficient high-performance scale operation. In embodiments, the MBRI MAP and BAP access side and backhaul side mesh routing capabilities, backhaul load balancing, RF propagation and routing capabilities, size, weight, form-factors, antennae options and powering options may allow an MBRI network to be deployable in any environment where complex radio engineering formerly performed in the field at high cost may now be replaced with automated desk-top MBRI designing capabilities where environmental factors affecting network performance may be addressed by incorporating additional meshed MAPs and BAPs as required to satisfy performance specifications while also meeting lowest cost deployment objectives. In embodiments, an automated design tool incorporating the technical design factors for the MBRI network technology interacting with the structured environmental factor data may be designed and operated. This tool capability when used in unison with the MBRI network technology may substantially lower the cost and time required for network architecture design in any given geography as well as the deployment planning program design.

In embodiments, the present invention may provide for low cost, fast deployment and network turn-up. The MBRI MAP and BAP access side and backhaul side mesh routing capabilities, backhaul load balancing, RF propagation and routing capabilities, size, weight, form-factors, antennae options and powering, including its ad-hoc, self-healing and self-forming attributes may enable a highly simplified, low labor intensive, low cast and rapid network deployment, installation and turn-up. In embodiments, fixed radio sites may be optimally selected to meet network propagation and performance requirements while concurrently being optimized for easy and low cost for site: acquisition, physical accessibility and preparation, rental and ongoing maintenance costs, and the like. A sufficient number of them may be chosen in any given geography to better assure for required network geographic coverage propagation and performance; in essence, more low cost MAPs may be added as necessary to “fill-in” propagation “holes” and to “reach” difficult coverage areas as a trade-off for fewer more expensive radios located at more costly sites, requiring complex RF designs and labor intensive field based RF engineering.

In embodiments, the present invention may provide for low cost and fast capacity expansion and network upgrade. The MBRI MAP and BAP access side and backhaul side mesh routing capabilities, RF propagation and routing capabilities, size, weight, form-factors, antennae options and powering, including its ad-hoc, self-healing and self-forming attributes may enable a highly simplified, low labor intensive, low cast and rapid network capacity expansion and network up-grade. In embodiments, backhaul load balancing may be an automatic feature of the MANET, and scale proportionally in relation to the number of BAPs. A field radio network design, deployment and ongoing management plan may include provisions for planned and unplanned network capacity expansions. As with the nature of the MBRI network system initial design and deployment innovations, any network capacity expansion, either permanent or temporary, may be met at low cost and rapidly using the same logic and tools to additional optimally pre-selected fixed site locations. Further, since the fundamental MBRI technology design may be incorporated into software and small form factor physical units, technology up-grades to an existing operational MBRI network may be effectuated at low cost and rapidly via software downloads or low cost and low labor intensive field installation activity.

In embodiments, the present invention may provide for seamless outdoor and indoor operation, including broadband coverage. The MBRI indoor premises located CAP, indoor premises located MAP when operationally associated with the outdoor fixed radio MAP and BAP access side and backhaul side mesh routing capabilities, backhaul load balancing, RF propagation and routing capabilities, size, weight, form-factors, antennae options and powering, including its ad-hoc, self-healing and self-forming attributes may enable seamless indoor coverage as indoor located CAPs and MAPs that may reach and connect with outdoor located MAPs and may be employed for indoor network coverage and indoor device connectivity. As may be with the logic of outdoor network design and planning, indoor RF propagation coverage and capacity and network performance requirements may be efficiently achieved with optimal site selection for fixed radio installation using the same data bases, network design logic and associated design tools, and the like. In embodiments, indoor CAP and MAP, as associated with outdoor MAP and BAP, may provide similar connectivity and broadband coverage for users as they migrate between indoor and outdoor environments.

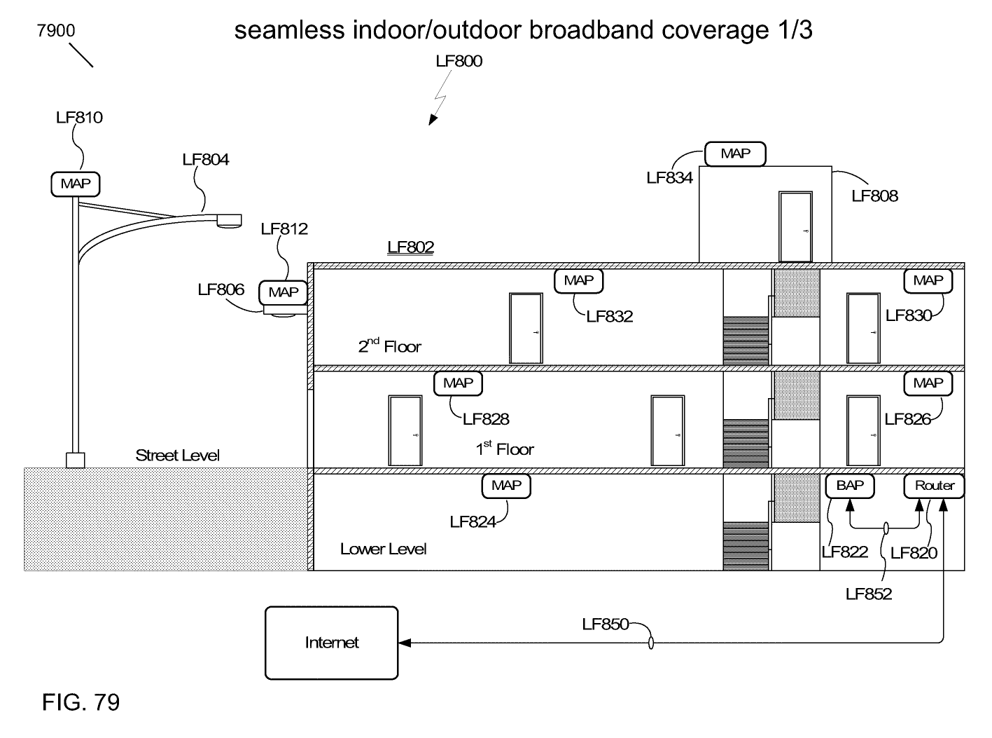

FIG. 79 illustrates one embodiment of seamless outdoor and indoor operation. In this instance, MBRI may be seen as deployed as a combination of outdoor (LF810, LF812, LF834) and in building (LF824, 826, 828, 830 832) MAP units along with BAP (LF822) so as to provide MBRI. In embodiments BAP (LF822) may provide access side and back haul side. In most installation back haul access (LF852) may be coupled to a suitable router or switch (LF820) which may allow broadband access to a high speed internet backhaul. In its absence BAP (LF822) may be equipped with suitable backhaul interface capable of direct connection to the internet. A combination of in building (LF802) and outdoor MAP units may provide users a seamless connectivity since outdoor units (LF810, LF812, LF834) can be advantageously deployed so as to provide interconnectivity within building (LF802) MAP and BAP units.

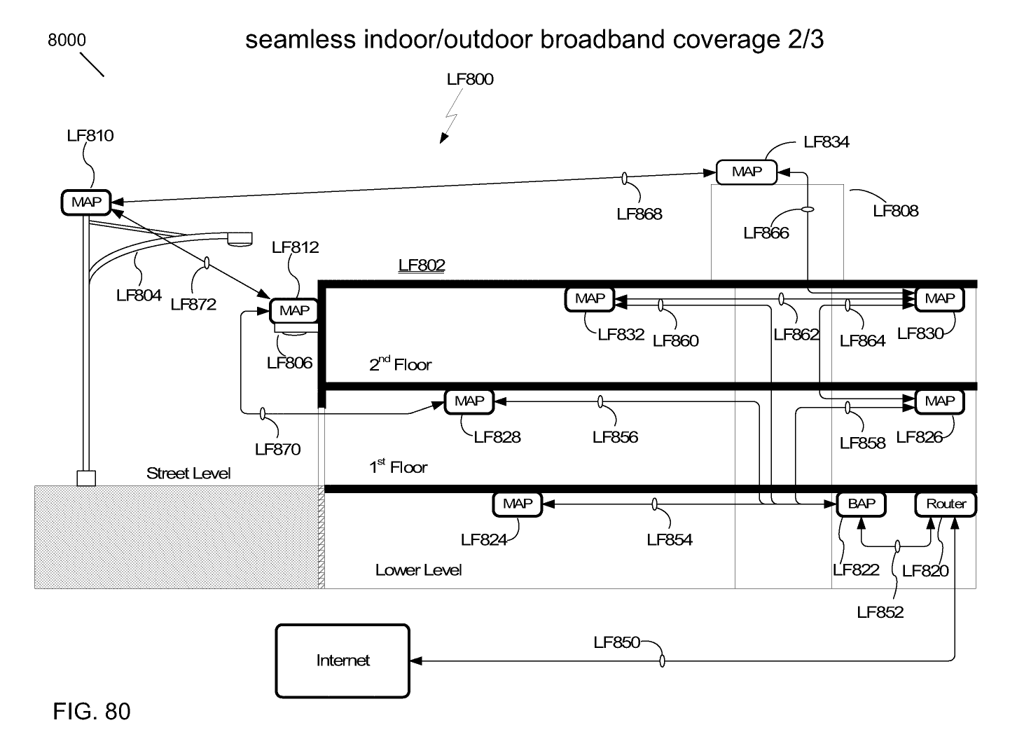

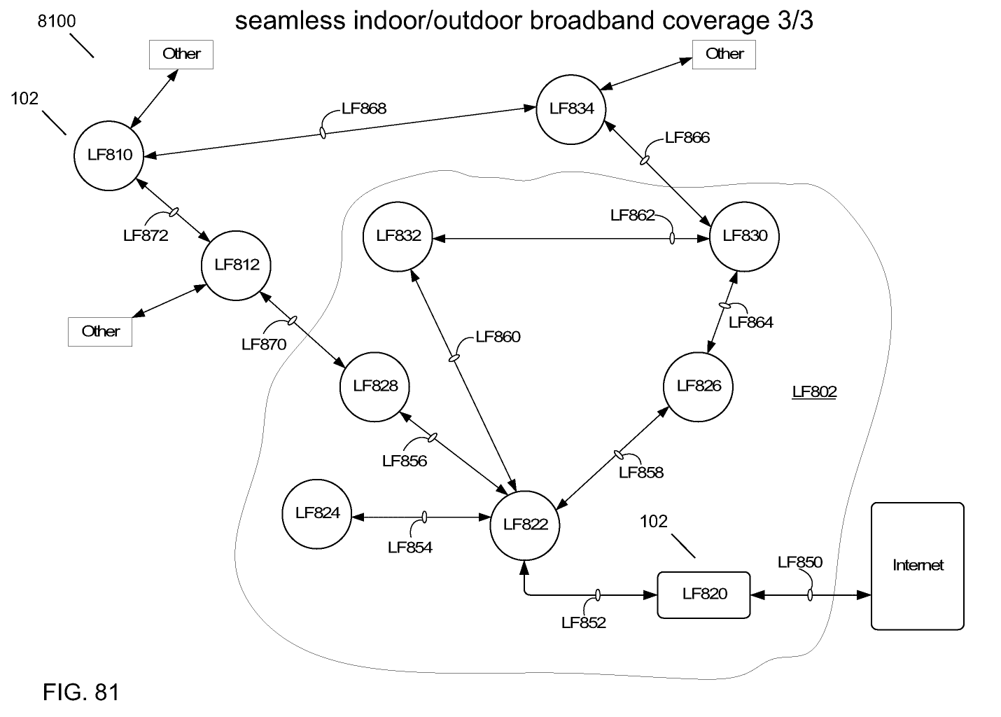

FIG. 80 illustrates a further embodiment of seamless outdoor and indoor operation. As shown, outdoor (LF810, LF812, LF834) MAP units may be deployed in a near proximity to a building (LF802) having its structural features removed (or washed out) to exemplify radio link connectivity between various MAP/BAP units. In some deployment scenarios it may be desirable to have outdoor units to be camouflaged or disguised as common street fixtures or so as to appear as a part of building architectural features. For example, a MAP (LF810) unit may be installed on top of light stand (LF804). In another instance a wall sconce light fixture (LF806) may be integrated with MAP (LF812), thus essentially camouflaging the MAP. In other circumstances MAP (LF834) may be mounted in a secured location, away from unauthorized access, in a ruggedized weather resistant enclosure. In building (LF824, 826, 828, 830 & 834) MAP units may be mounted in storage closets or on the back side of the ceiling tiles to reduce unauthorized access. Building installation may bring in additional complications since radio way propagation may be difficult to predict and full coverage may be difficult to attain. Node LF822 may be installed in near proximity of a stairwell. Stairwell along with ventilation shafts can provide suitable radio signal path to adjacent MAP units deployed on different floors. Appropriate signal strength and link quality may need to be attained between MAP/BAP units for satisfactory network performance. FIG. 81 provides an interconnection diagram for the FIG. 80 illustration.

In embodiments, the present invention may provide for network end-user deployment participation. The MBRI indoor premises located CAP, when operationally associated with the outdoor fixed radio MAP and BAP access side and backhaul side mesh routing capabilities, backhaul load balancing, RF propagation and routing capabilities, size, weight, form-factors, antennae options and powering, including ad-hoc, self-healing and self-forming attributes may enable end-user subscriber effectuated seamless indoor coverage as indoor located CAPs purchased (e.g. retail equipment purchase of service provider provided) by consumers and installed indoors by consumers as “plug and play,” “always-on” customer premises located devices that may reach and connect with outdoor located MAPs and may be employed for indoor network coverage and indoor device connectivity.

In embodiments, the present invention may provide for integration and coexistence with existing network and communications infrastructure. MBRI, which may be considered a mobile Internet, may become a natural extension of the fixed Internet, integrating with the existing infrastructure through BAP, MAP, and CAP access points in a seamless manner. The MBRI may provide an efficient use of existing backbone communications infrastructure, such as fiber, wire, microwave, radio, cellular, and the like, where BAP, MAP, and CAP access points may connect through fixed Internet resources to utilize the existing infrastructure. In addition, MBRI may provide a seamless integration with Internet communications facilities, such as WiMax, Wi-Fi, home networks, home routers, fiber to home optical network terminals, wired Internet, public safety network, enterprise network, machine to machine networks, municipal networks, fixed wireless, and the like.

MBRI may also coexist and utilize other communications facilities, such as with the cellular spectrum, LTE, GSM, Cable (HFC), electrical, satellite, unlicensed bands, and the like. In embodiments, a carrier may utilize MBRI to improve or expand their service. For example, if a carrier decides to use MBRI as a means to provide high bandwidth data services and continue voice services via their existing network solution, that may free up bandwidth at the tower and eliminate infrastructure cost otherwise required for upgrades. In another example, if a carrier has significant backhaul capacity at a tower this may be reused to support a MBRI operation. Since MBRI allows for direct P2P communication only external traffic may require the backhaul bandwidth, thus allowing for a greater number of connections compared to cellular. In another example, the carrier may add DYSAN capability to the tower to enable MRBI to co-share the cellular spectrum. In embodiments, MBRI may provide interfaces with operation support systems (OSS), which may be computer systems used by telecommunications service providers, and may describe the network systems dealing with the telecom network itself, supporting processes such as maintaining network inventory, provisioning services, configuring network components, managing faults, and the like. The MBRI may additionally interface with other existing network facilities, such as network management systems, network operations centers, and the like.

In embodiments, the MBRI may provide services in an improved manner over services offered in a cellular regime, such as providing Internet equivalent routing to mobile devices outside the cellular regime, direct access to applications that would otherwise be included in a controlled environment, such as in the case of a ‘walled garden’, IP application deployment to mobile devices outside the cellular regime, and the like. Mobile devices operating within a cellular system are often restricted in their access to applications. MBRI may provide users with the benefits of more direct routing and connectivity with applications, and as such, may provide MBRI enabled users with greater freedom of use with respect to applications than is typically available through a cellular system.

In embodiments, the MBRI may provide for node to node communications that may improve the performance within the network, including the use of node weight metrics, dynamic sharing of communications, dynamic data link segmentation and reassembly, nested weighted round robin queuing, multi-metric based multicast and unicast routing, and the like.

In embodiments, MBRI may provide for a communications system that may increase the successful outcome of a fair coin flip using a node weight metric. Channel access in a wireless ad-hoc communications network may pose the challenge of fair access and efficient use of channel bandwidth. That is, desired properties of a channel access protocol may include fairness (e.g. each node has the opportunity to transmit), and efficient use of channel bandwidth (e.g. bandwidth is utilized fully by the nodes with data to transmit). In embodiments, utilizing a ‘node weight’ may improve the efficiency and fairness of channel access. Node weight may include the notion of a metric that indicates the level of data activity at a given node. Each node in the network may compute its own node weight. A node may share this information with its one-hop neighbors (e.g. those that it can communicate with directly via wireless media). In turn, neighboring nodes may share node weight amongst the nodes within a two-hop neighborhood to enable distributed (vices centralized) scheduling. Node weight may be used to skew the distribution of channel access to those nodes with the most data to transmit (i.e. those with more ‘weight’). By utilizing a ‘fair coin flip’ to ensure a degree of fairness coupled with node weight to allocate bandwidth appropriately MBRI may better assure an efficient use of the wireless channel.

In embodiments, MBRI may provide for dynamic sharing of a communication channel based on nodal transmit and receive requirements using a set of bandwidth metrics in a communication system. Channel access in a wireless ad-hoc communications network may pose the challenge of fair access and efficient use of channel bandwidth. That is, desired properties of a channel access protocol may include fairness (e.g. each node has the opportunity to transmit) and efficient use of channel bandwidth (e.g. bandwidth is utilized fully by the nodes with data to transmit). In embodiments, MBRI may utilize a ‘bandwidth’ facility for improving the efficiency and fairness of channel access. Bandwidth may include the notion of metrics that indicate the level of data activity at a given node. Each node in the network may compute its own bandwidth in and bandwidth out for each of its 1 hop neighbors (e.g. all of the nodes within direct communication range of a transmitter). In turn, neighboring nodes may share bandwidth in and bandwidth out amongst the nodes within a two-hop neighborhood to enable distributed (vices centralized) scheduling. Bandwidth may be used in the calculation to skew the distribution of channel access to those nodes with the most data to transmit (i.e. those with a higher bandwidth out). By utilizing bandwidth out and bandwidth in to compute node weight for use in a ‘fair coin flip’, MBRI may better ensure a degree of fairness and efficient use of the wireless channel.

In embodiments, MBRI may prioritize nested weighted round robin queuing. Prioritized nested weighted round robin queuing may be associated with a parameterized mechanism to provide nodal quality of service for class-based traffic types. In embodiments, weights may meter the traffic onto the communication channel by class with a preemptive priority class of service provided. In embodiments, other queuing disciplines may be used in the MBRI, such as strict priority, simple round robin, and the like.

In embodiments, MBRI may provide for multi-metric based multicast and unicast routing. Heuristics may be developed, utilizing information from both the data link and physical layers, to create minimum cost routes utilizing delay, reliability, data rate capability, and the like, as metrics for the SLSR algorithm. The SLSR algorithm may perform the calculation on the heuristics to determine the minimum cost path. The creation of the heuristics may provide routes over the most reliable, least delay, and highest data rate links between any source and destination in a network. Additionally, tie breaking mechanisms for unicast routing may be added to eliminate the overload of the highest IP address mechanism.

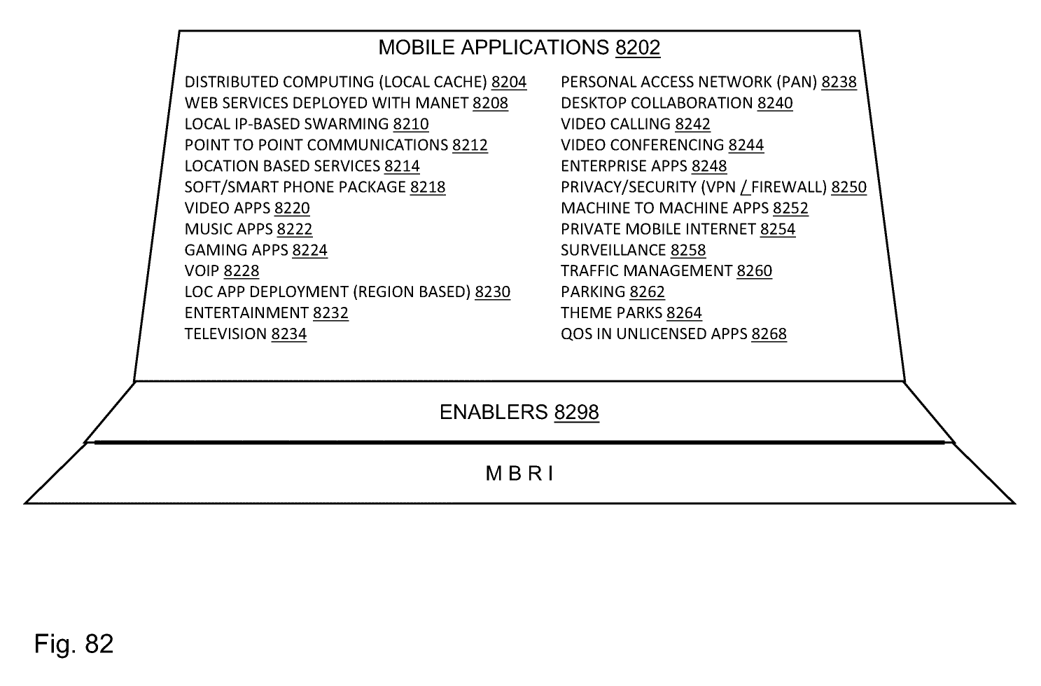

Referring to FIG. 82, a mobile broadband routable internet may be beneficially used with a variety of mobile applications, some of which are described herein, others of which will be understood, and all of which are within the scope of the present disclosure. Mobile applications 8202 may be enabled on the mobile broadband routable internet by one or more enablers associated with the mobile broadband routable internet. The mobile applications 8202 may include distributed computing (local cache) 8204, web services deployed with MANET 8208, local ip-based swarming 8210, point to point communications 8212, location based services 8214, soft/smart phone package 8218, video apps 8220, music apps 8222, gaming apps 8224, VoIP 8228, loc app deployment (region based) 8230, entertainment 8232, television 8234, personal access network (pan) 8238, desktop collaboration 8240, video calling 8242, video conferencing 8244, enterprise apps 8248, privacy/security (VPN/firewall) 8250, machine to machine apps 8252, private mobile internet 8254, surveillance 8258, traffic management 8260, parking 8262, theme parks 8264, QoS in unlicensed apps 8268, and the like. Enablers associated with the mobile broadband routable internet may include routing prioritization, network support for peer-to-peer traffic, peer to peer connectivity within mobile broadband routable internet, facilitating file sharing, user-generated and peer-to-peer applications without degrading system performance, direct device-to-device peering with symmetrical throughput, direct-to-device application deployment (e.g., for web 2.0 apps), distributed data for web apps in the mobile broadband routable internet device, distributed applications, multicast routing, remote network monitoring, control, and upgrade, adaptive transmit power control, FEC on long ip packets, adaptive link data rate, DYSAN—spectrum aware, spectral reuse with high system level throughput, frequency agnostic operation (operation at any frequency), network geo-location, multimedia, time synchronization, seamless outdoor and indoor operation, seamless indoor/outdoor broadband coverage, efficient use of real estate required for fixed radio installation, efficient connection to other wired telecom infrastructure required for connection to other networks, multiple fixed network gateway interfaces, low cost and fast network design engineering and deployment planning, low cost, fast deployment and network turn-up, low cost and fast capacity expansion and network upgrade, efficient use of existing backbone communications infrastructure, network end-user deployment participation, base station controller functions enabled subscriber device, service provider tools to manage consumption in a mobile internet, full radio resource management enabled subscriber device, multi-session enabled subscriber device, cost-based routing in a subscriber device, fully enabled ip router in subscriber device, MAC layer in subscriber device, route diversity, layer 2 forwarding (VPN, etc), internet-equivalent routing to mobile devices outside cellular regime—no need for walled garden or operator control of application deployment), ip application deployment to mobile devices outside cellular regime, mobile internet-style network, entirely local mobile internet applications, broadband throughput data rates to mobile subscriber devices, broadband throughput at vehicular speed mobility, mobile broadband routable internet basic, local ip-based swarming, and the like.

Below are representative embodiments of mobile applications enabled on the mobile broadband routable internet.

Mobile television, such as IP-based television may be enabled by routing prioritization on a mobile broadband routable internet. IP-based television may include streaming video and/or content that may benefit from prioritized routing over the mobile broadband routable internet. IP-based routing of television content may include transmission of the content through a plurality of mobile broadband routable internet nodes to reach a user device displaying the television content. To provide a smooth, pleasing display of television content on a mobile device in the mobile broadband routable internet, routing prioritization may allow the nodes participating in the routing of the television content to have require little or no buffering of the content. Without prioritized routing, content may need to be buffered at one or more of the nodes to ensure smooth delivery and display of the television content. Routing prioritization may facilitate reducing or eliminating the buffering in the user device that displays the television content to the user. Alternatively, television may be available at differentiated levels of performance on the mobile broadband routable internet. Free or advertisement based television may be utilized non-prioritized routing and fee-based or subscription-based television may utilize prioritized routing to ensure high quality television display on devices of the mobile broadband routable internet.

Mobile applications, such as machine-to-machine applications may be enabled by the mobile broadband routable internet support for peer-to-peer traffic. At least the routable nature of the mobile broadband routable internet allows communication among machines (e.g. mobile devices, servers, non-mobile devices, and the like) independently of fixed infrastructure elements. By adding peer-to-peer traffic support, machine-to-machine applications, such as file sharing, distributed databases, and the like may be available on the mobile broadband routable internet even without any fixed infrastructure elements.

Mobile applications, such as a private mobile internet may be enabled by peer-to-peer connectivity associated with the mobile broadband routable internet. Peer-to-peer connectivity may be used to configure a private mobile internet by making the peer-to-peer connections private. Alternatively, by establishing a private mobile internet on the mobile broadband routable internet, peer-to-peer connections accessible through the private mobile internet are also private. Peer-to-peer connectivity over the routing nodes of the mobile broadband routable internet may be implemented as a virtualized network that may be encoded similarly to a virtual private network so that even though the member of the private mobile network access the private mobile network through nodes of the mobile broadband routable internet that are not included in the private mobile network, the content and existence of the private mobile network remains private. Peer-to-peer connectivity within the mobile broadband routable internet may be configured similarly and therefore may facilitate private connection between and among members of a private mobile internet.

Mobile applications, such as video applications may be enabled by facilitating file sharing, user generated applications, peer-to-peer applications, and the like on the mobile broadband routable internet without degrading network system performance. Mobile video applications generally require substantial amounts of network bandwidth to deliver high quality, high fidelity video. It is common to find small form factor mobile devices, such as cellular phones that include digital cameras to capture images and video. Therefore, video content may be readily generated by nodes in the mobile broadband routable internet. Additionally, video content, especially feature length or high definition content may require a large amount of memory for storage. The file sharing and user and peer-to-peer application sharing enablers of the mobile broadband routable internet facilitate mobile video applications on the mobile broadband routable internet by distributing video content memory storage across a plurality of devices (e.g. mobile devices, fixed devices, fixed infrastructure elements, servers, and the like). As an example, mobile video applications operating within the mobile broadband routable internet may access video content using file sharing in a distributed file sharing configuration. Additionally, user generate video content, which may be bundled into a user generated mobile application that includes functionality associated with the video content (e.g. a video player, interactive user interface, forwarding features, blogging interfaces, and the like) can be readily shared among the mobile devices in the mobile broadband routable internet without having to access or interact with fixed infrastructure elements of the mobile broadband routable internet. Sharing of video files, user generated applications, and peer-to-peer applications may also facilitate mobile video applications in the mobile broadband routable internet operating without degrading network system performance through the sophisticated routing capabilities of the mobile broadband routable internet.

Mobile applications, such as point-to-point communication may be enabled on a mobile broadband routable internet through direct device-to-device peering with symmetrical throughput. Although routes taken to communicate between devices in the mobile broadband routable internet may be highly dynamic, the routes may be selected and adjusted dynamically to provide symmetrical throughput between any two nodes or points in the mobile broadband routable internet. In an example, if a first device communicates with a second device that has indicated a request for symmetrical communication, the routing of data will be configured and/or dynamically reconfigured by the first and second devices and any nodes (e.g. devices) providing the connection between the first and second devices to ensure symmetrical throughput. To ensure symmetrical throughput, nodes along the transmission route may select prioritized routing, normal routing, delayed routing, and the like to ensure the throughput is symmetrically balanced between the first and second devices.

Mobile applications, such as web services that are deployed with MANET may be enabled by direct-to-device application deployment (e.g. web 2.0 applications) using a mobile broadband routable internet. Web services (sometimes called application services) are services (usually including some combination of programming and data, but possibly including human resources as well) that may be available from a business's web server for web users and/or web-connected programs. Web service creation and availability present a major internet trend. Generally users can access web services by going to a central server. Some services can communicate with other services through middleware. Also web services are also increasingly enabled by the use of XML as a means of standardizing data formats and exchanging data and as the core language of the Web Services Description Language (WSDL). Access to web services, publishing and deploying web services, and sharing user created web services may be facilitated by direct-to-device application deployment. A user may request that a web service be deployed on his/her mobile device. Direct-to-device application deployment allows the web service provider to deploy the requested web service directly to the user's mobile device without having to clear any security protocol associated with a communication service provider, such as a cellular service provider. In this way, web service applications that may normally execute on the server may now execute on any of the mobile devices having received the direct deployment of the web service. This may facilitate distributing the computing load for and accessibility to the web service.

Mobile applications, such as distributed computing and personal area networking may be enabled by distributed data for web-type applications distributed across two or more mobile broadband routable internet devices. Distributed computing may take advantage of distributed data by allocating computing functions to devices based on accessibility of the distributed data. In an example, if data in a matrix is available on two devices in the mobile broadband routable internet, processing the matrix may be distributed to devices in proximity to the devices holding the matrix data. Personal area networking, which may include, among other embodiments a proximity based network may take advantage of the distributed data capabilities of the mobile broadband routable internet to allow a user to seamlessly access data on any device that is participating in the personal area network.

Mobile applications, such as local applications may be distributed across a local region of mobile broadband routable internet devices. Applications may be localized to a region and may be distributed across a plurality of devices in the region. By distributing the local application across devices in the region, routing delays associated with communicating among the distributed applications executing on devices in the region may be reduced or minimized. Also, the localization of the application may include determining the region for distribution. In an example, application localization may be based on one of a network geo-location and a device home region setting so that only devices within the geo-location and/or having a local home region setting would receive the distributed application. Additionally, application distribution may benefit processing load leveling by distributing application execution across a plurality of mobile broadband routable internet devices.

Mobile applications, such as soft/smart phone applications, enterprise applications, and the like may be enabled by multicast routing capabilities of the mobile broadband routable internet. Multicast routing allows a single source to identify a plurality of destination nodes or no specific destination node to receive a transmission. In this way, all devices that detect the multicast routing transmission may receive the transmission independently of any other device that is receiving the transmission. The mobile broadband routable internet may provide multicast routing by ensuring that the transmission is routed to every node, such as if no destination node is specified, or all specified destination nodes. Therefore, as an example, upgrading a mobile application such as a smart phone application or an enterprise application to which mobile devices on the mobile broadband routable internet are communicating, may be enabled. Enterprise applications may use multicast routing to provide network related updates such as to notify mobile nodes of a planned maintenance activity. Mobile enterprise applications may also benefit from multicast routing to distribute daily updates of information such as inventory, orders, and the like that the mobile users may prefer to access locally to preserve security of the information. Soft/smart phone mobile applications may utilize multicast routing to deliver contact information during a meeting. In an example, a salesman may visit a prospective client and may multicast his contact information to be available to every person in the company or at least a portion of the people, such as the attendees of the meeting.

Mobile applications, such as traffic management may be enabled on the mobile broadband routable internet through remote network monitoring, control, and upgrade. Remote monitoring of vehicular traffic is essential to properly managing the vehicular traffic. The mobile broadband routable internet may facilitate remote monitoring through connection of network devices in vehicles, pedestrians, bicyclists, traffic lights, toll booths, and the like. Data collected through remote monitoring may be analyzed to determine at least one preferred or alternate traffic pattern and remote upgrade may be used to adjust timing of traffic lights and other traffic management features. Even devices that are not directly connected to the mobile broadband routable internet may take advantage of remote upgrade by adapting an upgrade signal originating in the mobile broadband routable internet to contact a device outside the mobile broadband routable internet (e.g. a cellular phone network).

Mobile applications, such as music applications may be enabled by adaptive transmit power control on the mobile broadband routable internet. Mobile music applications may take advantage of the adaptive transmit power control during music searching. The mobile music application may intentionally select a lower transmit power for a search request to preserve power for music playback. If the lower power search request is unsuccessful, a higher power search request may be executed. In this way, the music application may attempt to rely on neighboring nodes to propagate the request throughout the network. Alternatively, the application may adjust transmit power based on signal strength of neighboring devices. Adaptive transmit power control may also be useful to music applications in that during playback, transmit power may be reduced to ensure battery power is reserved for playback time so that it is not diminished by high power music searching.

Mobile applications, such as video conferencing and the like may be enabled on a mobile broadband routable internet by forward error correction (FEC) on long IP packets. As the video conferencing IP connection is routed over the mobile broadband routable internet, portions of the video conference content may be embodied in long IP packets. In an example, video conference may include live video, live audio, data (e.g. image data), and the like. Packaging audio into long packets may reduce the number of packets required for the audio. However, as the long audio packets are transmitted through the ad hoc wireless network nodes of the mobile broadband routable internet, audio quality may be compromised if the content is not properly error corrected and FEC represents a key error correction method enabled in the mobile broadband routable internet.

Mobile applications, such as video calling and the like may be enabled by adaptive data link rate capabilities of the mobile broadband routable internet. A video calling mobile application may include routing video, audio, and control content between two video capable devices of the mobile broadband routable internet. The adaptive data link rate capabilities of the mobile broadband routable internet may facilitate selecting routing based on link data rate so that video and audio quality are maintained even when a link data rate changes. Alternatively, a data link rate may be adjusted, such as it may be increased, to ensure that video data arrives at a destination in time to maintain smooth video display. Video calling may use compression techniques that transmit information about the differences in sequentially captured image frames. Consequently, if the video content does not change from frame to frame, such as if the camera is pointing at an empty room or a static scene, the data link used for transmitting the video may be adapted to use a lower data rate because the amount of data being sent may be substantially reduced.

Mobile applications, such as parking related applications including searching for parking, reserving parking, seeking the reserved parking, paying for parking, and the like may be enabled by dynamic spectrum analysis (DYSAN) capabilities of the mobile broadband routable internet. Mobile parking applications may include vehicle operation in urban areas that include large objects that impact the availability of wireless communication spectrum. As a vehicle enters a tunnel, turns down a busy city street, enters a parking facility, and the like the available spectrum changes rapidly. Such rapid changes are readily accommodated by the DYSAN features of the mobile broadband routable internet and therefore can enable all aspects of mobile parking applications. In an example, a mobile device in a vehicle is communicating with other devices in the mobile broadband routable internet to ascertain parking status near a destination in a distant city. Upon entering the parking facility the vehicle-based mobile broadband routable internet device will be subjected to the impact of structural features on communication as well as a high density of vehicles that may include devices communicating over the mobile broadband routable internet. The spectrum for wireless communication may change dynamically based on the vehicle movement relative to the structural features and the activity from the dense concentration of devices. The DYSAN features of the mobile broadband routable internet may facilitate highly efficient and dynamic use of the available spectrum to ensure high quality connection to the vehicle-based mobile device over the mobile broadband routable internet.

An aspect of the mobile broadband routable internet that may be related to DYSAN is support of spectral reuse while maintaining a high system level throughput. This potentially related capability may enable offering quality of service guarantees for mobile applications on the mobile broadband routable internet. By supporting spectral reuse, as portions of the wireless communication spectrum become available or are determined to offer sufficient signal quality, the mobile broadband routable internet may use the portion of the spectrum, thereby ensuring that any available spectrum is utilized if there is demand for it. Also, because the mobile broadband routable internet may measure spectrum quality and availability, mobile applications may be able to offer quality of service guarantees that are based on up to date spectrum availability and quality.

Another aspect of the mobile broadband routable internet related to wireless operation may include operation of the mobile broadband routable internet at any frequency. This frequency agnostic feature of the mobile broadband routable internet may enable mobile applications such as voice over IP. In an example, a voice over IP mobile application may operate to provide voice communication between two devices connected to the mobile broadband routable internet. The voice over IP application can operate independently of any wireless radio frequency constraints that may be imposed by regulatory bodies, interference from other radio sources (e.g. transformers, broadcast towers, other radio towers, and the like), and the like. By being frequency agnostic, the mobile broadband routable internet is not restricted to certain frequencies of the wireless communication spectrum. In an example, a direct-connect voice over ip mobile application may be operated at a spectrum that is different than existing radio, cellular, and other communication without risk of interference with or from the existing radio communication sources.

Mobile applications, such as location based applications may be enabled by network geo-location features of the mobile broadband routable internet. The unique device based routing and network topology sensing capability of the mobile broadband routable internet facilitates geo-location by being able to detect a device within a swarm of devices. When one or more devices in the swarm is a fixed infrastructure device (e.g. a tower or other fixed radio device), the geo-location of the selected device may be determined as well. In this way, device geo-location may be detected and provided to mobile applications such as location based applications. In an example, a device of a user searching for a tailor may be geo-located to be close to W12th and 47th street in New York City. A location based search application may use the device location to identify and present information about tailors near to the location.

Mobile applications, such as gaming and entertainment may be enabled by multimedia capabilities and features of the mobile broadband routable internet. The multimedia capabilities may be provided on the mobile broadband routable internet through a hybrid frame structure that includes variable slot duration and sub-channelization of bandwidth. Mobile gaming applications may include a large amount of local graphics manipulation to provide a pleasing visual gaming display. However, the information that is communicated among devices participating in the gaming may be rather small in size and duration. However, the information may require high bandwidth to ensure rapid communication of the information so that actions in one of the gaming devices may impact the other gaming devices in near real-time. By providing a hybrid frame structure that supports variable slot duration, short signals among gaming devices may be accommodated at very high speed without utilizing a large amount of communication spectrum. When considering entertainment, the variable slot duration and sub-channelization that may be included in the multimedia features of the mobile broadband routable internet may enable entertainment by utilizing slot duration based on content demand. In an example, transmitting a short signal, such as in gaming or to transmit a user selection in a video game may only require a short duration slot. However, transmitting a portion of a frame of video data may involve larger or longer content that may best be transmitted with a long duration slot. At least as described herein, by providing variable slot duration capabilities the mobile broadband routable internet may offer key features that enable gaming, entertainment, and the like.

Mobile applications, such as desktop collaboration may be effectively enabled by time synchronization features of the mobile broadband routable internet. To allow simultaneous display of a shared virtual drawing board among a plurality of mobile devices, time synchronization of information exchange may be beneficial. Without the coordination of communication among devices that time synchronization provides, updates to users may occur at different times so that a first user may see an update to the virtual shared drawing board before another user. Without synchronization, active updates of the virtual shared drawing board would become out of phase, potentially causing the collaboration session to be ineffective. Time synchronization may also benefit desktop collaboration that includes multiple channels of communication. In an example, desktop collaboration among several devices over the mobile broadband routable internet may include a shared drawing board, a document viewing window, and voice over ip for discussing the shared board and document. By time synchronizing communication associated with the multiple channels of communication, the mobile broadband routable internet may facilitate coordinating the voice over ip and the visual transmissions so that they are arrive at each device with a proper phase relationship.

Mobile applications, such as mobile device use at a theme park may be enabled by seamless outdoor and indoor operation of the mobile broadband routable internet. Theme parks generally include outdoor and indoor activity and amusements. Some of the amusements may be limited to just indoor or just outdoor, however even indoor amusements are generally advertised to outdoor theme park visitors (e.g. signs or other display). By offering seamless outdoor and indoor operation, an outdoor visitor may receive information about an indoor amusement through the mobile broadband routable internet. An indoor mesh access point (MAP) or customer access point (CAP) associated with the indoor amusement may transmit information about the indoor amusement to all outdoor users by first communicating to an outdoor devices such as a fixed infrastructure device outside the indoor amusement. Also, a visitor may use the transmitted indoor amusement information to find the amusement while making a voice over ip phone call with instructions to a companion to join him. Upon entering the amusement, the visitor's device may be detected as being indoors so information related to fees, payment, seating, etc may be provided to the visitor while his voice over ip call continues uninterrupted due to the seamless outdoor and indoor operation of the mobile broadband routable internet.

Additionally, services such as high speed vehicle-based broadband can be enabled through the mobile broadband routable internet. As a vehicle operates at high speed, such as when traveling into and out of tunnels, a broadband connection to a device in or associated with the vehicle can be seamlessly maintained during the transitions. This seamless broadband session may be based on the deployment of MAPs so that a MAP inside the tunnel can communicate with a MAP or a fixed infrastructure element outside the tunnel.

Network security such as virus detection, firewall use, and the like are often found as part of an networked infrastructure. The seamless indoor/outdoor broadband capabilities of the mobile broadband routable internet enable network security independent of location and independent of outdoor/indoor transition. Therefore network security, such as a firewall can be fully functional for indoor use, outdoor use, transitional use, and the like.

Mobile applications, such as security or surveillance may be enabled on the mobile broadband routable internet by efficient use of real estate required for fixed radio installations. Because fixed radio installations associated with the mobile broadband routable internet may be as simple as placing a mobile type device at a planned location, a video surveillance or security camera can be readily equipped with a fixed radio and installed in a location that is most beneficial for the security or surveillance purpose. A casino that has a large plurality of surveillance cameras and recording capability may benefit from deploying mobile broadband routable internet radio enabled surveillance cameras. These adapted cameras could serve a dual purpose including surveillance and mobile broadband routable internet-based wireless communication. The high flexibility and dynamic routing nature of the mobile broadband routable internet devices may facilitate using the mobile device capability associated with the cameras as access points for casino visitor mobile devices.

Mobile applications, such as local IP-based swarming may benefit from and may be enabled by the efficient connection to other wired telecom infrastructure as may be required to connect the mobile broadband routable internet to other networks. Every mobile device of the mobile broadband routable internet may be a routable node and therefore may facilitate connection to other wired telecom infrastructure. In an example of efficient connection to other wired telecom infrastructure enabling local IP-based swarming, a device may include mobile broadband routable internet connectivity and other network (e.g. cellular) connectivity. The device with the cellular connection may act as a gateway between the mobile broadband routable internet and the cellular network. Other devices local to the device may use IP-based swarming methods to determine routing paths among the devices to enable access to the cellular network through the device.

Within the MBRI, multiple fixed-network gateway interfaces (such as and without limitation backhaul access points) may connect the mobile ad hoc network to the fixed network. Some embodiments may provide a distributed computing mobile application that communicates between a mobile device and a device on a fixed network. For example and without limitation, such a mobile application may enable nodes on the MBRI to function as members of a compute cloud. In some embodiments, owners or operators of the mobile device and/or the fixed device may receive compensation for participating in the compute cloud. For example, the owners or operators may receive cash compensation; increased access to computing, storage, network, or other computing resources; public recognition; frequent flier miles; or any and all other forms of reward. In some embodiments the device on the fixed network may be a personal computer, another compute cloud, a computing grid, or any and all other form of computing infrastructure. In any case, the distributed computing mobile application may enable the mobile device and/or the device on the fixed network to access the memory, processor, storage, or any and all other function or service of the other. In embodiments a plurality of mobile devices and/or devices on the fixed network may be present. Communications between the mobile devices and the devices on the fixed network may include IP packets that are routed through the MBRI as described herein and elsewhere. It will be understood that a variety of mobile applications may communicate between a mobile device and a device on a fixed network. All such mobile applications are within the scope of the present disclosure.

An automated network design tool may facilitate low cost and fast network design engineering and deployment planning of fixed infrastructure elements of a MANET. Some embodiments may deploy a web service via the MANET, the web service configured to use a network designed by the design tool. For example and without limitation, MANET provider in San Francisco may wish to seed the city with fixed infrastructure elements (such as mesh access points, backhaul access points, and the like) in order to provide a baseline level of MANET coverage within the city. The MANET provider may use the design tool to engineer and plan deployment of the fixed infrastructure elements. Once the fixed infrastructure elements have been deployed, the web service may be deployed. In this example, the web service may be aware of the fixed infrastructure elements may, based upon a triangulation or other such calculation comparing the relative signal strengths or latencies between a mobile device and the fixed infrastructure elements, estimate the mobile device's location. When the web service is a mobile mapping application, the location may be displayed on a map on the mobile device. The web service may mash-up or aggregate information relating to the location from a variety of web services (e.g. web sites, blog feeds, twitter streams, and so on) and communicate such information to the mobile device for display in association with the location. It will be understood that a variety of mobile applications may be configured to use the network designed by the design tool. All such mobile applications are within the scope of the present disclosure.

In some embodiments, an MBRI may be deployed quickly, at low cost, and with fast network turn-up by deploying a plurality mesh access points to provide network coverage in a geography. Some embodiments may further include a local IP-based swarming application that communicates at least in part via the mesh access points. Communicating with the mesh access points may, at least in part, allow the swarming application to route and forward IP packets through the MBRI. For example and without limitation, the MBRI may include a plurality of mobile devices and mesh access points. Some of the mobile devices may not be in direct communication with one another due to power constraints on radio transmissions, poor signal-to-noise radio of transmissions, extended distances between the mobile devices, radio obstructions between the mobile devices, multi-path effects caused by urban terrain, any and all combinations of the foregoing, and so on. In some such cases, a number of mobile devices that are not in direct communication with one another may be in direct communication with a common mesh access point. The local IP-based swarming application may discover this and route traffic between the mobile devices via one hop through the mesh access point. A variety of other such examples will be appreciated. It will understood that a variety of mobile applications may be associated with the MBRI's ability to be deployed quickly, at low cost, and with fast network turn-up. All such mobile applications are within the scope of the present disclosure.

In some embodiments, an MBRI may be quickly expanded, at low cost, by adding small form factor nodes. These nodes, which may be described in greater detail herein and elsewhere, may include mesh access points, backhaul access points, or the like. In any case a mobile application employing point-to-point communications may communicate via the small form factor nodes. The mobile application may require a user to have line-of-sight between his mobile device and the small form factor node, or to at least to have an antenna of his mobile device properly oriented with respect to the small form factor node. It will be understood that a variety of mobile applications using point-to-point communications are possible. All such mobile applications are within the scope of the present disclosure.

In some embodiments, an MBRI may make efficient use of existing backbone communications infrastructure. Such embodiments may route communications between a mobile device and a device on a remote network so as to substantially favor routes through the mobile, broadband, routable Internet that have fewer hops between the mobile device and a backhaul access point. A mobile application providing location-based services may utilize such communications. For example and without limitation, the mobile application may provide a user with information about the neighborhood in which he is walking. The mobile application may first communicate geographical coordinates of the user's mobile device to a server on a fixed network, the communication traveling through the MBRI via a relatively small number of hops to the backhaul access point bridging the MBRI to the fixed network. The server may respond to the geographical coordinates by transmitting information related to the coordinates back to the mobile device, the communication traveling through the fixed network to the backhaul access point and then through the MBRI via a relatively small number of hops to the mobile device. It will be understood that a variety of mobile applications providing location-based services are possible. All such applications are within the scope of the present disclosure.

In some embodiments, a user deployable access point may connect to the MBRI network. A mobile application may utilize said access point. An example of such a mobile application may be a soft/smart phone package in which the access point is embodied. When the user powers on the soft/smart phone, it may perform as an access point within the MBRI. It will be understood that a variety of mobile applications utilizing the user deployable access point are possible. All such mobile applications are within the scope of the present disclosure.

In some embodiments, a base station controller function may be provided in at least one subscriber's mobile device. A mobile application may utilize at least one of the controller functions. For example and without limitation, a video mobile application may utilize a controller function that configures an air interface of the base station to provide adequate bandwidth and suitable signal-to-noise ratio for communication of a substantially real-time video stream between the mobile device and the base station. In some embodiments, a previous configuration of the air interface or base station may be restored by the mobile application after transmission of the video stream has concluded. It will be understood that a variety of mobile applications that employ at least one of the base station controller function are possible. All such mobile applications are within the scope of the present disclosure.

In some embodiments, a service provider tool may be provided, the service provider tool for manage consumption of at least one device on the ad hoc network of the MBRI. The tool may be deployed on at least one of the plurality of mobile devices of the MBRI and may use at least one management path for reporting usage of the at least one device. A mobile application may report its computing/network resource utilization (i.e. usage) by using the path. For example and without limitation, a music mobile application may download or stream content from sources that are within and/or reachable via the MBRI. Such downloading or streaming may consume network resources, such as and without limitation network bandwidth. The music mobile application may report such consumption of network resources over the path. In some embodiments, the path may include a limited bandwidth, un-metered backchannel or the like between the mobile device running the music mobile application and a management server or the like. It will be understood that a variety of mobile applications that employ the path are possible. All such mobile applications are within the scope of the present disclosure.

In some embodiments, full radio resource management functions may be provided in a subscriber's mobile device. These management functions may enable a mobile application, which may operate responsively to a state of a managed radio resource. For example and without limitation, a gaming mobile application may allow a plurality of users to participate in a multi-player game, but only when the users' mobile devices have their radio resources switched into an appropriate state. The gaming mobile application may detect the state and may provide the multi-player game when the appropriate state is detected. It will be understood that a variety of mobile applications that operate responsively to a state of a managed radio resource are possible. All such mobile applications are within the scope of the present disclosure.

In some embodiments, multi-session functions may be provided in at least one of a plurality of devices of an MBRI. In such embodiments, a mobile application may communicate via multiple sessions. For example and without limitation, a VoIP mobile application may use one session for transmitting substantially real-time data that encodes voices waveforms while using a second session for transmitting lower priority signaling data. The one session may be configured to transmit data with low latency, low jitter, or the like, even if delivering such quality of service requires that greater resource utilization costs per bit will be incurred as compared with a lower quality of service configuration. The second session, on the other hand, may be configured with a lower quality of service configuration that requires, on average, that fewer resources per bit be consumed. The second channel may provide lower quality of services levels (e.g. greater latency, greater jitter, and so on) than the one channel, which may be acceptable given the nature of the data being transmitted over the second channel. It will be understood that a variety of mobile applications that communicate via multiple channels are possible. All such mobile applications are within the scope of the present disclosure.

In some embodiments, cost-based routing functions may form and reform links and routes through the MBRI. A mobile application may use the cost-based routing functions to deliver a desired balance of cost and quality of service. For example and without limitation, a mobile application may include installing itself on mobile devices within a particular region of the MBRI. The mobile application may determine which mobile devices are within the region my limiting installation to those mobile devices that can be reached through the MBRI while incurring up to but not more than a given cost. The cost may be measured in terms if Jules-per-bit, hops-per-packet or time-to-live, or the like. The desired balance of cost and quality of service may relate to the number of Jules consumed MBRI-wide to install the application (e.g. more Jules equals higher cost) and the number of mobile devices on which the application is installed (e.g. more mobile devices results in higher quality of service). It will be understood that a variety of applications that use cost-based routing functions to deliver a desired balance of cost and quality of service are possible. All such mobile applications are within the scope of the present disclosure.

In some embodiments, a IP router functions may be provided in a subscriber's mobile device. A mobile application may use the IP router functions to communicate via the ad hoc network. For example and without limitation, an entertainment mobile application may receive communications containing multimedia content or the like. These communications may reach a mobile device running the mobile application via the MBRI. The communications may traverse any number of intermediate mobile devices through the MBRI in order to reach the mobile device running the mobile application. The IP router functions within the intermediate mobile devices may route such communications through the MBRI, thus enabling such communication via the ad hoc network. It will be understood that a variety of mobile applications that use the IP router functions to communicate via the ad hoc network are possible. All such mobile applications are within the scope of the present disclosure.

In some embodiments, at least one of a plurality of mobile devices in an MBRI may include media access control layer capabilities. A mobile application may use the MAC layer capabilities to communicate via the ad hoc network. For example and without limitation, a television mobile application may receive multicast or broadcast signals from a television source, which may be a mobile device on the MBRI or a fixed network connected to the MBRI. The television mobile application may only receive data packets having a MAC address of the television source. Although this may not guarantee that the data packets are in fact from the television source (in some embodiments, the MAC address may be spoofed), it will limit the number of packets that an instance of the television mobile application needs to consider when listening to multicast or broadcast packets. It will be understood that a variety of mobile applications that use the Mac layer capabilities to communicate via the ad hoc network are possible. All such applications are within the scope of the present disclosure.

In some embodiments, route diversity may be provided within an MBRI network to facilitate assurance of packet communication. Route diversity may be based at least on a number of network devices in a geographic area, which provide a diverse selection of routes through which packet communication may travel. A mobile application may use route diversity to communicate via the ad hoc network of an MBRI. For example and without limitation, a personal area network may be a mobile application that uses route diversity. The personal area network may connect a variety of devices that are within close proximity of one another, such as and without limitation carried on one's person. At least one of the variety of devices may be connected to the MBRI. Route diversity may help ensure that the MBRI-connected device remains in communication with the MBRI, even has environmental or other factors that may affect connectivity change. The variety of devices may communicate with other devices in the MBRI through the MBRI-connected device. Thus, some or all of the devices may serve as a personal-area-network-to-MBRI bridge. It will be understood that a variety of mobile applications using route diversity to communicate via the ad hoc network are possible. All such applications are within the scope of the present disclosure.

In some embodiments, layer 2 forwarding may be provided within an MBRI, and a mobile application may communicate via said forwarding. For example and without limitation, a desktop collaboration mobile application may enable a plurality of users to share a single desktop interface. The desktop interface may appear on each of the users' mobile devices and interactions with the desktop on one device may suitably affect the desktop as it appears on the other devices. The instances of this mobile application may communicate with one another via a virtual private network, which may employ the layer 2 forwarding. It will be understood that a variety of mobile applications that communicate via layer 2 forwarding are possible. All such mobile applications are within the scope of the present disclosure.

In some embodiments, a node in an MBRI may also communicate with a cellular network through at least one fixed infrastructure element (e.g. a cell tower or the like) while the MBRI is provided outside the cellular network. In such embodiments a mobile application may communicate both through the cellular network and the MBRI's mobile ad hoc network. For example and without limitation, a video calling mobile application may provide three-way video calling between mobile devices on the MBRI and the cellular network. The mobile device of a first caller on the MBRI may connected to the mobile device of a second caller that is communicating via the MBRI and the fixed infrastructure element. The mobile device of a third caller on the cellular network may communicate with the mobile device of the second caller via the fixed infrastructure element. During the three-way call, the second device may more or less simultaneously communicate with the MBRI and the fixed infrastructure element to enable the call, that is to enable the transmission of video-and-voice data end-to-end between the first caller's mobile device and the third caller's mobile device. It will be understood that a variety of mobile applications that communicate through the cellular network and the mobile ad hoc network are possible. All such applications are within the scope of the present disclosure.

In some embodiments, IP application deployment may be provided to a device in an MBRI network. In addition to communicating with the MBRI, the device may also communicate with a cellular network through at least one of the fixed infrastructure elements of the MBRI. The application deployed over IP may be deployed over the MBRI (i.e. outside of the cellular network). For example and without limitation, a video conferencing mobile application may be deployed over IP to a device in the MBRI network. It will be understood that a variety of mobile applications may be deployed over IP to a device in the MBRI network, the device also communicating with the cellular network. All such applications are within the scope of the present disclosure.

In some embodiments, data packets may be routed through the mobile ad hoc network of an MBRI. The data packets may be IP packets or the like, and thus the MBRI may provide a mobile Internet-style network. Mobile applications may communicate via the data packets. For example and without limitation, an enterprise mobile application on a mobile device operatively coupled to the MBRI may communicate data packets encoding information relating to an enterprise. Such information may without limitation include calendar events, notes, email messages or the like, photographs, video, any and all combinations of the foregoing, and so on. The communication of data packets may be between multiple instances of the enterprise application running on multiple mobile devices operatively coupled to the MBRI; between a mobile device and a device on a fixed network, the fixed network operatively coupled to the MBRI by a backhaul link or the like; and so on. It will be understood that a variety of mobile applications may communicate via the data packets. All such applications are within the scope of the present disclosure.

In some embodiments, data packets may be routed through the mobile ad hoc network of an MBRI absent communications with fixed infrastructure elements of the MBRI. Mobile applications may communicate via data packets so routed. For example and without limitation, a privacy/security mobile application may receive the data packets; inspect them according to a policy (e.g. a firewall policy, a security policy, or the like); and then allow or deny the packets passage through the privacy/security mobile application to another application, network interface, or the like. It will be understood that a variety of mobile applications may communicate via data packets routed through the mobile ad hoc network absent communications with fixed infrastructure elements. All such applications are within the scope of the present disclosure.

In some embodiments, during normal operations the MBRI may provide broadband communications of at least 768 kbit/sec between nodes. Mobile applications may communicate via the broadband communications. For example and without limitation, machine-to-machine mobile applications may communicate via the broadband connections to keep in sync distributed databases, distributed shared memory, or the like. It will be understood that a variety of mobile applications may communicate via the broadband communications. All such applications are within the scope of the present disclosure.

In some embodiments, the MBRI may provide communications to nodes having a throughput of at least 768 kbit/sec when the nodes are in motion at vehicular speeds. Mobile applications may use such communications. For example and without limitation, a private mobile internet application may allow a restricted group of mobile devices in cars to communicate without exposing the content of such communications to eavesdroppers or other mobile devices. In some embodiments, the cars may be law enforcement vehicles and the communications may relate to coordinating the efforts of law enforcers. It will be understood that a variety of mobile applications may use communications as described in this paragraph. All such applications are within the scope of the present disclosure.

In some embodiments, a mobile application may communicate via the mobile ad hoc network of an MBRI. For example and without limitation, a surveillance mobile application may communicate video, audio, alarms, or the like via the mobile ad hoc network. The communications may be transmitted and/or received by mobile devices operatively coupled to the mobile ad hoc network. It will be understood that a variety of mobile applications may communicate via the mobile ad hoc network. All such applications are within the scope of the present disclosure.

In some embodiments, swarm intelligence may determine at least part of at least some routes through an MBRI. A mobile application may communicate via the MBRI. For example and without limitation, a traffic management mobile application may monitor network traffic on the MBRI to observe any affect of the routes chosen by the swarm intelligence. A user may access the traffic management mobile application to enable, disable, or otherwise modify the swarm intelligence's behavior. Alternatively or additionally, the traffic management mobile application may provide reports showing performance characteristics (e.g. latency, number of hops, packet lass, and so on) of routes selected by the swarm intelligence as compared with routes selected by other routing protocols or methods. It will be understood that a variety of mobile applications may communicate via an MBRI in which swarm intelligence determines at least port of at least some routes. All such applications are within the scope of the present disclosure.

Within the MBRI, multiple fixed-network gateway interfaces (such as and without limitation backhaul access points) may connect the mobile ad hoc network to the fixed network. A mobile application may communicate between a mobile device and a device on the fixed network. For example and without limitation, a parking mobile application may operate on a mobile device used by parking enforcement personnel. The parking mobile application may communicate via the MBRI to a central parking enforcement application running on a computer connected to the fixed network. As the personnel create a new parking ticket on the mobile device, communications between the mobile device and the computer may serve to update a central database containing information relating to issued tickets. It will be understood that a variety of mobile applications may communicate between a mobile device and a device on a fixed network. All such mobile applications are within the scope of the present disclosure.

An automated network design tool may facilitate low cost and fast network design engineering and deployment planning of fixed infrastructure elements of a MANET.

Some embodiments may deploy a theme park mobile application via the MANET. For example and without limitation, the theme park mobile application may operate on a mobile device held by a theme park patron. The mobile device and mobile application may together provide the patron with ability to jump substantially to the head of a line (e.g. the mobile device may display a message that indicates to a park attendant that the patron may jump the line). In order to operate, the mobile device may require connectivity to the MANET so that it can communicate with and coordinate with other mobile devices to provide for a desired distribution over time of line-jumping patrons at any particular park attraction. The automated network design tool may be employed to design and plan the deployment of fixed infrastructure elements of the MANET throughout the park, thus ensuring that adequate MANET coverage exists throughout the park. It will be understood that a variety of mobile applications may be configured to use the network designed by the design tool. All such mobile applications are within the scope of the present disclosure.

In some embodiments, an MBRI may be deployed quickly, at low cost, and with fast network turn-up by deploying a plurality mesh access points to provide network coverage in a geography. Mobile applications may be configured to communicate at least in part via the mesh access points. Such mobile applications may include an unregistered mobile application receiving a certain QoS provided by the MBRI with mesh access points. For example and without limitation, an application may operate as an unregistered application until a user possessing a registration key registers it. While operating as an unregistered mobile application, the application may receive the certain QoS from the MBRI. Once registered, however, the application may receive a different and more desirable QoS from the MBRI. In some embodiments, a provider of the MBRI (or any other entity) may receive compensation for issuing the registration key to the user. It will understood that a variety of mobile applications may be associated with the MBRI's ability to be deployed quickly, at low cost, and with fast network turn-up. All such mobile applications are within the scope of the present disclosure.

Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A computer program product embodied in a computer readable medium that, when executing on one or more computers, operates a mobile ad hoc network (MANET) by performing the steps of:
providing a mobile, broadband, routable internet (MBRI), in which a plurality of mobile devices interact as nodes in the MANET and in which packets are IP routable to the individual device independent of fixed infrastructure elements, wherein the nodes provide functional interaction with other nodes within the MANET to enhance MBRI operability; and
enabling a network characteristic to improve network operability for a mobile application.

2. The computer program product of claim 1, wherein the mobile application is at least one of a distributed computing mobile application, web services mobile application, point-to-point communications mobile application, location-based services mobile application, smart phone mobile application, video mobile application, music mobile application, gaming mobile application, voice over IP mobile application, local deployment mobile application, entertainment mobile application, television mobile application, personal area network mobile application, desktop collaboration mobile application, video calling mobile application, video conferencing mobile application, enterprise mobile application, privacy mobile application, security mobile application, machine-to-machine mobile application, private mobile Internet mobile application, surveillance mobile application, traffic management mobile application, parking mobile application, and unlicensed quality of service mobile application.

3. The computer program product of claim 1, wherein the network characteristic is providing routing priority within the network.

4. The computer program product of claim 3, wherein the routing priority is provided by granting channel access to a node for which prioritized routing is identified and sending delay-sensitive data from the node before sending delay-tolerant data from the node, and providing a voice over IP mobile application that uses the routing priority to manage routing of data within the mobile, broadband, routable internet.

5. The computer program product of claim 1, wherein the network characteristic is providing direct device-to-device peering with symmetrical output between at least two nodes of the MBRI.

6. The computer program product of claim 5, wherein the direct device-to-device peering enables a video conferencing mobile application.

7. The computer program product of claim 1, wherein the network characteristic is providing multicast routing.

8. The computer program product of claim 7, wherein the multicast routing enables a television mobile application.

9. The computer program product of claim 8, wherein the television mobile application provides broadcast television.

10. The computer program product of claim 8, wherein the television mobile application provides simulcast television.

11. The computer program product of claim 1, wherein the network characteristic is providing adaptive transmit power control.

12. The computer program product of claim 11, wherein the adaptive transmit power control enables a point-to-point communications mobile application.

13. The computer program product of claim 12, wherein the point-to-point communications mobile applications enables multiple parallel conversations on the same channel and frequency through power control in a geographic region.

14. The computer program product of claim 1, wherein the network characteristic is providing forward error correction.

15. The computer program product of claim 14, wherein the forward error correction enables a surveillance mobile application.

16. The computer program product of claim 1, wherein the network characteristic is providing dynamic spectrum access (DYSAN).

17. The computer program product of claim 16, wherein DYSAN enables machine-to-machine mobile applications.

18. The computer program product of claim 16, wherein DYSAN enables machine-to-machine mobile applications in an area with a high density of nodes.

19. The computer program product of claim 1, wherein the network characteristic is providing Internet-equivalent routing to mobile devices outside a cellular regime.

20. The computer program product of claim 19, wherein the Internet-equivalent routing enables the mobile device to be a mobile Internet portal.

21. The computer program product of claim 1, wherein the network characteristic is providing a mobile Internet-style network.

22. The computer program product of claim 21, wherein the mobile Internet-style network enables the mobile device to be a mobile Internet portal.

23. The computer program product of claim 1, wherein the network characteristic is providing local IP-based swarming.

24. The computer program product of claim 23, wherein the local IP-based swarming provides swarm intelligence to determine at least some parts of at least some routes through the MBRI.

25. The computer program product of claim 23, wherein the local IP-based swarming enables swam-based searching through a swarm-based searching web application.
